(19) United States
(12) Patent Application Publication
(10) Pub. No.: US 2009/0314005 A1
(43) Pub. Date: Dec. 24, 2009

(54) PISTON ENGINE SYSTEMS AND METHODS

(75) Inventor: Hans-Peter Messmer, Vienna (AT)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: Green Partners Technology GmbH

(21) Appl. No.: 12/340,466

(22) Filed: Dec. 19, 2008

Related U.S. Application Data
(60) Provisional application No. 61/016,344, filed on Dec. 21, 2007.
(60) Provisional application No. 61/091,297, filed on Aug. 22, 2008.

(51) Int. Cl. F02C 3/10; F01L 9/04; F02G 3/00; F01N 5/02; F02M 25/07

(52) U.S. Cl. 60/792; 123/90.11; 60/624; 60/320; 123/568.11

(57) ABSTRACT

The method for operating a piston engine system that includes modifying valve timing such that the gas displaced from the piston chamber is at a pressure and temperature nearly equivalent to the temperature and pressure at the end of the combustion stroke rather than being throttled as is the case for traditionally valve timings. When the high temperature and pressure gas enters an exhaust channel, thermally isolating means may line the exhaust channel such that the high temperature of the exhaust gas is maintained. A heat exchanger and an expander may be placed along the exhaust channel such that the high temperature and pressure of the exhaust gas are captured for useful work.

### RELATED APPLICATIONS

The present invention claims the benefit, under 35 USC §119(e), of the filing of U.S. Provisional Patent Application Ser. No. 61/016,344, entitled “Piston Engine System and Methods,” filed Dec. 21, 2007, and U.S. Provisional Application Ser. No. 61/091,297, entitled “System and Method for Improving the Efficiency of Piston Engines Operating in Partial Load,” filed Aug. 22, 2008, and these applications are incorporated herein for all purposes. U.S. Provisional Application entitled “Gas Turbine Systems and Methods” (Serial Number to be determined) filed concurrently herewith is a related application, the entire disclosure of which is incorporated herein by reference.

### TECHNICAL FIELD

The embodiments disclosed herein relate to internal combustion piston engines, and in particular to a system and method for increasing efficiency, increasing power, and reducing failure of such engines.

### BACKGROUND

Internal combustion piston engines are used in various applications. The most common cycles used in piston engines are the Otto cycle or the Diesel cycle. Piston engines may include any number of cylinders.

Four-stroke internal combustion engines, such as automotive gasoline or diesel engines, include the following strokes: (i) an intake stroke, (ii) a compression stroke, (iii) a combustion stroke, and (iv) an exhaust stroke. During a traditional four-stroke process, the intake stroke begins with the piston at the top (top-dead-center) of the cylinder, the intake valve opens, and the piston moves down to the bottom (bottom-dead-center) of the cylinder to draw air and gasoline into the cylinder. During the compression stroke the valves are closed, and the piston moves back up to compress the fuel-air mixture. During the combustion stroke, when the piston reaches the top of its stroke, the fuel is ignited and explodes to drive the piston down. Finally, during the exhaust stroke, the discharge valve opens and the exhaust gas leaves the cylinder as the piston moves up again.

A 2-stroke engine, however, performs compression and combustion with only two strokes or one revolution of the crank shaft. The intake and exhaust stroke happen simultaneously while the piston is at its bottom-dead-center position. The gas in the intake pipe is at a higher pressure than the gas being exhausted from the cylinder. Therefore, the intake gas pushes the gas in the cylinder into the exhaust pipe. The compression stroke occurs when the valves are closed and the piston moves to top-dead-center. Then, the fuel is ignited and explodes driving the piston to bottom-dead-center again.

Each of the above type engines can be naturally aspirated, super-charged, or turbo-charged. A naturally aspired engine receives air directly from the atmosphere. Super-charged and turbo-charged engines each employ a compressor to pack more mass of air and fuel into the cylinder. A super-charged engine runs the compressor off of a belt connected to the engine's drive shaft. A turbo-charged engine's compressor is driven by an exhaust stream expansion turbine. However, sometimes these terms are used interchangeably to mean any type of engine that compresses air and/or air and fuel prior to injecting it into the cylinder.

However, here are numerous inefficiencies and problems with the conventional piston engine systems. For example, naturally aspired and super-charged engines do not make use of the increased temperature and pressure of the exhaust stream. Even turbo-charged engines are inefficient because they require that the exhaust channel be kept at a lower pressure than that of the combusted product exhausted from the combustion chamber. This pressure loss is thermodynamically inefficient because it cannot be recovered or used to achieve useful work. Therefore, it would be advantageous to develop a system for more efficiently using the high exhaust temperature and pressure.

Moreover, current piston engines often use much more fuel than is required while idling, i.e., when they are in part-load, than they do when they are fully loaded to produce the same specific power (mechanical kW per thermal kW of the fuel). Therefore, it would be advantageous to devise a method for consuming less fuel during a partially loaded state.

Furthermore, the high pressure in piston engines often causes wear and failure. It would be advantageous to lower the compression end pressure in a cylinder while still keeping the compression end temperature high, in order to reduce wear without penalizing the power, density, and efficiency of the engine.

Compressed air provides more mass to a piston engine. However, compressed air received from a traditional compressor is also hotter than uncompressed air. The mechanical components of a piston engine may be jeopardized when exposed to high thermal stresses. It would be advantageous to compress air without increasing its temperature and to discharge such thermal energy into the environment at comparably low temperature levels.

Traditionally, pistons and cylinders use external cooling mechanisms to stay cooler than peak combustion temperatures. However, external cooling techniques are thermodynamically inefficient as the heat is typically lost to a cooling medium and not re-used. It would therefore be advantageous to develop a system for thermally isolating a piston and cylinder. Such a system would protect the piston and cylinder from thermal stresses while retaining the thermal energy normally lost through cooling these components. This thermal energy could then be used to perform useful work.

Also, high temperatures in the exhaust flow may surpass the mechanical resistance of traditional expansion turbines. Therefore, it would be advantageous to develop a method to lower the exhaust temperature.

In light of the above, it would be highly desirable to provide various systems and methods for increasing the efficiency of piston engines and longevity of the components of piston engines.

### SUMMARY

Conventional piston engines do not fully utilize the engine's exhaust stream. According to some embodiments, there is provided a method for extracting combustion level pressure from a four-stroke piston engine. The method comprises the steps of: (1) combusting a gas such that the gas has a first pressure at the end of a combustion stroke; (2) exhausting the gas into an exhaust gas flow path having substantially the first pressure during an exhaust stroke; (3) expanding the gas to a second pressure lower than the first pressure without introducing any additional gas during a portion of an intake stroke; (4) introducing aspired gas having a third pressure into the chamber when the second pressure is no greater than the third pressure during the remainder of the intake stroke; and (5) proceeding with a compression stroke. The process is then repeated.

In some embodiments, the first pressure of the exhaust gas flow is maintained in the exhaust pipe by a valve or turbine. In some embodiments, the exhaust gas flow is passed through an exhaust turbine to extract energy or rotate an electrical generator. In some embodiments, the intake air is first passed through a compressor prior to entering the piston engine chamber. In some embodiments, the compressor is run on the same shaft as the exhaust turbine. In some embodiments, the intake air is passed through an intercooler after it is compressed, and prior to entering the piston engine chamber. In some embodiments, the exhaust pipe is thermally isolated. In some embodiments, the isolation is performed by isolation chambers with highly reflective surfaces. In some embodiments, the isolation chambers are filled with gas. In some embodiments, the isolation chambers are maintained under a vacuum. In some embodiments, thermal isolation is performed by ceramic inserts within the exhaust pipe. Such inserts may be added to conventional engines after market.

Conventional piston engines often use more fuel than is required during part-load because more air-fuel mixture than is necessary is injected into a piston engine at a relatively high pressure. According to some embodiments, there is provided a method for pre-expanding aspired air in a piston engine. The method comprises the steps of: (1) during a portion of an intake stroke, introducing gas at a first pressure into a cylinder, (2) during the remainder of the intake stroke, lowering the pressure to a second pressure lower than the first pressure without introducing any additional gas into the cylinder, and (3) proceeding with the compression, combustion, and exhaust strokes as in a traditional four-stroke engine.

In the above described embodiments, there may be times when the exhaust pressure is below the ambient pressure at the beginning of the exhaust stroke. This situation would most likely occur during extreme part-load. In this case, the discharge valve is opened later when the ambient and cylinder pressure are approximately equal.

High pressures in piston engines often cause wear and failure. Therefore, in some embodiments, a pre-heated intake air-fuel mixture is injected into the piston engine utilizing pre-expansion valve timing. In these embodiments, the final temperature after pre-expansion is similar to a traditional engine's air-fuel temperature at injection. Thus, under the fully loaded embodiments, the air-fuel mixture to be combusted is under a lower pressure than in traditional engines while being at approximately the same temperatures thereby reducing wear without penalizing the power, density, and efficiency of the engine.

According to some embodiments, there is provided a method for managing fuel consumption in a partly loaded (hereinafter “part-load”) or fully loaded (hereinafter “full-load”) engine. The method comprises the steps of: (1) extracting heat from an engine's exhaust flow, (2) using the heat to increase the temperature of an ambient intake gas flow to a heated gas flow, (3) during a portion of an intake stroke, introducing the heated gas flow at a first pressure into a cylinder of the engine, and (4) proceeding with the remainder of the intake, compression, combustion, and exhaust strokes as in a traditional four-stroke piston engine. In some embodiments, during the remainder of the intake stroke, the piston engine lowers the pressure to a second pressure lower than the first pressure without introducing any additional gas into the cylinder.

In some embodiments, the exhaust gas circulation to the heat exchanger is controlled by means of a 3-way valve with a flap. The valve routes the exhaust out of exhaust pipe during full-load and routes the exhaust through the heat exchanger by means of the connecting channel during part-load.

According to some embodiments, there is provided another method for managing fuel consumption in a part-load engine. The method comprises the steps of: (1) extracting heat from an engine's exhaust flow; (2) using the heat to increase the temperature of a first ambient intake gas flow to a heated gas flow; (3) mixing the heated gas flow with a second ambient intake gas flow to a mixed gas flow; (4) during a portion of an intake stroke, introducing the mixed gas flow at a first pressure; (5) during the remainder of the intake stroke, lowering the first pressure to a second pressure lower than the first pressure without introducing any new air into the chamber; and (6) proceeding with the compression, combustion, and exhaust strokes as in a traditional four-stroke piston engine.

According to some embodiments, there is provided another method for managing fuel consumption in a partially loaded engine. The method comprises the steps of: (1) extracting an exhaust gas flow; (2) mixing the exhaust gas flow with an ambient intake gas flow to obtain a warmed mixed gas flow; (3) during a portion of an intake stroke, introducing the warmed mixed gas flow at a first pressure; (4) during the remainder of the intake stroke, lowering the first pressure to a second pressure lower than the first pressure; and (5) proceeding with the compression, combustion, and exhaust strokes as in a traditional four-stroke piston engine.

In some embodiments, a cooler is added to a recirculation pipe to cool the exhaust gas before mixing with the ambient air during full-load conditions. In this way the benefits of re-circulation can be achieved even during full-load when a heated intake gas is not desirable. In some embodiments, if a cooler is used during full-load, a bypass pipe is used to route the exhaust gas around the cooler during part-load. In some embodiments, exhaust gas circulation to the heat exchanger is controlled by means of a 3-way valve with a flap. The valve routes the exhaust gas out of the exhaust pipe during full-load and routes the exhaust gas through the heat exchanger by means of the connecting channel during part-load.

According to some embodiments, there is provided another method for managing fuel consumption in a part-load engine. The method comprises the steps of: (1) during a first portion of an intake stroke, introducing both an aspired gas and an exhaust gas at substantially a first pressure; (2) during a second portion of the intake stroke, lowering the first pressure to a second pressure lower than the first pressure without introducing any additional air or fuel; and (3) proceeding with the compression, combustion, and exhaust strokes as in a traditional four-stroke engine.

Alternatively, in some embodiments, the method comprises the steps of: (1) during a first portion of an intake stroke, opening both an intake valve and a discharge valve, such that air is aspired from the exhaust channel, as well as the intake channel at a first pressure; (2) during a second portion of the intake stroke, closing both an intake valve and a discharge valve and lowering the first pressure to a second pressure lower than the first pressure without introducing any additional air or fuel; and (3) proceeding with the compression, combustion, and exhaust strokes as in a traditional four-stroke piston engine.

According to some embodiments, there is provided another method for managing fuel consumption in a partially loaded engine. The method comprises the steps of: (1) during an exhaust stroke, opening both an intake valve and a discharge valve, such that exhaust gas escapes into an intake channel, as well as an exhaust channel at a first pressure; (2) during a first portion of an intake stroke, closing the discharge valve; (3) during a second portion of an intake stroke, closing the intake valve and lowering the first pressure to a second pressure lower than the first pressure without introducing any additional air or fuel; and (4) proceeding with the compression, combustion, and exhaust strokes as in a traditional four-stroke piston engine.

During extreme part-load, the exhaust pressure is below ambient pressure at the beginning of the exhaust stroke. If this is the case the discharge valve is opened later in the exhaust stroke. In these embodiments, the discharge valve is opened when the ambient and cylinder pressure are approximately equal.

Compressed air provides more mass to a piston engine. However, compressed air received from a traditional compressor is also hotter than uncompressed air. In some embodiments, fluid is injected and evaporated during compression. Such evaporation cools the compressed air. As such, the end compression temperature is near that of the temperature of the air at the intake of the compressor. In such embodiments, all of the injected fluid is vaporized such that the fluid droplets do not cause damage to the compressor blades and other components during compression.

According to some embodiments, there is provided a method for reducing wear and improving the power density of a piston engine. The method comprises the steps of: (1) compressing an ambient gas having a first temperature to a compressed gas; (2) diffusing the compressed gas to a low velocity gas; (3) injecting a liquid into the low velocity gas; (4) evaporating the liquid within the low velocity gas to create a vaporized gas mixture having a second temperature, where the second temperature is higher than the first temperature; (5) heating the vaporized gas mixture to a third temperature higher than the second temperature by means of a heat exchanger; (6) during a portion of an intake stroke, introducing the gas mixture at a first pressure; (7) closing an intake valve; (8) during the remainder of the intake stroke, lowering the pressure to a second pressure lower than the first pressure; (9) performing compression, combustion, and exhaust strokes; (10) expelling exhaust gas through an expander; (11) passing the exhaust gas through the heat exchanger; and (12) discharging the exhaust to the environment.

Using liquid vaporization to decrease a fluid's temperature can also be advantageous in the piston chamber. According to some embodiments, there is provided a method for operating a piston engine with liquid injection. The method comprises the steps of: (1) during a first part of a compression stroke, adding a liquid to a gas in a piston chamber, where the liquid evaporates into an evaporated fluid; (2) during a second part of the compression stroke, further compressing the gas and the evaporated liquid; (3) combusting the gas and the evaporated liquid to a combusted product; (4) exhausting the combusted product; and (5) proceeding with an intake stroke as in a traditional four-stroke piston engine.

In some embodiments, fluid is added during the compression stroke of either a 2-stroke or a four-stroke engine. In some embodiments, the temperature of the injected liquid is at a level between ambient and compression temperature. In some embodiments, three quarters (¾) of the overall compression time is isothermal, giving the injected liquid plenty of time to vaporize. In some embodiments, the pressure in the intake valve is higher than that of the discharge valve, causing no throttling or reflow problems. In some embodiments, the exhaust gas collection pipe maintains substantially the same pressure as the piston after the combustion cycle is over. This exhaust collection pipe pressure is only slightly lower than the inlet collection pipe pressure. In some embodiments, injection of the fluid in the piston chamber is controlled by the piston movement (appropriately designed camshaft) or by an electromagnetic valve.

According to some embodiments, there is provided: (1) compressing ambient aspired air with liquid to a substantially complete saturated compressed gas; (2) heating the saturated compressed gas to a heated compressed gas in a heat exchanger; (3) drawing the heated compressed gas into a piston chamber; (4) during a first part of a compression stroke, adding a liquid to a gas in the piston chamber; (5) evaporating the liquid during the first part of the compression stroke; (6) during a second part of a compression stroke, further compressing the gas and evaporated liquid; (7) during a combustion stroke, combusting the evaporated liquid and heated compressed gas to a combusted product; (8) during an exhaust stroke, releasing the combusted product; (9) expanding the combusted product to an expanded gas; and (10) passing the expanded gas through the heat exchanger.

In some embodiments, an additional expansion turbine is placed between the heat exchanger and the piston to expand the intake air prior to entering the piston. In some embodiments, the compressor turbine and one or both of the expansion turbines is on the same shaft (such that the expander's expansion turbines power the compressor). In some embodiments, surplus power from the turbines is used to drive an electrical generator. In some embodiments, surplus power from the turbines is used to deliver additional power to the engine's crankshaft. In some embodiments, the compressor turbine is a mechanical compressor, a screw or vane compressor, or any other suitable compressing mechanism. In some embodiments, the expansion turbine is a mechanical expansion device, such as a piston, a screw, or a rotary vane type expander.

Conventional piston engines use external cooling to keep portions of the engine mechanism from overheating and failing. However, external cooling causes an irrecoverable loss of usable heat energy. Some embodiments make use of thermally isolating piston elements such that they are not subject to thermal stresses while the heat energy of the combustion process is still maintained for further use. According to some embodiments, there is provided an apparatus for thermally isolating a cylinder and piston of an internal combustion engine, comprising a cylinder having a top and a bottom and made, at least partially, of a metallic material; a piston slideable within the cylinder between a bottom-dead-center position at a bottom of the cylinder to a top-dead-center position at the top of the cylinder; wherein at least a portion of the piston facing the top of the cylinder is made from a first thermally isolating material; and wherein at least a portion of the top of the cylinder facing the piston at top-dead-center position is made from a second thermally isolating material.

According to some embodiments, there is provided an apparatus for thermally isolating a cylinder and piston of an internal combustion engine, comprising a cylinder configured to hold a working gas and made at least partially of a metal material; a piston slideable within the cylinder between a bottom dead-center position and a top-dead-center position; wherein at least a portion of the piston facing the working gas is made from a first thermally isolating material; and wherein a portion of the cylinder facing the piston at top-dead-center is made from a second thermally isolating material. In some embodiments, the first thermally isolating material is the same as the second thermally isolating material. In some embodiments, the thermally isolating materials are ceramic. In some embodiments, the piston is made, at least partially, of metal.

In some embodiments, the piston is made of a first layer of thermally absorbing material on a first thermally isolating material and a second layer of thermally absorbing material on second thermally isolating material. In some embodiments, the first layer of thermally absorbing material and the second layer of thermally absorbing material are the same. In some embodiments, the thermally absorbing material is metal. In some embodiments, the metal is tungsten. In some embodiments, the metal layer is very thin, between 0.1 and 1 mm.

In some embodiments, a heat exchanger, expansion turbine, waste heat recovery engine, or other device is used to capture the heated exhaust. In some embodiments, the side surfaces of the piston not covered by a thermally isolating material are cooled with a cooling medium.

According to some embodiments, there is provided an apparatus for thermally isolating a cylinder and piston of an internal combustion engine, comprising: a cylinder having a top and a bottom; a piston slideable within the cylinder between a bottom-dead-center position at the bottom of the cylinder to the top-dead-center position at the top of the cylinder; wherein at least a portion of the piston facing the top of the cylinder defines a plurality of cavities for trapping small pockets of compressed air; and wherein at least a portion of the top of the cylinder facing the piston at top-dead-center defines a plurality of cavities for trapping small pockets of compressed air.

According to some embodiments, there is provided an apparatus for thermally isolating a cylinder and piston of an internal combustion engine, comprising: a cylinder having a top and a bottom; a piston slideable within the cylinder between a bottom-dead-center position at a bottom of the cylinder to a top-dead-center position at the top of the cylinder, wherein at least a portion of the piston facing the top of the cylinder includes a plurality of nozzles for delivering a fluid during a compression, and wherein at least a portion of the top of the cylinder facing the piston at top-dead-center includes a plurality of nozzles for delivering an isolating fluid layer during compression. In some embodiments, the fluid is a compressed gas. In other embodiments, the fluid is water or another vaporizable liquid.

According to some embodiments, there is provided another method for managing fuel consumption in a partially loaded engine by making use of a second 2-stroke closed cycle engine. The method comprises the steps of: (1) receiving a hot exhaust from a main four-stroke piston engine; (2) transferring thermal energy from the hot exhaust to a compressed dry working fluid; (3) aspiring the dry compressed working fluid into a 2-stroke waste heat recovery piston engine; (4) expanding the dry compressed working fluid in the waste heat recovery piston engine during a portion of an intake stroke; (5) during a first part of a compression stroke injecting a vaporizable liquid into the waste heat piston engine forming a compressed humid product; (6) exhausting the compressed humid product during a second part of a compression stroke; (7) condensing a liquid from the compressed humid product to a liquid and a dry compressed working gas; (8) re-circulating the dry compressed working gas along a first channel for re-heating; (9) re-circulating the liquid along a second channel for re-injection in the waste heat recovery piston engine.

According to some embodiments, there is provided an apparatus for recovering heat from a piston engine through an integrated closed loop 2-stroke waste recovery engine, comprising: a dry compressed working fluid at a pressure above ambient pressure in a closed loop system; a heat exchanger for receiving hot exhaust gas from a main piston engine and for transferring thermal energy from the exhaust gas to the compressed working gas of a closed 2-stroke waste recovery engine; a 2-stroke piston engine for receiving the compressed working gas, wherein the 2-stroke piston engine injects a vaporizable liquid into its piston chamber during a compression stroke to create a compressed humid product; a condenser for condensing the compressed humid product into a liquid and a dry compressed working gas; a pump and a channel for re-circulating the liquid into the piston cylinder of the 2-stroke waste heat recovery engine; and a channel for re-circulating the dry compressed working gas into the heat exchanger.

In some embodiments, the working fluid is a noble gas. In some embodiments, the working fluid is argon. In some embodiments, the liquid is water. In some embodiments, the liquid is Methanol, Butane or partially oxidized hydrocarbon. In some embodiments, the main piston engine is turbo-charged. In some embodiments, the timing of the 2-stroke engine is adaptable for partially loaded engines. In some embodiments, the expansion end temperature is near the dew point of steam.

According to some embodiments, there is provided an apparatus for reducing engine wear, comprising, a compressor turbine for aspiring air; a heat exchanger for heating the aspired air to heated air; an expansion means for expanding the heated air to expanded air; a piston engine for combusting the expanded air with a fuel to a combusted product; and an exhaust pipe for exhausting the combusted product to an external environment. In some embodiments, the expansion means is an expansion turbine. In some embodiments, the expansion occurs through pre-expansion in the piston cylinder by special valve timing. In some embodiments, the compressor also continuously adds a fluid. In some embodiments, the piston engine is a 2-stroke type engine. In some embodiments, the piston engine is a four-stroke type engine. In some embodiments, the turbine(s) are connected to an electrical generator. In some embodiments, the fuel is heavy. Some embodiments employ high pressure discharge valve timing. In some embodiments, the heat exchanger is a high pressure-high temperature heat exchanger. In some embodiments, an expansion turbine is positioned between the piston and the heat exchanger. In some embodiments, an expansion turbine is positioned between the heat exchanger and the exhaust pipe.

In conventional super-charged or turbo-charged engines high temperature exhaust flow may surpass the mechanical resistance of the expansion turbine positioned to receive the exhaust gases. Therefore, in some embodiments, there is provided a method for cooling an exhaust gas. The method comprises the steps of: (1) compressing an air flow in a compressor; (2) channelling a first portion of the compressed air flow having a first temperature into a bypass channel; (3) channelling a second portion of the compressed air flow into a piston cylinder; (4) performing a combustion cycle in the piston cylinder such that the second portion of an air flow has a second temperature higher than the first temperature; (5) exhausting the second portion of an air flow from the piston cylinder; (6) mixing the first portion of an air flow having a first temperature with a second portion of an air flow having a second temperature, (7) subsequently creating a unified air flow having a third temperature between the first temperature and the second temperature; and (8) expanding the unified air flow in an expander. In some embodiments, a heat exchanger pre-heats the air. In some embodiments, water is injected into the air flow in the compressor. In some embodiments, electrical generators are driven by the expander.

According to some embodiments, there is provided a method for cooling a working gas. The method comprises the steps of: (1) aspiring a gas at a first temperature and a first pressure into a first stage of a compressor; (2) compressing the gas to a first compressed gas having a second temperature and second pressure being higher than the first temperature and first pressure; (3) passing the first compressed gas to a first stage of an inter-cooling device separate from the compressor; (4) cooling the first compressed gas to a first cooled gas having a third temperature being higher than the first temperature and lower than the second temperature while still having the first pressure; (5) passing the first cooled gas to a second stage of the compressor and repeating steps 1 through 4 until a final gas having a final temperature and final pressure is achieved; and (6) discharging the final gas.

In some embodiments, the compressor may specifically have 3, 4 or 5 stages. In some embodiments, the compressor is used in a piston engine system. In some embodiments, the piston engine system may include a heat exchanger and an expansion turbine. In some embodiments, the compressor is driven by the expansion turbine where both are on a common shaft.

As will be described below, these embodiments create various systems and methods for increasing the efficiency of piston engines, the longevity of their components, or both.

### BRIEF DESCRIPTION OF THE DRAWINGS

For a better understanding of the nature and objects of the invention, reference should be made to the following detailed description taken in conjunction with the accompanying drawings, in which:

FIG. 1 is a schematic diagram of a stationary turbo-charged piston engine with a turbo compressor, turbo expander, and intercooler according to some illustrative embodiments;

FIGS. 2a-2e are schematic diagrams showing the valve actuation during operation of the engine shown in FIG. 1;

FIG. 3 is a magnified view of a part of the cylinder head shown in FIG. 1 implementing the exhaust channel isolation of some illustrative embodiments;

FIG. 4 is a magnified view of a part of the cylinder head of FIG. 1 implementing another illustrative embodiment for exhaust isolation;

FIG. 5 is a schematic of an arrangement of a piston engine where the intake valve and the discharge valve are controlled electrically by solenoids through a control device according to some illustrative embodiments;

FIG. 6 is a schematic of a turbo-charged piston engine of FIG. 1 with an electrical generator;

FIGS. 7a-7h are schematic diagrams showing the valve timing for pre-expansion in a cylinder of a four-stroke valve-controlled reciprocating piston and cylinder according to some illustrative embodiments;

FIG. 8a is a schematic of a four-stroke valve-controlled reciprocating piston engine with pre-heating of the aspired gas by a heat exchanger according to some illustrative embodiments, here operating at a fully loaded state.

FIG. 8b is a schematic of the engine shown according to FIG. 8a, but operating at a partially loaded state;

FIG. 9a is a schematic of a four-stroke valve-controlled reciprocating piston engine with pre-heating of the aspired gas by mixing with hot gas pre-heated by a heat exchanger according to some illustrative embodiments, here operating at or near a fully loaded stat.

FIG. 9b is a schematic of the engine shown in FIG. 9a, but operating at a partially loaded state;

FIG. 10a and FIG. 10b are schematic diagrams of an engine where pre-heating is achieved by externally re-circulated hot exhaust gas according to some illustrative embodiments;

FIG. 11 is a schematic diagram of the basic arrangement of such a super-charged four-stroke piston engine with pre-expansion valve timing according to some illustrative embodiments;

FIG. 12 is a theoretical S-T diagram showing the thermodynamic process carried out by the illustrative embodiment according to FIG. 11.

FIGS. 13a-13h are schematic diagrams of an engine modified to facilitate pre-heating by internal exhaust gas re-circulation through a first type of valve timing, according to some illustrative embodiments;

FIGS. 14a-14h are schematic diagrams of an engine modified to facilitate pre-heating by internal exhaust gas re-circulation through a second type of valve timing, according to other illustrative embodiments;

FIGS. 15a-15f are schematic diagrams showing a valve timing in a two-stroke piston engine with improved efficiency, according to some illustrative embodiments;

FIG. 16 is a schematic diagram of a piston engine system utilizing the 2-stroke timing described in FIG. 15a-FIG. 15f according to some illustrative embodiments;

FIG. 17 is a theoretical S-T diagram showing the thermodynamic process carried out by the illustrative embodiment of FIG. 16;

FIG. 18 is a schematic diagram of the general layout of an axial turbine compressor with inter-stage water injection according to some illustrative embodiments;

FIG. 19a is a schematic diagram showing the path of a fluid particle inside the impeller and diffuser of FIG. 19b.

FIG. 19b is a schematic diagram of an enlarged view of the first compressor stage of FIG. 18, according to some illustrative embodiments;

FIG. 19c is a theoretical S-T diagram showing the thermodynamic process carried out by the illustrative embodiment of FIG. 18;

FIG. 19d is a P-V diagram showing the thermodynamic process carried out by the illustrative embodiment of FIG. 18;

FIG. 20 is a schematic diagram of a piston engine where vaporizing a liquid during compression occurs by passing a working gas through an external tank of vaporizable liquid after one or more compression stages;

FIG. 21 is a theoretical S-T diagram showing the thermodynamic process carried out by the illustrative embodiment of FIG. 20;

FIG. 22 is a schematic diagram of an engine where vaporization of liquid occurs at increased working gas pressure and temperature as compared to ambient conditions according to some illustrative embodiments;

FIG. 23 is a theoretical S-T diagram showing the thermodynamic process carried out by the illustrative embodiment according to FIG. 22;

FIG. 24 is a schematic diagram of an engine where vaporization of the liquid occurs at increased working gas pressure and temperature as compared to ambient conditions and a post-expansion is carried out after the recuperator according to some illustrative embodiments;

FIG. 25 is a theoretical S-T diagram showing the thermodynamic process carried out by the illustrative embodiment according to FIG. 24 in a detailed theoretical S-T diagram;

FIG. 26 is a schematic diagram of an engine where first an adiabatic compression is carried out to a higher temperature level, before compression with vaporization of liquid occurs according to some illustrative embodiments;

FIG. 27 is a theoretical S-T diagram showing the thermodynamic process carried out by the illustrative embodiment according to FIG. 26 in a detailed theoretical S-T diagram;

FIGS. 28a-28e are schematic diagrams of a 2-stroke piston and cylinder with liquid injection timing according to some illustrative embodiments;

FIG. 29 is a schematic diagram of a valve-controlled 2-stroke piston engine system with liquid injection timing shown in FIGS. 28a-28e;

FIG. 30 is a theoretical S-T diagram of the thermodynamic cycle carried out by the piston engine of FIG. 29;

FIGS. 31a-31h are schematic diagrams of a four-stroke piston engine piston and cylinder with liquid injection timing according to some illustrative embodiments;

FIG. 32 is a schematic diagram of a four-stroke piston engine system with liquid injection timing shown in FIGS. 31a-31h;

FIG. 33 is a theoretical S-T diagram of the thermodynamic cycle carried out by the piston engine of FIG. 32;

FIG. 34a and FIG. 34b are schematic diagrams of a cylinder and piston with a thermally-isolated combustion space for minimizing the cooling losses, according to some illustrative embodiments;

FIGS. 35a-35c are schematic diagrams of a cylinder and piston with an internally operated effusion-isolated combustion space for minimizing the cooling losses, according to some other illustrative embodiments;

FIG. 36a and FIG. 36b are schematic diagrams of piston engines with an externally operated effusion-isolated combustion space for minimizing the cooling losses according to some illustrative embodiments;

FIG. 37 is a schematic diagram of an engine system having both a main four-stroke piston engine and a 2-stroke waste heat recovery piston engine which uses a closed loop compressed working gas, according to one illustrative embodiment;

FIGS. 38a to 38b are theoretical S-T diagrams showing the thermodynamic processes of the engines in the illustrative embodiment of FIG. 37. FIG. 38a is a theoretical S-T diagram of the thermodynamic process carried out by the main four-stroke piston engine of the illustrative embodiment of FIG. 37. FIG. 38b is a theoretical S-T diagram of the thermodynamic process performed by the 2-stroke waste heat recovery piston engine of the illustrative embodiment of FIG. 37;

FIGS. 39a to 39f are schematic diagrams of the valve timing of the 2-stroke waste heat recovery engine shown in FIG. 37;

FIGS. 40a and 40b are theoretical S-T diagrams of other the thermodynamic processes of the engines in illustrative embodiment of FIG. 37. FIG. 40a is a theoretical S-T diagram of the thermodynamic processes carried out by the main four-stroke piston engine of the illustrative embodiment of FIG. 37. FIG. 40b is a theoretical S-T diagrams of another thermodynamic process performed by its waste heat recovery piston engine;

FIG. 41 is a schematic diagram of a turbo-charged four-stroke piston engine with a pre-expansion turbine according to some illustrative embodiments;

FIG. 42 is a theoretical S-T diagram of the thermodynamic cycle carried out the engine shown in FIG. 41;

FIG. 43 is a schematic diagram of a turbo-charged 2-stroke piston engine with a pre-expansion turbine according to some illustrative embodiments;

FIG. 44 is a theoretical S-T diagram of the thermodynamic process which is carried out by the piston engine of FIG. 43;

FIG. 45 is a schematic diagram of a turbo-charged piston engine where the exhaust gas is further expanded after passing through the recuperator according to some illustrative embodiments;

FIG. 46 is a theoretical S-T diagram of the thermodynamic process carried out by the piston engine shown in FIG. 45;

FIG. 47 is a schematic diagram of another arrangement of a turbo-charged four-stroke piston engine with a pre-expansion turbine and a high temperature heat exchanger according to some illustrative embodiments;

FIG. 48 is a schematic diagram of an illustrative embodiment where the hot exhaust gases directly heat a high-temperature recuperator before they are expanded in an external expansion device;

FIG. 49 is a theoretical S-T diagram of the thermodynamic process which is carried out by the piston engine of FIG. 48;

FIG. 50 is a schematic diagram of an illustrative embodiment where part of the compressed fresh air is bypassing the piston engine and is mixed immediately after the piston engine with the hot exhaust gas;

FIG. 51 is a theoretical S-T diagram of the thermodynamic process carried out by the engine according to FIG. 50;

FIG. 52 is a schematic diagram of a turbo-charged four-stroke piston engine which re-circulates the hot exhaust gas at a high temperature level by means of a second high-temperature recuperator according to some illustrative embodiments;

FIG. 53 is a schematic diagram of a turbo-charged four-stroke piston engine which re-circulates the hot exhaust gas at a high temperature level by means of mixing with pressurized and pre-heated fresh air according to some illustrative embodiments;

FIG. 54 is a schematic diagram of a turbo-charged four-stroke piston engine which re-circulates the hot exhaust gas at increased temperature and pressure levels where the fresh air is first compressed separately according to some illustrative embodiments;

FIG. 55 is a schematic diagram of a turbo-charged four-stroke piston engine which carries out a semi-closed cycle by re-circulating most of the exhaust gas at increased temperature and pressure levels and aspiring oxygen-enriched for combustion according to some illustrative embodiments;

FIG. 56 is a schematic diagram of a turbo-charged four-stroke piston engine which employs a condenser to remove excess steam from the re-circulated exhaust gas;

FIG. 57 is a schematic diagram showing a piston engines which combines multiple inter-cooled high-compression by a compressor turbine, a recuperator, pre-expansion in the piston engine, ceramic isolation of the combustion chamber, isolated exhaust gas path and minor throttling to provide all of the net mechanical power on the piston engine's crankshaft according to some illustrative embodiments;

FIG. 58 is a theoretical S-T diagram of the thermodynamic cycle carried out by the illustrative embodiment shown in FIG. 57;

FIG. 59 a schematic diagram of a piston engine similar to the illustrative embodiment of FIG. 57 where the entire amount of mechanical energy is delivered on the shaft of the expansion turbines;

FIG. 60 is a theoretical S-T diagram of the thermodynamic cycle carried out by the illustrative embodiment shown in FIG. 59;

FIG. 61 a schematic diagram of a piston engine similar to the illustrative embodiments of FIG. 57 and FIG. 59 wherein pre-compression is carried out by a screw compressor and uses a combination of ceramic and effusion isolation;

FIG. 62 is a theoretical S-T diagram of the thermodynamic cycle carried out by the illustrative embodiment shown in FIG. 61;

FIG. 63 shows an arrangement of a piston engine with a heat exchanger and a turbo expander according to an illustrative embodiment;

FIG. 64 shows an example of a thermodynamic process carried out under full-load for an Otto engine in a theoretical S-T diagram;

FIG. 65a shows an example of a thermodynamic process carried out in partial load for a conventional Otto engine with throttle in a theoretical S-T diagram;

FIG. 65b shows an example of the thermodynamic process carried out in partial load for an Otto engine according to an illustrative embodiment in a theoretical S-T diagram;

FIG. 66 shows a diagram efficiency at various loads, comparing conventional Otto engines and Otto engines according to an illustrative embodiment;

FIG. 67 shows an arrangement of a piston engine using exhaust gas recirculation (EGR) according to an illustrative embodiment;

FIG. 68 shows an arrangement of a piston engine with a first heat exchanger, a turbo expander and a second heat exchanger-cooler for waste heat recovery together with the piston engine according to an illustrative embodiment; and

FIG. 69 is an example of a comparison of the Otto cycle under or near full-load and the cycle according to an illustrative embodiment in partial load when waste heat recovery is carried out with the arrangement shown in FIG. 6.

Like reference numerals refer to the same or similar components throughout the several views of the drawings.

### DETAILED DESCRIPTION OF THE EMBODIMENTS

Systems and methods using isentropic compression are described herein. Reference will be made to certain embodiments of the invention, examples of which are illustrated in the accompanying figures. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, and components that are well-known to those of ordinary skill in the art are not described in detail to avoid obscuring aspects of the present invention.

A vaporizable liquid is any liquid capable of vaporization under compression with a working gas, such that a temperature of the working gas is high enough to evaporate the vaporizable liquid. In some illustrative embodiments, the vaporizable liquid may be water, ethanol, methanol, fuel, or the like, and mixtures thereof, as will be understood by one skilled in the art. In some illustrative embodiments with closed-cycle gas piston engine arrangements, certain liquids produced by chlorofluorocarbons (CFCs) may be used as the vaporizable liquid. In some illustrative embodiments, the vaporizable liquid is water. In some illustrative embodiments, the vaporizable liquid is the fuel to be burnt in the combustion chamber. In other illustrative embodiments, the vaporizable liquid is a mixture of both fuel and water.

The amount of vaporizable liquid added to the working gas is adjusted in such a manner that all of the liquid is just vaporized after compression is completed, i.e., the compressed working gas leaving the compression stroke is not over-saturated with vapor from the vaporizable liquid. In some illustrative embodiments, the amount of liquid vaporized is determined in such a way that at least approximately 80% of the thermal energy discharged into the environment (or the thermal energy transferred to the lower temperature level reserve) is carried by the vapor to be released by condensation after discharge. In piston engines with typical upper temperatures beyond approximately 600° C., the amount of vaporizable liquid is determined such the latent heat of vaporization for the amount of vaporizable liquid added to the working gas is equal to approximately 30% to 50% of the thermal energy which drives the piston engine.

In some illustrative embodiments, the working gas is any gas capable of combustion with the desired fuel. In some embodiments, the working gas may be nitrogen, helium, argon, or another noble gas, carbon dioxide, oxygen, an inert gas, a mixture of such gases, or the like, as will be understood by one skilled in the art. In some embodiments, the working gas may be a mixture of nitrogen and various combustion products, formed, for example, by burning natural gas or liquid hydrocarbons with air.

The process by which the vaporizable liquid is transformed into vapor may be referred to as evaporation or vaporization. A condensate is a vaporizable liquid that had been vaporized and has been returned to the liquid state by condensation. A working gas is a gas that passes through a piston engine in order to do work, such as producing thrust, heat, energy, or the like.

One skilled in the art will recognize that predicted and illustrative values may vary widely based on a particular illustrative embodiment. The temperatures predicted are subject to the thermal and mechanical tolerances of the materials in a particular physical embodiment. In some illustrative embodiments, components with maximum thermal and mechanical tolerances are used to allow for maximum temperatures and maximum efficiency.

As will be appreciated by one skilled in the art, the degree of recuperation depends on the temperature of the working gas as it leaves the compressor (the compression end temperature). Lower compression end temperatures increase the effectiveness of the recuperator given the same exhaust gas temperature.

Throughout the description, mechanical imperfections of the various components are neglected unless otherwise noted. One skilled in the art will recognize that predicted values may vary widely based on the particular embodiment. The temperatures predicted are subject to the thermal and mechanical tolerances of the materials in a particular physical embodiment. In some embodiments, components with maximum thermal and mechanical tolerances are used to allow for maximum temperatures and maximum efficiency.

### I: Modified Valve Timing Embodiments

A: High Pressure Exhaust

Basic piston engines exhaust combusted products directly to the atmosphere. Since the atmosphere is at approximately 1 bar and around 15° C., and since the combusted product is at a significantly higher temperature and pressure, exhausting the combusted product into the atmosphere is wasteful. While the atmosphere is not always at approximately 1 bar and around 15° C., it will be appreciated that the combusted product is typically at a higher temperature and pressure than the atmosphere. Turbo-charged engines make more use of the combusted product by passing it through an expansion turbine. However, current turbo-charged engines require that the exhaust channel be kept at a lower pressure than that of the combusted product exhausted from the combustion chamber. This is because traditional engine timing requires that both the intake and the discharge valves be opened at the same time during the end of an exhaust stroke and the beginning of an intake stroke. Therefore, traditional turbo-charged engines must typically maintain an exhaust channel pressure at or below that of the intake channel pressure to avoid re-flow of the combusted products into the intake channel. Exhausting the combusted product into a lower pressure exhaust channel causes throttling. The pressure lost by throttling is thermodynamically inefficient because it cannot be recovered or used to achieve useful work. Therefore, it would be advantageous to develop an un-throttled system for using the temperature and pressure of the combusted product prior to exhausting them. The illustrative embodiments below address creating a piston engine to address these problems.

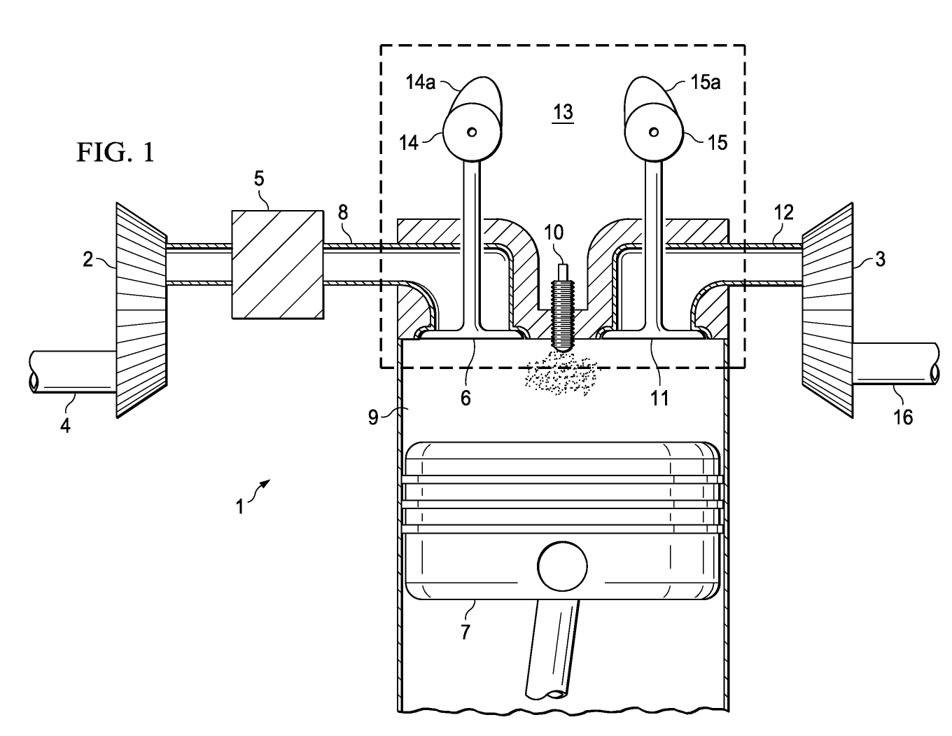

FIG. 1 is a schematic diagram of an embodiment with an arrangement of a stationary four-stroke turbo-charged piston engine 1 with an optional turbo compressor 2 and turbo expander 3. The forthcoming values for temperature, pressure and flow rate are illustrative and are not limiting in any way. This embodiment may be used by an Otto, Diesel, or hybrid type engine. The turbo compressor 2 aspires fresh air through the inlet 4, compresses it and delivers the compressed air with now higher temperature to an optional intercooler 5. Although the intercooler 5 is optional, it may be used in some embodiments to increase both efficiency and power. The air pressure delivered by the compressor 2 may be around 2.8 bar, and its temperature may be around 170° C. The intercooler 5 may cool the compressed air to approximately 55° C., but maintains its pressure, e.g., if the original pressure was 2.8 bar, the ending pressure would also be 2.8 bar.

The gas passes through the inlet channel 8, into the cylinder 9 and is mixed with fuel injected by the injection nozzle 10, in the cylinder head 13. Alternatively, fuel may be injected into the air stream in inlet channel 8. The fuel and air are compressed when the piston 7 moves upward, the fuel air mixture then combusts. The force from the combustion drives the piston 7 downward. The combustion products are exhausted through the exhaust collection pipe 12. The pressure in the exhaust collection pipe 12 is maintained at a pressure approximately the same as that in the cylinder 9 at the time of exhaust. This high pressure in the exhaust collection pipe 12 may be maintained by a valve or by the turbo expander 3. The exhaust gas is then passed through the turbo expander 3 before being discharged into the environment through the outlet 16 at approximately atmospheric pressure.

Typically, the turbo expander 3 powers the turbo compressor 2 by direct coupling (i.e., both impellers are on the same shaft) but this is not required in all embodiments. The turbo expander 3 may be made of several independent partial expanders operating in parallel or in series. Likewise, the turbo compressor 2 may be made of several independent compressors operating in parallel or in series. Also, a mechanical compressor and/or expander may be used. For example, in the case of very large engines, which require a large volume of airflow, several compressors 2 may be provided in parallel to supply sufficient compressed air. As many large engines are custom built with a corresponding number of cylinders, it may be necessary to form a corresponding number of compressor turbines instead of developing and building individual ones with the each appropriate volume flow. Two or more compressor turbines may also be arranged in series to increase the charge pressure, instead of increasing the design pressure of a certain compressor turbine. It is also possible to combine compressor turbines and mechanical chargers as, for example, screw compressors. At least for moderate exhaust gas temperatures, mechanical expanders may also be employed. One example would be a screw expander, these engines may run as compressors but can also act as expansion devices when inverting their rotational direction.

In some embodiments, the valves 6 and 11 are actuated by cams 14a and 15a mounted on camshafts 14 and 15, respectively. These valves 6 and 11 together with the cams 14a, 15a and the camshafts 14 and 15 from one implementation of the control means between the piston cylinder 9 and the exhaust gas collection pipe 12.

The valve timing controls the flow of the hot and pressurized exhaust gases from the piston engine 1 after the expansion stroke in such a manner that the pressure drop between the cylinder 9 at the end of the expansion cycle and the exhaust gas collection pipe 12 is as low as the technical restraints that the system will allow.

In conventional engines the valve timing of the intake valve 6 and the discharge valve 11 are that both valves are simultaneously open for a sizable portion of the exhaust stoke. In the illustrative embodiments described herein, opening both the intake valve 6 and the discharge valve 11 simultaneously may cause a considerable re-flow from the exhaust gas collection pipe 12 through the cylinder 9 into the inlet channel 8. This may lead to a malfunction of the engine, because no air would be aspired into the engine.

Moreover, lowering the pressure in the exhaust gas collection pipe 12 below the pressure of the air being introduced from the turbo compressor 2, as is done in current turbo systems, penalizes the engine's efficiency considerably. Therefore, the arrangement of the engine shown in FIG. 1 and the control timing of the valves 6 and 11, according to the principles of the illustrative embodiments described herein, avoid this re-flow problem and maintains a higher pressure of the gas in the exhaust gas collection pipe 12.

The expansion turbine 3 aspires the hot and pressurized gas from the collection pipe 12 and expands it to ambient pressure, after which the exhaust gas is discharged to the environment through the outlet 16.

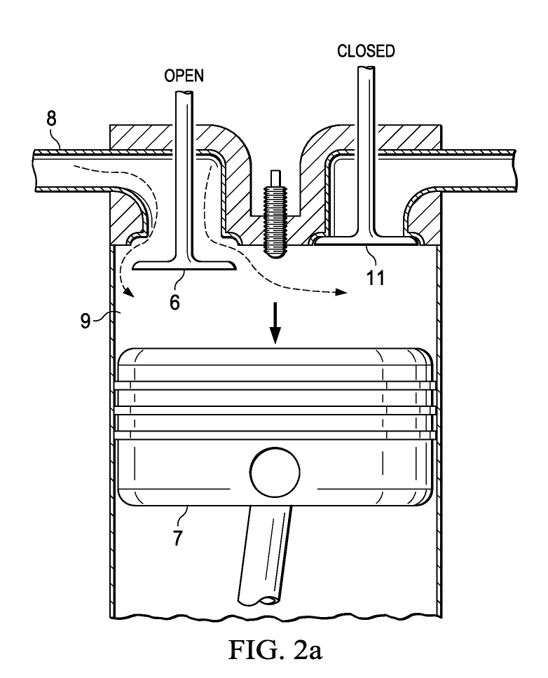

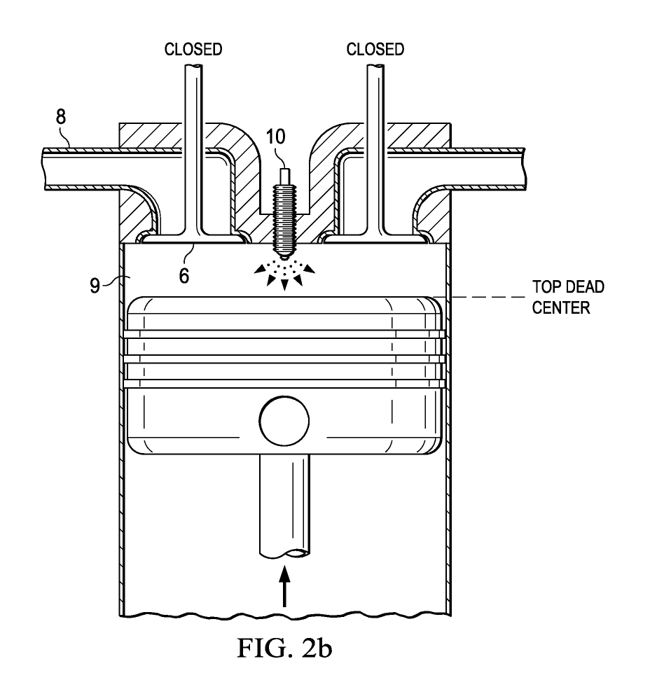

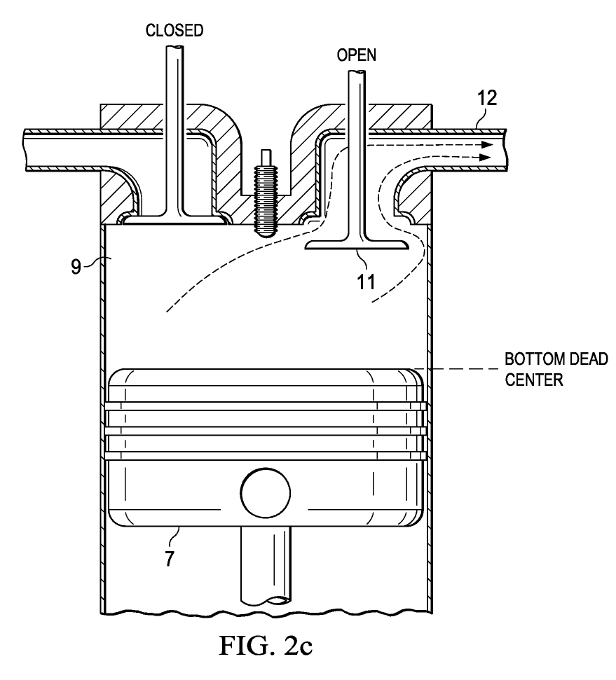

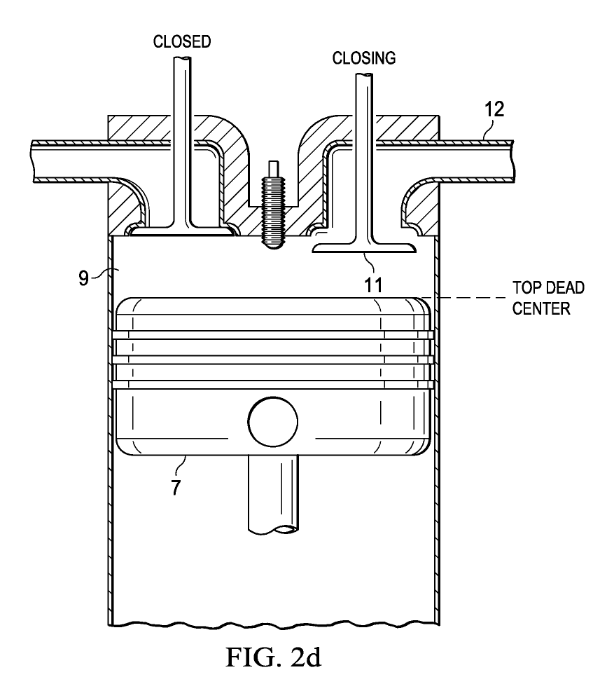

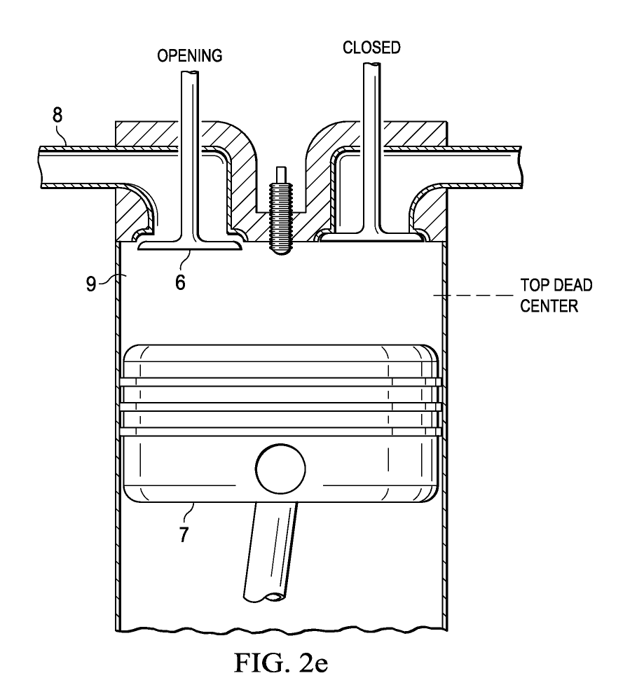

FIGS. 2a-2e are schematic diagrams showing the valve timing according to some illustrative embodiments. In the course of the intake stroke of the engine 1, the intake valve 6 opens and aspires the compressed air through the inlet channel 8 into the cylinder 9 by means of the piston 7 moving downward away from top-dead-center. (FIG. 2a). The intake valve 6 then closes. During the course of the compression stroke, the piston 7 moves up to top-dead-center, thereby compressing the air aspired into the cylinder 9 (FIG. 2b). Near the top-dead-center position, the injection nozzle 10 injects fuel into the cylinder. In diesel engines, this air-fuel mixture will immediately ignite because of the high temperature of the compressed air. In other embodiments, a spark from a spark plug may be required. Also, in other embodiments, the fuel may be added to the compressed air before it is introduced into the cylinder. During the combustion stroke, the fuel burns and rapidly expands, thereby causing the piston 7 to move downward away from top-dead-center.

During the course of the exhaust stroke, the exhaust may be discharged as follows. As soon as the piston 7 reaches, or is near to, bottom-dead-center, the discharge valve 11 opens and fluidly connects the contents of the cylinder 9 with the exhaust gas collection pipe 12. (FIG. 2c). The gas pressure in the exhaust gas collection pipe 12 may be kept at a pressure substantially similar to the gas pressure in the cylinder 9 at the time of discharge, e.g., 8 bar. Because the expansion turbine 3 operates continuously while the piston engine 1 operates in an intermittent manner, there may be minor pressure fluctuations in the collection pipe.

By moving upward, piston 7 discharges the compressed and combusted hot gas in the cylinder 9 into the exhaust gas collection pipe 12. (FIG. 2d). Because the pressure difference between the cylinder 9 and the exhaust gas collection pipe 12 is relatively small, a simple gas displacement process may be carried out. This displacement process is different from the throttling process that takes place in conventional engines, which results from a gas collection pipe being at a lower pressure than the cylinder 9.

As soon as piston 7 reaches top-dead-center, the discharge valve 11 closes. The pressure of the small amount of remaining gas in the cylinder 9 is still as high as the pressure in the exhaust gas collection pipe 12 and, therefore, it is much higher than the pressure in the inlet channel 8. To avoid reflows from the cylinder at a high pressure into the inlet channel, the piston 7 may first move down. Then, the intake valve 6 again opens to aspire compressed air from the turbo compressor 2 through the inlet channel 8 (FIG. 2e).

In the described example, with an inlet pressure of 2.8 bar and a collection pipe pressure of 8 bar, a downward movement of the piston may be necessary to lower the pressure in the cylinder before the inlet piston 6 is opened. The pressure in the cylinder may be lowered to below the inlet pressure, e.g., lower than 2.8 bar. In some embodiments, the space between the piston 7 and the cylinder head 13 may be doubled. Then, the intake valve 6 opens so that the piston 7 may aspire air through the inlet channel 8 by moving further downward to complete the intake stroke.

Some embodiments may employ late combustion. In the case of late combustion, during the combustion stroke, the fuel is burned when the piston 7 has started to move downward from the top-dead-center position. In a late combustion process, a lower expansion ratio exists than is the case for a normal combustion process because the combustion volume is larger due to the piston movement that has already taken place. However, the final volume, at the bottom-dead-center position remains the same. This means that both pressure and temperature at the moment of discharge into the exhaust gas collection pipe may be increased. Consequently, the gas in the cylinder 9 is hotter and at a higher pressure than in a traditional cycle. A system according to the present embodiment may use this additional temperature and pressure. The gas displacement cycle may be maintained as described above with reference to FIGS. 1 and 2. A minor difference being that the piston 7 moves down further in the cylinder 9 before the intake valve 6 opens again. In other words, in order for the gas pressure in the cylinder 9 to equal that of the pressure in the inlet channel 8, the distance that the piston moves from the top-dead-center before the intake valve 6 opens is further than that of the traditional cycle. The exhaust gas collection pipe may be fed an exhaust gas at a higher pressure and temperature. The expansion turbine 3 expands this gas to deliver more mechanical energy than in a traditional cycle. The efficiency of the machine is lowered only marginally for combustion extensions of 50%, equal to a rise in power by approximately 50% for combined operation of the engine 1 and the turbo compound system comprising the compressor 2, the intercooler 5 and the expansion turbine 3. A combustion extension means, in this case, that the time of injecting and burning fuel is enlarged by 50%, i.e., the injection time and the amount of injected fuel is higher than in the usual case.

In traditional engines, this so-called “late combustion” or “extended combustion” means that a significant part of the fuel is burnt at working gas pressures and/or densities already lower than at the beginning of combustion because the piston has already moved down and lowered working gas pressure or increased the working gas volume and therefore decreased working gas density. Hence, the remaining expansion ratio is lower than in case of quick combustion (e.g., near to isochoric combustion as is the case for gas engines) and less mechanical work may be extracted in the remaining expansion length, as in the case of early combustion. Consequently, both the exhaust pressure and temperature are higher. With traditional exhaust gas throttling an even higher throttling ratio occurs because the intake pressure remains the same, but the exhaust pressure has decreased. This lowers efficiency in traditional engines. However, this is not the case in the present embodiment because a considerable part of the remaining “late” expansion is transferred to the expansion turbine and may be usable. No major loss of mechanical energy necessarily occurs. Due to the higher firing power by burning an increased amount of fuel, the combined mechanical power of the piston engine and the expansion turbine may also be increased. The effect is a more powerful engine with similar or greater efficiency.

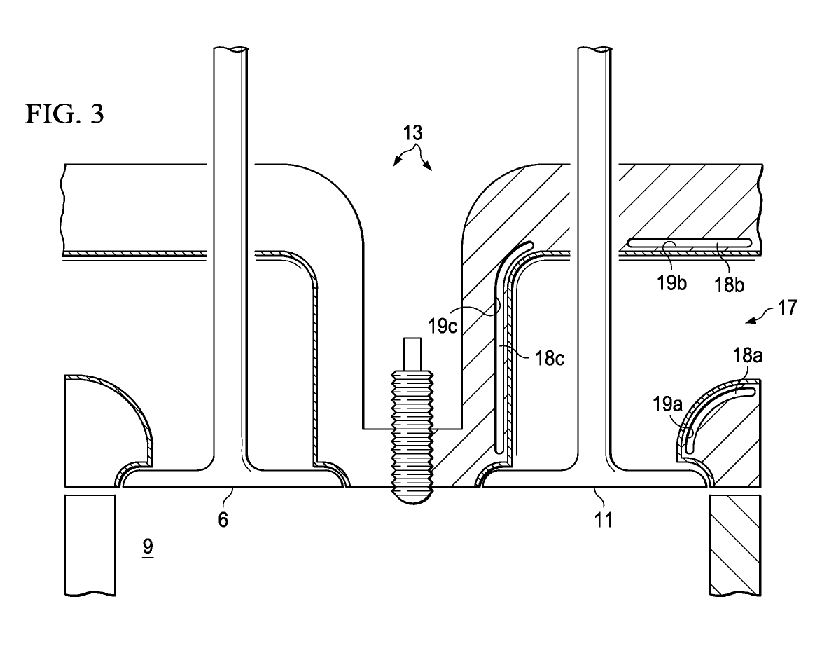

FIG. 3 shows a magnified view of a part of the cylinder head 13 and exhaust channel 17 employing exhaust isolation. Exhaust isolation may be useful when dealing with high pressure exhaust collection as described in FIG. 1 and FIG. 2a-2e, although it can be used in any exhaust channel. FIG. 3 shows isolation chambers 18a, 18b, and 18c formed in the material surrounding the exhaust channel 17. These chambers may be evacuated or filled with a fluid. In some embodiments, the inner surfaces 19a, 19b and 19c are covered with a highly reflective material to minimize radiation losses. For example, they may be covered with vapor deposited aluminium or chrome. Other isolation means are also possible, for example, a ceramic coating with low thermal conductivity may be used. Alternatively, in some embodiments, the entire exhaust channel is constructed from a material having a low thermal conductivity.

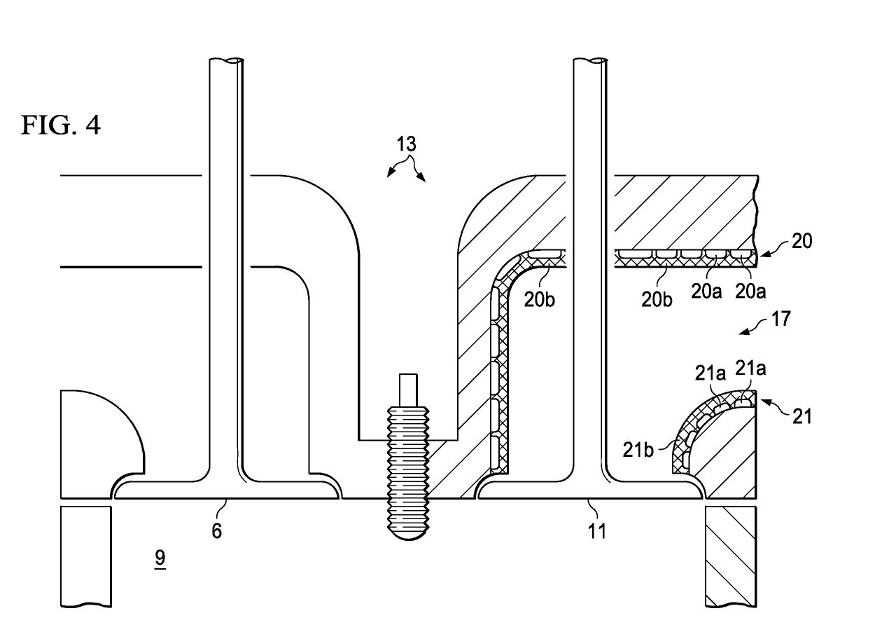

FIG. 4 shows a magnified view of a part of the cylinder head 13 implementing another embodiment for exhaust isolation. In this embodiment, the isolation means is one or more inserts. Inserts 20 and 21 are positioned on the surface of the exhaust channel 17. In some embodiments, these inserts 20 and 21 are made of a material having a low thermal conductivity, such as ceramic material. Several cavities 20a and 21a may be formed on the surfaces of the inserts 20 and 21 which face the surface of the exhaust channel 17. The cavities 20a and 21a separate the inserts 20 and 21 from the surface of the exhaust channel 17. Bridges 20b and 21b may be situated between the cavities 20a and 21a which supports the inserts 20 and 21. The inserts 20 and 21, with the cavities 20a and 21a and bridges 20b and 21b, may absorb the pressure exerted by the hot exhaust gases and provide an effective exhaust isolation means. The inserts may be mounted after the engine has been manufactured.

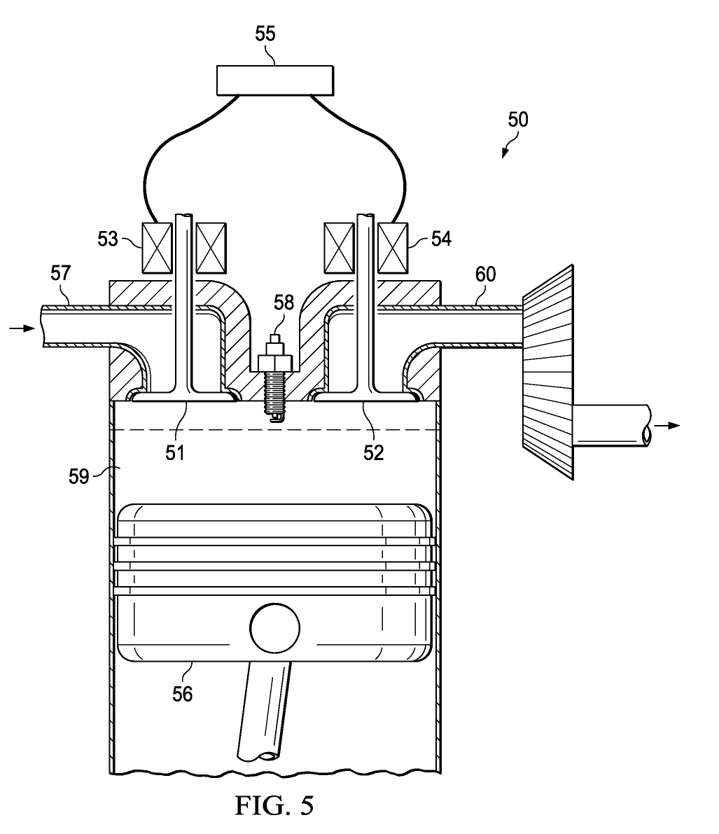

FIG. 5 is a schematic of a piston engine 50 where the intake valve 51 at the inlet pipe 57 and the discharge valve 52 at the exhaust pipe 60 are controlled electrically by solenoids 53 and 54, respectively, through a control device 55. In this embodiment, the timing of the valves is easier to control and adjust as the timing is not necessarily dependent on the rotation of a camshaft. Also shown is a spark plug 58 which discharges a spark into the piston chamber 59 to ignite the air-fuel mixture, thereby pushing the piston 56 downward as in the embodiments explained above.

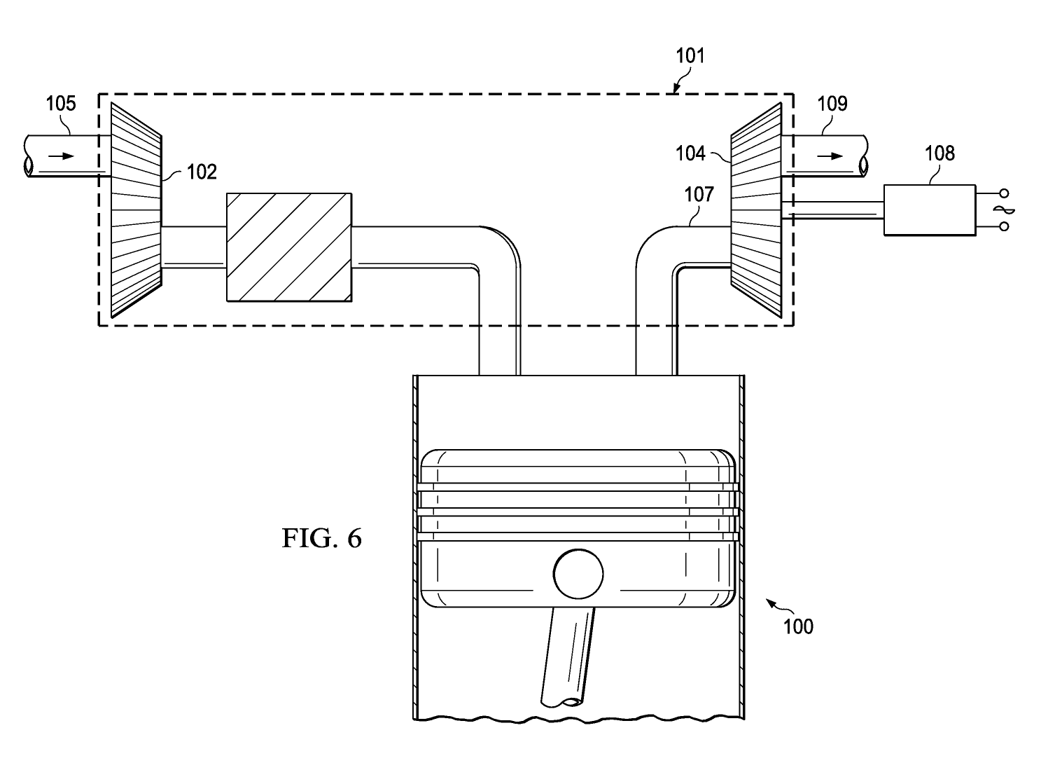

FIG. 6 shows the general layout of a compound turbo system with a four-stroke piston engine 100, a turbo charger 101, and a generator 108. Normally, the mechanical power from the expansion turbine 104 positioned between the outlet pipe 107 and the exhaust pipe 109 drives the compressor 102, compressing air aspired through the inlet 105. In the present embodiment, surplus mechanical power from the expansion turbine 104 may also be used to drive the generator 108. Alternatively, the expansion turbine 104 can be coupled to the piston main engine's camshaft or drive shaft to deliver more mechanical power to either of these shafts.

This arrangement may use the static pressure of the comparably slow moving exhaust gas in the exhaust gas collection pipe 107. Other arrangements where the turbine uses the impulse of fast moving exhaust gases from the piston main engine may also be used.

The above described embodiments may have numerous advantages. As the discharge cycle of the engine is a displacement cycle for the hot gases rather than a throttling process, the temperature, pressure, specific volume, and entropy remain nearly constant between the piston main engine's cylinder at the end of the expansion cycle and the exhaust gas collection pipe. This enables the turbo expander to carry out a complete expansion of the hot gases to ambient pressure without an increase in entropy.

Current engines may be converted to include the control means, such as a valve-camshaft combination, which define and carry out intake and exhaust of the working and flue-exhaust gas. A computer may control an additional actuator which adapts valve timings further. Also, an additional expansion means, described above, may be used to significantly improve engine efficiency. For example, in some embodiments, the camshaft of four-stroke engines is replaced by a camshaft with the above described timing and an additional expansion device is installed, or if an expansion device already exists, it may be replaced by a new and more powerful exposition device.

A 20% gain in mechanical power may be possible for turbo-charged piston engines according to the above described embodiments, depending on the initial efficiency, without requiring any additional fuel. Furthermore, the thermally isolated exhaust channels may lower the loss of thermal energy from the hot gases from the engine and considerably increase the mechanical power delivered by the expansion turbine. Still further, if late combustion is employed, the engine's power may be further increased without significantly decreasing efficiency. This means that the specific installation costs of the engine (cost per kW) may be lowered.

B: Pre-Expansion

1. Pre-Expansion Valve Timing

A partially loaded engine does not need to deliver as much power as a fully loaded engine. As such, it may be advantageous to devise a method for consuming less fuel, when less fuel is needed, during an engine's partially loaded state. The following embodiments provide greater fuel efficiency by modifying valve timings such that the piston engine pre-expands the aspired air-fuel mixture prior to the compression and combustion strokes. It should be noted that the modified valve timings discussed below are in the context of a partially loaded engine and are compared to the valve timings of a traditional fully loaded engine. However, the modified valve timing may be advantageous in certain fully loaded applications, especially when utilized with pre-heated intake gas, as will be discussed below.

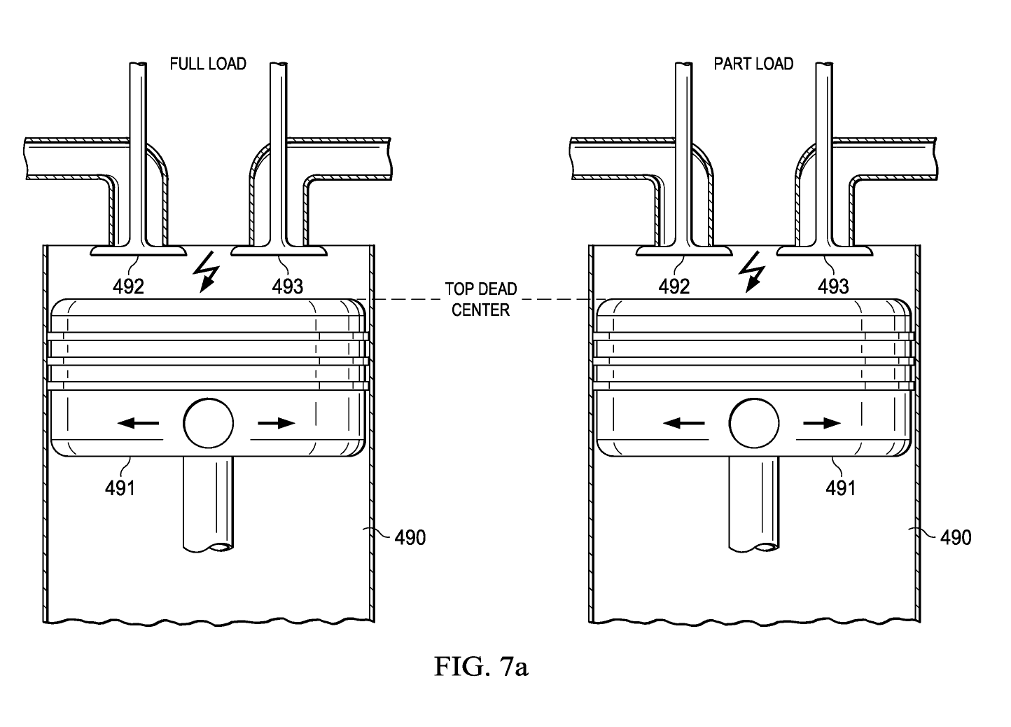

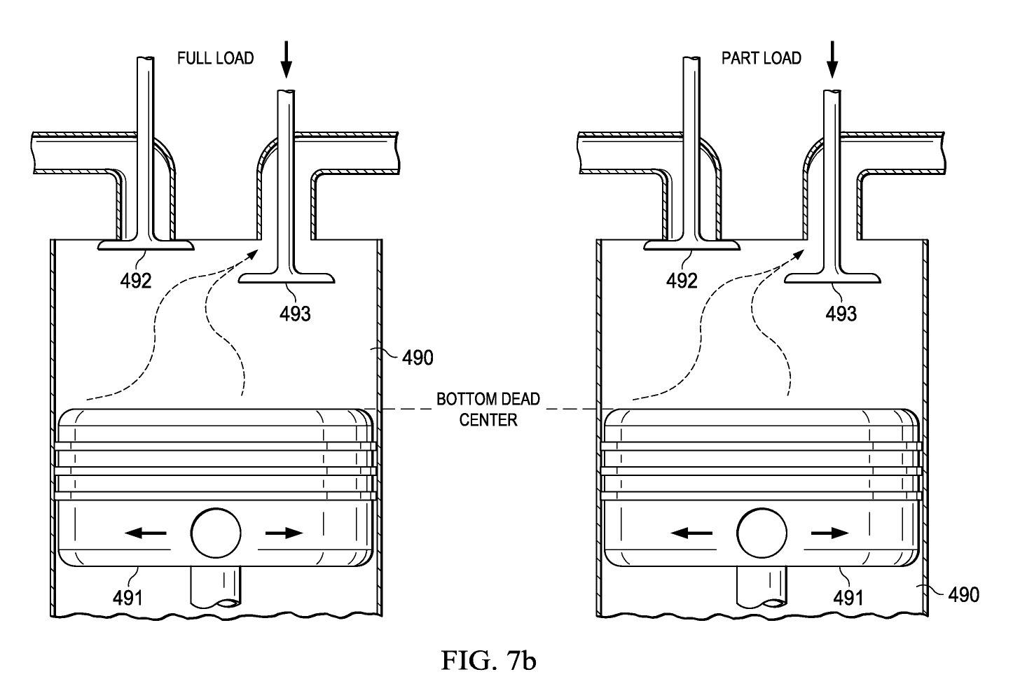

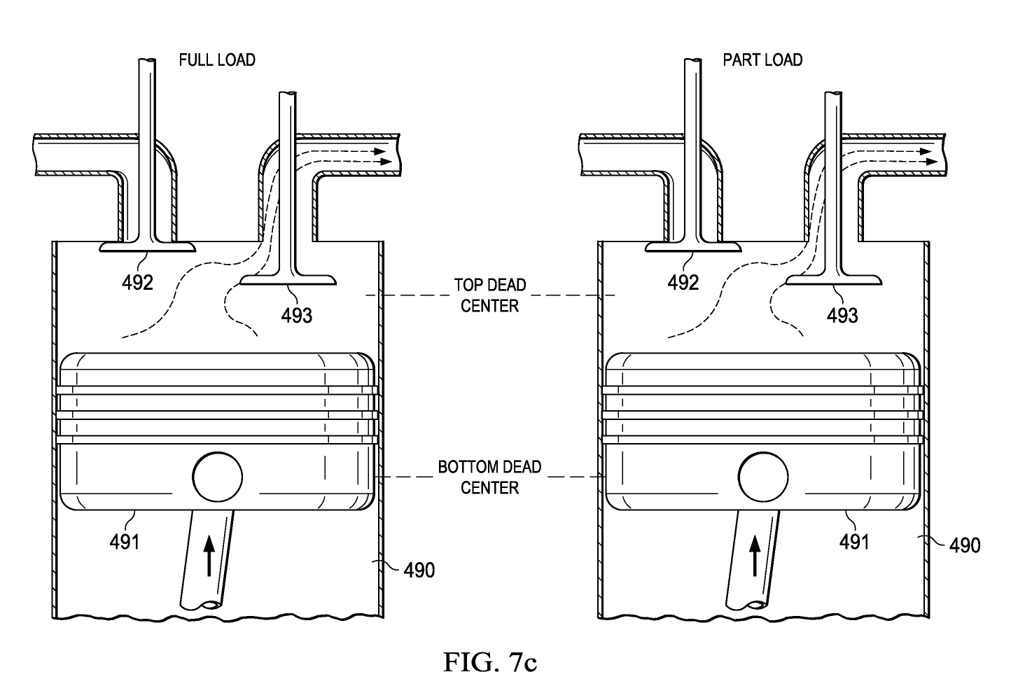

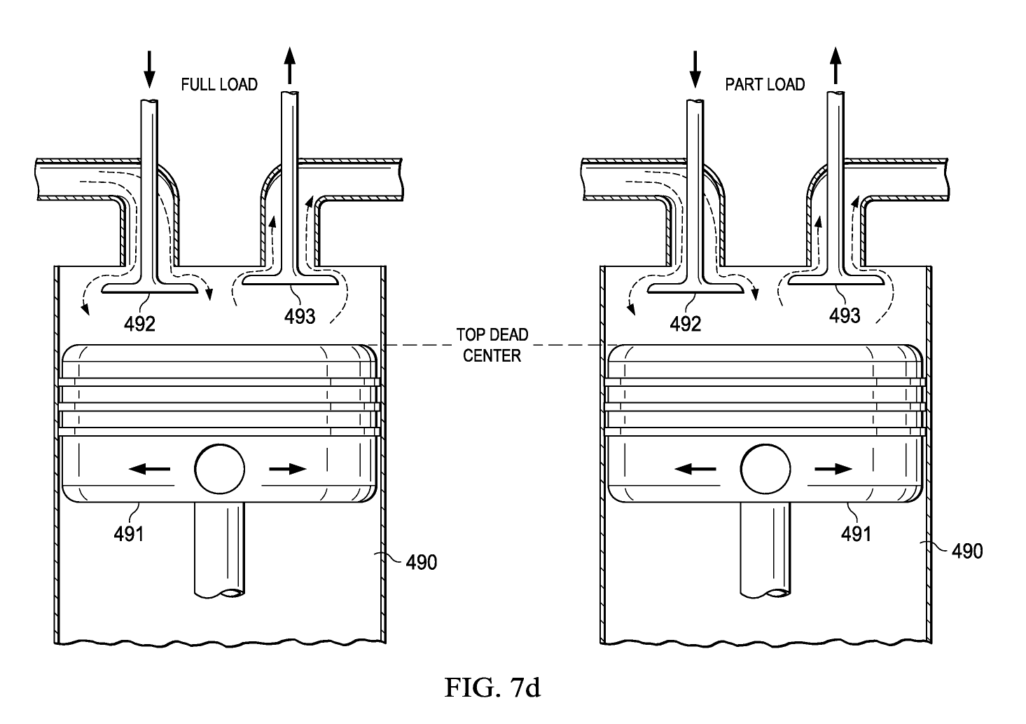

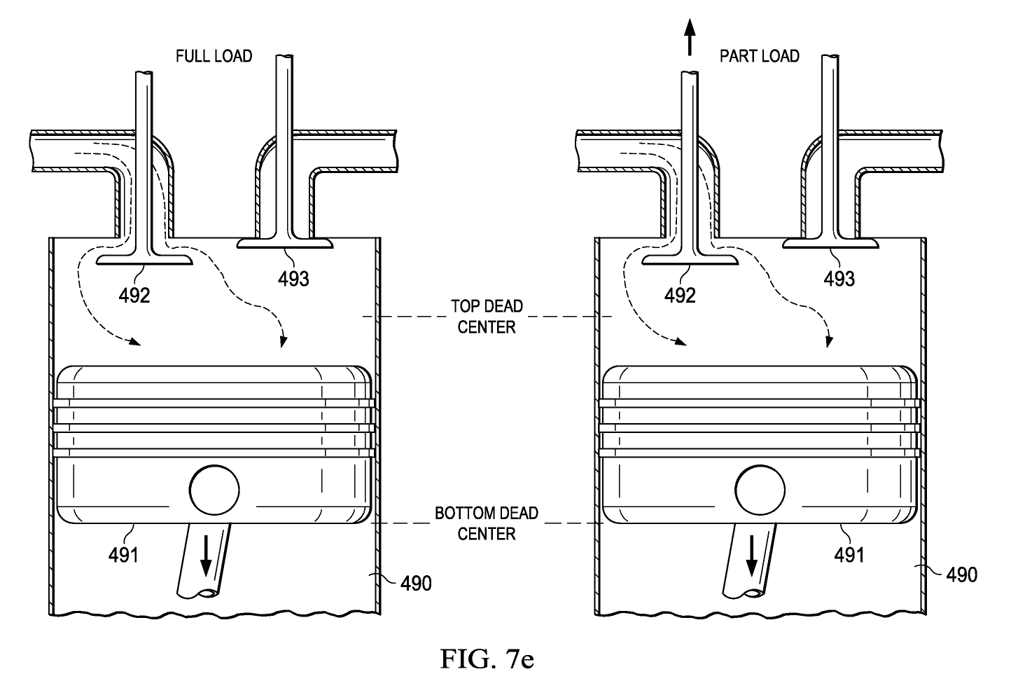

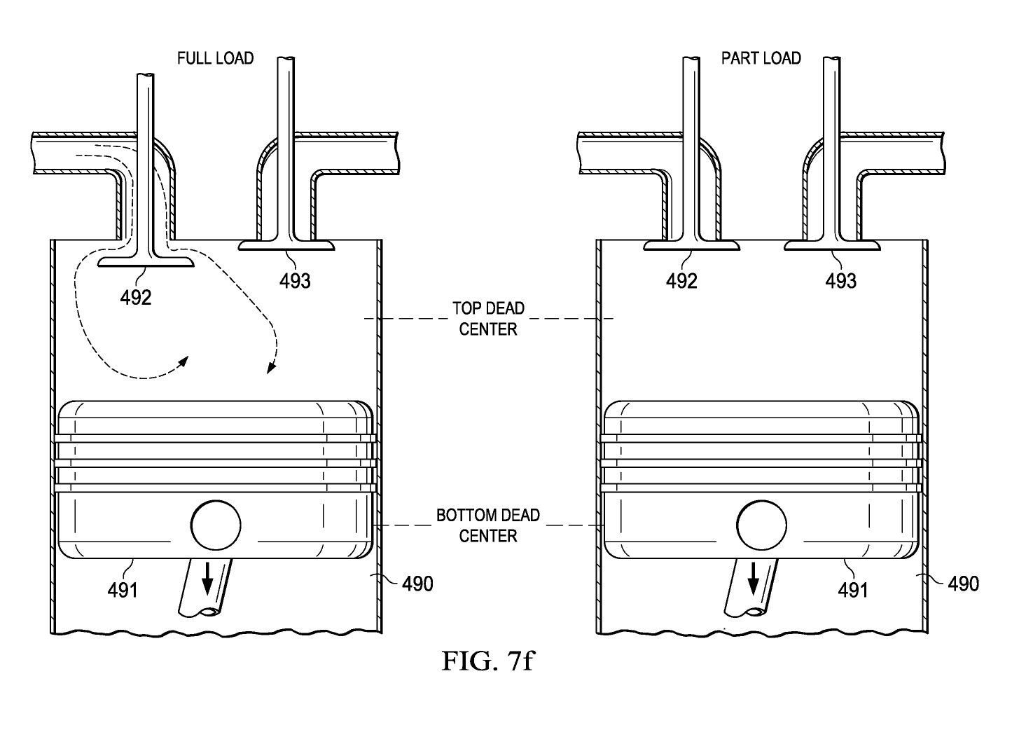

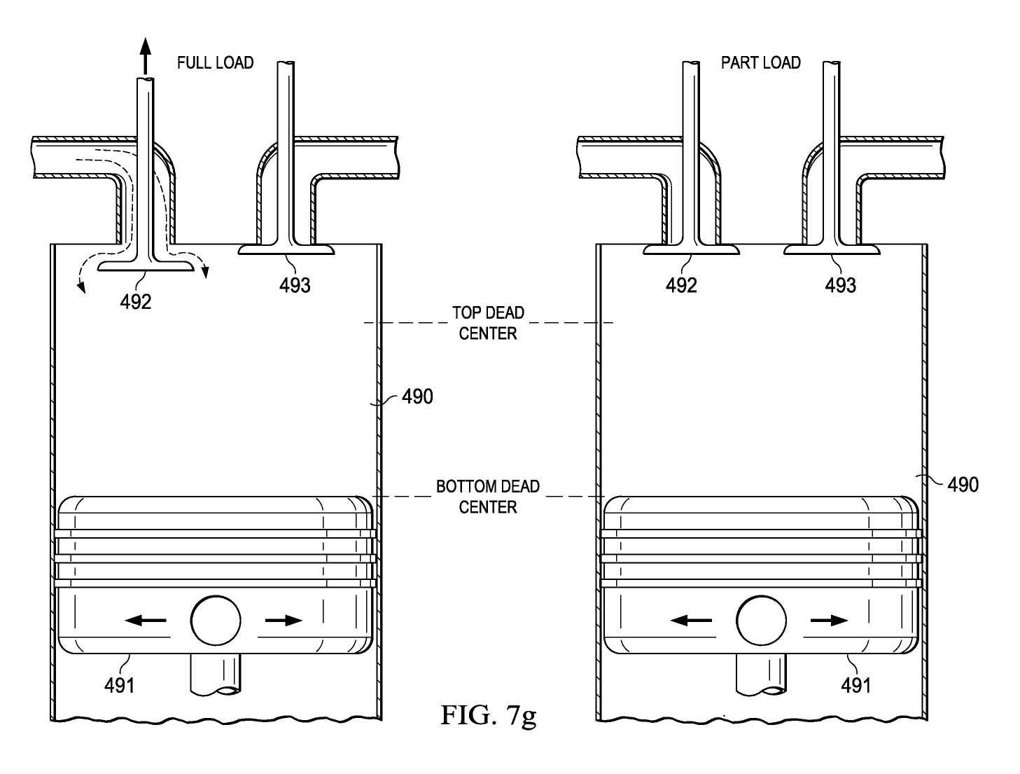

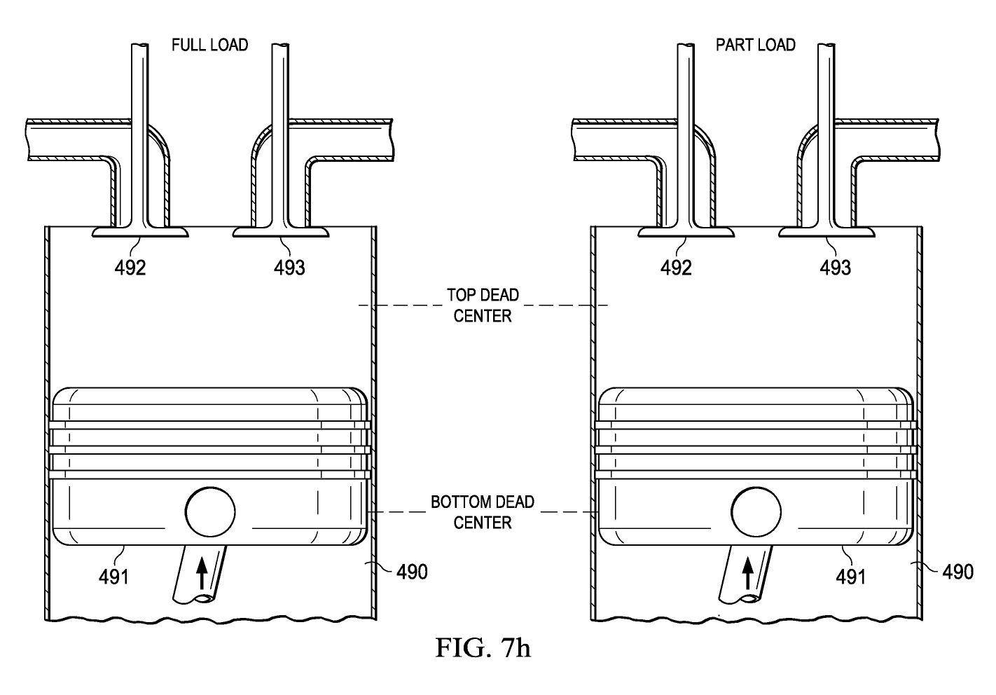

FIGS. 7a to 7h show the valve timings for a four-stroke valve-controlled reciprocating piston engine according to some embodiments. FIG. 7a shows the piston's 491 position in the engine cylinder 490 at its top-dead-center position ignition, whether by a spark plug or by injecting self-igniting fuel, that occurs both in a fully or partially loaded state. Both the intake valve 492 and the discharge valve 493 remain closed.

FIG. 7b shows that the piston 491 moves down, and near or at the bottom-dead-center position, the discharge valve 493 opens in both under full- and part-load. The hot exhaust gases start discharging through the open discharge valve 493. It will be appreciated that during partial loading, the exhaust gas pressure in the cylinder 490 may be below ambient pressure, and at the beginning of the exhaust stroke a re-flow into the cylinder 490 through the open discharge valve 493 may occur. This may be avoided by a variable discharge valve timing which enables the opening of the discharge valve 493 when both ambient and cylinder pressure are almost equal.

As shown in FIG. 7c, both under full- and part-load, the piston 491 moves upward and forces the hot exhaust gas to leave the cylinder 490 through the open discharge valve 493. When the piston 491 reaches, or goes near, the top-dead-center position, the discharge valve 493 closes and the intake valve 492 starts to open, as shown in FIG. 7d. This means that the air or air-fuel mixture in the intake pipe starts to move into the cylinder 490 through the open intake valve 492. This occurs during a partial and fully loaded state.

FIG. 7e shows the valve positions at an intermediate position of the piston 491 in the course of its downward movement in this intake stroke, both under full- and part-load. Under full-load the intake valve 492 remains open. The intake valve 492 starts closing much earlier in part-load so as to restrict the mass of the aspired air or air-fuel mixture.

As shown in FIG. 7f, under full-load, the piston moves down towards its bottom-dead-center position while the intake valve remains open throughout the whole intake stroke. However, in part-load the valve closes before the piston has reached its bottom-dead-center position. This causes the aspired fresh air or air-fuel mixture to pre-expand and the temperature to drop.

As shown in FIG. 7g, under full-load, the intake valve 492 now also closes when the piston 491 reaches its bottom-dead-center. Under part-load, the intake valve 492 has already been closed for a significant time and the air or air-fuel mixture in the cylinder 490 has been pre-expanded. Consequently, this pre-expansion causes both the pressure and the temperature of the air or air-fuel mixture to drop.

It will be appreciated that there has been no throttling in the course of the aspiration stroke. Consequently, the pressure has dropped from ambient pressure to a significantly lower value which means that the mass of the aspired air or air-fuel mixture has been reduced without imposing any throttling or other efficiency-penalizing state changes. Reduced mass intake means a reduced load and, therefore, part-load is achieved at a high efficiency.

As shown in FIG. 7h, both under full- and part-load, the piston 491 moves up and compresses the air or air-fuel mixture in the cylinder 490.

2. Systems which Pre-Heat Inlet Air and Use Pre-Expansion Valve Timing for Managing Fuel Consumption in Part-Load Applications

The pre-expansion process described above lowers the temperature and pressure of the air-fuel mixture in the piston chamber during expansion. Therefore, the compression temperature will likewise be lower using pre-expansion, which may cause fuel condensation and decreased compression end temperature before combustion and other efficiency penalizing effects. Therefore, it may be advantageous to preheat the air which is aspired into the piston chamber. The embodiments described below address these issues by pre-heating freshly aspired air. The pre-heated aspired air then passes into a cylinder having modified valve timing, as described above, to pre-expand the preheated air-fuel mixture. However, because the air-fuel mixture has been pre-heated, the final expanded temperature in the piston may be still at or above the comparable temperature of a fully loaded motor. Consequently, the compression end temperature before combustion may be maintained or even surpasses traditional engines.

a. Heat Exchanger and Pre-Expansion Valve Timing

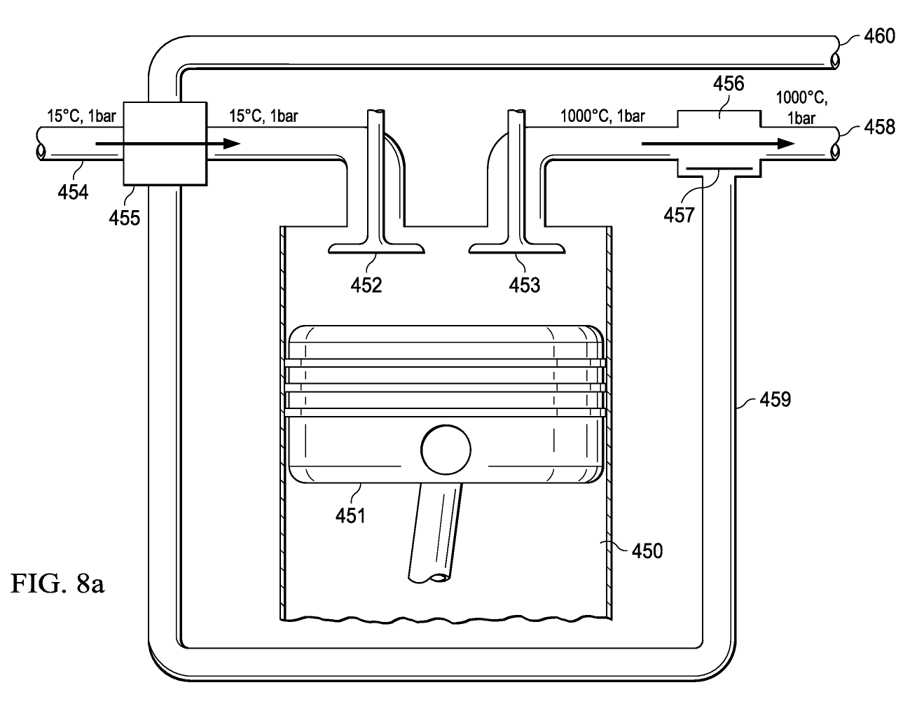

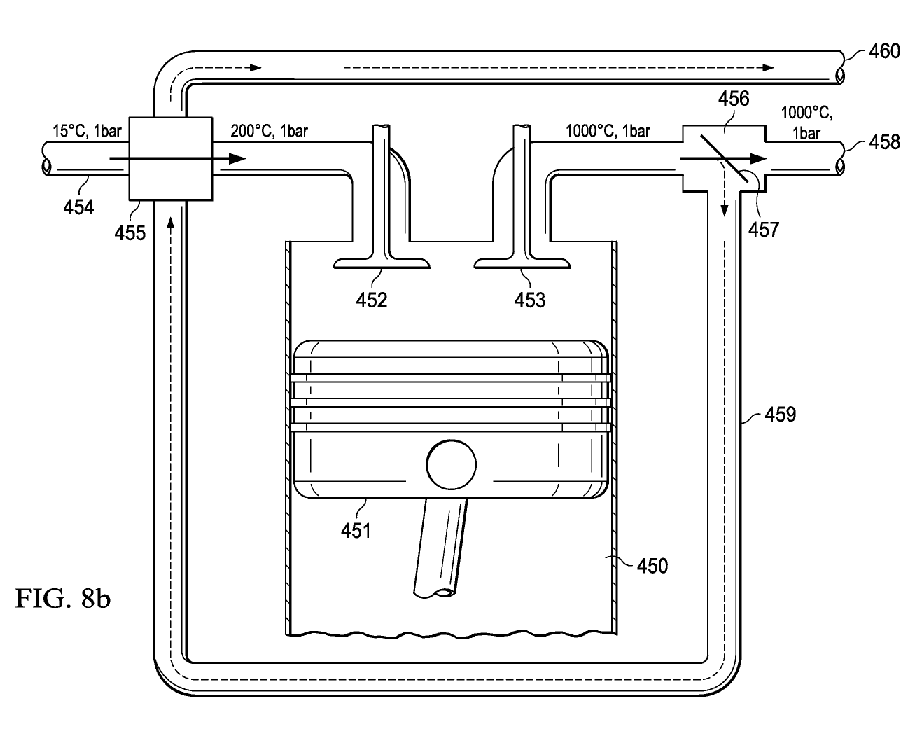

FIG. 8a shows an embodiment of a four-stroke valve-controlled reciprocating piston engine with a heat exchanger 455 and 3-way control valve 456—operating at full-load. The engine comprises a piston 451 slide-able within a cylinder 450. Intake of aspired air is controlled by the intake valve 452 and exhaust of the combusted gas by the discharge valve 453. FIG. 8a shows the condition where the piston engine is running at or near full-load.

Fresh air or an air-fuel mixture is aspired through the inlet 454 under normal conditions, for example 15° C., 1 bar, and passes through the heat exchanger 455. As the engine is running at or near full-load, very little heating occurs in this heat exchanger 455 and the aspired gas leaves it at nearly the same temperature and same pressure as aspired. Pressure losses caused by passing through the heat exchanger 455 are neglected in the description for ease of explanation. The forthcoming values for temperature, pressure and flow rate are illustrative and are not limiting in any way.

The gas flow is controlled by the intake valve 452 in such a manner that the cylinder 450 is filled completely as desired with the aspired gas. After the usual compressing, combustion, and expansion strokes, the discharge valve 453 opens and allows the hot exhaust gases, for example 1000° C., 1 bar, leave the cylinder 450 by the upward movement of the piston 451. The hot exhaust gas passes through a 3-way control valve 456 with a flap 457 which controls the flow of the exhaust gas. Under full-load, the flap 457 allows all the exhaust gas pass and discharges the gas to the atmosphere through the outlet 458. Under part-load, the 3-way valve taps to a connecting channel 459 which leads to the heat exchanger 455 for channelling the hot exhaust gas to the heat exchanger 455 for heating purposes of pre-heating the inlet air before exhausting the cooled gases through exit pipe 460.

FIG. 8b shows the same four-stroke valve-controlled reciprocating piston engine with a heat exchanger 455 and 3-way control valve 456 operating in part-load. In part-load fresh air or an air-fuel mixture is aspired through the inlet 454 under normal conditions, for example 15° C., 1 bar. The fresh air or air-fuel mixture passes through the heat exchanger 455. While the engine is running at part-load, the heat exchanger 455 increases the temperature of the aspired gas to 200° C. while maintaining the pressure.

In part-load, valve timing of the intake valve 452 is adjusted to cause pre-expansion. This valve operation has already been described in detail above with reference to FIGS. 7a to 7h. At the end of this pre-expansion cycle, when the piston 451 has reached the bottom-dead-center, both pressure and temperature of the gas have been lowered. This means that the compression stroke starts from a point where the pressure of the fresh gas is significantly lower than under full-load. However, the temperature of the aspired gas is at least equal or even higher than the gas in full-load because it was pre-heated in the heat exchanger 455. Consequently, the compression end temperature may be maintained as compared with full-load without any throttling.

After the usual compressing, combustion, and expansion strokes, the discharge valve 453 opens and allows the hot exhaust gases, for example 1000° C., 1 bar, leave the cylinder 450 by the upward movement of the piston 451. The hot exhaust gas passes through a 3-way control valve 456 with the flap 457 now in a position which channels a significant part of the hot exhaust gas into the channel 459 and, consequently, to the heat exchanger 455. Here, the hot exhaust gas pre-heats the aspired air or air-fuel mixture and is finally discharged into the environment through the outlet 460.

By adjusting the position of the flap 457 in the 3-way control valve 456 the amount of hot exhaust gas fed to the heat exchanger 455 may be controlled. Therefore, the temperature of the fresh gas leaving the heat exchanger 455 and fed to the intake valve 452 may be set at any desired temperature according to the operating requirements for increased part-load efficiency.

b. Pre-Heated Heat Exchanger and Pre-Expansion Valve Timing for Non-Delay Use

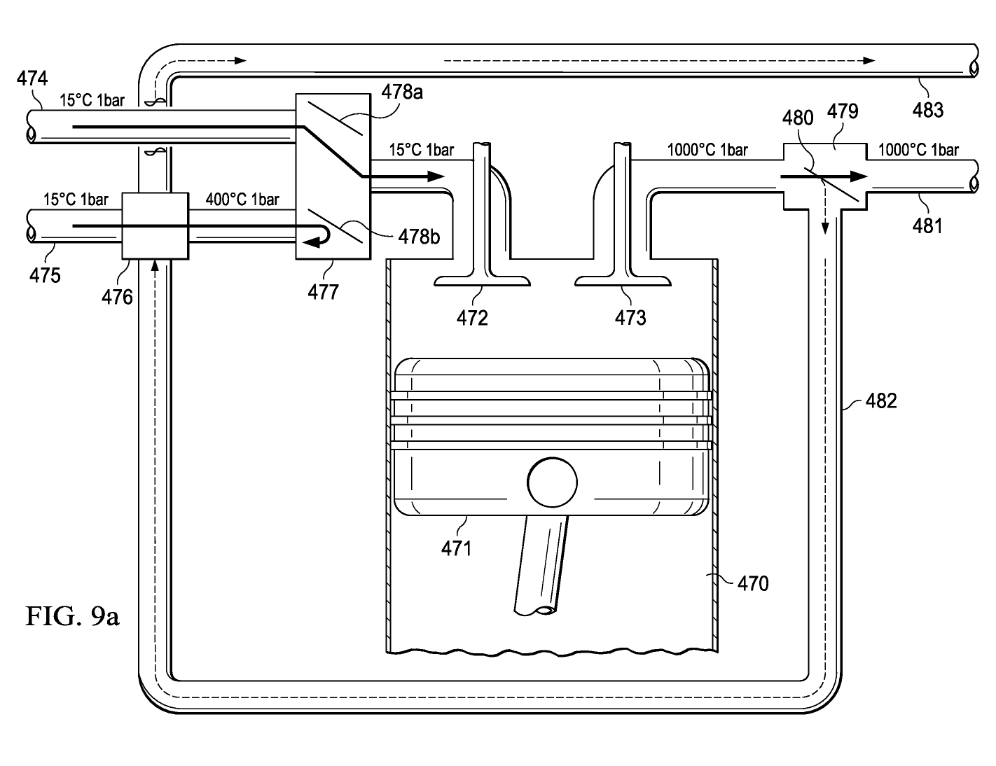

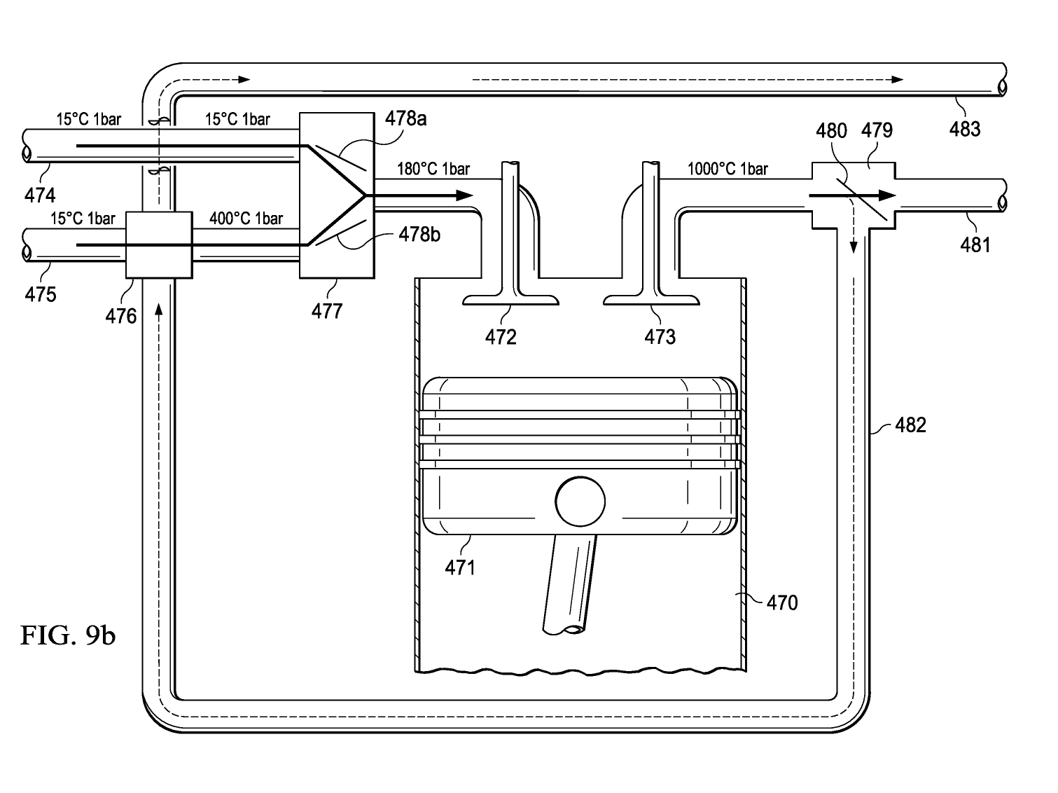

The described arrangement in reference to FIGS. 8a and 8b may have a delay in raising the temperature of the fresh air when a load change occurs quickly, as the flap 457 must typically be moved, the hot exhaust gas has to flow through the channel 459 and the heat exchanger 455 must be heated. Therefore, the arrangement according to FIGS. 9a and 9b may be appropriate for stationary or marine applications where load does not change rapidly.

In mobile applications, such as cars or trucks, it may be advantageous to continuously maintain the heat exchanger at a higher temperature so that the temperature of the aspired air or air-fuel mixture may be heated quickly to respond to sudden load changes.

FIGS. 9a and 9b show such an embodiment where the heat exchanger may be maintained at a higher temperature. In some embodiments, a volume of hot air is stored for immediate use by means of dual inlets 474, 475, a heat exchanger 476, and a controllable mixer 477. A piston engine in a partially loaded state (e.g., an idling car) passes the otherwise wasted hot exhaust gases through a heat exchanger 476 to extract heat. This heat is then used to pre-heat air aspired into the engine. The pre-heated aspired air then passes through a controllable mixer 477 which mixes fresh air and pre-heated air to a desired ratio. Then the mixed air passes into a piston with modified valve timing, as described above, to pre-expand the preheated air-fuel mixture.

The benefit of this design is that the heat exchanger may remain hot. Thus, the engine may respond to a sudden load change without delay by merely changing the mixing ratio in the controllable mixer 477.

The piston engine comprises a cylinder 470 wherein a piston 471 reciprocates, as usual. The intake is controlled by the intake valve 472, the exhaust of the combusted gas by the discharge valve 473. FIG. 9a shows an embodiment where the piston engine is running at or near full-load.

Air or an air-fuel mixture is aspired through the inlet 474 under normal conditions, for example 15° C., 1 bar, and directly enters the controllable mixer 477 where it can be mixed with another part of air or an air-fuel mixture which is aspired through the inlet 475 and heated by the heat exchanger 476. The mixing ratio and, hence, the temperature of the gas which is fed to the intake valve 472 may be freely controlled, such as by movable flaps 478a and 478b.

When the engine is running at or near full-load, very little mixing with pre-heated air occurs in this mixer 477 and the aspired gas leaves the mixer 477 at approximately the same temperature and pressure, as aspired. The gas flow is controlled by the intake valve 472 in such a manner that the cylinder 470 is filled completely as desired with the aspired gas. After the usual compression, combustion, and expansion strokes the discharge valve 473 opens and allows the hot exhaust gases, for example 1000° C., 1 bar, leave the cylinder 470 by the upward movement of the piston 471. The hot exhaust gas passes through a 3-way valve 479 with a flap 480 which controls the flow of the exhaust gas. Under full-load the flap 480 allows most of the exhaust gas pass and discharges it to atmosphere through the outlet 481. Only a minor part of the hot exhaust gas is fed to the channel 482 so that the heat exchanger 476 can be maintained at operating temperature and pre-heat a sufficient amount of air or air-fuel mixture required for a quick load change.

Even under full-load, a certain amount of hot exhaust gas at a maximum of 25%, in one illustrative embodiment, is channelled through the heat exchanger 476 to maintain a sufficient thermal reserve if the flaps 478a and 478b in the mixer 477 quickly change position. This reduces the amount of un-heated air and increases the amount of pre-heated air available to control the higher mixing temperature of the gas before it is fed to the piston engine. This also keeps the exhaust channel 482 warm. The remaining exhaust gas not channelled through the heat exchanger may be discharged through the outlet 483.

In general, this embodiment may show a quicker response to load changes which are associated with temperature changes of the air or air-fuel mixture aspired by the piston engine. Moreover, in some embodiments, the temperature of the gas fed to the intake valve 472 is controlled in a more precise manner by moving the flaps 478 to immediately alter the mixing temperature.

It will be appreciated that the 3-way valve 479 is optional. Without such a 3-way valve, a constant amount of the hot exhaust gas is channelled through the heat exchanger 476 which reduces complexity and costs but may expose the heat exchanger 476 to constant high exhaust gas temperatures even when no air is being aspired.

FIG. 9b shows the flap position and gas flow in part-load state, where again air or an air-fuel mixture is aspired through the inlet 474 under normal conditions, for example 15° C., 1 bar, and passes to the mixer 477. Also, air or an air-fuel mixture is aspired through the inlet 475 under normal conditions, for example 15° C., 1 bar, and enters the heat exchanger 476 where it is heated to 400° C. From there it passes to the mixer 477. Here, the flap 478a is closed more under full-load, while the flap 478b controlling the flow of pre-heated gas from the heat exchanger 476 is more open than under full-load so as to achieve a mixing temperature of ˜180° C. This pre-heated and mixed gas is guided to the intake valve 472 for intake into the cylinder 470. In a non-limiting example, a fraction of approximately 57% of air from the inlet 474 at 15° C. and a fraction of approximately 43% of pre-heated air from the heat exchanger 476 at 400° C. is mixed to achieve the desired temperature of 180° C.

During partial loading, the valve timing of the intake valve 472 is adjusted to cause pre-expansion. This valve operation has been already described in detail above with reference to FIGS. 7a to 7h. The pre-expansion causes a lowered temperature and pressure in the piston chamber, but the pre-compression temperature under part-load is equivalent to the pre-compression temperature under full-load because the air is pre-heated by the heat exchanger, as described above. Consequently, the compression end temperature is at least maintained as compared to full-load without any throttling.

After the usual compressing, combustion, and expansion strokes, the discharge valve 473 opens and allows the hot exhaust gases, for example 1000° C., 1 bar, leave the cylinder 470 by the upward movement of the piston 471. During extreme partial loading, the discharge valve may open after the piston 471 has already moved upward because the expansion end pressure at the bottom-dead-center position may be well below ambient pressure and an early valve opening would cause a loss of usable mechanical energy.

The hot exhaust gas passes through a 3-way valve 479 with the flap 480 now in a position which allows a larger part of the hot exhaust gas to enter the channel 482 and, consequently, to provide higher heat to the heat exchanger 476. Here, the hot exhaust gas pre-heats the aspired air or air-fuel mixture and is finally discharged into the environment through the outlet 483.

By adjusting the position of the flaps 478a and 478b in the mixer 477, the temperature of the gas leaving the mixer 477 and being fed to the intake valve 472 can be set at any desired temperature according to the load requirements for increased part-load efficiency. The 3-way valve 479 provides an additional control means.

To optimize the overall efficiency of each piston engine, the actual pre-heating temperature in the heat exchangers 455, 476 and/or mixers 477 and the actual valve timing of the intake valve 472 may be determined by test-runs. In general, as the load drops, the pre-heating temperature rises and the intake valve starts closing earlier. This means a larger expansion, but as the pre-heating temperature rises, the pre-expansion end temperature is kept at a sufficiently high level. Typically, the temperature rise of the aspired air or air-fuel mixture before it is fed to the intake valve 472, is to a temperature between 50° C. and 250° C., depending on the load which may be as low as 10% or lower. As the embodiment allows a much higher efficiency in part-load, fuel consumption is significantly lower than that of traditional engines.

It will be appreciated that the embodiment is not only applicable to Otto engines, but also to Diesel engines. Also here, it may be beneficial to reduce the amount of aspired air during partial loading to reduce the mechanical compression work in the compression stroke. As the described pre-heating ensures an equally high or even higher compression end temperature upon the end of the compression stroke both efficiency and ability to ignite the injected fuel may be maintained. Additionally, the corresponding lower mean pressure in this case reduces the mechanical load on the engine during partial loading and ensures in many cases a complete expansion of the working gas in the cylinder at the end of the expansion stroke to make the most use of the mechanical energy produced by burning fuel.

c. Exhaust Recirculation Mixer and Pre-Expansion Valve Timing

In the case of a partly loaded engine, it is not necessary that the intake gas be completely fresh. It may be advantageous to re-circulate a certain portion of exhaust gas. Instead of employing a heat exchanger to pre-heat the aspired air or air-fuel mixture, a small part of the hot exhaust gas may be directly used for heating. The mixed air is then warm enough to realize the benefits of pre-heated air, described above.

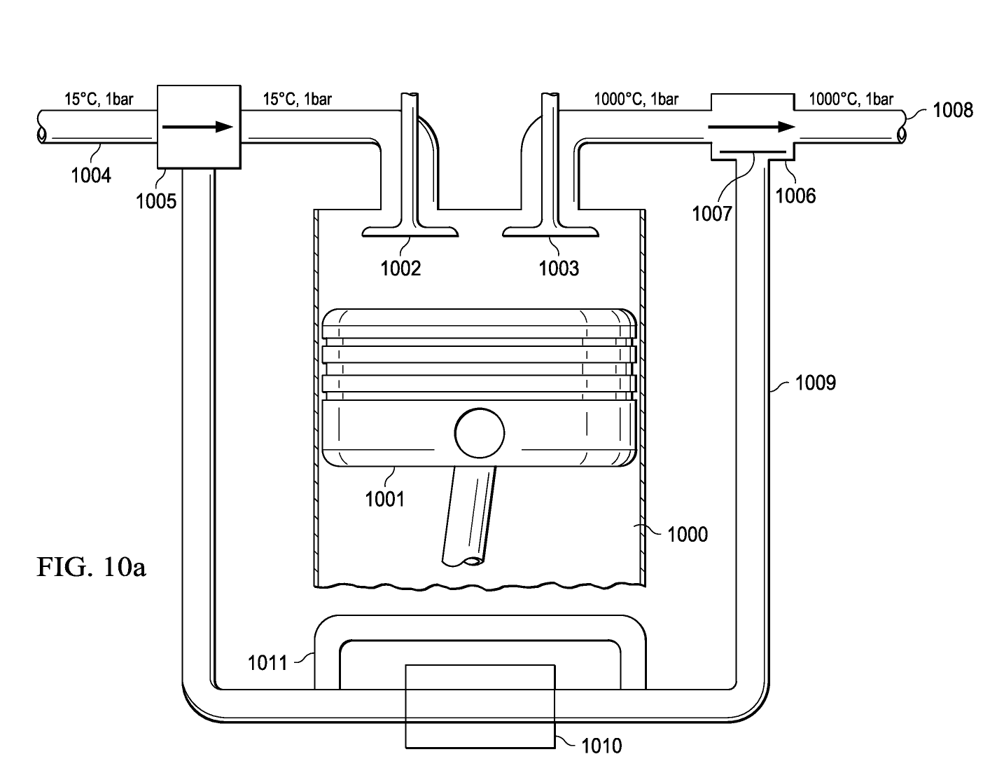

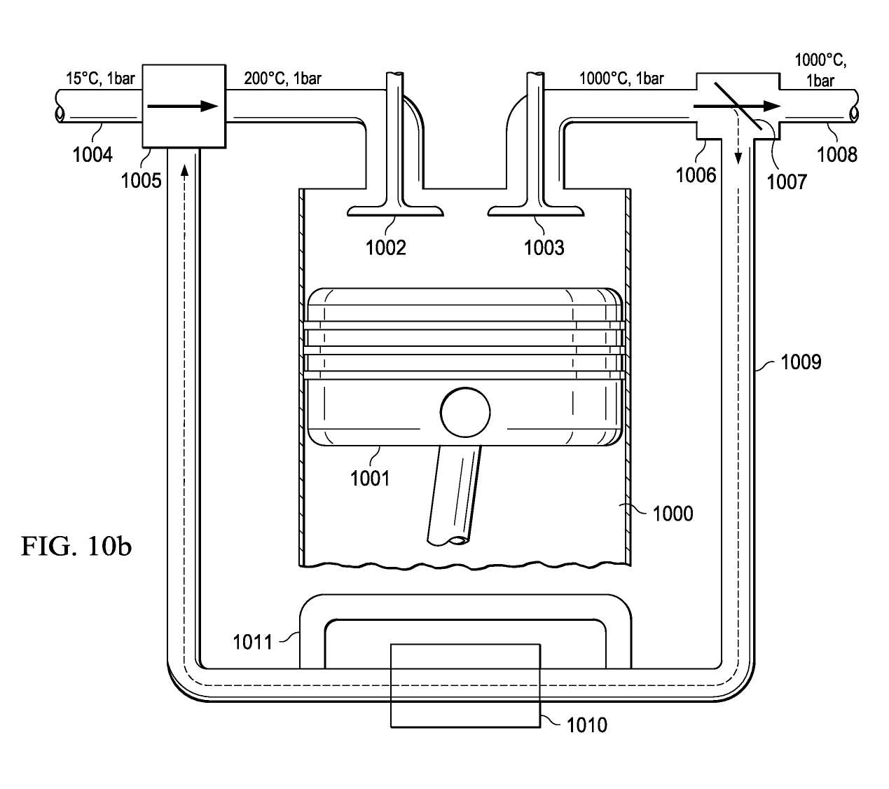

FIG. 10a and FIG. 10b show an embodiment where pre-heating is achieved by externally re-circulated hot exhaust gas. The piston engine comprises a cylinder 1000 wherein a piston 1001 moves up and down as usual. The intake is controlled by the intake valve 1002, and the exhaust by the discharge valve 1003. FIG. 10a shows the piston engine running at or near full-load. The forthcoming values for temperature, pressure, and flow rate are illustrative and are not limiting in any way.

Air or an air-fuel mixture is aspired through the inlet 1004 under normal conditions, approximately 15° C., 1 bar, and passes through the mixer 1005. As the engine is running at or near full-load, very little, hot exhaust gas is mixed with the aspired air or air-fuel mixture. In some embodiments, cooled exhaust gas is mixed to achieve exhaust gas re-circulation without significantly increasing the temperature of the gas fed to the piston engine. Hence, the aspired gas leaves the mixer 1005 at approximately the same temperature and same pressure as aspired. The gas flow is controlled by the intake valve 1002 in such a manner that the cylinder 1001 is filled with as much gas as desired.

After the usual compressing, combustion, and expansion strokes, the discharge valve 1003 opens to let the hot exhaust gases, for example 1000° C., 1 bar, leave the cylinder 1000, which is caused by the upward movement of the piston 1001. The hot exhaust gas passes through a 3-way valve 1006 with a flap 1007 which controls the flow of the exhaust gas. Under full-load, the flap 1007 passes nearly all the exhaust gas and discharges it into the environment through the outlet 1008, i.e., closing the connecting channel 1009 which leads to the mixer 1005.

If exhaust gas re-circulation is required during full-load, or a relatively higher load, the 3-way valve 1006 may feed a desired amount of hot exhaust gas to the connecting channel 1009. In some embodiments, the temperature of the aspired air may not be significantly increased, and an optional cooler 1010 may be provided to cool the re-circulated hot exhaust gas. This cooler 1010 may be operated, or bypassed by a controllable bypass pipe 1011 to increase the temperature of the re-circulated exhaust gas in part-load.

FIG. 10b shows the flap position and gas flow in part-load operation, where again air or an air-fuel mixture is aspired through the inlet 1004 under normal conditions, for example, 15° C., 1 bar, and passes to the mixer 1005. As the engine is now running at a part-load, the mixer 1005 increases the temperature of the aspired gas to 200° C. while maintaining its pressure by mixing in a corresponding amount of hot exhaust gas. In one embodiment, around 20% of the mixture may be composed of the re-circulated exhaust gas, but it will be appreciated that any suitable amount of re-circulated exhaust gas may be used. This means that at least for a moderate temperature increase (e.g., 200K or less) of the aspired air or air-fuel mixture, the external exhaust gas re-circulation is a comparably simple and low-cost option.

During partial loading, the gas flow is controlled by the intake valve 1002 so that the cylinder 1001 is no longer completely filled with the pre-heated gas. This means that the intake valve 1003 closes earlier than during a fully loaded state, thereby causing a pre-expansion cycle as the piston 1001 continues moving downward, and, consequently, expanding the pre-heated gas. This valve operation has already been described in detail above with reference to FIGS. 7a to 7h.

The hot exhaust gas passes through the 3-way valve 1006 with the flap 1007 now in a position which channels a significant part of the hot exhaust gas into the connecting channel 1009 and, consequently, to the mixer 1005. Here, the hot exhaust gas pre-heats the freshly aspired air or air-fuel mixture through mixing, and is finally fed together with the aspired air to the piston engine. The optional cooler 1010 may be increasingly disabled or bypassed as the engine load decreases. Disabling the cooler 1010 raises the exhaust gas temperature in the mixer 1005 according to the temperature requirements for the air or air-fuel mixture which is supplied to the piston engine.

3. Heat Exchanger and Pre-Expansion Valve Timing for Full-Load

It is well established that high pressures in the piston engine can cause wear, and in some instances, failure. Therefore, it may be desirable to limit the compression end pressure of a piston engine even during a fully loaded state while increasing, or at least maintaining, a high compression end temperature. In traditional engines, the compression end temperature, which often strongly correlates to engine efficiency, is increased by increasing the compression ratio and, consequently, the compression end pressure. However, in the current embodiment, engine wear may be reduced without penalizing the power and efficiency of the engine by introducing a high intake temperature.

By controlling both pressure and temperature of the aspired air after it passes through a heat exchanger, higher compression end temperatures may be reached, even for lower compression ratios of the piston engine. This may allow high air temperatures to ignite injected fuel and to increase efficiency of the thermodynamic process carried out by a turbo-charged piston engine according to the fully loaded embodiment without increasing the compression pressure and the combustion pressure beyond the intended values. In other words, the efficiency and combustion characteristics of the piston engine may be improved without the need for increased pressure. The combination of an appropriate high compression temperature and a reasonable compression ratio (e.g., between 6 and 14) together with a corresponding base pressure after the first expansion in the course of the combined intake-expansion stroke (or by the external expansion turbine 4 as discussed above) ensures a high mean pressure without too high of a peak pressure at the end of the combustion cycle. Consequently, engine wear may be reduced without penalizing the power density and efficiency of the engine.

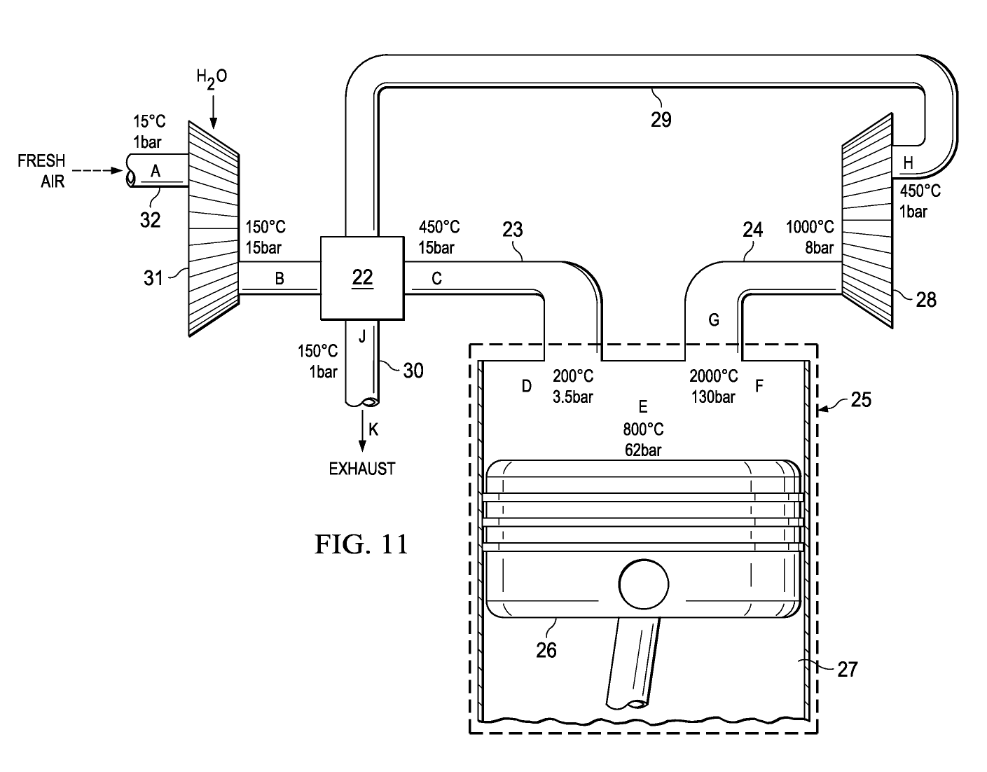

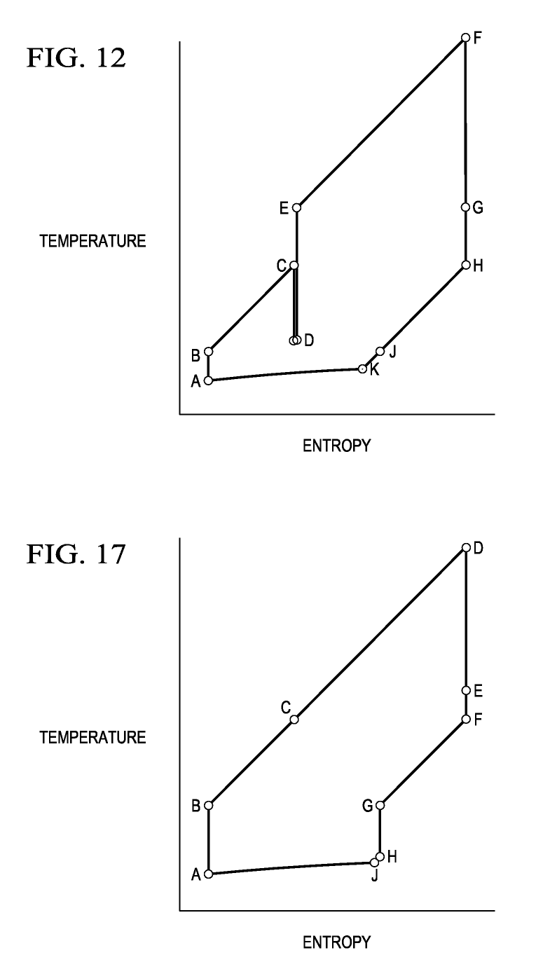

FIG. 11 shows the basic arrangement of such a super-charged four-stroke piston engine according to some embodiments. FIG. 12 shows the theoretical S-T diagram showing the thermodynamic process carried out by the embodiment of FIG. 11. These figures will be explained in conjunction with one another. The forthcoming values for temperature, pressure, and flow rate are illustrative and are not limiting in any way. The compressor turbine 31 aspires fresh air with a temperature of approximately 15° C. and ambient pressure of 1 bar (state point “A” in FIG. 12) through the inlet 32 and compresses it under continuous supply and vaporization of water to approximately 150° C. and approximately 15 bar (state point “B” in FIG. 12). Consequently, this compression is basically an isentropic state change as no external heat is supplied or extracted. Hence, the line A-B in FIG. 12 which indicates this state change is a straight line in parallel to the temperature axis.

The compressed air-steam mixture passes through the recuperator 22 where it is heated to approximately 450° C. while maintaining its pressure at approximately 15 bar (state “C” in FIG. 12). Now, the piston engine 25 which comprises a piston 26 reciprocating within the cylinder 27, first aspires the compressed air-steam mixture through its intake pipe 23. No expansion takes place. The intake valve (not shown in FIG. 11) closes before the piston 26 reaches its bottom dead center. Therefore, the isentropic expansion state change C-D (FIG. 12) is carried out by the piston engine 25. For better understanding, irreversibilities and losses are neglected at this stage of description. At the bottom dead center of the piston state “D” is reached with a temperature of around 200° C. and a pressure of approximately 3.5 bar. The piston 26, again, moves up and compresses the aspired air-steam mixture to reach a compression end temperature of around 800° C. and a pressure of around 62 bar (state point “E” in FIG. 12). Depending on the fuel, combustion occurs by externally igniting the fuel through a spark plug or by injecting the fuel to self ignite. Combustion of the fuel causes both temperature and pressure of the air-steam mixture rise to approximately 2000° C. and approximately 130 bar, respectively (state point “F” in FIG. 12).

The piston 26 moves down to expand the hot working gas to a temperature of approximately 1000° C. and a pressure of around 8 bar at its bottom dead center (state point “G” in FIG. 12). The exhaust valve (not shown) opens and the still hot working gas leaves the cylinder 27 through the exhaust pipe 24. As described earlier, the valve timing is set in such a manner that a substantial displacement of the hot and still pressurized exhaust gas into the exhaust pipe 24 occurs. In one embodiment, no significant throttling takes place. The expansion turbine 28 expands the exhaust gas further to ambient pressure of approximately 1 bar and a corresponding temperature of approximately 450° C. (state point “H” in FIG. 12).

The de-pressurized, but still hot exhaust gas, is channelled to the recuperator 22 through the pipe 29 to heat the freshly aspired and compressed air-steam mixture from the compressor turbine 31. Consequently, the mixture cools down to approximately 150° C. at ambient pressure of approximately 1 bar (state point “J” in FIG. 12). Finally, the cooled exhaust gas is discharged to the environment through the exhaust pipe 30. By mixing with ambient air the exhaust gas first cools down until it reaches the dew point of the steam (state point “K”) according to the amount of injected water in the compressor turbine 31.

The compressor turbine 31 and the expansion turbine 28 may be mounted on the same shaft (e.g., turbo-charger). It is also possible that an additional generator is connected to use the power surplus which may be generated by these coupled turbines. Alternatively, the expansion turbine 28 may be coupled to the crankshaft of the piston engine 25 to deliver the surplus power to the crankshaft. By moderately throttling the exhaust gas from the piston engine into the exhaust pipe 24, the power generated by the expansion turbine 28 may be set so that it delivers enough power to operate the compressor turbine 31 for compression. Additionally, the remaining power delivered by the crankshaft of the piston engines may increase while the power against which the piston 26 must typically move out the exhaust gas into the exhaust pipe 24 decreases. If this throttling is moderate (i.e., the pressure in the exhaust pipe 24 is at least half of the pressure at the end of the expansion stroke in the cylinder 27), then the irreversibility and, hence, the efficiency decrease caused by such throttling may be negligible. In the illustrative embodiment, throttling into the exhaust pipe 24 down to a pressure of around 5 bar may enable the expansion turbine 28 to drive the compressor turbine 31 while the efficiency decrease would be around 1% as compared to the thermal power of the burnt fuel. If, throttling down to less than the pressure of 2.3 bar in the intake pipe takes place, then an efficiency loss of around 3% as compared to the thermal power of the burnt fuel may occur.

By controlling both pressure and temperature after the recuperator 22 (FIG. 11) in an appropriate manner, even for lower compression ratios of the piston engine, higher compression end temperatures may be reached. This allows high air temperatures to ignite injected fuel and to increase efficiency of the thermodynamic process carried out by the super-charged piston engine according to some embodiments, without increasing the compression end pressure and the combustion pressure beyond the intended values. In other words, the efficiency and combustion characteristics of the piston engine may be improved without the need to increase pressure. The combination of an appropriate high compression temperature and a reasonable compression ratio (e.g., between 6 and 14) together with a corresponding base pressure after the first expansion in the course of the combined intake-expansion stroke ensures a high mean pressure without too high of a peak pressure at the end of the compression stroke. Consequently, the engine wear may be reduced without penalizing the power density and efficiency of the engine. In case of the described embodiments, the compression end temperature may be relatively high, e.g., 800° C., for which a compression ratio of at least 16:1 (in case of air as working gas and a perfect compression state change: 19:1) may be required. This would give rise to a compression end pressure of over 140 bar. Together with the pressure increase by burning the fuel to a value above 200 bar, this clearly reaches the limit of today's material resistance. As a consequence, when maintaining state-of-the-art maximum pressure, the charge pressure may be increased without increasing the peak pressure in the engine. This may improve the power density of the piston engine.

C: Internal Exhaust Recirculation by Modified Valve Timing

It may be advantageous to re-circulate a certain portion of exhaust air into the piston engine to pre-heat the newly aspired air and to mix a portion of unburned fuel from the exhaust back into the piston cylinder. This process may be accomplished by external exhaust re-circulation. In applications where space is limited, re-circulation internally in the piston may be accomplished by modifying the valve timing, as described below.

It may be beneficial to reduce the amount of aspired air in part-load to reduce the mechanical compression work required in the compression stroke. Pre-heating ensures higher compression end temperature in part-load than would exist otherwise. Thus, by preheating, combustion efficiency and the ability to ignite the injected fuel may be maintained. Additionally, the corresponding lower mean pressure in this cylinder may reduce the mechanical load on the engine in part-load and ensure, in many cases, a complete expansion of the working gas in the cylinder at the end of the expansion stroke to make the most use of the mechanical energy produced by burning fuel without the need for Miller or Atkinson timing.

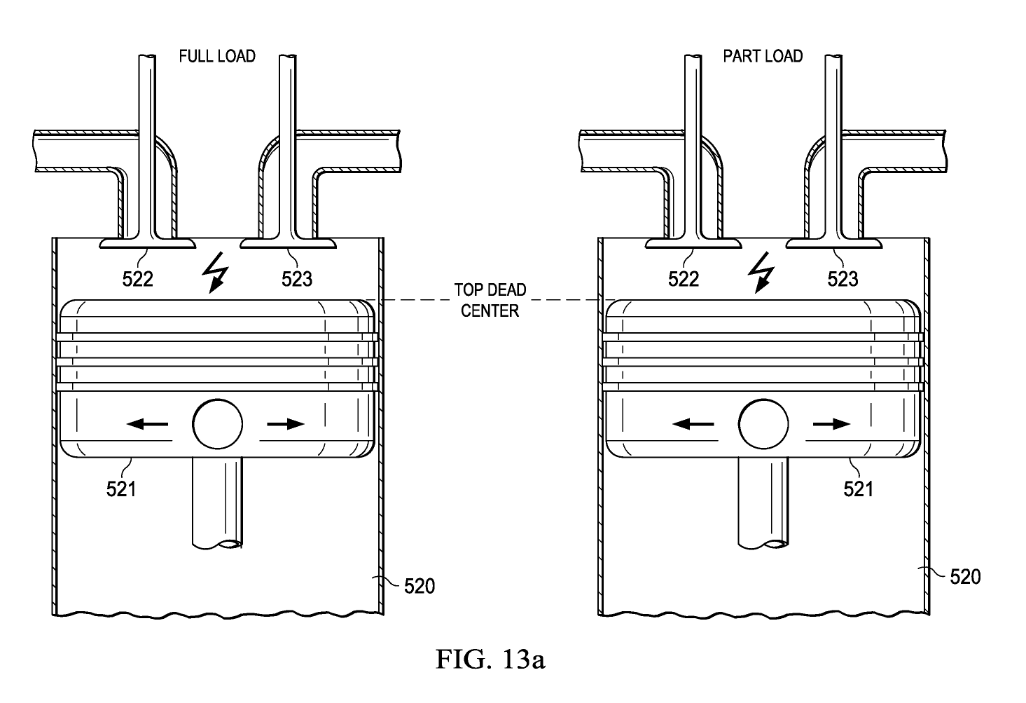

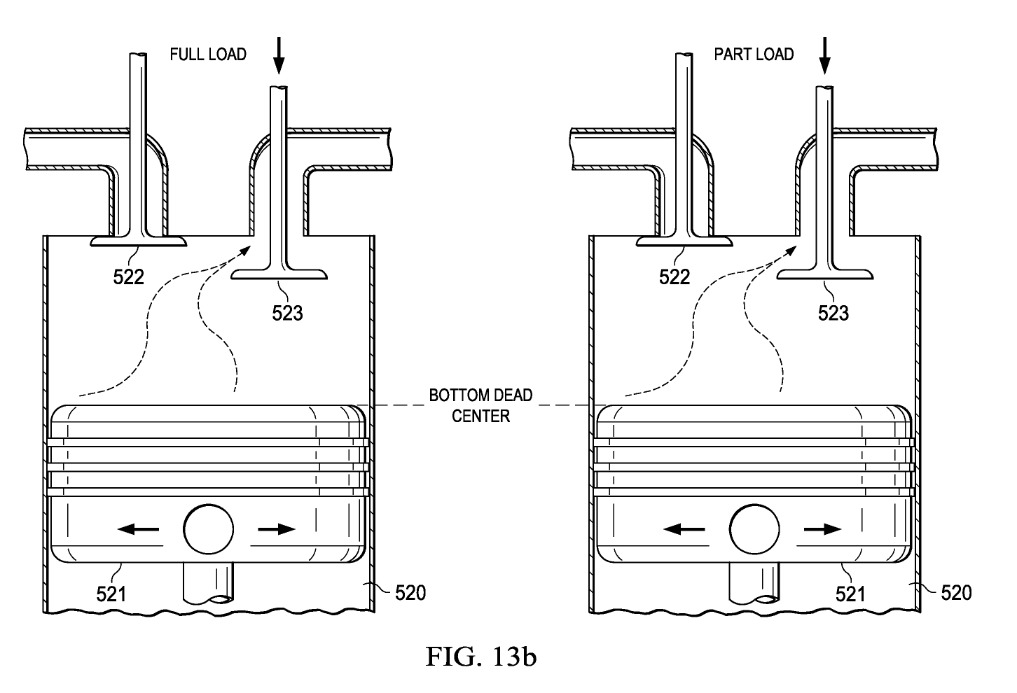

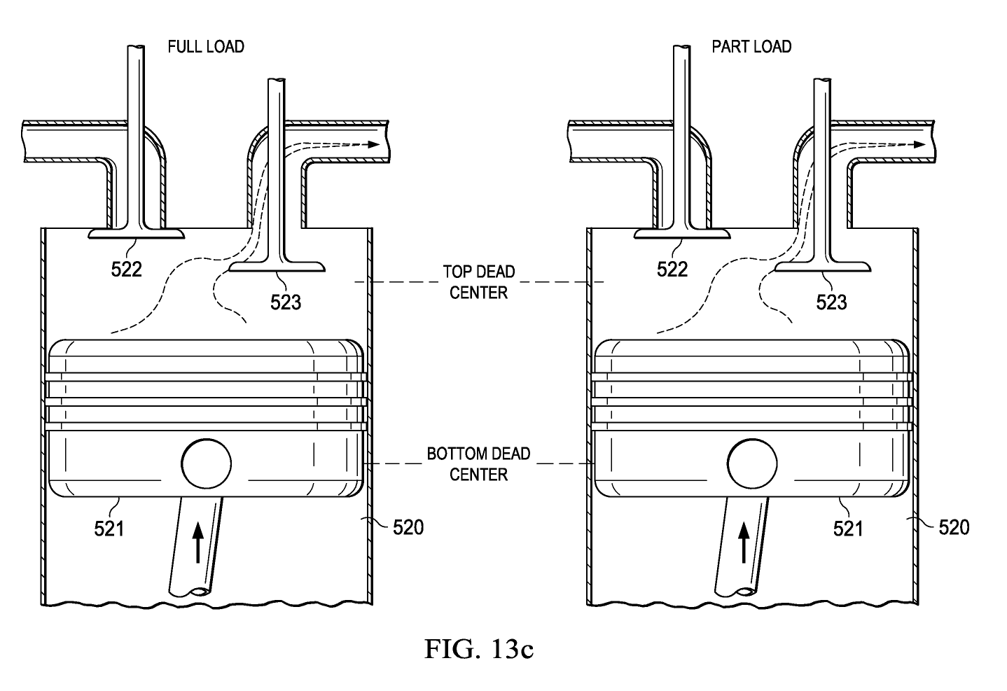

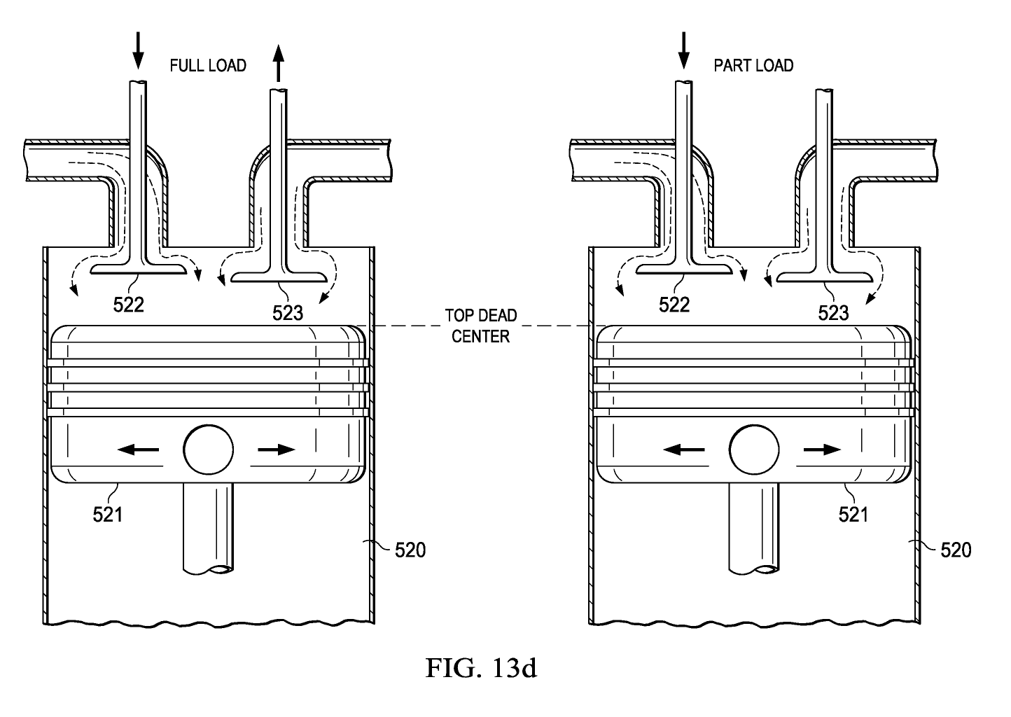

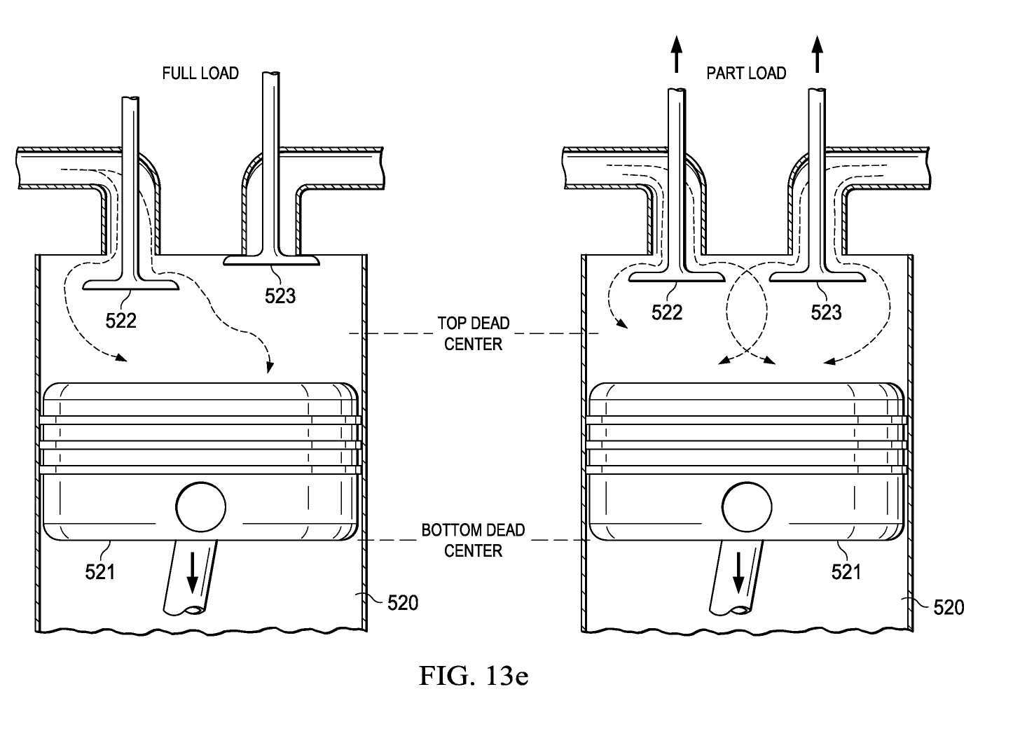

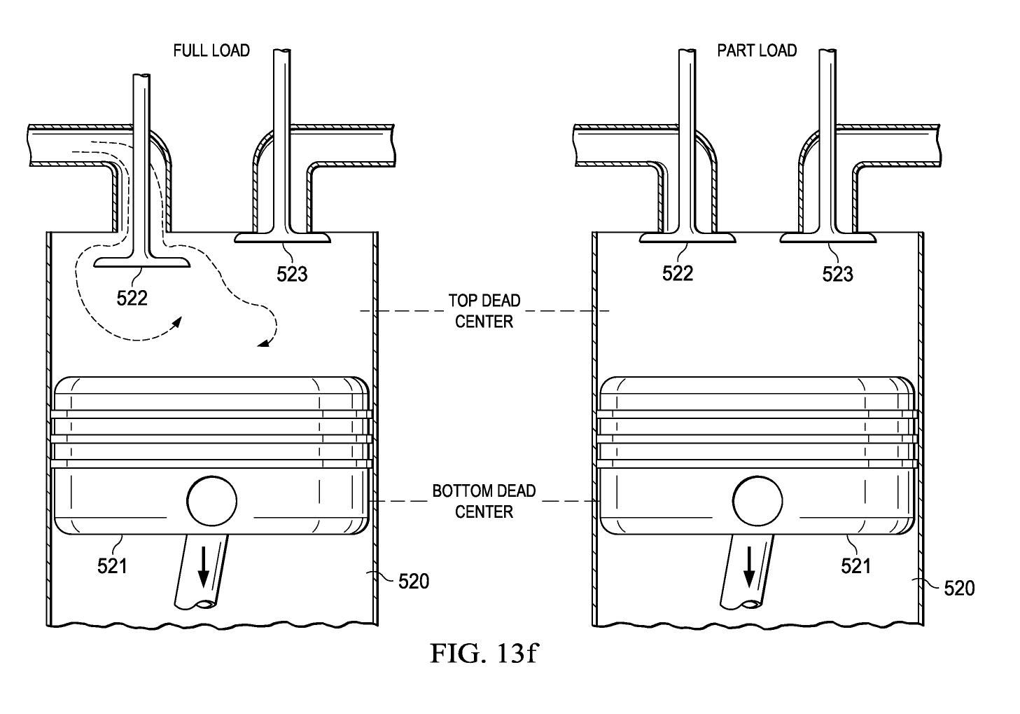

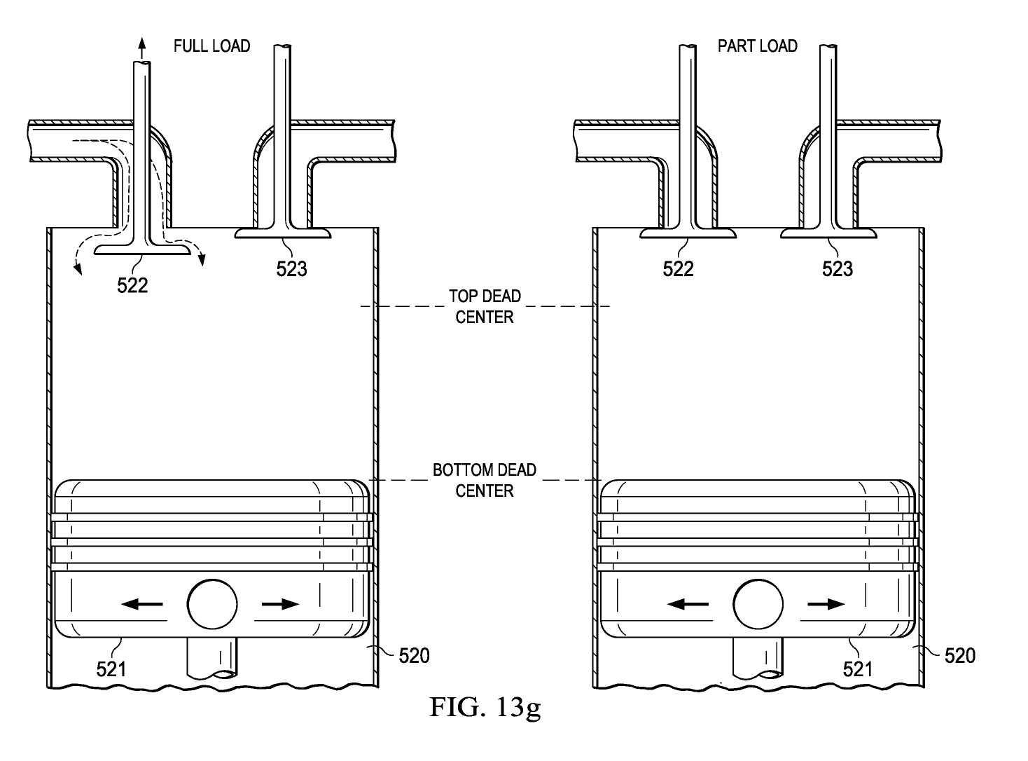

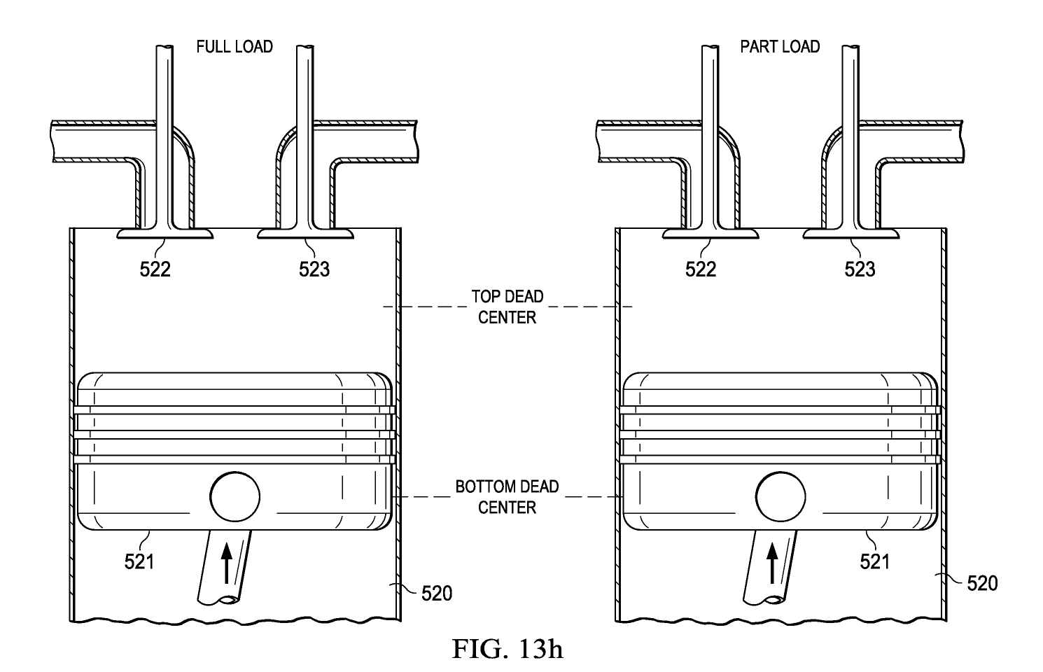

FIGS. 13a to 13h is a schematic diagram of an engine modified to facilitate pre-heating by internal exhaust gas re-circulation through a first type of valve timing, according to some embodiments. It should be noted that the modified valve timings discussed below are for a partially loaded (or part-load) engine and are compared to the valve timings of a traditional fully loaded engine. However, this same modified valve timing may be advantageous in certain fully loaded applications. The forthcoming values for temperature, pressure, and flow rate are illustrative and are not limiting in any way.

FIG. 13a shows the piston 521 position in the engine cylinder 520 at its top-dead-center position when ignition occurs, whether by a spark plug or injecting a self-igniting fuel, or both, under full- and part-load. Both, intake valve 522 and discharge valve 523 are closed.

When the piston 521 reaches the bottom-dead-center position, the discharge valve 523 opens, as shown in FIG. 13b. The hot exhaust gases start to discharge through the open discharge valve 523. In an extreme part-load, it might happen that the exhaust gas pressure in the cylinder 520 may be below ambient pressure and at the beginning of the exhaust stroke a re-flow into the cylinder 520 through the open discharge valve 523 may occur. This may be avoided by providing a variable discharge valve timing which enables the opening of the discharge valve 523 when both ambient and cylinder pressure are approximately equal.

As shown in FIG. 13c, both under full- and part-load, the piston 521 moves upward and forces the hot exhaust gas to leave the cylinder 520 through the open discharge valve 523. When the piston 521 reaches the top-dead-center position, the discharge valve 523 closes and the intake valve 522 starts to open (FIG. 13d) under full-load. This means that the aspired air or air-fuel mixture in the intake pipe starts to move into the cylinder 520 through the opening intake valve 522. On the other hand, in part-load, when the piston 521 reaches near its top-dead-center position, the discharge valve 523 is not closed but kept open, either completely or partially depending on the amount of exhaust gas re-circulation required. The intake valve 522 starts to open (FIG. 13d). This means that, in part-load, aspired air or air-fuel mixture in the intake pipe, as well as already displaced hot exhaust gas in the exhaust pipe, move into the cylinder 520 through the opening intake valve 522 and the still open discharge valve 523.

FIG. 13e shows the valve positions at an intermediate position of piston 521 in the course of its downward movement during the intake stroke, both under full- and part-load. Under full-load the intake valve 522 remains open. On the other hand, under part-load, the intake valve already starts to close as does the discharge valve. The extent to which each valve is open determines the amount of hot exhaust gas which mixes with the cool air or air-fuel mixture aspired through the intake valve 522. The temperature of the hot exhaust gas is much higher than that of the aspired air. Therefore, its density is much lower and, hence, a large volume of re-circulating exhaust gas only may represent a minor gas mass and thermal energy capacity. Neglecting specific thermal energy differences between the aspired air and the exhaust gas, and realistic temperatures of 50° C. for the aspired air and around 1000° C. for the exhaust gas, will lead to a mixing temperature of around 240° C. for equal re-flow volumes, i.e., same gas volumes pass through the intake valve in case of the aspired air and the discharge valve in case of the re-circulated exhaust gas.

As shown in FIG. 13f, under full-load the piston moves down towards the bottom-dead-center position while the intake valve remains open throughout the whole intake stroke. In part-load the valves closes before the piston has reached the bottom-dead-center position. This causes the aspired air or air-fuel mixture to expand.

As shown in FIG. 13g, under full-load the intake valve 522 closes when the piston 521 reaches the bottom-dead-center position, and the intake stroke ends. Under part-load, the intake valve 522 has already been closed for a significant amount of time and the air or air-fuel mixture in the cylinder 520 has consequently been pre-expanded.

For part-load, the pre-expansion causes both a pressure and temperature drop. However, as the temperature of the gas mixture in the cylinder 520 (upon closing of both the intake valve 522 and the discharge valve 523) may be significantly higher than under full-load, the temperature of the air or air-fuel mixture under part-load may remain at least at ambient temperature at the end of the pre-expansion stroke.

It will be appreciated that no throttling occurs during part of the intake stroke. By pre-expanding the air or air-fuel mixture in part-load, the pressure may drop from ambient pressure to a lower value which means that the mass of the aspired air or air-fuel mixture has been reduced without imposing any throttling or other efficiency-penalizing state changes. Reduced mass intake means reduced load and, therefore, part-load may be achieved at a high efficiency.

As shown in FIG. 13h, both under full-load and part-load, piston 521 moves up and compresses the air or air-fuel mixture in the cylinder 520. Because part-load compression starts at a temperature comparable to the gas temperature under full-load, after compression, a similar compression end temperature may be reached and the thermodynamic cycle efficiency may be maintained.

In general, as the load drops, a larger amount of hot exhaust gas is re-circulated through the discharge valve 523 into the cylinder 520. With decreasing load, the intake valve 522 starts closing earlier, and the discharge valve 523 is kept open closer to when the intake valve 522 is closed. In other words, the discharge value 523 is kept open longer.

Typically, the temperature rise of the aspired air or air-fuel mixture in part-load upon closing of both the intake valve 522 and the discharge valve 523 may be between 50° C. and 250° C., depending on the load.

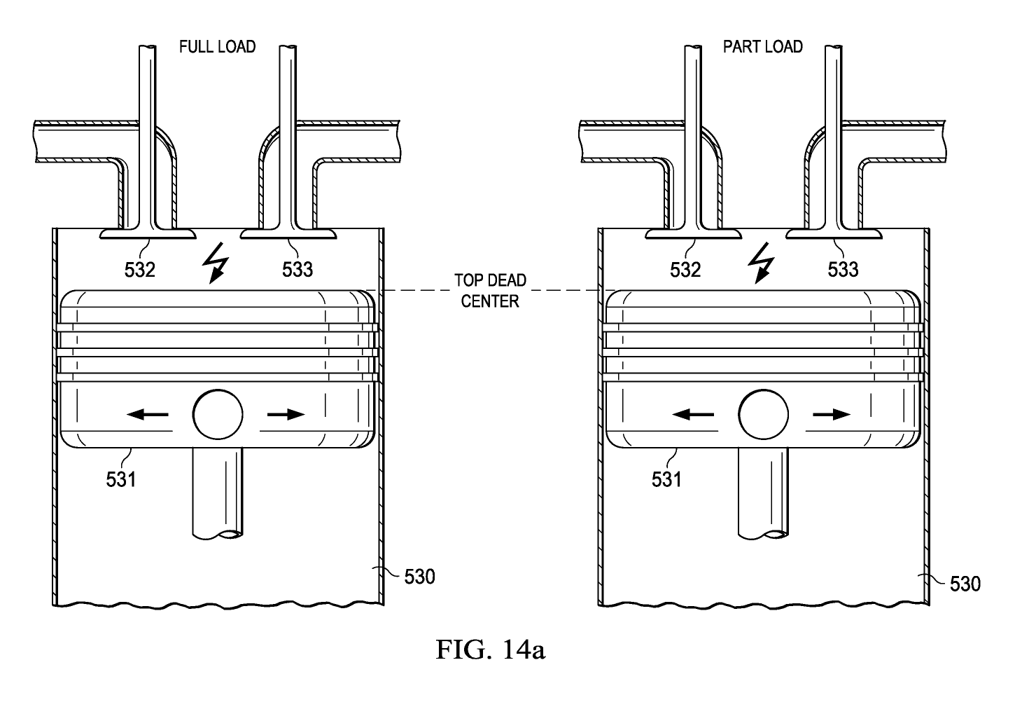

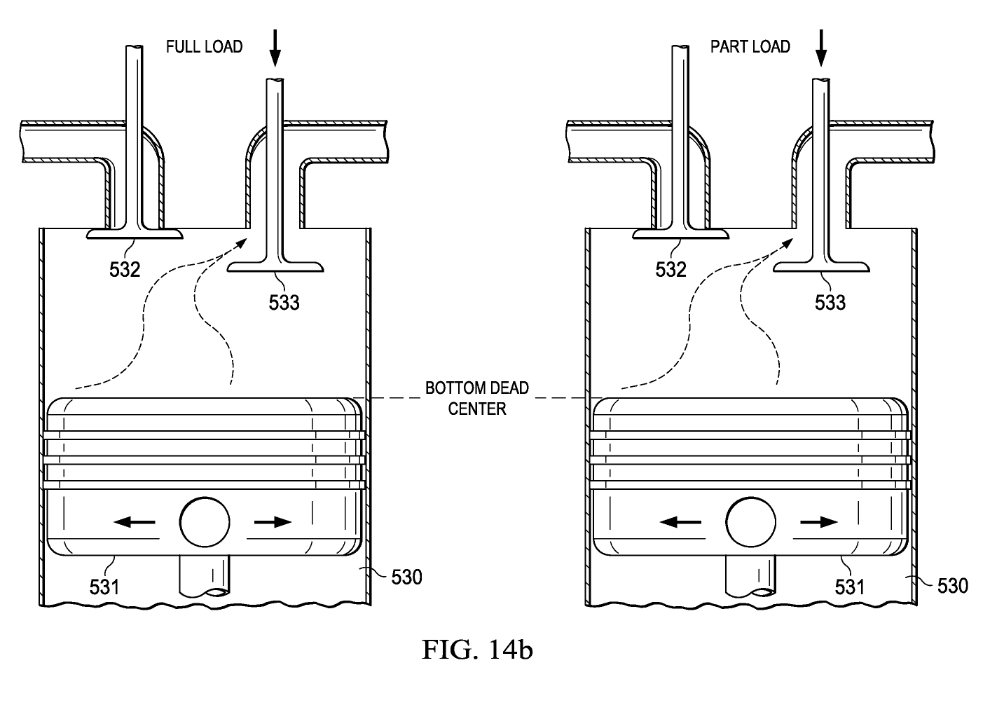

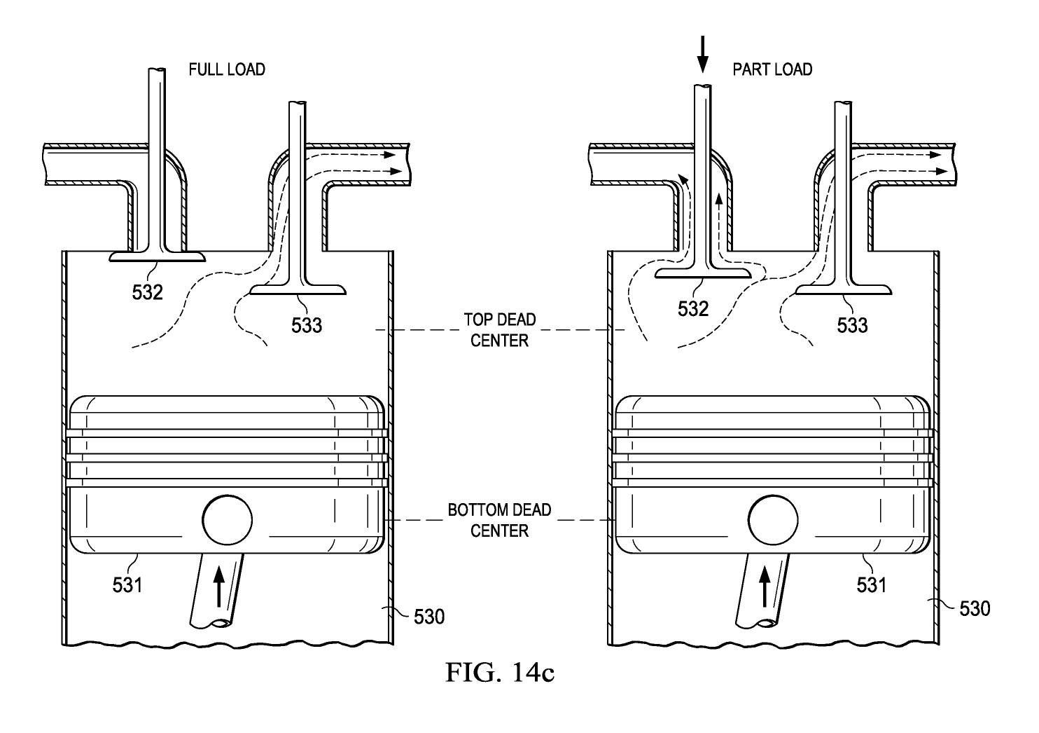

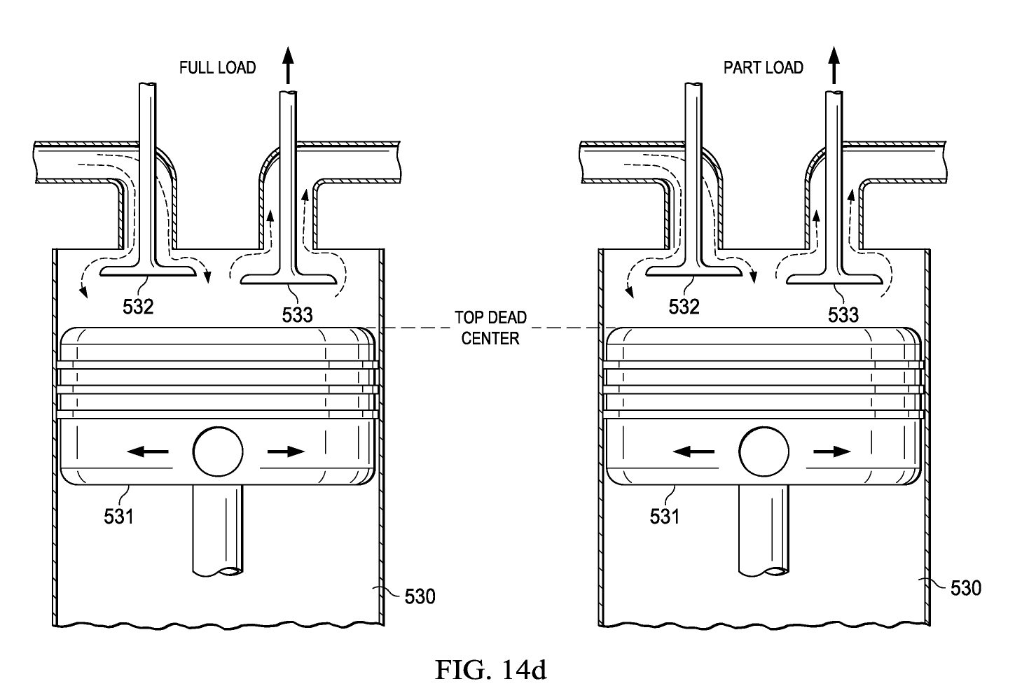

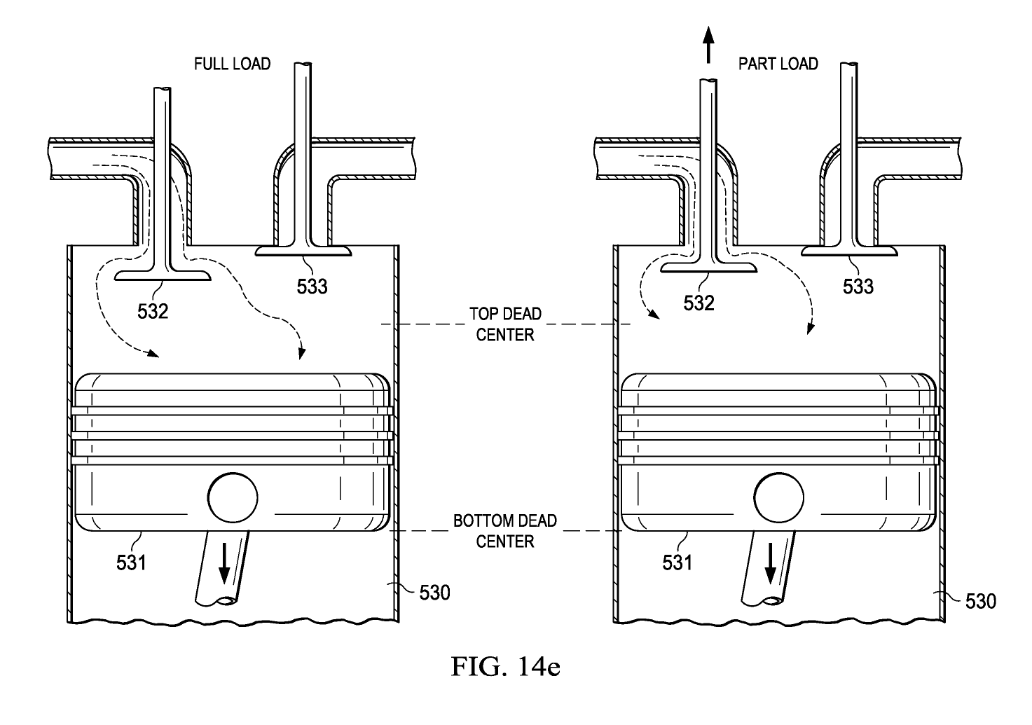

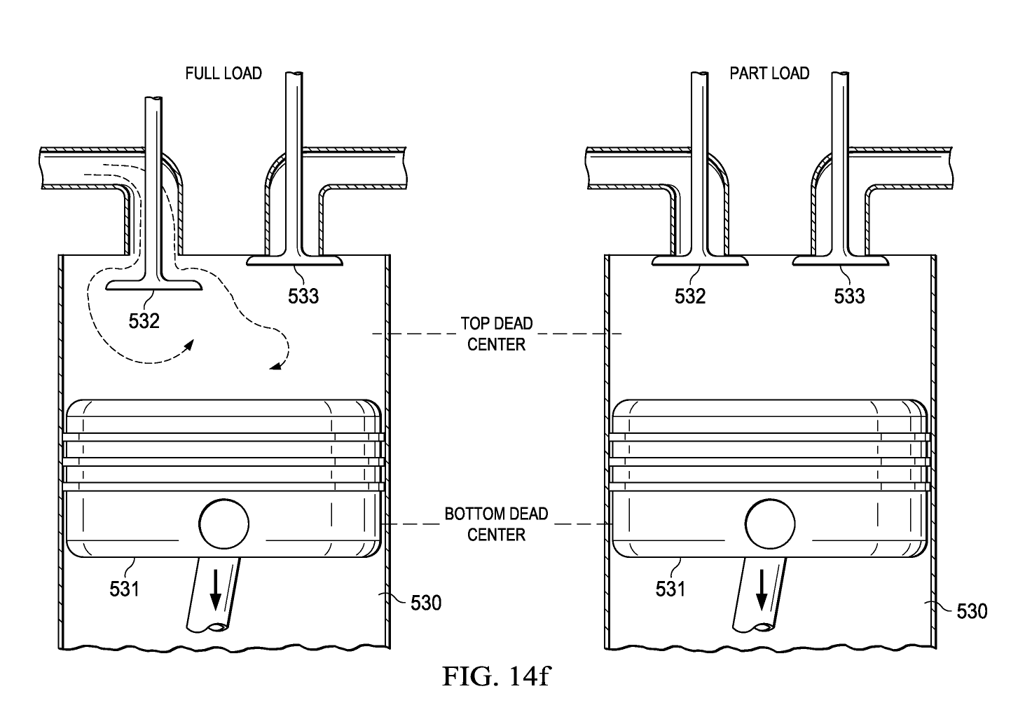

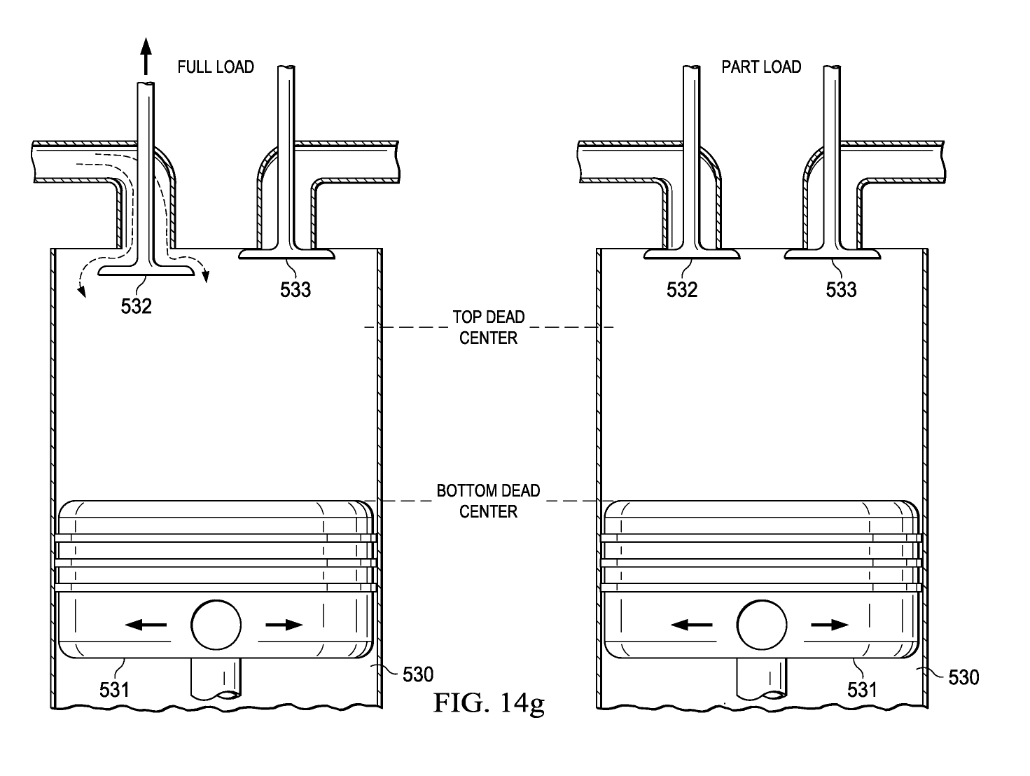

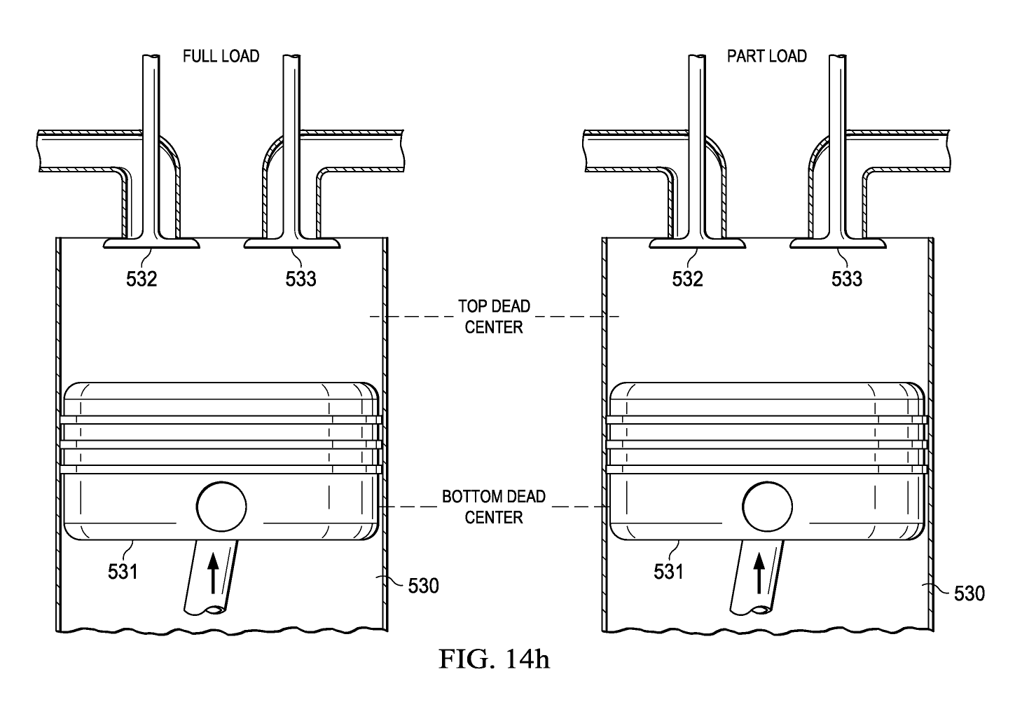

FIGS. 14a to 14h show a series of schematic diagrams of an engine modified to facilitate pre-heating by internal exhaust gas re-circulation through a second type of valve timing, according to other embodiments. Here, re-heating occurs mainly in the intake pipe before the intake valve.

FIG. 14a shows the piston 531 position in the engine cylinder 530 at its top-dead-center position when ignition occurs, both under full-load and part-load. Ignition may be accomplished by a spark plug or by injecting self-igniting fuel. Both, intake valve 532 and discharge valve 533 are closed.

The piston 531 moves down, and when it reaches the bottom-dead-center position the discharge valve 533 opens, as shown in FIG. 14b, both under full-load and part-load. The hot exhaust gases start to discharge through the open discharge valve 533. It will be noted that during an extreme part-load it might happen that the exhaust gas pressure in the cylinder 530 may be below ambient pressure and at the beginning of the exhaust stroke a re-flow into the cylinder 530 through the open discharge valve 533 may occur. This may be avoided as described above by variable discharge valve timing.

As shown in FIG. 14c, under full-load, the piston 531 moves upward and forces the hot exhaust gas to leave the cylinder 530 through the open discharge valve 533 while the intake valve 532 is kept closed. However, in part-load, the intake valve 532 opens when the piston begins to move upward. Because the intake valve is open as the piston moves upward, a re-flow of the hot exhaust gas into the intake pipe takes place. Thus, the hot exhaust gas mixes with the cool air or air-fuel mixture in the intake pipe. Depending on the actual part-load state, the temperature increase of the aspired air is typically up to a temperature in the range of 50° C. to 250° C., but may be higher especially in case of highly knock-resistant fuel or in case of Diesel engines.

When the piston 531 reaches near a top-dead-center position, the discharge valve 533 closes in both full-load and part-load. Under full-load, the intake valve 532 starts to open (FIG. 14d), while in part-load intake valve 532 remains opened. This causes the aspired air or air-fuel mixture in the case of full-load to move into the cylinder 530 though the intake valve 532. In the case of part-load, the corresponding pre-heated mixture with the earlier displaced and mixed exhaust gas in the intake pipe moves into the cylinder 530 through the intake valve 532.

FIG. 14e shows the valve positions at an intermediate position of the piston 531 in the course of its downward movement in the intake stroke, both under full-load and part-load. Under full-load the intake valve 532 remains open while in part-load the intake valve 532 starts to close.

As shown in FIG. 14f, under full-load, the piston moves down towards the bottom-dead-center position while the intake valve 532 remains open throughout the whole intake stroke. However, in part-load the valve closes before the piston 531 has reached the bottom-dead-center position. This causes the aspired fresh air or air-fuel mixture with the earlier re-circulated exhaust gas to expand.

As shown in FIG. 14g, under full-load, the intake valve 532 finally closes when the piston 531 reaches the bottom-dead-center position, and the intake stroke ends. Under part-load, the intake valve 532 is already closed and the air or air-fuel mixture in the cylinder 530 has been pre-expanded. Consequently, in part-load, both pressure and temperature drop. However, since the temperature of the gas mixture was pre-heated by the exhaust gas, the temperature in the cylinder 530, once the intake valve 532 is closed, and may remain at least at ambient temperature at the end of this pre-expansion stroke.

It will be appreciated that, in one embodiment, no significant throttling occurs during the intake stroke. By pre-expanding the air or air-fuel mixture in part-load, the pressure may drop from ambient pressure to a lower value which means that the mass of the aspired air or air-fuel mixture has been reduced without imposing any throttling or other efficiency-penalizing state changes. Reduced mass intake means reduced load and, hence, part-load may be achieved at high efficiency.

As shown in FIG. 14h, both under full- and part-load, the piston 531 moves up and compresses the air or air-fuel mixture in the cylinder 530. Since part-load compression starts at a temperature comparable to the gas temperature under full-load, after compression, a comparable compression end temperature may be reached and the thermodynamic cycle efficiency may be maintained.

In general, as the load drops, a larger amount of hot exhaust gas is re-circulated through the intake valve 532 into the intake pipe during the exhaust stroke. Later, in the course of the intake stroke, the hot exhaust gas in the intake pipe is re-circulated into the cylinder 530. This is achieved by pre-opening the intake valve 532 so that a larger amount of hot exhaust gas may leave the cylinder 530 through the intake valve 532 into the intake pipe. With decreasing load, the intake valve 532 also closes earlier to allow for a higher pre-expansion ratio and, consequently, a lower expansion end pressure and, hence, a lower air mass. As both the intake valve opening and closing are moved towards earlier timing, in most cases, a simple timing shift while maintaining the opening duration may be sufficient. This largely simplifies the intake valve control.

It should be noted that all of the modified valve timings described herein are not only applicable to Otto engines, but also to Diesel engines.

D: Improved Valve Timing for Two Stroke Engine

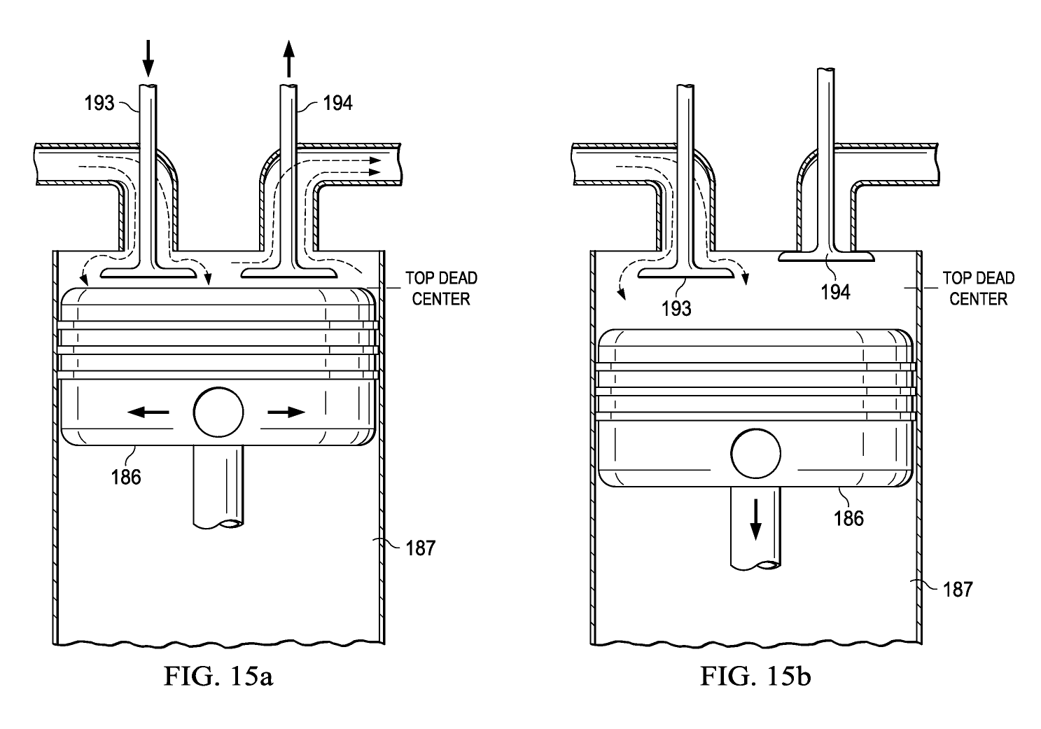

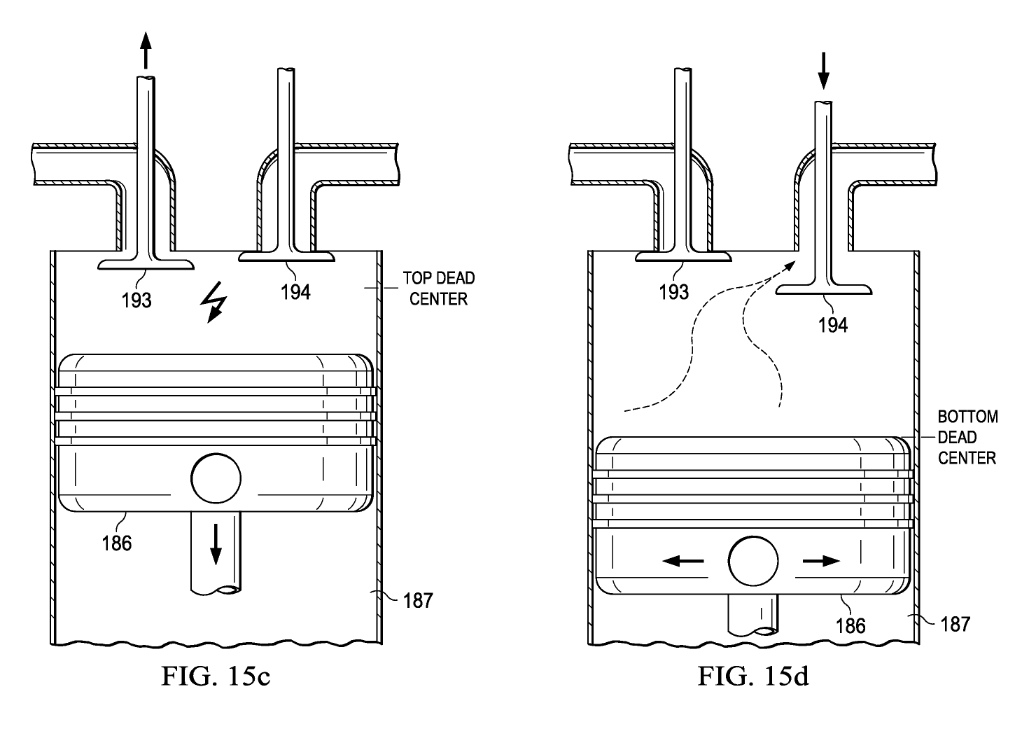

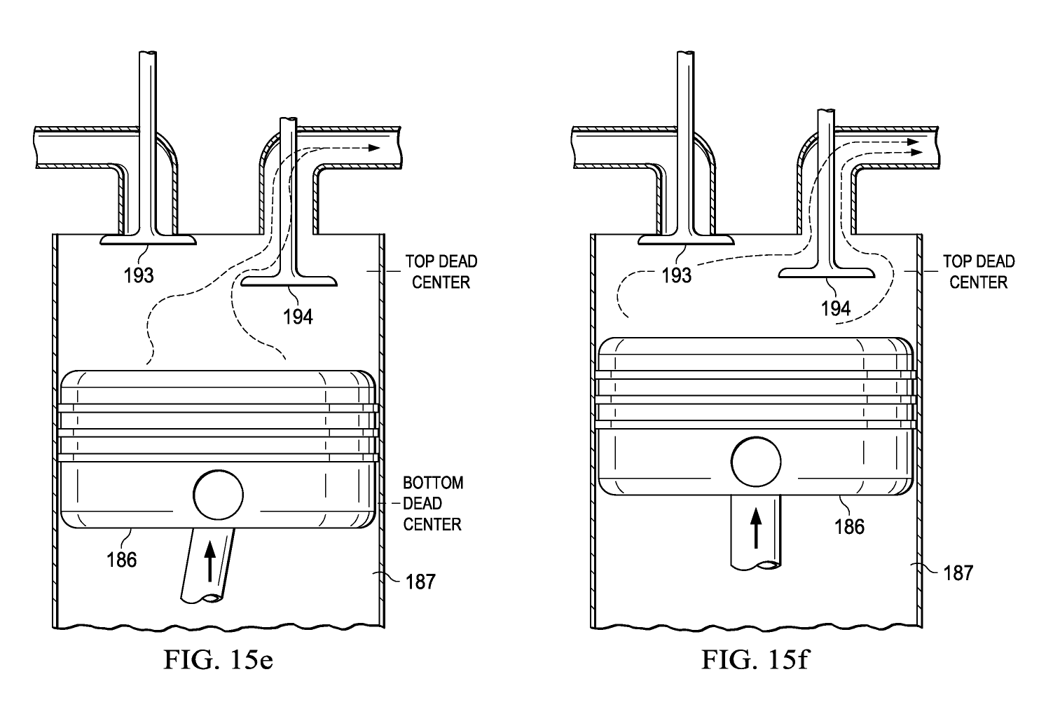

FIG. 15a to FIG. 15f show the valve timing in a two stroke piston engine with improved efficiency. In FIG. 15a, the piston 186 is at its top-dead-center position. It will be appreciated that the top-dead-center position of the piston 186, is much higher here than in four-stroke embodiments, because no combustion space remains as no compression stroke is carried out. The piston approaches the cylinder head as near as both the intake valve 193 and the exhaust valve 194 allow. The arrows within the piston 186 indicate the piston movement. The arrows above the intake valve 193 and exhaust valve 194 indicate the movement of the corresponding valve.

The piston 186 is at its top-dead-center position within the cylinder 187 when the exhaust valve 194 closes (FIG. 15a) and as much exhaust gas as possible has been discharged into the exhaust pipe 184. The intake valve 193 starts to open to begin the intake of the highly pressurized fresh air or air-fuel mixture.

As the piston 186 starts to move down (FIG. 15b) the intake valve 193 opens completely and the downward movement of the piston 186 aspires the fresh air into the cylinder 187. When the piston 186 has reached such a position that enough of the fresh air or air-fuel mixture has moved into the cylinder 187, the intake valve 193 closes. As soon as this intake valve 193 is closed, the air-fuel mixture is ignited or the fuel is injected and starts to burn and both temperature and pressure of the working gas rise (FIG. 15c). At this point, the piston 186 is still far away from its bottom dead center position. Especially in the case of slow moving large-scale piston engines, there is sufficient time to open and close the intake valve 193 near the dead center positions as the piston moves slowly.

By moving downward towards its bottom dead center position, the piston 186 expands the hot working gas heated by burning the fuel (FIG. 15d). At this point, both the intake valve 193 and the exhaust valve 194 are closed.

As soon as the piston 186 reaches its bottom dead center position (FIG. 15d) the exhaust valve 194 opens to allow the hot and pressurized working gas to leave the cylinder 187 by the following upward movement of the piston 186.

As shown in FIG. 15e, this upward movement of the piston 186 moves the still hot working gas out of the cylinder 187 without significant throttling. The exhaust valve 194 is opened at its maximum and the exhaust stroke is performed. When the piston 186 approaches its top-dead-center position (FIG. 15f) the exhaust valve 194 starts to close and may re-compress a small amount of the exhaust gas so as to reduce the pressure difference between the exhaust pipe and the intake pipe. When the piston 186 has reached its top-dead-center position, the cycle starts again (FIG. 15a)

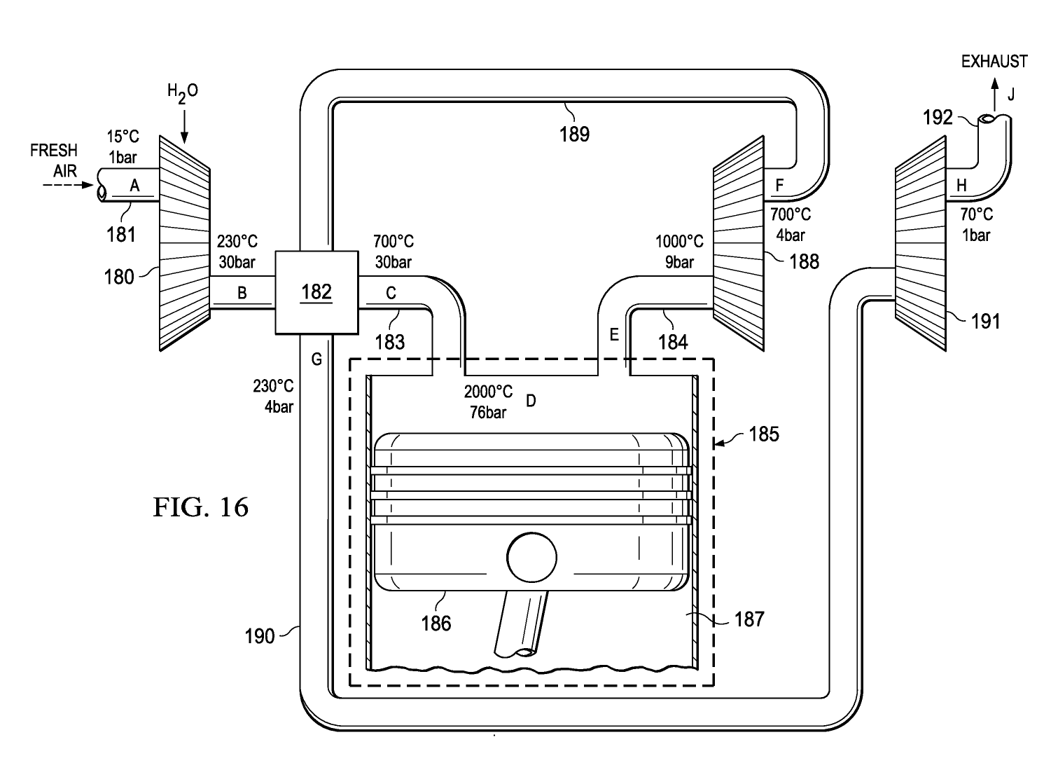

FIG. 16 is a piston engine system utilizing the 2-stroke timing described in FIGS. 15a-f. FIG. 17 is a theoretical S-T diagram describing the thermodynamic process carried out by the embodiment of FIG. 16. These figures will be explained in conjunction with one another. FIG. 16 shows such an embodiment where the compressor 180, which may be a turbine, a mechanical compressor like a screw or rotary vane compressor, or a combination of turbine and mechanical compressor, delivers highly compressed fresh air at approximately 30 bar. This pressure is usually attained by aero-derived turbo compressors. The piston engine is operated as a valve-controlled 2-stroke engine described above. The forthcoming values for temperature, pressure, and flow rate are illustrative and are not limiting in any way.

The compressor turbine 180 aspires fresh air with a temperature of approximately 15° C. and ambient pressure of approximately 1 bar (state point “A” in FIG. 17) through the inlet 181 and compresses it under continuous supply and vaporization of water to the comparably high temperature of approximately 230° C. and the high pressure of approximately 30 bar (state point “B” in FIG. 17).

The compressed air-steam mixture passes through the high-temperature recuperator 182 where it is heated to approximately 700° C. while maintaining its pressure at approximately 30 bar (state “C” in FIG. 17). Now, the piston engine 185, which comprises a piston 186 reciprocating within the cylinder 187, aspires the compressed air-steam mixture through an intake pipe 183. The intake valve (not shown) opens and subsequently closes as soon as sufficient air or air-fuel mixture has entered the cylinder 187. In other words, the intake valve may close before the piston 186 reaches the bottom-dead-center position. The comparably high temperature of approximately 700° C. of the working gas after the recuperator 182 is equivalent to a theoretical Otto engine efficiency of 70% (i.e., a compression ratio of more than 20:1). This means that the use of the high-temperature recuperator 182 may generate an efficiency of some of the highest compressing gas engines without the drawbacks of exceedingly high compression end pressures (in case of a compression ratio of 20:1 for air, the compression end pressure for a naturally aspired engine may be already beyond 65 bar).

Combustion occurs immediately after the intake valve has closed and both temperature and pressure of the air-steam mixture raise to approximately 2200° C. and approximately 76 bar, respectively (state point “D” in FIG. 17).

The piston 186 moves down to expand the hot working gas to a temperature of approximately 1000° C. and a pressure of around 9 bar at its bottom dead center position (state point “E” in FIG. 17). The exhaust valve (not shown) opens and the still hot working gas leaves the cylinder 187 through the exhaust pipe 184. The pressure in the intake pipe 183 is higher and, hence, no throttling into the exhaust pipe 184 takes place. The expansion turbine 188 expands the exhaust gas further to an intermediate pressure of approximately 4 bar and a corresponding temperature of approximately 700° C. (state point “F” in FIG. 17).

The pressurized and still hot exhaust gas is channelled through the pipe 189 to the recuperator 182 to heat the freshly aspired and compressed air-steam mixture from the compressor turbine 180. Consequently, the mixture cools down to approximately 230° C. at constant pressure of approximately 4 bar (state point “G” in FIG. 17).

The cooled, but still pressurized, exhaust gas is supplied through the pipe 190 to the second expansion turbine 191, where it is expanded to ambient pressure of approximately 1 bar and the final exhaust temperature of approximately 70° C., before it is discharged into the environment through the exhaust 192. By mixing with ambient air, the exhaust gas first cools down until it reaches the dew point of the steam (state point “J”) according to the amount of injected water in the compressor turbine 180 (and possibly produced steam by burning hydrogen-containing fuel).

It will be appreciated that the combustion process may be extended to a longer continuous combustion than described with reference to FIGS. 16, 17 and 15a to 15f. This means that the piston 186 may move down considerably while combustion continues. In this case, the piston engine 185 continuously delivers mechanical power and both the exhaust temperature and pressure are higher when the exhaust valve 194 opens at the end of the expansion stroke. The high firing temperature and the succeeding additional expansion by the two expansion turbines 188 and 191, together with the condensation of the steam as thermal energy transfer to the lower thermal reserve, do not penalize such late combustion.

Some turbines can support inlet temperatures of well over 1200° C. In this case, the piston engine 185 behaves as a power-delivering combustion chamber, and both efficiency and overall power of the turbine-piston engine arrangement shown in FIG. 16 may increase. In this arrangement, the main advantages of a piston engine (e.g., high pressure sustainability, high combustion temperatures, high mechanical and thermodynamic efficiency due to the limited size of the engine while running at high pressure, etc) are combined with the main advantages of a gas turbine (high volume flow at low and moderate pressure, and reduced maintenance).

The described valve timings and embodiment may also be used in case of an externally fired piston engine running in a closed cycle arrangement. In a closed cycle arrangement, instead of igniting the fuel as shown in FIG. 15c, the intake valve 193 closes and expansion of the hot and pressurized working gas is carried out.

In this embodiment, the working gas is first preheated by a recuperator. A temperature of between 200° C. and 400° C. may be appropriate. This corresponds to the state change B→C in FIG. 17. Then the working gas is further heated externally through a heat exchanger (not shown in FIG. 16), which is heated for example, by the flue gases of the combustion of solid fuel, by a porous combustor, or any other source of thermal energy. This temperature increase corresponds to the state change C→D in FIG. 17. The hot and pressurized working gas is then aspired by the piston engine 185 according to the valve timing shown in FIG. 15a to 15c and expanded. The engine may run in a closed configuration, i.e., the exhaust 192 is short-circuited to the inlet 181 through a cooler-condenser (not shown) which cools the working gas and condenses the vaporized liquid for later vaporization in the compressor turbine 180. The compressor turbine 180 may also be a piston engine. One or both of the expansion turbines 188 and 191 may be omitted. A similar configuration may be used with turbines rather than piston engines.

II: Compressor with Liquid Injection

An isentropic compression process holds the entropy of a working gas constant, while raising the working gas' temperature and pressure. Ideal (theoretical) cycles assume perfectly isentropic compression, but real compressors irreversibly increase the entropy of the working gas in an adiabatic process that is not isentropic. A compressor, as used herein, is a device for compressing a working gas, gas-vapor mixtures, or exhaust gases, and includes pumps, compressor turbines, reciprocating compressors, piston compressors, rotary vane or screw compressors, and devices and combinations capable of compressing a working gas. In some embodiments, a particular type of compressor, such as a compressor turbine, may be used.

As the compression process heats the working gas, compressors typically consume more power at constant compression ratio. Compressors also consume more power when higher compression ratios are used. In some embodiments, the working gas is mixed with a vaporizable liquid, so that the gas and the liquid are compressed in the compressor together thereby producing a gas-vapor mixture, reducing the temperature increase caused by the compression process, and substantially holding the entropy of the working gas constant. In some embodiments, the vaporizable liquid evaporates near thermodynamic equilibrium. Compressors include parts, such as turbine blades or impellers, which may be eroded by the impact of fast moving liquid or particles in the working gas. In some embodiments, the vaporizable liquid evaporates in a manner such that it does not contact the compressor parts after it is introduced to the working gas. In some embodiments, a working gas, such as nitrogen, is compressed for use in a device or chemical process, such as an engine. In some embodiments, the compressor is driven by an external engine, such as an electric motor, a gas turbine, or a diesel engine. In some embodiments, the compressor is driven by energy produced by the working gas.

1. Evaporative Cooling Methods for Compressors

Unlike the embodiments disclosed herein, techniques, such as inlet fogging or misting, attempt to increase energy output from gas turbines by lowering the intake temperature of aspired air in hot or dry environments. Ideally, inlet fogging only adds as much vapor as can saturate the air at the intake temperature so that no vaporization occurs during compression and the liquid does not impact compressor parts. Lowering the end temperature of compressed gas tends to reduce efficiency, unless a means is provided, as described herein, for heating the compressed gas after compression but before it reaches an external source of thermal energy, such as a combustion chamber. According to embodiments described herein, sufficient vaporizable liquid is added to the working gas such that the gas is substantially saturated at the compression end temperature and the compression end temperature is lowered compared to the compression end temperature without the addition of vaporizable liquid. As used throughout this disclosure, “substantially saturated” typically refers to a saturation level greater than 10%, and, in some embodiments, at least 25%. A second compressor or recuperator (i.e., a heat exchanger) may be used to preheat the compressed working gas as described more fully below.

Vaporization during the compression process tends to increase thermodynamic efficiency when the working gas is heated at a constant pressure after compression, especially if the vaporization is carried out both quickly and near thermodynamic equilibrium. But, increasing the vaporization rate merely by increasing the gas or liquid temperatures tends to move the process away from thermodynamic equilibrium, thereby reducing efficiency. In some embodiments, droplet size and/or the flow rate of the working gas is reduced. In some embodiments, the working gas temperature and pressure are increased for introduction and evaporation of the vaporizable liquid.

2. Initial Injection of Vaporizable Liquid Droplets

One method of supplying vaporizable liquid to a compressor for substantially isentropic compression is to supply the entire amount of vaporizable liquid may before compression. For example, the vaporizable liquid may be supplied to the compressor with the working gas by spraying droplets through injection nozzles. Medium to high-pressure pumps may supply pressurized liquid to injection nozzles which spray small droplets of vaporizable liquid into the working gas.

In some cases, including for fast running axial turbines, the droplets must typically be small enough to avoid damaging the blades or other parts of the compressor by impact. For a turbine compressor in particular, the impact of vaporizable liquid on the fast moving impeller, or—after acceleration by the impeller—other parts of the turbo compressor, erodes the compressor parts. By contrast, for radial turbines even high droplet content and comparably large droplets do not cause damage. In general, the vaporizable liquid be injected into the working gas in the form of droplets that are as small as possible, in order to increase the surface area of vaporizable liquid in contact with the working gas. In a one embodiment, the droplets of vaporizable liquid are less than 5 μm in diameter.

Compression raises the temperature of the working gas causing substantially continuous evaporation of the vaporizable liquid throughout the compression process. The evaporation process in turn uses thermal energy added by the compression process, maintaining a relatively lower temperature than without evaporation and raising the dew point of the gas-vapor mixture. In other words, the compression energy is used to vaporize the liquid. The amount of vaporizable liquid supplied is enough to absorb the thermal energy from the compression process. The total amount of vaporizable liquid may be supplied at a rate between approximately 12% to approximately 30% of the aspiration rate of the working gas, but it will be appreciated that any suitable rate may be employed. For example, in one non-limit embodiment, a 5 MW large gas piston engine burning natural gas and having an air mass flow of approximately 8 kg/s the injection rate of water, as the vaporizable liquid, is between approximately 1.0 kg/s (12.5% of air mass flow) and 2.4 kg/s (30% of air mass flow) corresponding to a condensation power of 2.5 MW to 6 MW.

The amount of liquid vaporized may be determined in such a way that at least 80% of the thermal energy discharged into the environment (or the thermal energy transferred to the lower temperature level reserve) is carried by the vapor to be released by condensation after discharge. In engines with typical upper temperatures beyond 600° C., the amount of vaporizable liquid is determined such that the latent heat of vaporization for the amount of vaporizable liquid added to the working gas may be equal to approximately 30% to 50% of the thermal power of the fuel or other high-temperature thermal source, like a high temperature heat exchanger.

In some embodiments, the compressed working gas may be between approximately 50% saturated and completely saturated with vapor after compression. In some embodiments, the vaporizable liquid may be pressurized and injected at a higher temperature than that of the working gas, so that the vapor pressure of the vaporizable liquid exceeds the working gas pressure causing the droplets to separate into more and smaller droplets. In some embodiments, the vapor partial pressure may not be more than approximately 30% of the pressure of the working gas without the added vapor. In some embodiments, the vaporizable liquid may be pre-heated before injection to a temperature in the range between the compression end temperature without injection and the decreased compression end temperature of the saturated working gas after injection and vaporization.

In some embodiments, the temperature difference between the working gas and the vaporizable liquid may be minimized. When minimizing the temperature difference between the working gas and the vaporizable liquid, the vapor pressure of the liquid may be generally far below the gas pressure.

The amount of vaporizable liquid provided may be such that at the end of compression, the working gas is saturated (or somewhat sub-saturated) by the vapor produced and no droplets are present after compression, (i.e., all liquid has vaporized). But in some embodiments, for example in a radial or diagonal compressor, a surplus of vaporizable liquid may be injected before or during compression, removed after compression, and-re-circulated for re-injection.

3. Inter-Stage Injection of Vaporizable Liquid Droplets

A method of supplying vaporizable liquid, according to some embodiments, is to supply the vaporizable liquid to a compressor in stages for substantially isentropic compression. In some embodiments, the compressor is a multi-stage axial turbine compressor. In some embodiments, radial or diagonal turbines may be employed in conjunction with or instead of axial turbines.

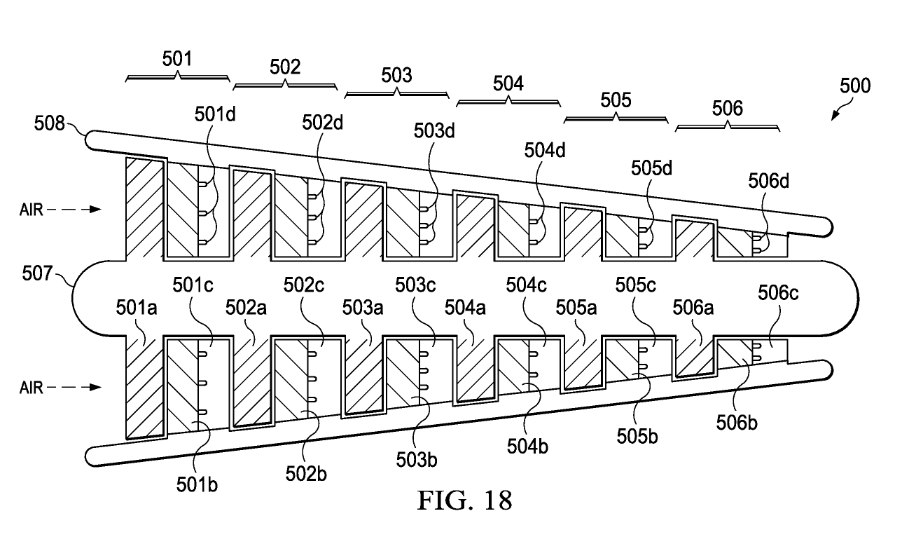

FIG. 18 shows the general layout of an axial turbine compressor 500 with inter-stage water injection according to some embodiments. The turbo compressor may comprise multiple stages, such as the six stages 501, 502, 503, 504, 505 and 506, each formed by an impeller 501a, 502a, 503a, 504a, 505a, and 506a, a diffuser or stator 501b, 502b, 503b, 504b, 505b, and 506b and an injection channel 501c, 502c, 503c, 504c, 505c, and 506c. In some embodiments, the impellers 501a to 506a are mounted on the same shaft 507 and rotated quickly at the same revolution speed. In some embodiments, the impellers 501a, 502a, 503a, 504a, 505a, and 506a are mounted on a plurality of shafts. Because a compressor is an engine consuming mechanical power, the shaft(s) may be driven externally, for example, by the expansion turbine or an electric motor.

In some embodiments, the diffusers 501b to 506b are mounted on the casing 508 and do not rotate. In some embodiments, each compressor stage includes an injection channel adjacent to its respective diffuser, such that the working gas flows through the diffuser before entering the injection channel. In some embodiments, the injection channels are provided with injectors, such as injection nozzles or the like. For example, after each of the diffusers 501b, 502b, 503b, 504b, 505b and 506b injection channels or areas 501c, 502c, 503c, 504c, 505c and 506c are formed.

In some embodiments, each one of the injection channels 501c to 506c may contain injection nozzles 501d, 502d, 503d, 504d, 505d and 506d. In some embodiments, the volume of injection channels 501c to 506c is such that the transit time for the vaporizable liquid droplets to cross the injection channels 501c to 506c is at least 20 ms. In some embodiments, the volume is set so that the transit time is between approximately 50 ms and 500 ms. In some embodiments, the volume is set so that the transit time is between approximately 0.1 and 1 second.

To increase the transit time the injection space may be formed in such a manner that a circular movement of the compressed gas-steam occurs, i.e., the movement has a significant component in a tangential direction of the turbine's casing. In one non-limiting example, the compressed working gas will basically flow in a circular or circumferential direction because it is accelerated by the impeller and slowed down in the diffuser such that the longitudinal component of the flow is very low compared to the circumferential component of the flow. This is similar to a circular movement around the longitudinal axis of the turbine.

In some embodiments, the nozzles have a circular cross-section. In some embodiments, the “nozzle” may be a grid of injection nozzles. In some embodiments, the injectors may inject the liquid into the injection channels 501c to 506c so as to distribute the droplets evenly in the gas flow. The liquid injection may also take place in the diffusers 501b, 502b, 503b, 504b, 505b, 506b. In this case the injection channels 501c, 502c, 503c, 504c, 505c, and 506c may be partly or completely omitted.

In some embodiments, an injector injects and atomizes vaporizable fluid in droplets of a diameter of less than 5 μm so that substantially all of the droplets evaporate in the slow moving air. In some embodiments, only enough vaporizable liquid to absorb the thermal energy from the temperature increase is added at each stage. The vaporizable liquid for injection at each stage may be pre-heated to a temperature in the range between the temperature at which the gas is aspired by the impeller and the temperature at which the further compressed gas enters the injection area.

The evaporation may cool the working gas. Unlike conventional axial compressors in the described embodiments, the working gas may leave the compressor at a substantially increased pressure, but at only a slightly higher temperature than at intake. Because cooler working gas requires less work to compress the overall power consumption of the compressor may be decreased by the evaporative cooling after each diffuser as compared to adiabatic compressors.

At each injection channel, the vaporizable liquid may be completely evaporated such that droplets do not damage the impeller blades. The cooled working gas with the completely vaporized fluid enters each subsequent impeller, diffuser, and injector, and the process repeats, as described above. Vaporizable liquid can be added in quantities up to the saturation point of the compressed working gas.

In some embodiments, the temperature increase during the compression process may be controlled, as desired. For example, vaporizable liquid may be injected only in the first four stages 501, 502, 503 and 504. Then compression in the subsequent two stages 505 and 506 may be completed without liquid vaporization thereby leading to a higher end temperature. Alternatively, the injection nozzles 501d to 506d may be throttled and inject only a part of the liquid required to substantially saturate the working gas. Consequently, each stage raises the temperature of the working gas more than with evaporation of the complete amount of liquid because there is less evaporative cooling at each stage. Injecting vaporizable liquid between only some of the stages requires less mechanical compression power because the corresponding thermodynamic process is nearer equilibrium.

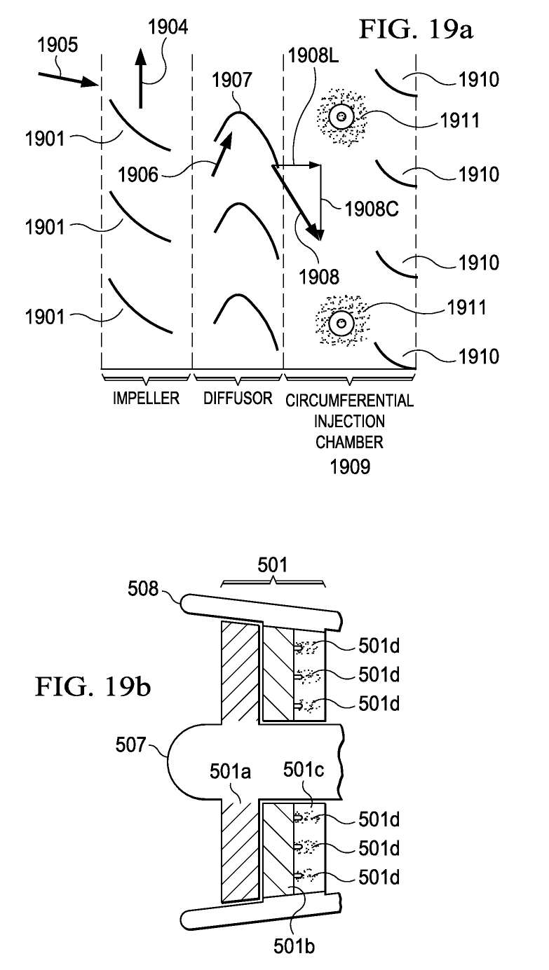

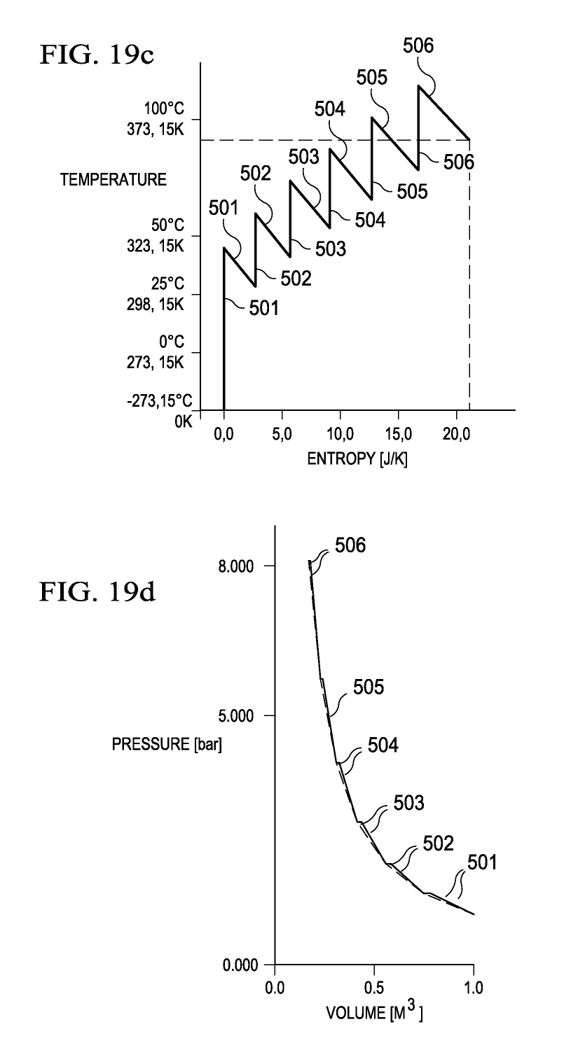

FIG. 19a shows the path of a fluid particle in the impeller and diffuser of FIG. 18. The impeller with the blades 1901 moves in the direction of the arrow 1904 and aspires working gas entering the turbine stage in the direction of the arrow 1905. A fast impeller movement accelerates the working gas and alters its direction so that it flows out of the impeller in the direction of the arrow 1906. The blades 1907 of the diffuser slow down the working gas and, consequently, increase its pressure. The diffuser also reverses the circumferential movement so that the working gas leaves the diffuser in the direction of the arrow 1908. By imposing a larger circumferential component 1908C as compared to the longitudinal component 1908L, the working gas starts to cover a large distance in a circumferential direction within the circumferential injection-vaporization chamber 1909 before the working gas is supplied to the following compressor stage through the curved outlets or nozzles 1910 which produce the desired flow vector for the working gas.

The flow distance between the diffuser blades 1907 and the entrance to the subsequent compressor stage may be negligible (e.g., close to zero). Injection nozzles 1911 inject the liquid to be vaporised into the circumferential chamber 1909. Due to the increased passage time of the compressed working gas from the diffuser 1907 to the outlets or nozzles 1910 to the subsequent compressor in the current embodiment, a substantial portion of the injected liquid may vaporise.

The working gas may rotate up to several times in the circumferential chamber 1909 until it enters the following compressor stage. In some embodiments, the chamber may be structured in the form of a worm gearbox to avoid the mixing of working gas freshly supplied by the diffuser with working gas which has already spent some time circulating in the circumferential chamber 1909 and has a higher saturation level.

By using a circumferential injection space instead of a straight injection channel, the passage and, hence, the vaporization time may be increased. This means that the passage time may be increased. In some embodiments, this may be sufficient to achieve complete vaporization of the injected liquid even if the final vapour content is near saturation. Accordingly, transit time can be significantly increased without significantly increasing the length of the casing and, hence, the turbine.

FIG. 19b shows an enlarged view of the first compressor stage 501, according to some embodiments. When the shaft 507 is rotated, the impeller 501a aspires working gas and accelerates the working gas. In some embodiments, compression may occur at the impeller itself. In this case the working gas mixture accelerated by the impeller enters the diffuser at an elevated temperature and is decelerated in the diffuser 501b. Consequently, the pressure and temperature rises. The subsequent liquid injection then lowers the temperature while maintaining the pressure.

The fast moving working gas slows in the diffuser 501b and flows into the injection channel 501c at a moderate speed (e.g. approximately 50 m/s). Because of the acceleration of the working gas, and the subsequent slowing in the diffuser, both the temperature and pressure rise. Consequently, the temperature of the compressed working gas flowing into the injection channel 501c may be higher than the temperature at which the working gas was aspired by the impeller 501a. To cool the working gas, the injection nozzle 501d at the entrance of the injection channel 501c injects the vaporizable liquid into the warmed working gas. Because the speed of the working gas in channel 501c is relatively low the droplets have enough time to vaporize.

The energy required for evaporation is taken from the warm working gas which, in turn, cools down. The amount of vaporizable liquid injected is controlled in such a way that at the end of the injection channel 501c no droplets, or nearly no droplets, are present. The temperature decrease caused by the vaporization process may also be adjusted by varying the amount of vaporizable liquid that is injected.

The pressurized and cooled working gas then leaves the injection channel 501c and, hence, the first compressor stage 501, and is aspired by the impeller 502a (FIG. 18) of the next stage. Similar to the process in the first stage 501, in the second stage 502 the impeller 502a (FIG. 18) accelerates the working gas (mixed with vaporized liquid) and the diffuser 502b (FIG. 18) slows the working gas down, further increasing its pressure and temperature. When entering the injection channel 502c (FIG. 18), the injection nozzle 502d (FIG. 18) injects and atomizes the vaporizable liquid for evaporation.

This process may then be carried out in stages 503, 504, 505 and 506 (FIG. 18). Finally, the compressed working gas leaves the turbo compressor with substantially increased pressure but a minor temperature increase. The temperature increase is dependent on the vapor saturation property of the injected liquid. The compressed working gas leaving the final stage 506 (FIG. 18) may contain no more vapor than the maximum vapor density at the dew point of the working gas. In some embodiments, the compressed working gas is no more than approximately 1% oversaturated.

FIGS. 19c and 19d show illustrative theoretical diagrams of entropy (S) versus temperature (T) (a theoretical S-T diagram) and pressure (P) versus volume (V) (a P-V diagram), respectively, for the compression of 1 m³ of air and approximately 0.062 kg of water in an axial turbo compressor according to the embodiments of FIG. 18. The compression process described with respect to FIGS. 18 and 19b using liquid injection after every compression stage approximates the pure isentropic process as indicated in FIGS. 19c and 19d. The reference numerals in FIGS. 19c and 19d correspond to respective stages of the compressor turbine shown in FIG. 18. After every injection, the subsequent compression is substantially isentropic, hence the temperature rises, but the entropy remains virtually unchanged as shown in FIG. 19c. The injection of vaporizable liquid, and evaporation in a non-saturated space, lowers the temperature but increases entropy.

The non-limiting, illustrative values shown in FIGS. 19c and 19d were calculated for 1 m³ of air with 100% humidity at 15° C. and 1013 mbar at the beginning of compression. The compression ratio used was 8, so the final pressure after compression was approximately 8.104 bar. The compression end temperature was found to be approximately 91° C. and the amount of vaporized water in the gas-vapor mixture was approximately 0.075 kg, approximately 0.062 kg of which was injected and vaporized and approximately 0.013 kg of vapor was already present in the ambient air at 100% humidity. The mechanical work used for compression was approximately 256 kJ. The entropy increase was approximately 0.021 kJ/K, corresponding to an irreversible loss of mechanical energy of approximately 6.1 kJ at ambient conditions. In other words, only approximately 2.4% of the mechanical work required was lost due to entropy increase. Thus, in this example, inter-stage injection of vaporizable liquid during compression enables substantially isentropic compression with a thermodynamic efficiency of approximately 97.6%.

Pre-heating the vaporizable liquid for injection to a temperature between the predicted compression end temperature without injection and the predicted temperature of the saturated gas-vapor mixture after injection and vaporization (i.e., between approximately 114° C. and approximately 91° C. for compressor stage 6 in FIG. 18) may lower the loss of mechanical energy due to the irreversible vaporization process at each stage.

4. Continuous Supply of Vaporizable Liquid

Some embodiments supply the vaporizable liquid continuously during compression (by injection, for example) and carry out the compression under virtually continuous vaporization of the liquid, i.e., the liquid vaporizes with the temperature increase due to the compression increases, and the dew point rises. The vaporizable liquid may be continuously injected, for example, by simple nozzles, and travel with the working gas through at least one stage in the compressor. If both the temperature and the pressure of the working gas are sufficiently high, then vaporization may be rapid. Consequently, this strategy may be suited for a system with exhaust gas re-circulation at increased temperature and pressure.

5. Inter-Stage Gas-Liquid Mixing in External Tanks

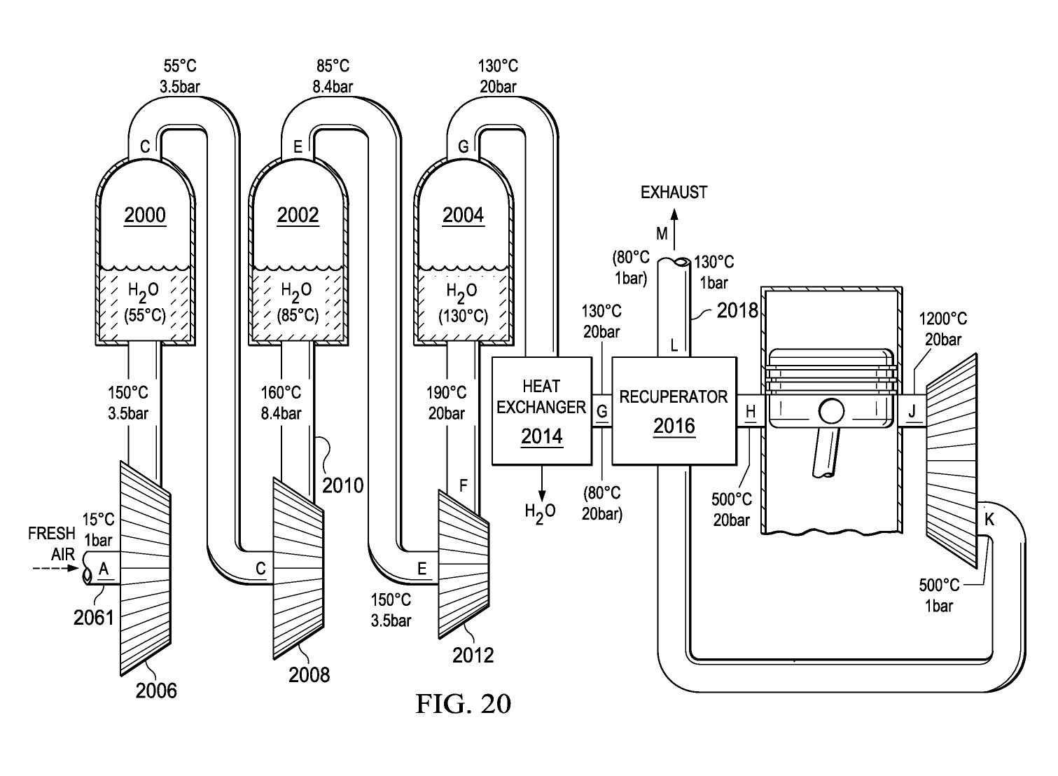

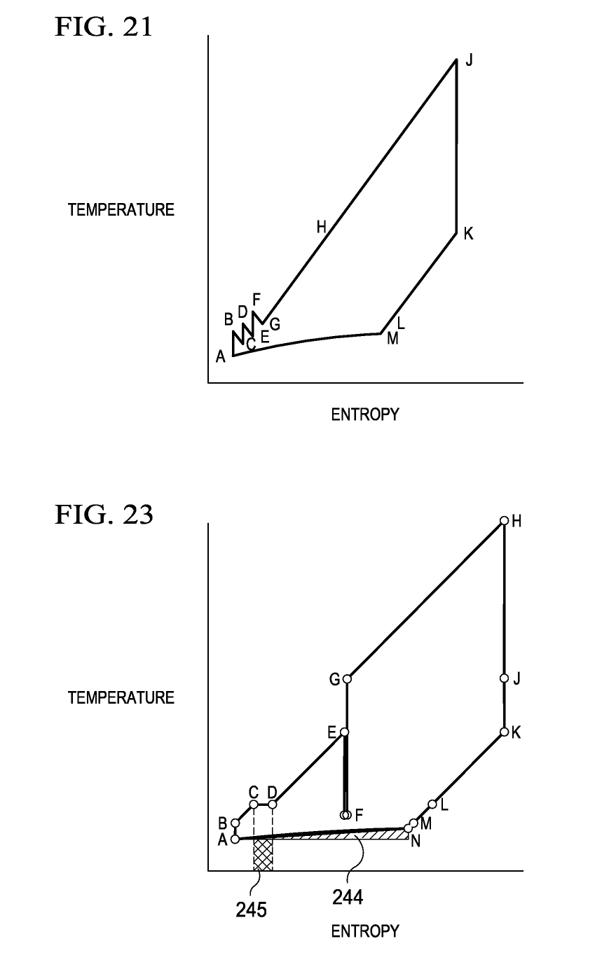

FIG. 20 shows an arrangement for compressing a working gas and vaporizing a liquid by passing the working gas through an external tank of vaporizable liquid after one or more compression stages. Particularly in the case where axial turbines are used for the compressor, the working gas is compressed in a plurality of compressor stages before being delivered to an external tank of vaporizable liquid. FIG. 21 is a theoretical S-T diagram of the thermodynamic process carried out by the system shown in FIG. 20. The temperature and pressure values shown in FIGS. 20-21 are for illustrative purposes only and are not limiting in any way.

The external tanks 2000, 2002, and 2004 hold significantly more vaporizable liquid than the working gas can absorb by evaporation. While the illustrative embodiment shows three external tanks 2000, 2002, 2004, it will be appreciated that any suitable number of tanks may be employed. In the illustrative embodiment, the volume of the tanks may be adjusted such that transit time through each tank is between approximately 0.1 and 1 seconds. However, it will be appreciated that the volume of the tanks may be adjusted so that any suitable transmit time may be achieved. In some embodiments, the temperature of the vaporizable liquid in each tank is within approximately 20K of the temperature at which the working gas leaves that respective tank. Compression with vaporization near thermodynamic equilibrium may be arranged by passing a working gas through an external tank of vaporizable liquid after one or more compression stages.

In some embodiments, a radial compressor 2006 aspires a working gas and compresses it to a first compression end temperature and pressure. The working gas may be supplied to a first tank 2000 of vaporizable liquid at a first tank temperature between the intake temperature and the first compression end temperature. In some embodiments, the working gas passes through the tank in between approximately 0.1 and 1 seconds. In some embodiments, saturating the working gas with the vaporizable liquid may comprise repeatedly spraying large quantities of vaporizable liquid through the working gas, passing the working gas through the vaporizable liquid, using waterfall “curtains,” or other methods for saturating the working gas with vapor from the vaporizable liquid to optimize evaporative cooling. In the tank 2000, the working gas is cooled by evaporation to a temperature approximately equal to the tank temperature. After mixing the vaporizable liquid with the working gas, the substantially saturated gas-vapor mixture is discharged from the tank. If non-vaporized liquid remains mixed with the working gas it may be removed, for example, by a centrifugal separator (not shown).

A second radial compressor 2008 compresses the gas-vapor mixture to a second compression end temperature and pressure before supplying it, via a pipe 2010 or other suitable means, to a second tank 2002 for mixing with vaporizable liquid at a temperature between the first tank temperature and the second compression end temperature. Again mixing and evaporative cooling until saturation at the second tank temperature is carried out before discharge. Any non-vaporized liquid may be removed before the gas-vapor mixture is compressed in the third radial compressor 2012 to a third temperature and pressure. The compressed gas-vapor mixture is again mixed with vaporizable liquid and cooled by additional evaporation in a third tank 2004 at a third tank temperature between the second tank temperature and the third compression end temperature.

In some cases, the temperature of the vaporizable liquid in each respective tank 2000, 2002, and 2004 is near the working gas temperature upon leaving each respective tank. Thus, most of the thermal energy required for vaporization in the tanks may come from the compressed and heated working gas entering each tank and only a minor part from pre-heating the vaporizable liquid before supplying the vaporizable liquid to each vaporization tank. The working gas may be saturated with vapor upon leaving each tank. The corresponding gas-vapor mixture temperature may be defined by the temperature of the working gas after compression, the liquid temperature in each tank and the saturation characteristics (e.g., condensing line) of the vaporizable liquid.

An “external tank” as used in the context of this application simply means a space somewhat off the traditional flow path of a compression chamber where no major obstacles are produced for the working gas flow and saturation to take place. With increasing the number of stages, the tank sizes decrease because the density of the working gas rises due to its increased pressure. In piston engine applications, even for engines with several hundreds of kW power, the external tanks may not be larger than the engine itself. In the case of mobile applications performing closed cycles, the tanks may be smaller than the injection spaces while still being sufficiently large for vaporization.

B. Vaporization at Increased Temperature and Pressure

If air or another working gas is nearly saturated with steam, then, the net vaporization rate (mass of vaporized liquid per time unit) decreases rapidly. Increasing the working gas temperature far beyond the dew point would solve the vaporization problem. On the other hand, a large difference between saturation pressure and actual saturation (or in other words, between the dew point and the actual gas temperature) means that the vaporization may take place far from thermodynamic equilibrium and a significant entropy increase may occur. This may adversely affect the overall efficiency of the engine. It may be possible that such an off-equilibrium state change causes such a negative effect that the thermodynamic advantage to use a combined gas-steam working fluid is not only eliminated, but may even show an overall negative effect on efficiency.

In real engines, the mechanical efficiency is not perfect and vaporization does not occur quickly near the dew point. Therefore, it may be advantageous to carry out the vaporization at increased working gas pressures and increased temperatures. An increased working gas pressure may increase the density and, hence, move the vaporization state change towards an equilibrium state, while the increased temperature may increase the vaporization rate. Also, hot liquid may be vaporized to carry out the vaporization process closer to the thermodynamic equilibrium as the working gas temperature is elevated.

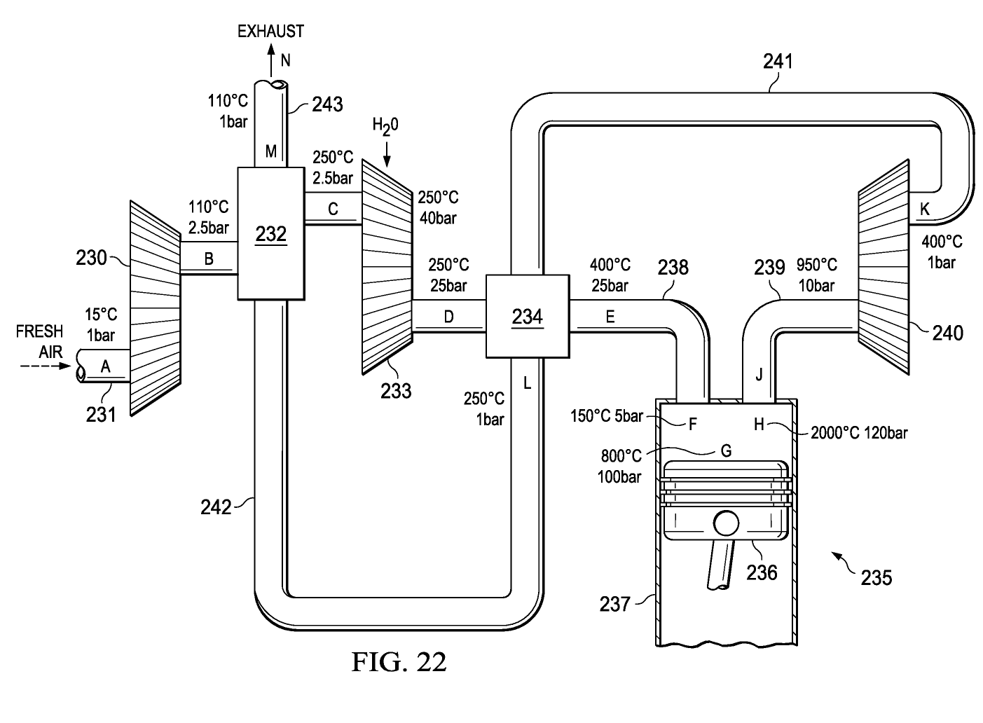

FIG. 22 shows an embodiment where vaporization of the liquid occurs at increased working gas pressure and temperature as compared to ambient conditions. FIG. 23 shows the thermodynamic process carried out by the embodiment according to FIG. 22 in a detailed theoretical S-T diagram. The forthcoming values for temperature and pressure are for illustrative purposes and are not limiting in any way. The compressor turbine 230 aspires fresh air at the ambient conditions of 15° C. and 1 bar (state “A” in FIG. 23) through an inlet 231 and compresses the air in an adiabatic (isentropic) manner without liquid vaporization to 2.5 bar, resulting in a working gas temperature of 110° C. (state “B” in FIG. 23). The compressed air is then supplied to the first recuperator 232 where it is heated to 250° C. while maintaining its pressure (state “C” in FIG. 23). The subsequent compressor turbine 233 then further compresses the pre-heated working gas under continuous vaporization of water, or other suitable fluid, to a pressure of 25 bar while maintaining its temperature at 250° C. (state “D” in FIG. 23).

This temperature-maintaining compression with liquid vaporization is a non-reversible process because it is carried out off the thermodynamic equilibrium, as the compressed air is not saturated with steam from the beginning. Consequently, an entropy increase occurs. The associated loss of mechanical power is indicated by the shaded area 245 in FIG. 23.

In one embodiment, the injected water is pre-heated to a temperature comparable to the compression temperature of 250° C. of the air exiting the compressor turbine 230. Here, the same temperature of 250° C. is chosen. As a side-effect, the steam pressure of water at this temperature may be higher than the compression end pressure of the compressor turbine 233 (e.g., 40 bar compared to 25 bar) and injection may be carried out more easily. The elevated temperature at which compression is carried out by the compressor turbine 233 ensures, together with the non-saturated working gas, fast evaporation of the injected water droplets. In the end, the non-reversibility of vaporizing in hot air is more than balanced by the high vaporization rate and the efficiency in a real engine may be increased.

The wet compressed air is supplied to the second recuperator 234 where the working gas is heated to 400° C. while maintaining its pressure at 25 bar (state “E” in FIG. 23). The piston engine 235 aspires the heated fresh working gas through its intake pipe 238. First, the piston 236 reciprocating in the cylinder 237 pre-expands the working gas to a pressure of 5 bar, resulting in a temperature of 150° C. (state “F” in FIG. 23). Then the piston 236 compresses the working gas to 100 bar and 800° C. (state “G” in FIG. 23), before combustion of the fuel occurs and the temperature rises to 2000° C. and the pressure to 120 bar (state “H” in FIG. 23). These are typical values for medium-sized Diesel engines. Again, the comparably high compression end temperature allows the combustion of heavy fuel oil and other fuels which are difficult to ignite. At the end of the expansion stroke in the piston engine 235, the working gas has a temperature of 950° C. and a corresponding pressure of 10 bar (state “J” in FIG. 23).

The working gas is then discharged into the exhaust pipe 239 without major throttling and enters the expansion turbine 240 where it is expanded down to ambient pressure, resulting in a temperature of 400° C. (state “K” in FIG. 23).

Through the pipe 241 the expanded but still hot exhaust gas is supplied to the second recuperator 234 where it heats the compressed fresh working gas from the second compressor turbine 233. Consequently its temperature drops to 250° C. while the pressure remains constant (state “L” in FIG. 23). Afterwards, the pipe 242 conducts the exhaust gas to the first recuperator 232 where the aspired fresh air or air-fuel mixture (working gas) from the first adiabatic compressor turbine 230 is heated. The exhaust gas is, again, cooled, here down to 110° C. (state “M” in FIG. 23) before it is discharged into the environment through the exhaust 243. By mixing with ambient air, the exhaust gas first cools down (state “N” in FIG. 23) to the dew point and then condensation of the steam occurs. The mechanical work which can be potentially produced by such condensation is indicated by the hatched area 244 in FIG. 23. As shown, this area is small relative to the overall area enclosed by the cycle path. Hence, the efficiency of the engine is relatively high. It will be appreciated that such condensation of the vaporized liquid need not occur necessarily when mixing with ambient air. If the ambient air is sufficiently dry and/or warm, then, the steam may be simply diluted and never reach the dew point. In this case another minor irreversibility may occur which may not affect the efficiency of the described engine.

By compressing first the air to an intermediate level (i.e., 2.5 bar), any vaporization takes place in a smaller volume and the steam density may be higher from the start in the second compressor turbine 233. This may lower the irreversibility of the compression in the second compressor turbine 233 as compression and vaporization starts nearer to the thermodynamic equilibrium. Of course, also in the course of the first compression, water or another vaporizable liquid may be vaporized so as to increase humidity already right from the start. This will further increase the efficiency. But the major part of the steam is still produced by vaporization in the second compressor turbine 233.

C. Vaporization at Increased Temperature and Pressure with Additional Post-Expansion Means

If the first compressor compresses the fresh air or air-fuel mixture to a temperature substantially above ambient temperature, then, the exhaust gas is discharged into the environment at higher temperature, which means avoidable loss of mechanical energy. This is especially the case for real heat exchangers as a certain temperature gradient between the flow and counter-flow of the medium to heat and the medium to be heated exists.

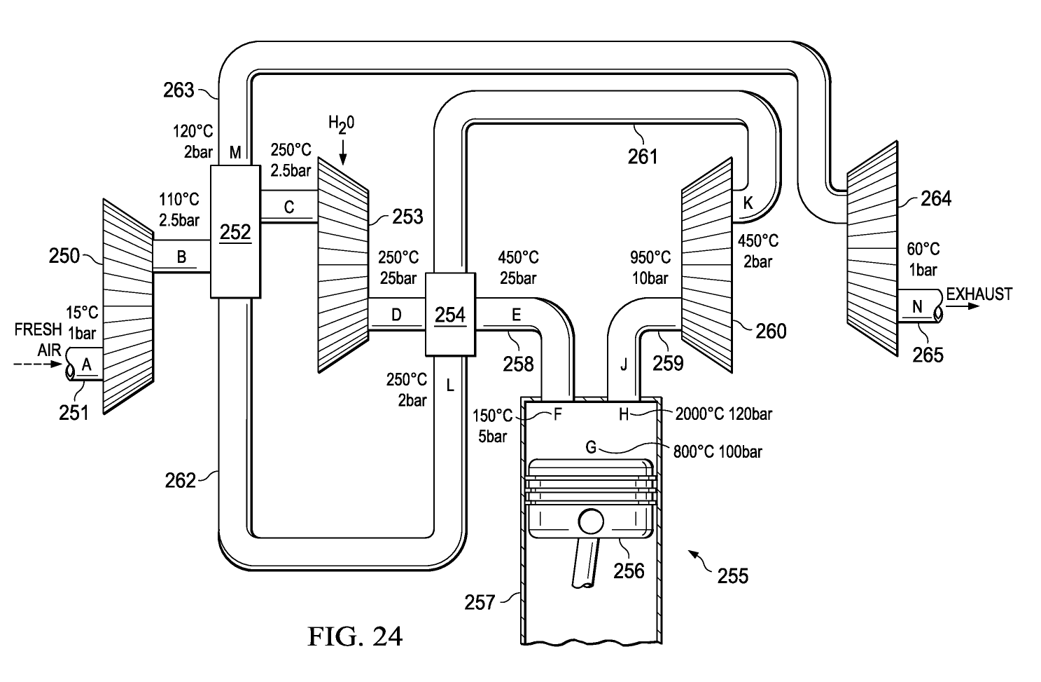

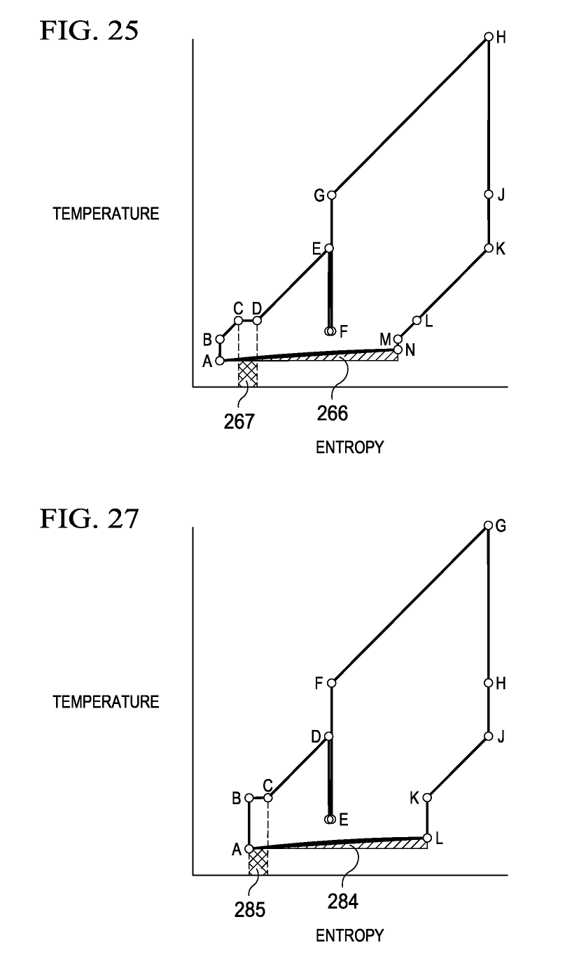

FIG. 24 shows an embodiment where vaporization of the liquid occurs at increased working gas pressure and temperature as compared to ambient conditions and a post-expansion of the exhaust gas is carried out after the first recuperator. FIG. 25 shows the thermodynamic process carried out by the embodiment according to FIG. 24 in a detailed theoretical S-T diagram. The forthcoming values related to temperature and pressure are for illustrative purposes and are not limiting in any way.

The compressor turbine 250 aspires fresh air at the ambient conditions of 15° C. and 1 bar (state “A” in FIG. 25) through its inlet 251 and compresses it in an adiabatic (isentropic) manner without liquid vaporization to 2.5 bar, resulting in a working gas temperature of 110° C. (state “B” in FIG. 25). The compressed air is then supplied to the first recuperator 252 where it is heated to 250° C. while maintaining its pressure (state “C” in FIG. 25). The subsequent compressor turbine 253 then further compresses the pre-heated working gas under continuous vaporization of water to a pressure of 25 bar while maintaining its temperature at 250° C. (state “D” in FIG. 25).

This temperature-maintaining compression with liquid vaporization is a non-reversible process because it is carried out off the thermodynamic equilibrium since the compressed air is not saturated with steam from the beginning. Consequently, an entropy increase occurs. The associated loss of mechanical power is indicated by the shaded area 267 in FIG. 25.

In some embodiments, the injected water is pre-heated to a temperature comparable to the compression temperature of 250° C. of the air exiting the compressor turbine 250. Here, the same temperature of 250° C. is chosen. As a side-effect, the steam pressure of water at this temperature may be higher than the compression end pressure of the compressor turbine 253 (e.g., 40 bar compared to 25 bar) and injection may be carried out more easily. Also here, the elevated temperature at which compression is carried out by the compressor turbine 253 ensures, together with the non-saturated working gas, fast evaporation of the injected water droplets. In the end the non-reversibility of vaporizing in hot air is more than balanced by the high vaporization rate and the efficiency in a real engine may be increased.

The wet compressed air is supplied to the second recuperator 254 where the working gas is heated to 450° C. while maintaining its pressure at 25 bar (state “E” in FIG. 25). The piston engine 255 aspires the heated fresh working gas through its intake pipe 258. First, the piston 256 reciprocating in the cylinder 257 pre-expands the working gas to a pressure of 5 bar, resulting in a temperature of 150° C. (state “F” in FIG. 25). Then, the piston 256 compresses the working gas to 100 bar and 800° C. (state “G” in FIG. 25), before combustion of the fuel occurs and the temperature rises to 2000° C. and the pressure to 120 bar (state “H” in FIG. 25). At the end of the expansion stroke in the piston engine 255, the working gas has a temperature of 950° C. and a corresponding pressure of 10 bar (state “J” in FIG. 25).

The working gas is then discharged into the exhaust pipe 259 without major throttling and enters the expansion turbine 260 where it is expanded down to a pressure of 2 bar, i.e., above ambient pressure, resulting in a temperature of 450° C. (state “K” in FIG. 25).

Through the pipe 261 the expanded but still hot exhaust gas is supplied to the second recuperator 254 where it heats the compressed fresh working gas from the second compressor turbine 253. Consequently its temperature drops to 250° C. while the pressure remains constant at 2 bar (state “L” in FIG. 25). Afterwards, the pipe 262 conducts the exhaust gas to the first recuperator 252 where the aspired fresh air or air-fuel mixture (working gas) from the first adiabatic compressor turbine 250 is heated. The exhaust gas is, again, cooled, here down to 110° C. (state “M” in FIG. 25) before it is supplied to the second expansion turbine 264 for final expansion down to ambient pressure (state “N” in FIG. 25). The second expansion turbine expands the working gas basically to the dew point to maximize the mechanical power delivered while still the thermal energy of the condensing steam remains at its maximum to transfer the highest thermal energy possible to the lower thermal reserve (e.g., the environment) at the lowest possible temperature.

Afterwards, the expanded exhaust gas is discharged into the environment through the exhaust 265. By mixing with ambient air, condensation of the steam occurs. The mechanical work which can be potentially produced by such condensation is indicated by the hatched area 266 in FIG. 25. As is apparent, this area is small relative to the overall area enclosed by the cycle path. Hence, the efficiency of the engine is relatively high. It will be appreciated that such condensation of the vaporized liquid need not occur necessarily when mixing with ambient air. If the ambient air is sufficiently dry and/or warm, then, the steam may be simply diluted and never reach the dew point.

By compressing first the air to an intermediate level (e.g., 2.5 bar), any vaporization takes place in a smaller volume and the steam density may be higher from the start in the second compressor turbine 253. This may lower the irreversibility of the compression in the second compressor turbine 253 as compression and vaporization starts nearer to the thermodynamic equilibrium. Of course, also in course of the first compression, water or another vaporizable liquid may be vaporized so as to increase humidity already right from the start. This will further increase the efficiency. But the major part of the steam is still produced by vaporization in the second compressor turbine 253.

D. Vaporization at Increased Temperature

Instead of using a first recuperator to increase the temperature of the fresh air or air-fuel mixture, already the first compressor may compress the fresh air or air-fuel mixture to an even higher temperature than is the case for the embodiments described above.

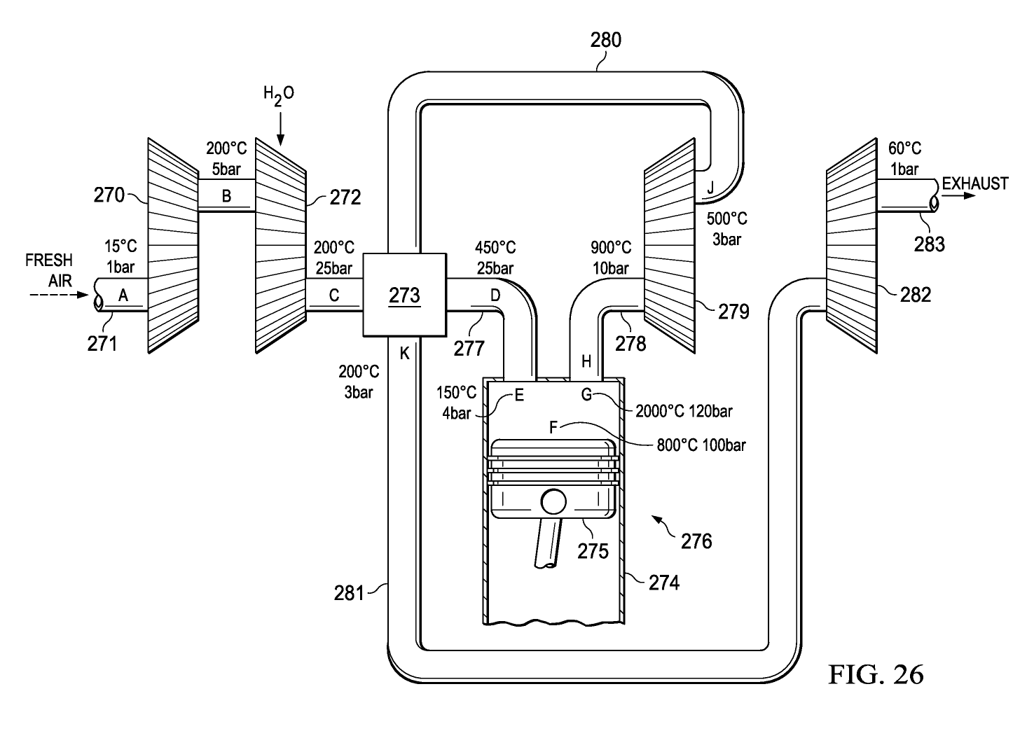

FIG. 26 shows an embodiment where first an adiabatic compression is carried out to a higher temperature level before compression with vaporization of liquid occurs. FIG. 27 shows the thermodynamic process carried out by the embodiment according to FIG. 26 in a detailed theoretical S-T diagram. The forthcoming values for temperature and pressure are for illustrative purposes and are not limiting in any way.

The compressor turbine 270 aspires fresh air at the ambient conditions of 15° C. and 1 bar (state “A” in FIG. 27) through an inlet 271 and compresses the air in an adiabatic (isentropic) manner without liquid vaporization to 5 bar, i.e., twice the pressure as in the embodiment described before with reference to FIG. 24. The resulting working gas temperature is around 200° C. (state “B” in FIG. 27). The compressed and hot air is then supplied to the subsequent compressor turbine 272 which further compresses the pre-heated working gas under continuous vaporization of water to a pressure of 25 bar while maintaining its temperature at 200° C. (state “C” in FIG. 27).

This temperature maintaining compression with liquid vaporization is a non-reversible process as already described above. Consequently, an entropy increase occurs. The associated loss of mechanical power is indicated by the shaded area 285 in FIG. 27.

In some embodiments, the injected water is pre-heated to a temperature comparable to the compression temperature of 200° C. of the air exiting the compressor turbine 270. Also here, the elevated temperature at which compression is carried out by the compressor turbine 272 ensures, together with the non-saturated working gas, fast evaporation of the injected water droplets.

The wet compressed air is supplied to the recuperator 273 where the working gas is heated to 500° C. while maintaining its pressure at 25 bar (state “D” in FIG. 27). The piston engine 274 aspires the heated fresh working gas through its intake pipe 277. First, the piston 275 reciprocating in the cylinder 276 pre-expands the working gas to a pressure of 4 bar, resulting in a temperature of around 150° C. (state “E” in FIG. 27). Then, the piston 275 compresses the working gas to 100 bar and 800° C. (state “F” in FIG. 27), before combustion of the fuel occurs and the temperature rises to 2000° C. and the pressure to 120 bar (state “G” in FIG. 27). At the end of the expansion stroke in the piston engine 274, the working gas has a temperature of 900° C. and a corresponding pressure of 10 bar (state “H” in FIG. 27).

The working gas is then discharged into the exhaust pipe 278 without major throttling and enters the first expansion turbine 279 where it is expanded down to a pressure of 3 bar, i.e., substantially above ambient pressure, resulting in a temperature of 500° C. (state “J” in FIG. 27).

Through the pipe 280, the expanded, but still hot exhaust gas, is supplied to the recuperator 273 where it heats the compressed fresh working gas from the second compressor turbine 272. Consequently its temperature drops to 200° C. while the pressure remains constant at 3 bar (state “K” in FIG. 27). Afterwards, the pipe 281 conducts the exhaust gas to the second expansion turbine 282 for final expansion down to ambient pressure (state “L” in FIG. 27). The second expansion turbine 282 expands the working gas basically to the dew point to maximize the mechanical power delivered while the thermal energy of the condensing steam remains at its maximum to transfer the highest thermal energy possible to the lower thermal reserve (e.g., the environment) at the lowest possible temperature.

Afterwards, the expanded exhaust gas is discharged into the environment through the exhaust 283. By mixing with ambient air, condensation of the steam occurs. The mechanical work which can be potentially produced by such condensation is indicated by the hatched area 284 in FIG. 27. As is apparent, this area is small relative to the overall area enclosed by the cycle path. Hence, the efficiency of the engine is relatively high. It will be appreciated that such condensation of the vaporized liquid need not occur necessarily when mixing with ambient air. If the ambient air is sufficiently dry and/or warm, then, the steam may be simply diluted and never reach the dew point.

The first and second compressor turbines 270 and 272 can be formed by one single compressor turbine where simply after a certain number of adiabatic stages (sufficient for the first adiabatic compression) liquid injection into the stator begins. In other words, the vaporizable liquid is or supplied to the inlet of the compressor or the first stages. The vaporizable liquid is supplied if a sufficient temperature increase has occurred that ensures that the injected droplets have already vaporized before the working gas enters the subsequent stage. This eliminates the problem of drop impact as no drops exist upon entrance into the subsequent stage and no impeller blades are hit.

It may depend on the mechanical and thermodynamic efficiency of the first compressor turbine 272 and the second expansion turbine 282, whether such an arrangement with increased compression ratio in the first compressor turbine 272 or the former combination of a lower compressing first compressor turbine 250 and a first recuperator 252 described in FIG. 24, is more efficient. With increasing quality of the compressors and expanders, the embodiment described with reference to FIG. 26 may begin to be more efficient.

In the course of the compression in the first compressor turbine 270, water or another vaporizable liquid can be vaporized so as to increase humidity already before compression with strong liquid vaporization starts in the second compressor turbine 272. It will be appreciated that compression in the first compressor turbine 270 is carried out with the vaporization of liquid in such quantities that saturation is not reached and vaporization occurs quickly.

### III: Fluid Injection Piston Engines

Liquid vaporization can be carried out, at least partially, also in the piston engine itself. The embodiments discussed below describe injecting a liquid into the piston cylinder at the beginning of a compression stroke such that the liquid vaporizes in the course of a first part of compression stroke and prior to the combustion stroke. In some embodiments, because the temperature of the mixture is above the dew point of the liquid, the injected liquid may vaporize almost instantaneously.

The vaporization of the liquid may cause the temperature to remain nearly constant during a first part of the compression stroke. The second part of the compression stroke may be carried out in an isentropic-adiabatic manner, and temperature and pressure rise accordingly. In one embodiment, the first and the second part of the compression stroke form the complete and integral compression stroke. Because the working gas has been heated prior to aspiration, even the lower isentropic-adiabatic compression ratio may cause a high compression end temperature which may correspond to a high efficiency. This high compression end temperature may be reached with a substantially lower compression end pressure because the quasi-isothermal compression resulting from the vaporization of fluid during the first part of the compression stroke kept both the temperature and pressure lower than in a traditional engine. As the later expansion is carried out basically as an adiabatic expansion, the pressure expansion ratio is considerably higher than the total pressure compression ratio, so a more efficient and power depositing expansion can be obtained. In other words, a desired high compression end temperature is reached without the associated extremely high compression pressures in traditional engines. Thus, the mechanical components may not be as jeopardized as they are in traditional engines. Liquid injection and vaporization starts early in the compression stroke and is terminated before the piston reaches its top-dead-center position.

Liquid injection at the beginning of the compression stroke may have several effects, and a few of these will be discussed below. First, vaporization of the liquid occurs so that after expansion, the corresponding condensation may cause the major discharge of low-temperature thermal energy (e.g., 30%-50% of the fuel energy) as soon as the dew point is reached. Second, the quasi-isothermal compression at the beginning of the compression stroke may cause a lower pressure increase. Therefore, a higher adiabatic pressure expansion ratio may be achieved in the later expansion stroke. This causes a lower exhaust temperature and pressure and more power for the piston engine.

A: 2-Stroke Engine

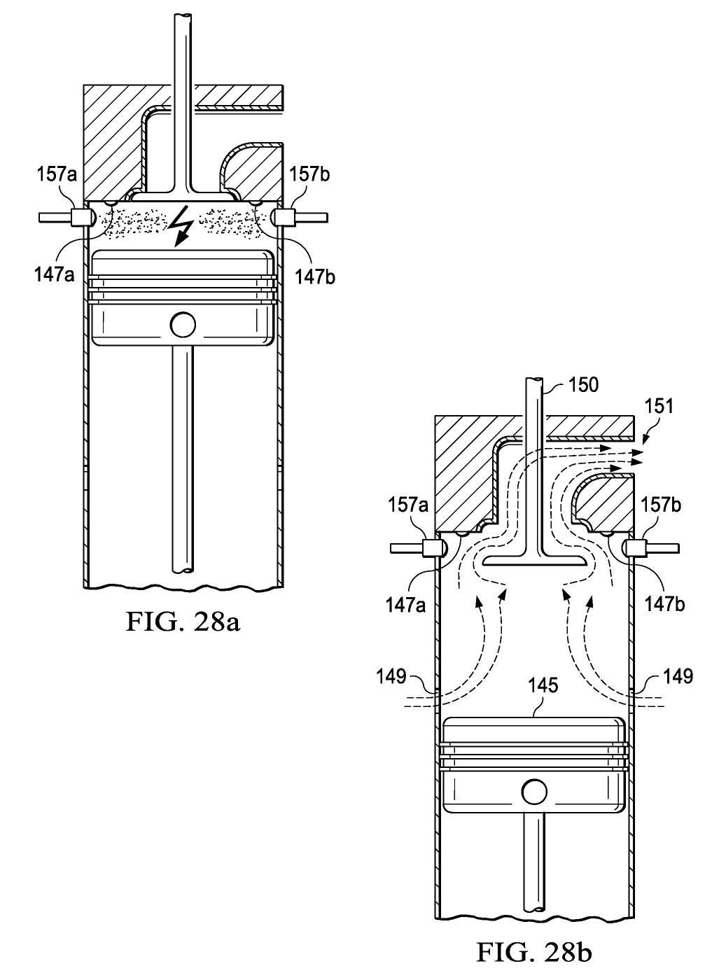

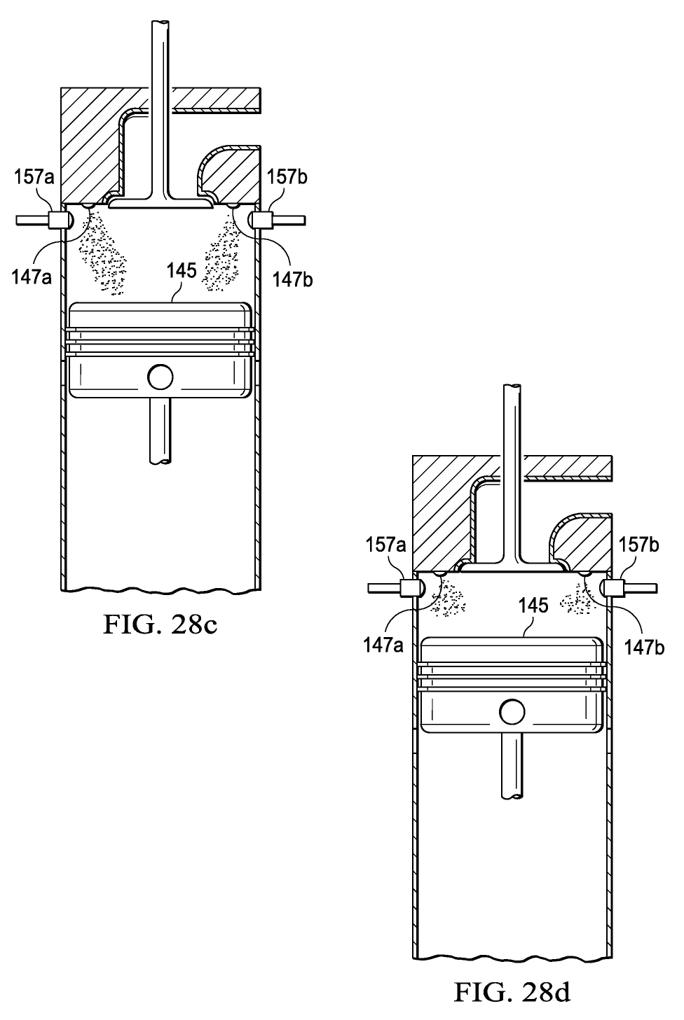

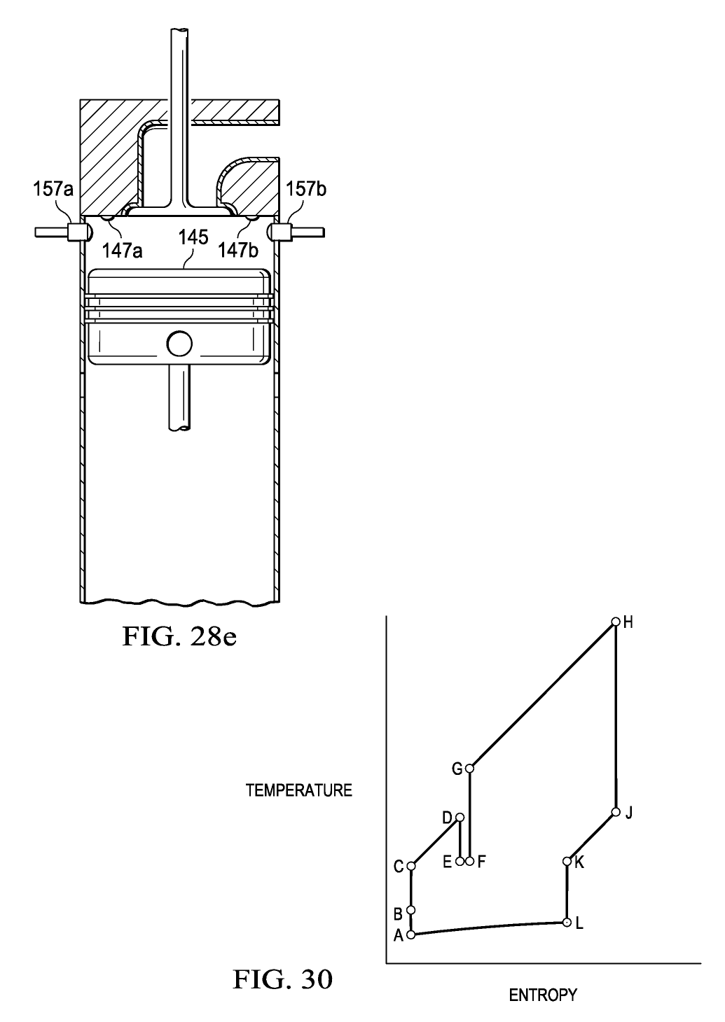

FIGS. 28a to 28e show the liquid injection timing for a 2-stroke piston engine. FIG. 28a shows the nozzles 157a and 157b injecting fuel which starts to burn in the combustion stroke, thereby forcing the piston down. As shown in FIG. 28b, when the piston 145 has reached its bottom-dead—center position, the ring inlet opening 149 is exposed and simultaneously the discharge valve 150 is opened. The piston engine aspires fresh air through its exposed ring inlet opening 149. The aspired air, which is under a higher pressure than the combusted gas, drives the combusted gas through the open discharge valve 150 out into the exhaust pipe. The aspired air is compressed in a compressor prior to being aspired by the 2-stroke engine. In the course of, or after this compression the aspired air, a certain amount of fluid may have been vaporized. If this is the case, the further liquid vaporization which takes place in the piston may cause an even higher total vaporization share as at the time of intake.

By moving upward, the piston 145 blocks the ring inlet opening 149 and, then starts to compress the aspired air. The temperature of the air at the beginning of the compression stroke is above the dew point of the liquid, as such, it can vaporize a high amount of liquid injected at this point.

FIG. 28c shows that the liquid injection nozzles 147a and 147b start to inject liquid as the piston moves up for compression. In some embodiments, the flow of injected liquid is controlled in such a way that the temperature remains nearly constant. This may cause the pressure of the air-steam mixture to rise, but the temperature to remain approximately the same. In some embodiments, due to the high temperature of the air-steam mixture in the cylinder, vaporization of the injected liquid may occur almost instantaneously.

As the liquid injection occurs into a hot, but not saturated air-steam mixture, entropy rises because this injection and subsequent vaporization is a non-reversible process. However, this entropy increase is usually sufficiently low enough to not harm efficiency very much. In some embodiments, the temperature at the beginning of the compression stroke and the amount of injected liquid can be adjusted in such a way that at the end of this compression stroke with the liquid, or other vaporizable liquid, injection and vaporization, reach at least a 25% saturation (i.e., the partial pressure of the steam reaches at least 25% of the saturation pressure at the corresponding temperature). The temperature of the injected liquid or vaporizable liquid is at a level between ambient and compression temperatures. As piston engines are usually liquid-cooled, the liquid to be injected may be heated by this cooling liquid or the cooling liquid may be used directly. If at least a saturation of 25% is reached at the end of the compression stroke with liquid injection, the entropy increase in the course of the non-reversible vaporization process is small and the benefits in a real engine may surpass the disadvantage of such a non-reversible vaporization.

As shown in FIG. 28d, the nozzles 147a and 147b stop injecting liquid during the compression stroke. As shown in FIG. 28e, the piston 145 goes on moving up and further compresses the air-steam mixture. Without the liquid injection, the pressure would rise to a much higher value, jeopardizing the mechanical components. Efficiency is also improved because this vaporization increases the steam load and, hence, the condensation power at low temperatures after expansion. Finally, the piston 145 reaches it top-dead-center position and the cycle starts again with the injection and combustion of the fuel as shown in FIG. 28a. Any appropriate combustible fuel may be used, such as natural gas or gasoline. Combustion may occur by externally igniting the fuel through a spark plug or by injecting the fuel directly as in diesel engines.

Liquid injection at the beginning of the compression stroke enables a high pressure expansion ratio at a high mean pressure. Consequently, the power density of the engine is at least maintained, if not increased, to that of conventional engines. Additionally, as the efficiency rises, nearly all of the mechanical power may be produced at the engine's crankshaft, which may be used to drive a vessel propeller or generator.

B: Two-Stroke Piston Engine System with Liquid Injection

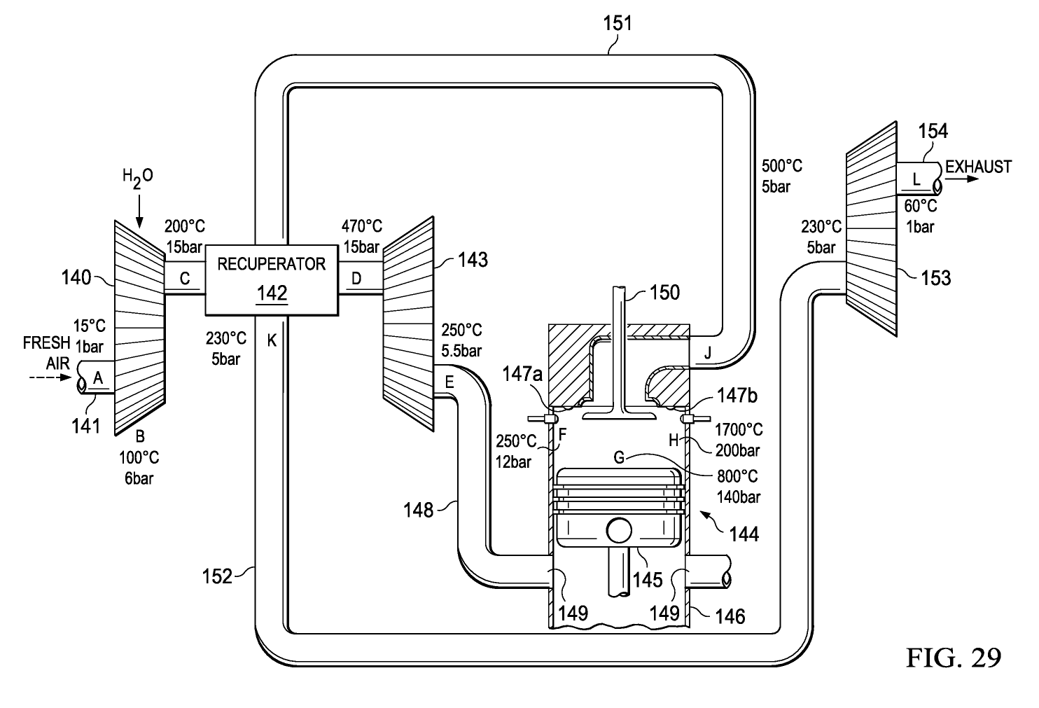

FIG. 29 is a schematic diagram of a valve-controlled 2-stroke piston engine system with liquid injection timing described above, and the liquid used is water. FIG. 30 is a theoretical S-T diagram showing the thermodynamic cycle carried out by the piston engine according to FIG. 29. These two figures will be described in conjunction with one another. The forthcoming values for temperature and pressure are for illustrative purposes and are not limiting in any way.

In FIG. 29, the compressor turbine 140 aspires fresh air with a temperature of approximately 15° C. and ambient pressure of approximately 1 bar (state point “A” in FIG. 30) through the inlet 141 and compresses it under continuous supply and vaporization of water to approximately 100° C. and approximately 6 bar (state point “B” in FIG. 30). Afterwards, the compressor turbine 140 carries out an adiabatic compression without a liquid (water) supply; hence, the temperature of the air-steam mixture increases more rapidly and reaches approximately 200° C. at a pressure of approximately 15 bar when leaving the compressor turbine 140 (state point “C” in FIG. 30). It then passes through the recuperator 142 where it is heated to 470° C. while maintaining its pressure at 15 bar (state point “D” in FIG. 30). The first expansion turbine 143 expands the pre-heated working gas to approximately 250° C. and a pressure of approximately 5.5 bar (state point “E” in FIG. 30). The intake channel 148 delivers the partially expanded working gas to the ring inlet opening 149 of the 2-stroke piston engine 144. This engine includes a piston 145 reciprocating within the cylinder 146. The piston 145 taps or exposes the ring inlet opening 149 according to the typical 2-stroke gas exchange scheme. The discharge of the exhaust gas is controlled by a hydraulically operated discharge valve 150.

The piston engine 144 aspires the partially expanded air-steam mixture through its exposed ring inlet opening 149 (state point “E” in FIG. 30). By moving upward, the piston 145 first taps the ring inlet opening 149 and, then, starts to compress the aspired air-steam mixture. The water injection nozzles 147a and 147b start to inject water as the piston moves up for compression. In some embodiments, the flow of injected water is controlled in such a way that the temperature remains almost constant. This causes the pressure to rise but the temperature to remain approximately equal (state change E-F in FIG. 30). When a pressure of approximately 12 bar is reached (state point “F” in FIG. 30) at the temperature of approximately 250° C., water injection stops and the compression continues in an isentropic manner.

The piston 145 continues moving up and further compresses the air-steam mixture to reach a compression end temperature of around 800° C. and a pressure of around 140 bar (state point “G” in FIG. 30). Combustion of the fuel causes both the temperature and pressure of the air-steam mixture (the working gas, as now the composition has changed by burning the fuel) to rise to approximately 1700° C. and approximately 200 bar, respectively (state point “H” in FIG. 30).

The piston 145 moves down to expand the hot working gas to a temperature of only approximately 500° C. and a pressure of around 5 bar at its bottom-dead-center position (state point “J” in FIG. 30). When the piston 145 reaches its bottom-dead-center position, the discharge valve 150 opens and the still hot working gas leaves the cylinder 146 through the exhaust pipe 151. The water injected compression together with the high expansion ratio also allows an expansion end pressure at or below the pressure after the first expansion turbine. Consequently, no throttling into the exhaust pipe 151 takes place to avoid re-flow of the exhaust gas into the intake system and no entropy increase associated with throttling occurs.

The still hot exhaust gas is channelled through the pipe exhaust 151 to the recuperator 142 to heat the freshly aspired and compressed air-steam mixture from the compressor turbine 140. Consequently, the exhaust gas cools down to approximately 230° C. at a pressure of approximately 5 bar (state point “K” in FIG. 30). Finally, the cooled, but still pressurized exhaust gas, is supplied to the second expansion turbine 153 where it is expanded to an ambient pressure and temperature of approximately 60° C. which is almost the dew point of the contained steam (state point “L” in FIG. 30). This gas is discharged into the environment through the exhaust 154. By mixing with ambient air the steam condenses, or may simply be diluted, in the drier air (state change L-A in FIG. 30).

C: Four-Stroke Piston Engine with Liquid Injection

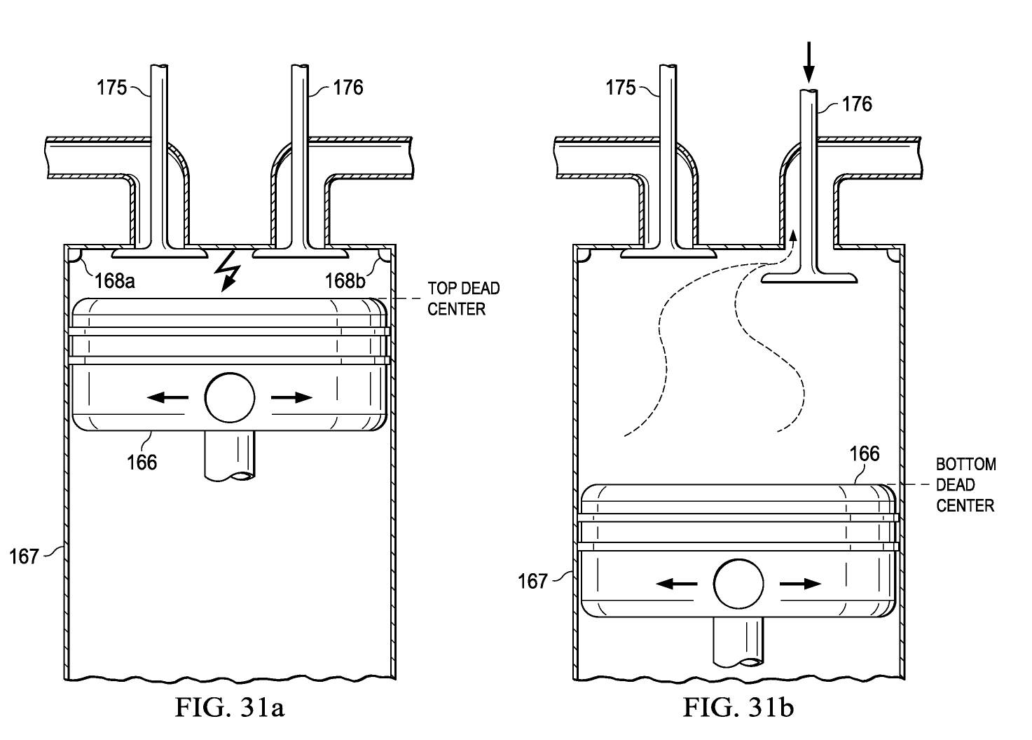

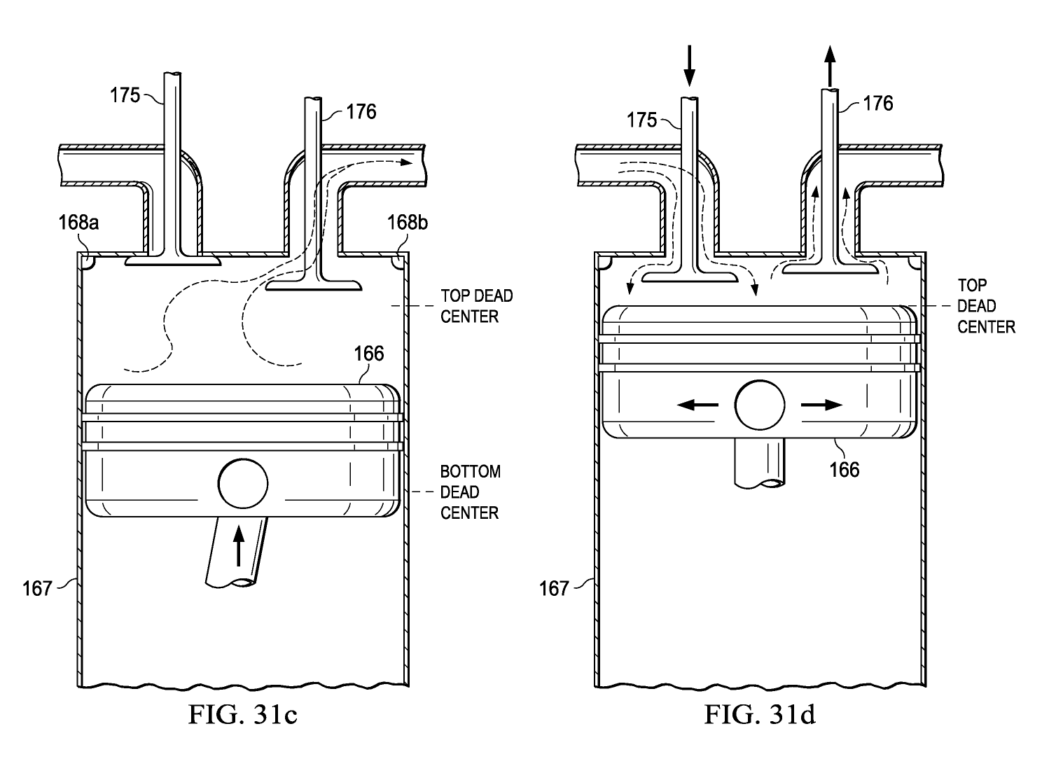

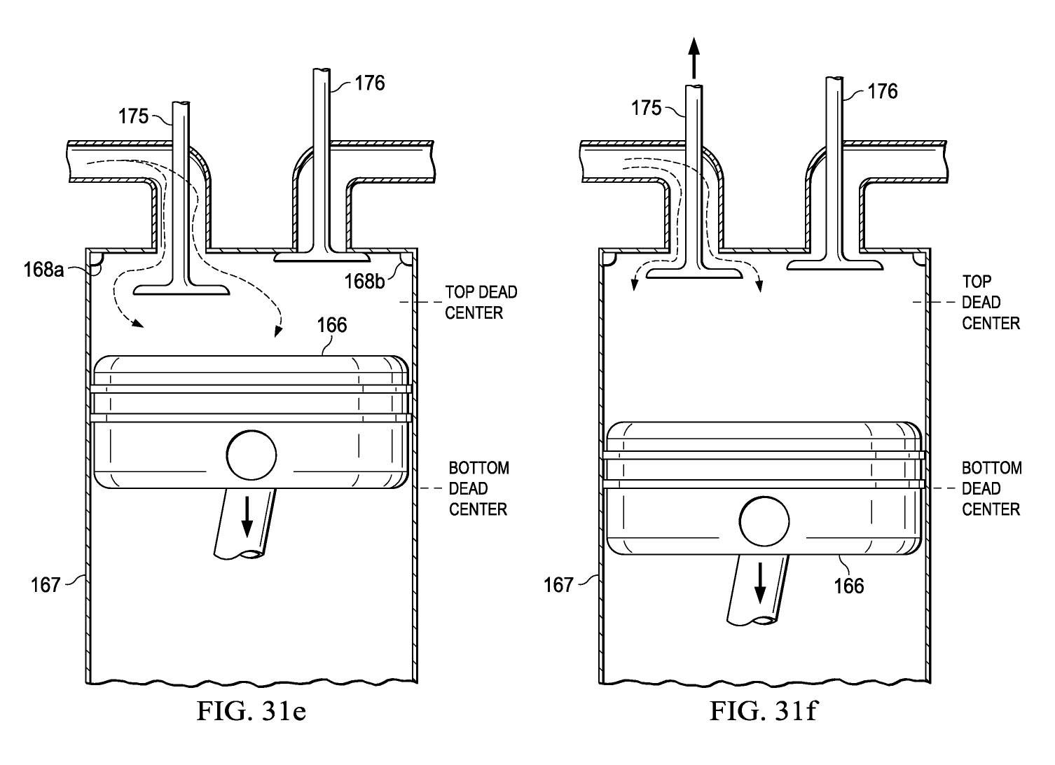

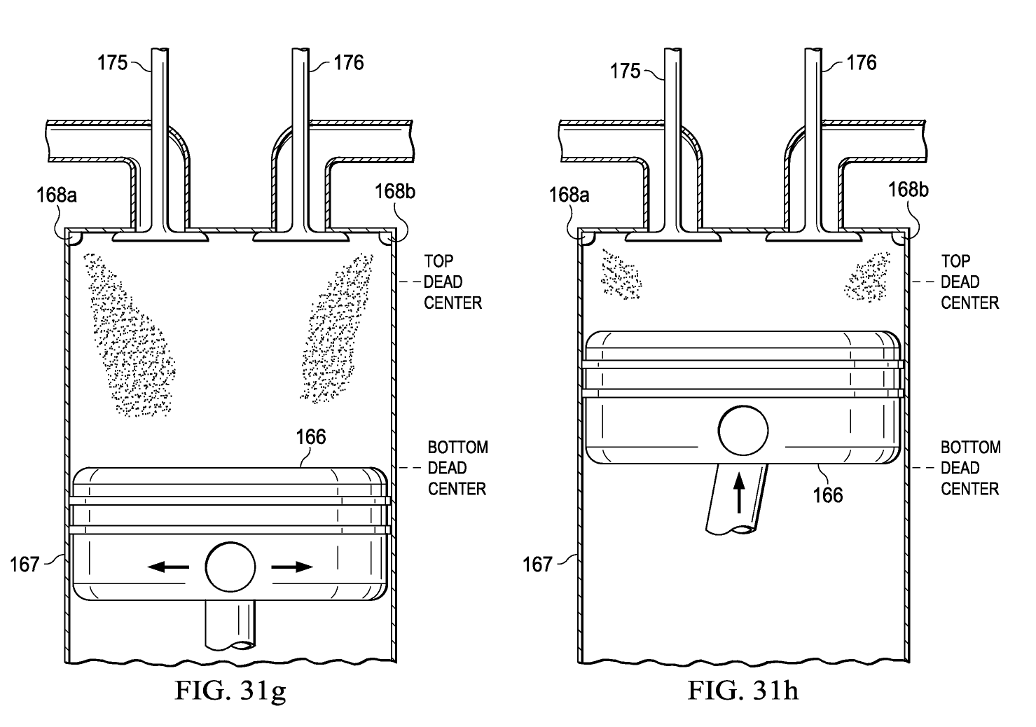

FIGS. 31a to 31h show the liquid injection timing of a four-stroke piston engine.

In FIG. 31a, the piston 166 is at its top-dead-center position within the cylinder 167 when the fuel is ignited and burns to increase both the pressure and temperature of the working gas. Both, intake valve 175 and discharge valve 176 are closed.

As shown in FIG. 31b, as soon as the piston 166 reaches its bottom-dead-center position, the discharge valve 176 opens to allow the hot and pressurized working gas to leave the cylinder 167.

As shown in FIG. 31c, an upward movement of the piston 166 exhausts, the still hot working gas out of the cylinder 167 by displacement, i.e., without major throttling. As shown in FIG. 31d, when the piston 166 reaches its top-dead-center position, the discharge valve 176 closes and the intake valve 175 opens.

As shown in FIG. 31e, the downward movement of the piston 166 causes the compressed fresh air or air-fuel mixture to enter the cylinder 167. As shown in FIG. 3 If, the intake valve 175 closes before the piston 166 has reached its bottom-dead-center position and, thus, the aspired air or air-fuel mixture is pre-expanded as the piston 166 continues to move downward.

As shown in FIG. 31g, as soon as the compression stroke begins, the nozzles 168a and 168b start to inject water or other vaporizable liquid as tiny droplets may vaporize immediately because of the high temperature of the air in the cylinder 167. The liquid flow is controlled in such a way that the vaporization of the continuously injected droplets, maintains the working gas at an approximately constant temperature during compression. This is called “isothermal” or “quasi-isothermal” compression as the temperature may be maintained at a constant level. The ongoing compression by the piston 166 increases the pressure and also the saturation of the gas as more liquid vaporizes. The volume continues to decrease as the compression continues.

As shown in FIG. 31h, the nozzles 168a and 168b stop to inject the liquid part way through the compression stroke, and further compression may occur in an adiabatic manner, increasing both the temperature and the pressure of the working gas until it reaches the top-dead-center position, as shown in FIG. 31a. The cycle then repeats itself.

D: Four-Stroke Piston Engine System with Liquid Injection

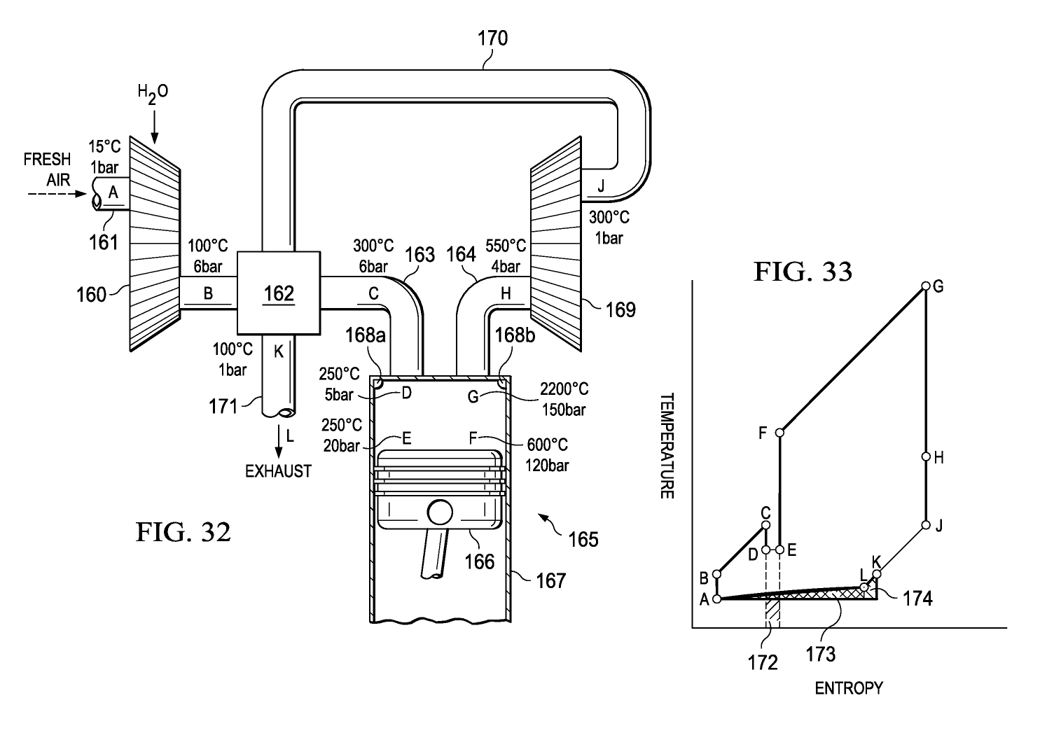

FIG. 32 is a schematic diagram of a four-stroke piston engine system with liquid injection timing, as described above. The liquid used is water. FIG. 33 is a theoretical S-T diagram of the thermodynamic cycle carried out by such piston engine in FIG. 32. These two figures will be described in conjunction with one another. The forthcoming values for temperature and pressure are for illustrative purposes and are not limiting in any way.

The compressor turbine 160 aspires air with a temperature of approximately 15° C. and ambient pressure of approximately 1 bar (state point “A” in FIG. 33) through the inlet 161 and compresses it under a continuous supply and of vaporizable water to the moderate temperature of approximately 100° C. and the moderate pressure of approximately 6 bar (state point “B” in FIG. 33).

The compressed air-steam mixture passes through the recuperator or heat exchanger 162 where it is heated to approximately 300° C. while maintaining its pressure at approximately 6 bar (state “C” in FIG. 33). The piston engine 165, which comprises a piston 166 reciprocating within the cylinder 167, first aspires the compressed air-steam mixture through its intake pipe 163. The intake valve (not shown in FIG. 32) closes before the piston 166 reaches its bottom-dead-center position. Therefore, a substantially isentropic expansion state change C-D (FIG. 33) is carried out by the piston engine 165. State “D” is reached with a temperature of approximately 250° C. and a pressure of approximately 5 bar when the piston is at the bottom-dead-center position. Then, the piston moves up and starts to compress the aspired air-steam mixture.

Water is injected through the nozzles 168a and 168b in such a way that the temperature of the air-steam or air-fuel-steam mixture is maintained at approximately 250° C. The pressure continues rising during the compression stroke until a pressure of approximately 20 bar is reached (state point “E” in FIG. 33). Now the nozzles 168a and 168b stop injecting water. Because of the further compression by the piston 166 both the temperature and pressure rise. It will be appreciated that even for the moderate isothermal compression ratio of approximately 4, as may be expected of this illustrative non-limiting embodiment, the isothermal compression represents nearly ¾th of the overall compression time. Therefore, there may be time for the injected water to vaporize. When the piston 166 reaches its top-dead-center position, a pressure of approximately 120 bar and a temperature of approximately 600° C. is reached (state point “F” in FIG. 33). The adiabatic compression ratio is around 3.5 which leads to an overall compression ratio of 14. This corresponds to a typical high-compressing turbo-charged gas engine for stationary applications.

Then, combustion occurs and both the temperature and pressure of the combusted product rises to approximately 2200° C. and approximately 150 bar, respectively (state point “G” in FIG. 33). The typical combustion is a mixture of isochoric and isobaric temperature increase as the piston 166 already starts to move down while the combustion is still in progress. In a pure isochoric combustion, both pressure and temperature would be higher than is the case of the described example. In a pure isobaric combustion, both temperature and pressure would be lower. For any combustion at the beginning pressure, and temperature rise in a nearly isochoric manner. Around the top-dead-center position, the piston moves very slowly and, hence, combustion is much quicker than the piston movement. Followed by a quasi-isobaric combustion when the piston accelerates, the combustion space is quick increasingly quick to enlarged while combustion still continues. This leads to combustion where the temperature rises but the pressure does not change more than ±25% typically, depending on the velocity relation between combustion and piston movement. This may be regarded as quasi-isobaric. The negative effect is that the remaining volume expansion ratio after combustion has completed, is now lower than the volume compression ratio before, and a lower expansion occurs than would be possible for a given mechanical arrangement. Therefore, the engine typically burns the fuel quickly, because a higher combustion temperature means a higher thermodynamic efficiency and higher effective expansion ratio means a higher mechanical efficiency of the piston engine. Quickly burning the fuel may lead to high combustion pressures. However, in these embodiments, such a combined “quasi” isochoric-isobaric combustion may occur not only without penalizing the overall engine efficiency, but may be desired to lower mechanical (and thermal) stress on the engine components.

The piston 166 moves down to expand the hot working gas to a temperature of approximately 550° C. and a pressure of approximately 4 bar at its bottom-dead-center position (state point “H” in FIG. 33). The discharge valve (not shown) opens and the still hot working leaves the cylinder 167 through the exhaust pipe 164. The pressure in the intake pipe 163 is higher and, hence, no throttling into the exhaust pipe 164 takes place. The expansion turbine 169 expands the exhaust gas further to ambient pressure of approximately 1 bar and a corresponding temperature of approximately 300° C. (state point “J” in FIG. 33).

The de-pressurized, but still hot exhaust gas, is channelled through the pipe into the recuperator 162 to heat the aspired and compressed air-steam mixture from the compressor turbine 160. Consequently it cools down to approximately 100° C. at an ambient pressure of approximately 1 bar (state point “K” in FIG. 33). Finally, the cooled exhaust gas is discharged into the environment through the exhaust 171. By mixing with ambient air, the exhaust gas cools down to the dew point of the steam (state point “L”) according to the amount of injected water in the compressor turbine 160 and in the piston engine 165.

IV: Thermal Isolation of Piston and Cylinder

Mechanical constraints require that the piston and cylinder remain cooler than the peak combustion temperature of the working gas. With decreasing piston and cylinder dimensions, the cooling losses may become increasingly important. Therefore, it may be advantageous to develop a thermally isolated piston and cylinder such that most of the thermal energy normally lost by cooling the piston and cylinder may instead be kept in the working gas such that it may be exhausted and re-used.

In general, the thermal transfer may be described by the following formula:

Pₜₕₑᵣₘ=α*A*ΔT

α is the thermal transfer coefficient, A is the transfer area, and ΔT is the temperature difference between, in the case of the described embodiment, the hot working gas and the cooled piston and cylinder surface. In general, the thermal transfer coefficient α, in turn depends, among other parameters, on the working gas pressure P and the working gas temperature T in the following manner:

α˜P^{0.8}*T^{-0.5}

To lower the thermal cooling losses and, hence, to increase the engine's efficiency, full ceramic engines have been developed. Ceramic engines are able to run without a cooling medium. However, they do not significantly affect the engine's efficiency as may have been expected. Detailed calculations show that the reason is due to the fact that thermal losses were just transferred to the exhaust gas and not re-used. Furthermore, full ceramic engines are expensive to produce and highly brittle, thereby, being more likely to fail in operation.

For some ceramic engines, calculations show that the major part of thermal transfer from the hot working gas upon combustion occurs within the first 45° of crankshaft rotation, or a corresponding piston movement in case of Wankel or other rotary piston engine. Consequently, only a part of the cylinder surface may be coated or produced from thermally isolating material. Additionally, calculations also show that only a very thin surface layer of the cylinder and piston surface facing the combustion area is affected by the thermal energy transfer. The heat capacity of the working gas is simply too small to heat or cool a major part of the cylinder and piston within one revolution. As such, the embodiments described below seek to make use of a partial coating of thermal insulation, while decreasing the cost to produce and increasing the longevity of the engine, (i.e., only insulating the piston and cylinders exposed to the majority of the thermal stresses of combustion.)

The embodiments below relate to thermally isolating the surfaces of a cylinder and piston facing the combustion space of an internal combustion engine. Because the surfaces are isolated, no major loss of thermal energy to the outside, i.e., cooling fluid or directly the environment, occurs. Instead, the thermal energy, which is transferred during combustion and the first part of the expansion stroke, from the hot flue gases to the engine surface, is stored in a thin layer of the isolating surface. During the second part of the expansion stroke, when the working gas temperature has dropped below this surface temperature, in the course of the exhaust stroke and to a lesser degree also in the course of the next intake and compression strokes, this thermal energy re-flows from the heated surfaces back to the working gas, whether exhaust gas or freshly aspired working gas. Consequently, the temperature of the exhaust remains relatively high. The heat from the exhaust can be captured and re-used for a variety of purposes. This isolation may reduce the thermal energy loss through the piston and cylinder walls, thereby producing more usable energy for the entire engine system. The additional thermal energy present in a significantly higher exhaust temperature can be captured and re-used, as explained in other parts of this specification. Thermal energy, which has been re-transferred from the hot surfaces to the freshly aspired and cooler working gas, is re-inserted into the engine cycle and, consequently, re-used internally. This re-transfer occurs, according to the above cited relation α˜P^{0.8}*T^{-0.5} mostly at the end of compression, i.e., at an already increased compression temperature. This may be advantageous as the thermodynamic efficiency of such a re-flow is defined by the temperature of the thermal energy receiving gas.

A: Thermal Isolation by Insulation

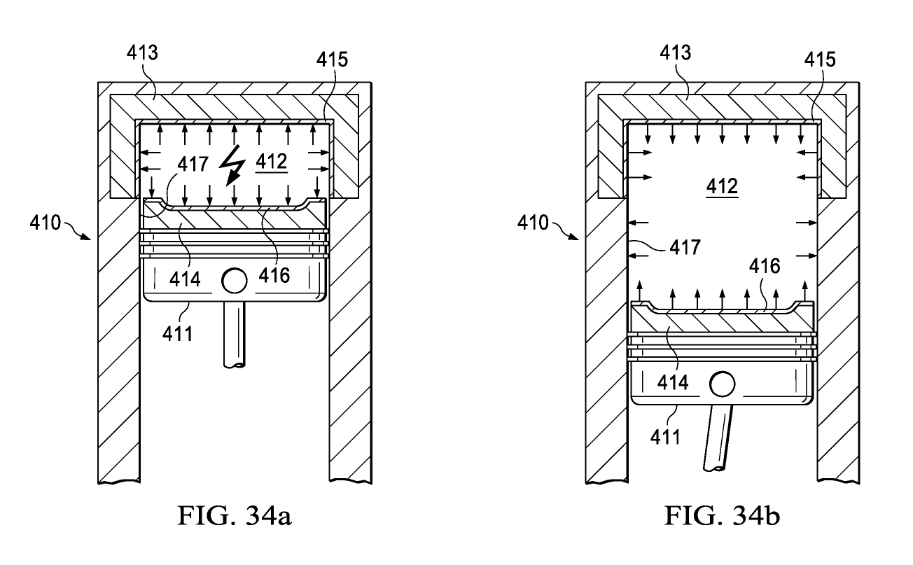

FIG. 34a and FIG. 34b are schematic diagrams of a cylinder and piston with a thermally-isolated combustion space for minimizing the cooling losses, according to a first embodiment. FIG. 34a shows the piston 411 position near its top-dead-center position within the cylinder 410 when combustion occurs. The combustion space 412 is enclosed by insulation 413 and 414, such as a ceramic, on both cylinder 410 and the piston 411. The cylinder insulation 413 and the piston insulation 414 are present only in the space that surrounds the combustion space when the piston 411 is at top-dead-center. Due to the vastly increased working gas temperature at the end of combustion, thermal energy attempts to transfer to the surface of the combustion space. This is indicated by the small arrows in FIG. 34a. Due to the fact that the insulation by its very nature is non-conductive, only a thin surface layer 415 of the cylinder insulation 413 and a thin surface layer 416 of the piston insulation 414 may be affected by the temperature changes of the working gas. By providing an insulation layer at the position shown, a majority of the thermal transfer from the hot working gas to the piston 411 and cylinder 410 may be prevented, and a thermal transfer to the insulating surface layers 415 and 416 may occur. The isolation layers may act as quickly responding short-time thermal reserves, which receive and supply thermal energy from and to the working gas, respectively, depending on the actual progress of expansion.

FIG. 34b shows that as the piston 411 moves down, it exposes the surface 417 of the cylinder 410 which is not coated by insulation. Here, the piston may move directly on the surface and lubrication may be required. Lubricants are usually not very temperature-stable beyond approximately 250° C., and, hence, this surface 417 might require cooling. However, only a small amount of thermal energy may be transferred from the hot working gas to the cooling medium (not shown) through the surface 417. In some illustrative embodiments, 80% or more of the thermal energy lost by the hot working gas may be transferred only to the surface layers 415 and 416.

The expansion continues as the piston moves downward, and the working gas reaches a temperature below the surface temperature of the layers 415 and 416. At this point, the insulating surfaces 415 and 416 start to heat the working gas. This is indicated by the small arrows in FIG. 34b emanating from the surfaces 415 and 416 into the combustion space 412. The much smaller flow of thermal energy from the still hot working gas to the cooled surfaces 417 is maintained and this small loss still goes on as shown in FIG. 34b.

Also, in the course of working gas discharge during the exhaust stroke and in the course of the intake stroke, in the case of four-stroke engines, or the combined exhaust-intake in 2-stroke engines, the insulating surfaces 415 and 416 transfer a significant amount of thermal energy to the working gas.

The only thermal energy that may not be recovered is the loss through the cooled surfaces 417 and the loss through the imperfect insulations 413 and 414. The major part of the thermal energy transferred to the insulating surface layers 415 and 416 in the course of combustion and in the beginning of the expansion stroke is re-transferred to the working gas which leaves the cylinder 410 in the course of the gas exchange cycle. In some embodiments, up to 80% of the thermal energy may be re-transferred in this manner. As such this thermal energy is available, for use in, for example, a subsequent expansion turbine, a waste heat recovery engine, or a heat exchanger. By adapting the cycle parameters accordingly the increased temperatures may be used as described elsewhere herein.

B: Metallic Layer on Insulation

The insulations 413 and 414 in FIG. 34a and 34b may show increased temperatures. However, the insulating surface layers 415 and 416 may have fluctuating temperature synchronously-related to the piston revolutions. In other words, the surface layers 415 and 416 may show a significant and quickly changing temperature fluctuation. It may be advantageous, therefore, to form these surface layers 415 and 416 from a highly temperature resistant, but nevertheless temperature flexible material appropriate for such quick temperature changes. For example, tungsten or another metal may be used. Some thin metal layers show a high thermal transfer coefficient. As the isolating effect is produced by the insulations 413 and 414, no additional thermal energy loss may occur by such a compound material. In some embodiments, the metal layer may be between 0.1 and 1 mm, to buffer the quick temperature changes on the first surface facing the combustion space and to transform them into a temperature-constant level on the second surface facing the insulation. It will, however, be appreciated that such a metal layer may have any suitable thickness.

C: Internal Effusion Isolation

Instead of transferring combustion thermal energy to the surface of the combustion space and then re-transferring the thermal energy from the heated surface back to the working gas, it may be advantageous to minimize a thermal energy transfer to the surface of the combustion space altogether.

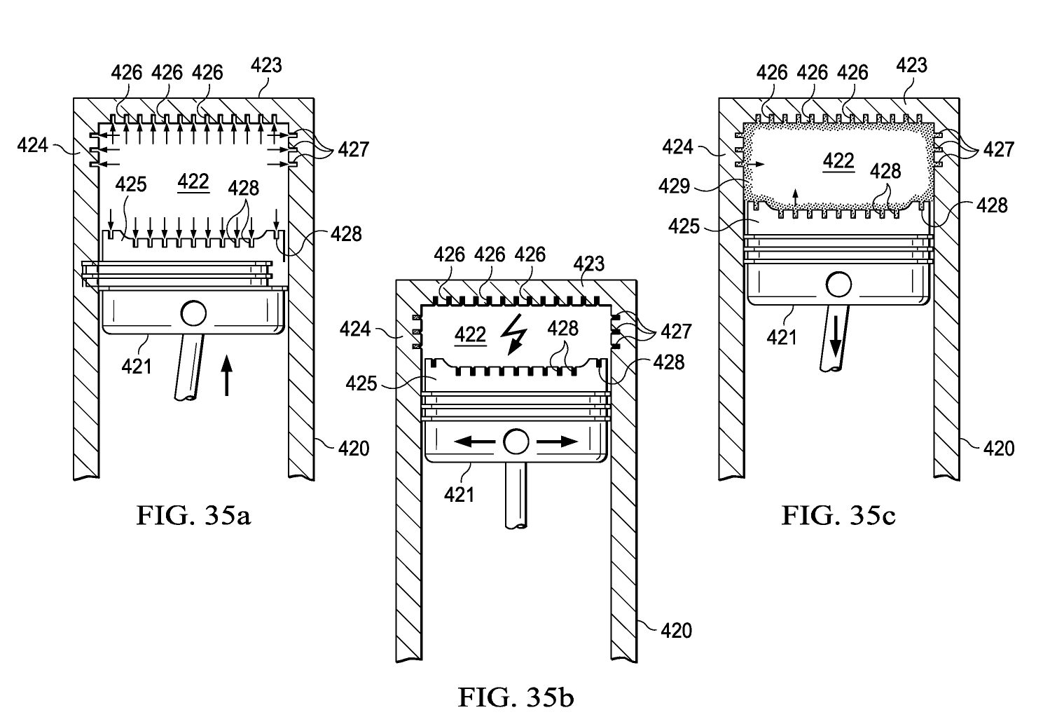

FIGS. 35a to FIG. 35c are schematic diagrams of a cylinder and piston with an internally operated effusion-isolated combustion space for minimizing the cooling losses, according to a second embodiment. A piston 421 reciprocates within a cylinder 420 to form a piston engine. The compression, combustion, and expansion space 422 is partially limited by the cylinder head 423, the combustion ring area 424, and the piston top 425. Within these surfaces small cavities 426, 427, and 428, respectively, are formed.

In FIG. 35a, the piston 421 moves up in the course of the compression stroke, and the compressed working gas at the same pressure as in the combustion space, begins to fill these cavities 426, 427 and 428.

As shown in FIG. 35b, the cavities are filled with compressed working gas when the piston 421 has reached its top-dead-center position. Fuel is injected and combustion starts. The injection and combustion process is controlled in such a manner that although the temperature rises because fuel combustion, the pressure starts to lower as soon as the piston 421 moves down and begins its expansion stroke. The combustion process, therefore, is carried out in a substantially sub-isobaric manner where the pressure decreases because of expansion is faster than the pressure increase due to fuel combustion.

As shown in FIG. 35c, because the pressure of the working gas in the space 422 is lower than pressure of the gas in the cavities 426, 427, and 428, and because the temperature of the working gas is higher than the gas in the cavities 426, 427, and 428, the compressed working gas flows out of the cavities 426, 427 and 428. This effusion may produce a gas isolation layer 429 covering the surfaces cylinder head 423, the combustion ring area 424, and the piston top 425. The isolation layer 429 inhibits direct contact between the hot combustion gases in the space 422, and the surfaces of the cylinder head 423, the combustion ring area 424, and the piston top 425. Therefore, only a minor thermal loss occurs due to radiation. Furthermore, in some embodiments, the surfaces may be externally cooled, but cooling losses may be largely reduced without the need for external cooling.

D: External Effusion Isolation

Instead of using the piston to fill the cavities with pressurized working gas in the course of compression, as described above, an externally operated device may be used. This may be helpful in cases when combustion occurs quickly, as is the case in gas engines, and the pressure of the working gas rises to the point where gases in the pockets may not flow out quickly enough to provide an isolation layer.

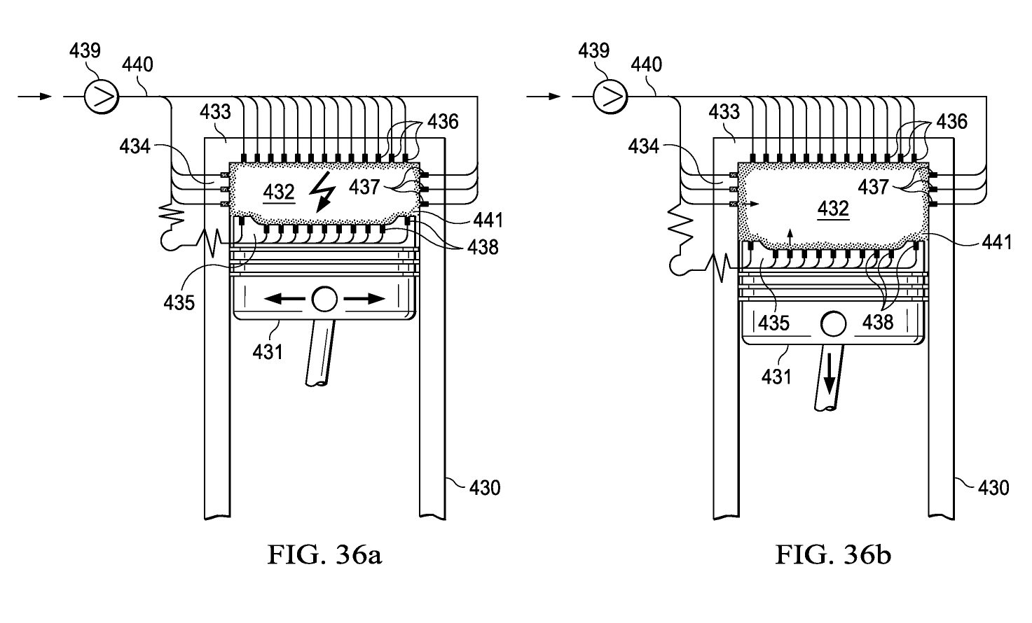

FIG. 36a and FIG. 36b show an embodiment with an externally operated effusion-isolated combustion space. FIG. 36a shows a piston 431 reciprocating within a cylinder 430 forming a piston engine. The compression, combustion, and expansion space 432 is partially limited by the surfaces of the cylinder head 433, combustion ring area 434, and piston top 435. Within these surfaces small nozzles 436, 437 and 438, respectively, are formed. When the piston 431 has reached its top-dead-center position, fuel is burnt. During combustion of the fuel, an external high pressure pump 439 produces sufficiently pressurized air, or another appropriate gas, and provides it in a controlled manner through the pipe 440 to the nozzles 436, 437 and 438, such that an insulating gas layer 441 is formed. Because the pressure of the compressed air provided by the high-pressure pump 439 may be adjusted as required, no restrictions apply to the combustion process.

FIG. 36b shows that the isolating gas layer 441 inhibits a direct contact between the hot combustion gases in the space 432 and surfaces of the cylinder head 433, combustion ring area 434, and piston top 435. Hence, only a minor thermal loss may occur due to radiation. The surfaces may still be cooled, but cooling losses may be largely reduced. This is because, as described above, the major part of thermal transfer from the hot working gas upon combustion may occur while the piston is at or near its top-dead-center position.

Instead of air, or another appropriate gas, water or another appropriate vaporizable liquid may be used. In the illustrative embodiment, a high-pressure pump 439 provides a small amount of water through the pipe 440 to the nozzles 436, 437 and 438. The combustion process causes the droplets to vaporize and the produced steam isolates the combustion space surface from the hot combustion gases.

In all of the above described embodiments, it is possible to isolate only one or part of the described surfaces. It is also possible to combine a ceramic or ceramic and metal insulation, as described with reference to FIGS. 34a and 34b, with effusion isolation as described with reference to FIGS. 35a to 36b. As the externally operated embodiment according to FIGS. 36a and 36b may be more complicated, especially in case of the piston 431, in some embodiments, the nozzles may only be implemented on the non-movable parts, i.e., the cylinder head 433 and combustion ring 434, while still obtaining sufficient benefits.

V: Waste Heat Recovery Piston Engine

Compact arrangements are often preferred in medium-sized engines like those used in cars, trucks, boats, or small stationary engines because of space or economic restrictions. Therefore, it may be advantageous to integrate a waste heat recovery device into the piston engine itself.

Various heat recovery devices have previously been proposed for mobile or semi-mobile applications. These previously proposed heat recovery devices typically use a heat exchanger or vaporizer which is heated by the hot exhaust gas to heat and vaporize a liquid. In most cases, a hydrocarbon, or something similar, is used because of its higher steam pressure at ambient temperature, which defines the expansion volume and, hence, the size of this additional engine. From a mechanical point of view, it is difficult to integrate such a steam engine into the same motor block as the engine producing the exhaust heat. Also, the vaporization occurs at a temperature substantially below the exhaust gas temperature, which is not optimal. Finally, most of the liquids employed are inflammable or hazardous to the environment.

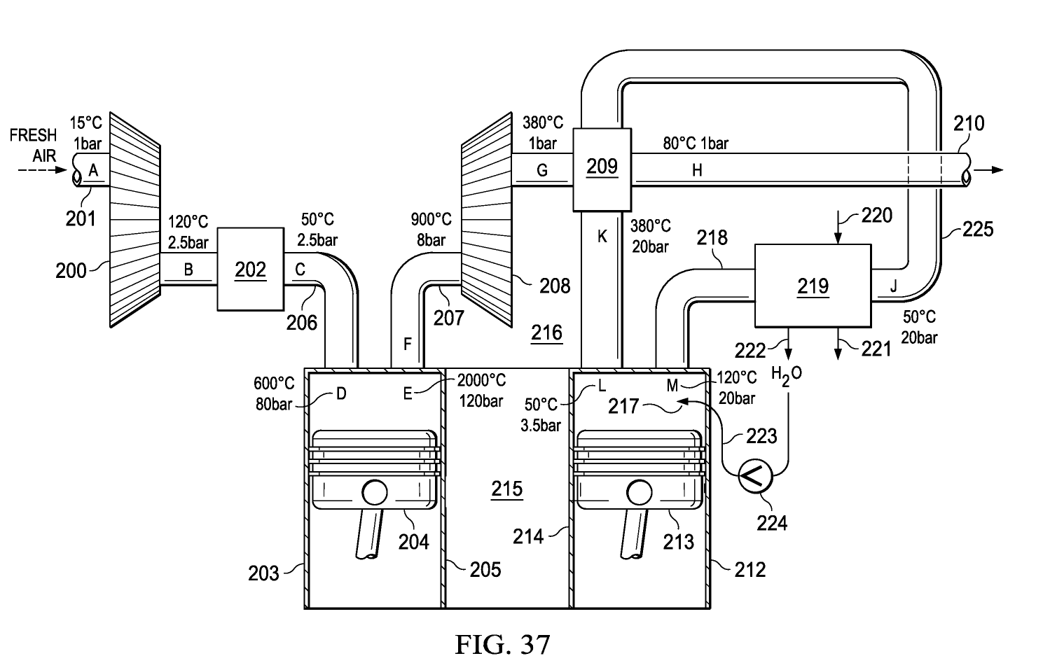

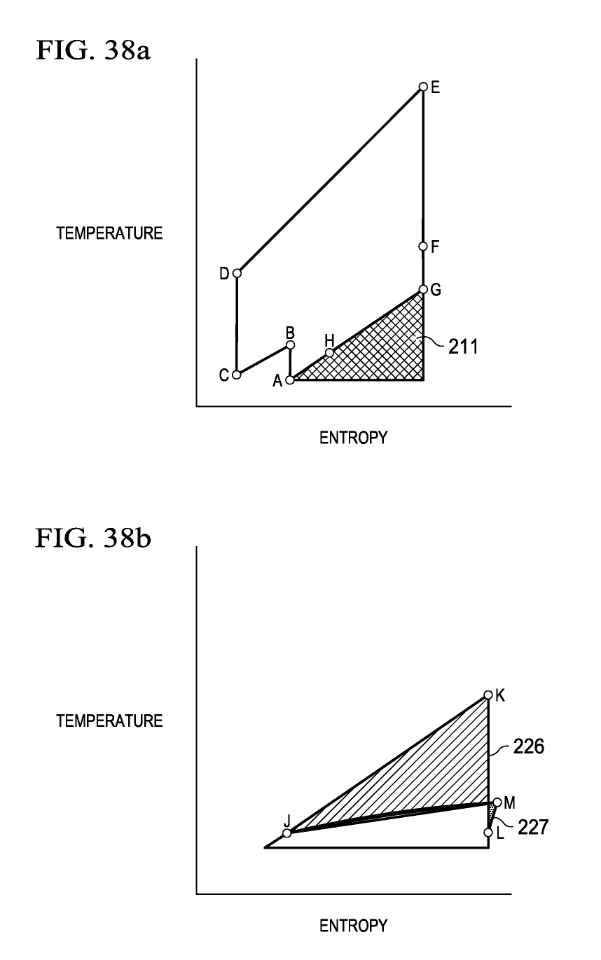

FIG. 37 is a schematic diagram of an engine system having both a main four-stroke piston engine and a 2-stroke waste heat recovery piston engine which uses a closed loop compressed working gas, according to one embodiment. FIG. 38a-38b is a schematic diagram of an engine system having thermodynamic processes of the engines in the embodiment of FIG. 37. FIG. 38a shows the thermodynamic process carried out by the main four-stroke piston engine of the embodiment of FIG. 37. FIG. 38b shows the thermodynamic process performed by the 2-stroke waste heat recovery piston engine of the embodiment of FIG. 37. These figures will be discussed in conjunction with one another. The forthcoming values for temperature and pressure are for illustrative purposes and are not limiting in any way.

In FIG. 37 the compressor turbine 200 aspires fresh air or an air-fuel mixture (state “A” in FIG. 38a) through the inlet 201 and compresses it in an adiabatic manner to approximately 2.5 bar, resulting in a compression end temperature of around 120° C. (state “B” in FIG. 38a). The inter-cooler 202 cools the compressed air down to approximately 50° C. while maintaining its pressure at approximately 2.5 bar (state “C” in FIG. 38a). Afterwards, the main piston engine 203, which comprises at least one piston 204 in at least one cylinder 205, aspires the cooled and pressurized air through its intake pipe 206 and carries out a typical operation of a four-stroke gas engine. The main piston engine 203 first compresses the air to approximately 80 bar, resulting in a compression end temperature of around approximately 600° C. (state “D” in FIG. 38a), then ignites the fuel to start combustion which increases, both the pressure and temperature of approximately 120 bar and approximately 2200° C., respectively (state “E” in FIG. 38a), and finally expands the hot working gas to approximately 900° C. and approximately 8 bar (state “F” in FIG. 38a). The discharge valve (not shown) opens and the hot and still pressurized exhaust gas is discharged into exhaust pipe 207.

The expansion turbine 208 aspires the hot exhaust gas and expands it to ambient pressure, resulting in a temperature of around 380° C. (state “G” in FIG. 38a). As the exhaust gas is still hot and carries a significant amount of useful thermal energy, it is cooled in the heat exchanger 209 down to approximately 80° C. (state “H” in FIG. 38a) before it is discharged into the environment through the exhaust 210. Typically, the expansion turbine 208 drives the compressor turbine 200. In case this expansion turbine 208 delivers more power than is required by the compressor turbine 200, the surplus power may be coupled to the crankshaft of the main piston engine 203 or may be used, for example, to drive an additional generator, or any other suitable device.

The hatched area 211 in the theoretical S-T diagram of FIG. 38a indicates the mechanical power which may still be extracted from the hot exhaust gas after the expansion turbine 208. In case of a non-turbo-charged, i.e., naturally aspired, piston engine, or in case no intercooler 202 is used or the temperature of the environment is very high, the hatched area may increase indicating potential increased importance of such a waste heat recovery means.

In some embodiments, the waste heat recovery means is a waste heat recovery engine 212 comprising at least one piston 213 reciprocating in at least one cylinder 214 as shown in FIG. 37. This waste heat recovery means is formed together with the main piston engine 203 within the same integrated engine 215. Piston 213 and cylinder 214 of the waste heat recovery means may be of identical dimensions and mass and run synchronically with the other pistons 204 and cylinders 205. This means that the main four-stroke piston engine and the waste heat recovery means may form one single integrated engine 215.

In the embodiment of FIG. 37, the waste heat recovery means uses pressurized argon as working gas in a closed and sealed cycle. Any other suitable gas may be employed, such as, for example, nitrogen or even air. A noble gas, argon, presents several advantages, no corrosion occurs and because of the high isentropic exponent (1.66 for argon as compared to 1.4 for air or nitrogen) a lower compression and expansion rate is required to produce the required temperature changes. The pressurized argon at a temperature of approximately 50° C. and a pressure of approximately 20 bar (state “J” in FIG. 38b) passes through the heat exchanger 209 and is heated to approximately 380° C. (state “K” in FIG. 38b). The waste heat recovery engine 212 aspires the pressurized and heated argon through its intake pipe 216. As soon as the piston 213 has aspired enough argon, the intake valve (not shown) closes and expansion starts. When the piston 213 reaches its bottom-dead-center position the argon has been expanded to a pressure of approximately 3.5 bar and a temperature of 50° C. (state “L” in FIG. 38b). Now the piston starts to compress the argon again but under continuous injection of water through the nozzle 217. In the course of this water-injected compression both pressure and temperature rise. The temperature increase caused by this compression (state change L-M in FIG. 38b), is much less than has been the temperature decrease by an adiabatic expansion (state change K-L in FIG. 38b). As soon as compression has completed (state “M” in FIG. 38b) the discharge valve (not shown) opens and discharges the compressed and humid argon into the exhaust pipe 218 which supplies the argon to the cooler-condenser 219. In this cooler-condenser 219, the warm and humid argon is cooled down and the water which has been injected and vaporized in the course of compression (state change L-M in FIG. 38b), is condensed and removed through the outlet 222. A cooling medium, such as water or ambient air, enters through the inlet 220, cools the argon and condenses the steam and then leaves through the outlet 222.

The condensed water is re-circulated in a closed loop through the pipe 223 by means of the feed pump 224 to the injection nozzle 217. The cooled and dried argon leaves the cooler-condenser at a temperature of approximately 50° C. and a pressure of approximately 20 bar and is fed again to the heat exchanger 209 through the pipe 225 for heating to close the cycle.

The hatched area 226 in FIG. 38b minus the hatched area 227 indicates the mechanical power delivered by the waste heat recovery engine 212. The hatched area 227 appears because the compression with fast vaporization is not completely reversible and, hence, entropy rises. As the dew point of the vaporized water is above ambient temperature, the non-hatched area below the condensation-cooling line M-J cannot be converted into mechanical power. Using a vaporizable liquid with higher saturation pressure and, thus, higher molar density at a given temperature, moves this line downward and the delivered power and efficiency increase. Water may be chosen for the vaporizable liquid because it is cheap, non-inflammable and innocuous for the environment.

Depending on the thermal load presented by the heat exchanger 209 and by the load of the main piston engine 203, the base pressure may be varied accordingly so that even at the constant displacement of the waste heat recovery engine 212, this engine can be controlled just to process the presented thermal load. For example, under full-load with full waste heat production, the base pressure of the recovery engine 212 may be at 3.5 bar and the maximum pressure at 20 bar. If the produced waste heat from the main piston engine 203 is 50 kW, then the required mass flow of the recovery engine working gas is around 0.320 kg/s. Both the main piston engine 203 and the recovery engine 212 may rotate with 3000 rpm. As the recovery engine 212 operates as 2-stroke engine, a volume flow of 0,061 m3/=61 dm³/s may be employed, equivalent to a displacement of 1.2 dm³. The power produced by such a recovery engine is approximately 10 to 13 kW, i.e., 20% to 25% of the main engine, a comparable specific power kW/dm³. In other words, the additional mechanical overhead of the recovery engine is basically in proportion to the additional power produced by the overall engine (main combustion engine 203 plus recovery engine 212). The recovery engine displacement is generally fixed. Consequently, the volume flow at 3000 rpm is generally fixed to be 61 dm³/s. If the load of the engine now decreases to 30%, the waste heat also decreases to a value of approximately 30% i.e. 15 kW. Consequently, the mass flow of the working gas may also decrease to approximately 30%. But as the displacement and for a given rpm, the volume flow are fixed, the only way to reduce the mass flow is to reduce the working gas pressure to approximately 1 bar. As a result, the maximum pressure of the cycle drops from 20 bar to 6 bar. If the waste heat load increases again, the base pressure is accordingly increased by a pressure modification device. Devices to set-up these pressures may include, among other things, a pressure reserve tank for the unused working gas, controllable valves, and a control means (e.g., controller). An auxiliary compressor to re-increase the base pressure may be employed. It may also be possible to use the recovery engine itself instead.

It should be noted that the waste recovery means may operate in a similar manner with any main piston engine arrangement. It is also possible to separate the waste heat recovery means from the piston engine and to operate it separately.

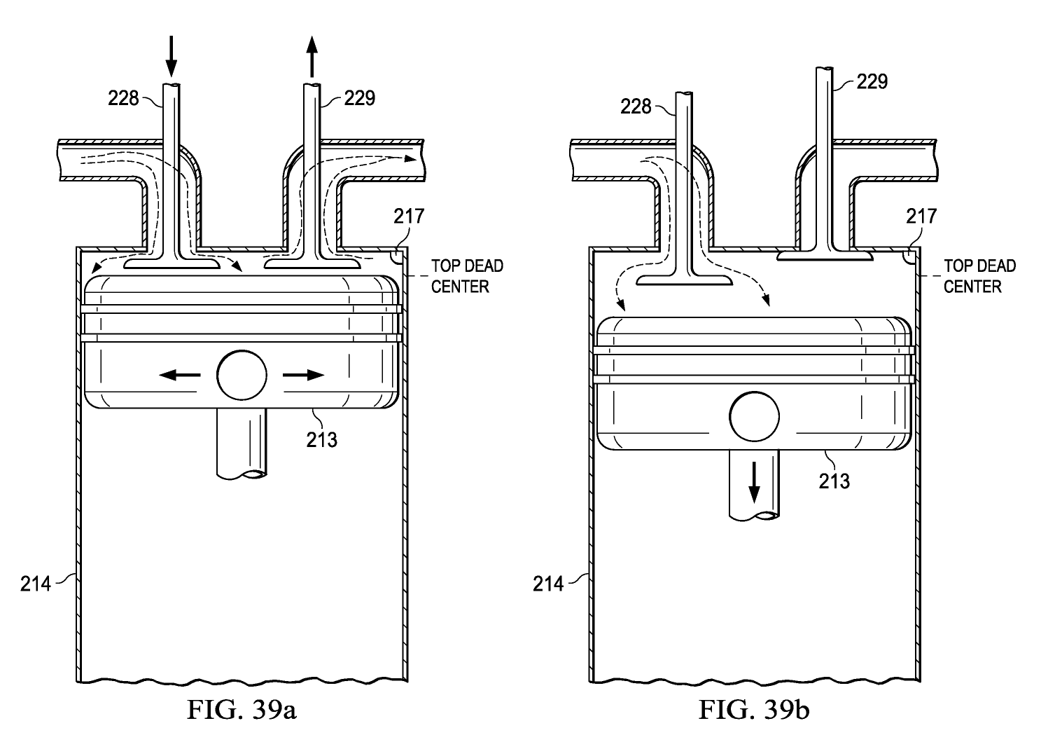

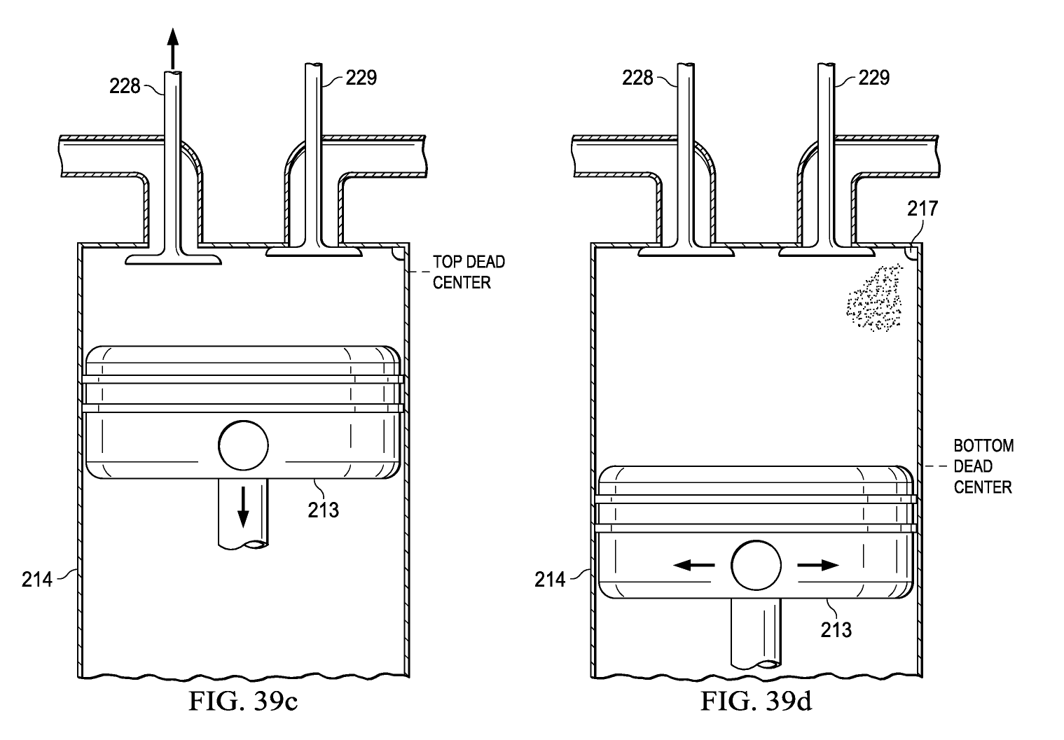

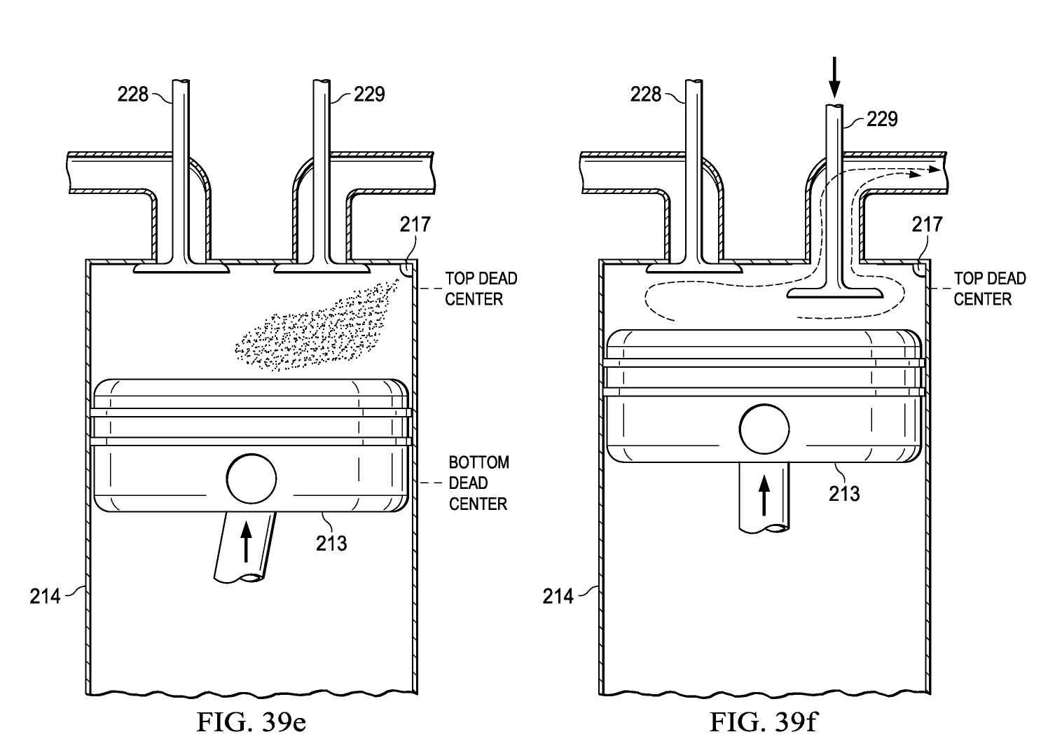

FIGS. 39a to 39f are schematic diagrams of the valve timing of the 2-stroke waste heat recovery engine shown in FIG. 37 in a more detailed manner. When the piston 213 is located at its top-dead-center position within the cylinder 214, the intake valve 228 starts to open while the discharge valve 229 closes completely (FIG. 39a). The piston 213 moves down and the intake valve 228 opens completely to allow the intake of pressurized and hot argon, or other gas (FIG. 39b). As soon as the piston 213 has aspired sufficient argon or other gas into the cylinder 214, the intake valve 228 closes and isentropic expansion begins (FIG. 39c) by the ongoing downward movement of the piston 213. As shown in FIG. 39d, when the piston 213 reaches the bottom-dead-center position, the nozzle 217 starts to inject water as tiny droplets. The piston 213 moves upward to compress the argon while the nozzle 217 goes on injecting water (FIG. 39e). As shown in FIG. 39f, when the compression stroke has completed, the discharge valve 229 starts to open and the piston 213 displaces the compressed and humid argon through the discharge valve 229 until the piston 213 reaches its top-dead-center position, then the discharge valves close and the cycle starts again according to FIG. 34a.

Because the base pressure of the working gas in the waste heat recovery engine 212 of FIG. 37 may be significantly above ambient pressure, and because the waste heat recovery engine 212 performs as a 2-stroke engine, the power delivered is relatively high. This means that, in some embodiments, the waste heat recovery engine 212 may use only one piston and cylinder of the integrated piston engine 215. For large cylinder numbers (e.g., 8 and more) a total of 2 or more pistons and cylinders may be advantageous for waste heat recovery. The waste heat recovery engine produces power at a power density comparable to the main piston engine. As the efficiency increases, power loss may be decreased and a power increase may be achieved.

The present embodiment may be adapted to work with a non-turbo-charged engine. In the case, of a naturally aspired engine, the complete charge system comprising compressor turbine 200, intercooler 202 and expansion turbine 208 shown in FIG. 37 is not provided. This means that the exhaust gas temperature of a naturally aspired engine may be higher than a turbo-charged engine because inter-cooling by the compressor turbine 200 and by the piston 204 is eliminated. Correspondingly, the temperature of the exhaust gas entering the cooler-condenser 219 may be increased and the waste heat recovery engine 212 may be adapted accordingly. This usually means a higher expansion-compression rate performed in said engine (state changes K-L and L-M, of FIG. 38b respectively).

The waste heat recovery engine 212 of FIG. 37 may also be adapted to run in part-load. In part-load, the compression performed by the compressor turbine 200 of the turbo-charged system decreases and the thermal energy transferred from the inter-cooler 202 to the environment may be lower. In other words, the turbo-charged piston engine in part-load may behave more like a naturally aspired engine. The efficiency decreases and the exhaust gas temperature rises. This may be addressed by changing the base pressure of the waste heat recovery engine 212 and/or by adapting the timing of the intake valve.

The waste heat recovery engine may also use a vaporizable fluid other than water. For example, Methanol, Butane, or a partially oxidized hydrocarbon may be employed. By using a vaporizable liquid with a higher saturation pressure than water, lower temperatures at the end of the compression cycle with liquid injection (state “M” in FIG. 38b) may be reached. This increases the efficiency of the thermodynamic cycle carried out by the engine described with reference to FIG. 37. Since the system is closed and sealed, very little fluid will escape into the environment.

In the case of the cycle carried out by the waste recovery engine 212 according to FIG. 38b, the expansion of the working gas (state change K-L in FIG. 38b) ends near dew point of the steam contained in the argon gas. The subsequent compression with water injection, therefore, starts at or very close to, a point of thermodynamic equilibrium. Preferably, the compression would be carried out along the condensation line and maintain this equilibrium towards a high efficiency. At least in case of fast running piston engines, this may be difficult to perform as it typically requires a sufficient steam pressure difference between the saturation pressure at the corresponding argon temperature and the actual steam pressure. Due to the compression (state change L-M in FIG. 38b), the temperature and the saturation pressure may change rapidly in fast running engines.

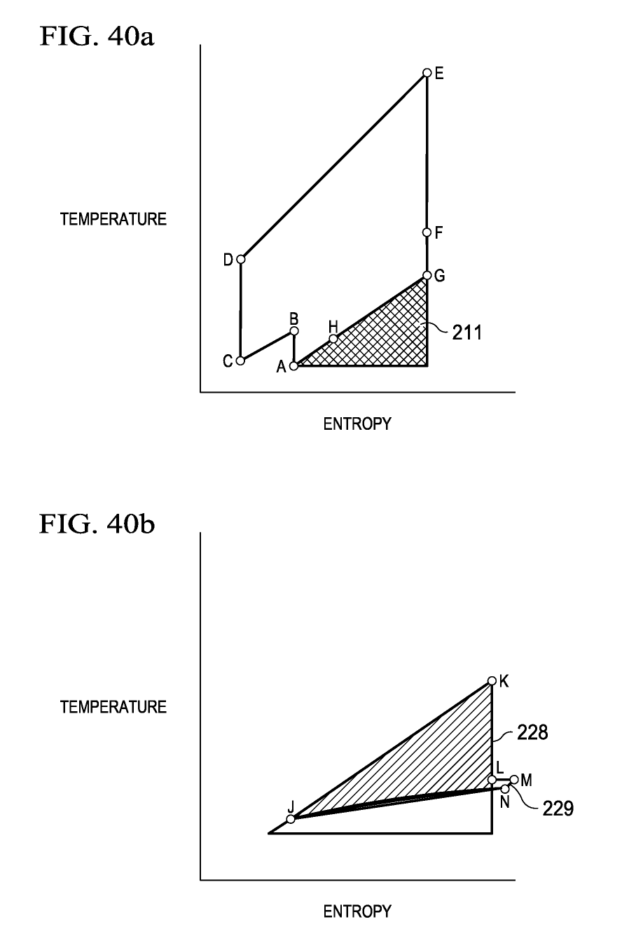

FIG. 40b shows another illustrative cycle performed by the waste heat recovery engine 212 of FIG. 37 where the expansion ends at a temperature near the dew point of steam after a subsequent compression, i.e., the compression hits the condensation line (state L in FIG. 40b). This means that the expansion ratio may be smaller, leading to more compact engines, and that the water injection and vaporization may start with warm and dry argon. This is a state away from the thermodynamic equilibrium, which is somewhat penalized with an entropy increase (state change L-M in FIG. 40b). However, this ensures a quick vaporization of the water while maintaining the temperature. The waste heat recovery engine which carries out this cycle may be the same as shown in FIG. 37. Additionally, the cycle carried out by the main piston engine may be the same as shown in FIG. 37; consequently, the main engine's cycle in FIG. 40a may be substantially similar to that shown in FIG. 38a.

First, the pressurized but dry argon may be heated in the heat exchanger 209 to a temperature of approximately 380° C. while maintaining its pressure at approximately 20 bar (state change J-K in FIG. 40b). Subsequently, the waste recovery engine 212 of FIG. 37 may expand the dry argon down to a temperature of approximately 120° C. and a corresponding pressure of approximately 5.6 bar. The saturation may be below 10%, i.e., the actual steam pressure is below 10% of the saturation pressure at approximately 120° C. The piston 213 starts to re-compress the expanded, dry argon and simultaneously the nozzle 217 may start to inject water. As the argon is relatively warm and dry, the injected water droplets may vaporize immediately. The temperature may remain constant, but the entropy may rise (state change L-M in FIG. 40b). At the end of compression the argon may be compressed to approximately 20 bar again and nearly saturated with steam (state “M” in FIG. 40b). The discharge valve opens and the piston 213 discharges the argon into the pipe 218 which supplies it to the cooler-condenser 219. Here, the humid argon may be first cooled down until the dew point is reached (state change M-N in FIG. 40b). Then condensation may start and the vaporized water is condensed and removed before the dried argon is supplied to the heat exchanger 209 for re-heating.

The thermodynamic cycle described with reference to FIG. 38b may require an isentropic volume expansion ratio of around 3:1 to expand the argon from approximately 380° C./20 bar down to approximately 50° C./3.5 bar. However, in case of the cycle described with reference to FIG. 40b, a volume expansion ratio of 2.2:1 may be employed. Also, the compression ratios to achieve the initial pressure of 20 bar differ. e.g., 4.7:1 compared to 3.6:1.

To achieve a good compromise between the more efficient cycle according to FIG. 38b and the better vaporizing cycle according to FIG. 40b, an intermediate cycle may be carried out where the isentropic expansion reaches a temperature between the approximately 50° C. of the first cycle and the approximately 120° C. of the second cycle.

VI: Pre-Expansion with External Turbine

High pressures in the piston engine can cause wear or failure. Therefore, it may be desirable to lower the intake pressure of a piston engine, in both full and partly loaded states. If the intake temperature is kept sufficiently high, engine wear is reduced without penalizing the power, density, and efficiency of the engine.

A: Turbo-Charged Piston Engine with Pre-Intake Expansion Turbine and High Pressure Exhaust Collection Valve Timing

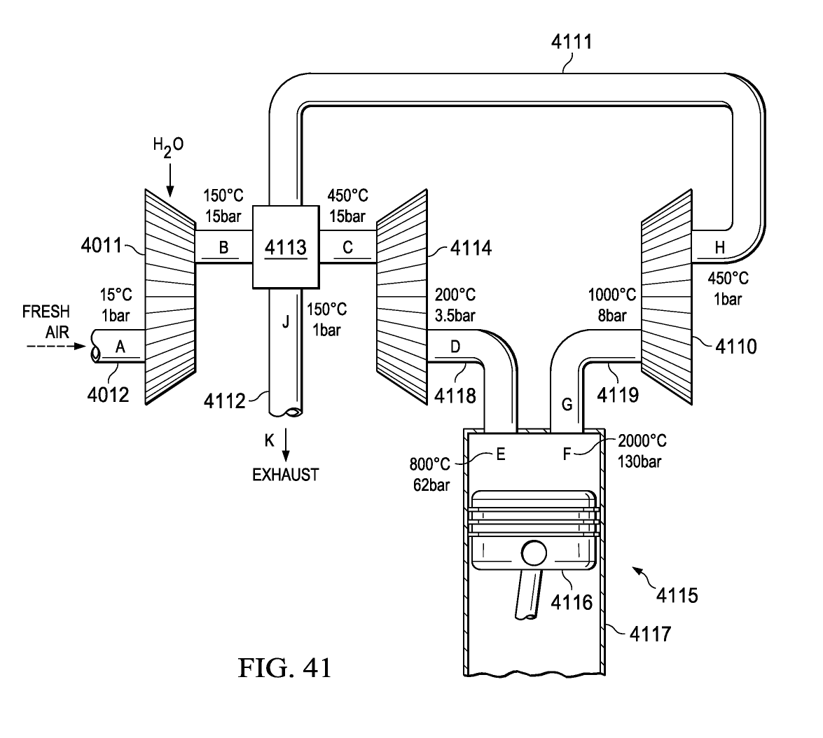

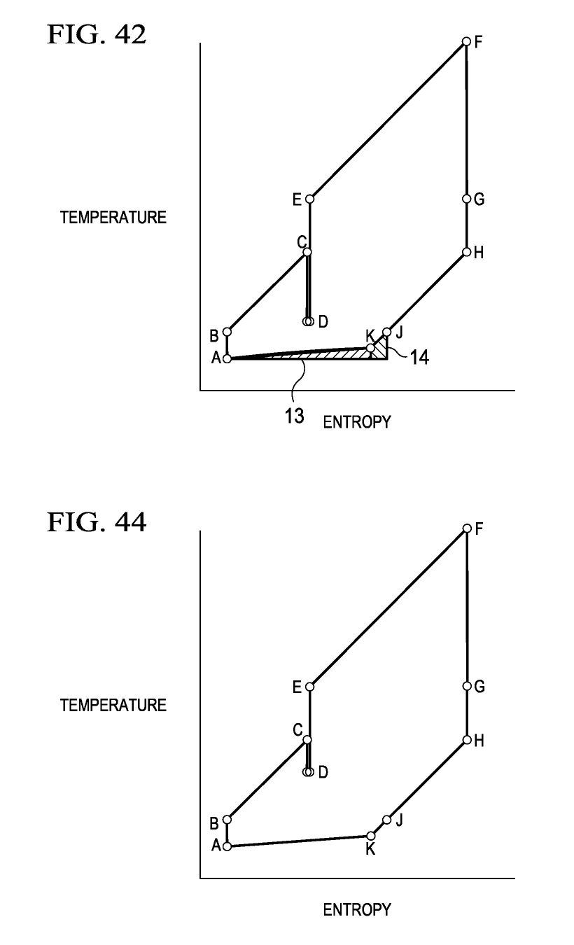

FIG. 41 is a schematic diagram of a turbo-charged four-stroke piston engine with a pre-expansion turbine for pre-expanding an intake gas prior to entering a piston engine cylinder, and FIG. 42 shows the thermodynamic process carried out by the engine of FIG. 41. These figures will be discussed in conjunction with one another. The forthcoming values for temperature and pressure are for illustrative purposes and are not limiting in any way.

In this embodiment, a compressor turbine 4011 aspires fresh air through an inlet 4012 and compresses it. The compressor turbine 4011 may use vaporization of water to cool the compressed air. The compressed air then passes through a recuperator 4113 where it is heated by an exhaust flow. Then, the heated air passes through an expansion turbine 4114 where both its temperature and pressure are reduced. The warm air passes through an intake pipe 4118 and into a piston engine 4115, e.g., a four-stroke piston engine, comprising a piston 4116 reciprocating within the cylinder 4117, where it is combusted and then exhausted through an exhaust pipe 4119. The exhaust pipe 4119 may be at a higher pressure than the intake pipe 4118. Consequently, the valve timing may be set in such a manner that no major throttling takes place. The details of this valve timing are described above in the valve timing section of this specification. The exhaust is expanded in a second expansion turbine 4110. Excess energy from the expansion turbines 4114 and 4110 may be used to run an electrical generator or other suitable device or devices. The expanded air passes through a pipe 4111 to the recuperator 4113, where it is cooled. The air is then exhausted through an exhaust 4112.

This process can be illustrated by the following detailed example. The compressor turbine 4011 aspires fresh air with a temperature of approximately 15° C. and ambient pressure of approximately 1 bar (state point “A” in FIG. 42) through the inlet 4012 and compresses it under continuous supply and vaporization of water to approximately 150° C. and approximately 15 bar (state point “B” in FIG. 42). This compression is basically an isentropic state change as no external heat is supplied or extracted. Hence, the line A-B in FIG. 42, which indicates this state change, is a straight line in parallel to the temperature axis.

The compressed air-steam mixture passes through the recuperator 4113 where it is heated to approximately 450° C. while maintaining its pressure at approximately 15 bar (state “C” in FIG. 42). The expansion turbine 4114 then expands the heated air-steam mixture in an isentropic manner to approximately 200° C. and approximately 3.5 bar (state “D” in FIG. 42). No external thermal energy is provided or extracted, hence the isentropic expansion.

The piston engine 4115, which comprises a piston 4116 reciprocating within the cylinder 4117, first aspires the expanded air-steam mixture through an intake pipe 4118. In one embodiment, no mechanical or other losses occur at the end of this intake stroke and the aspired air-steam mixture is still located at the same point “D” in the theoretical S-T diagram of FIG. 42. A simple displacement has occurred from the expansion turbine through the intake pipe into the cylinder 4117. It would be appreciated that neither the compression or expansion or displacement carried out is ideal, but accompanied by some losses and entropy increase. However, these are neglected in this example.

As the piston 4116 moves up, it compresses the aspired air-steam mixture to reach a temperature of approximately 800° C. and a pressure of approximately 62 bar. Combustion of the fuel causes both temperature and pressure of the combusted product rise to approximately 2000° C. and 130 bar, respectively (state point “F” in FIG. 42).

The piston 4116 moves down to expand the hot working gas to a temperature of approximately 1000° C. and a pressure of approximately 8 bar at its bottom-dead-center position (state point “G” in FIG. 42). The discharge valve (not shown) opens and the hot working gas leaves the cylinder 4117 through the exhaust pipe 4119. As described earlier, in one embodiment, the valve timing is set in such a manner that a substantial displacement of the hot and still pressurized exhaust gas into the exhaust pipe 4119 occurs and no significant throttling takes place. The second expansion turbine 4110 expands the exhaust gas further to ambient pressure of approximately 1 bar and a corresponding temperature of approximately 450° C. (state point “H” in FIG. 42).

The lower pressure hot exhaust gas is channelled through the pipe 4111 to the recuperator 4113 to heat the aspired and compressed air-steam mixture from the compressor turbine 4011. Consequently, the gas cools down to approximately 150° C. at an ambient pressure of approximately 1 bar (state point “J” in FIG. 42). Finally, the cooled exhaust gas is discharged into the environment through the exhaust 4112. By mixing with ambient air, the exhaust gas first cools down until it reaches the dew point of the steam (state point “K”) according to the amount of injected water in the compressor turbine 4011. By condensing the steam in ambient air, a large amount of thermal energy is liberated while the temperature decrease is comparably small. This happens because the condensing energy of steam is relatively high (e.g., over 2 MJ/kg) and condensation occurs at nearly constant temperature.

The amount of thermal energy which may be transferred to the environment at the lower temperature level according to Carnot's model of thermodynamic engines with higher and lower thermal reserves may be small and the temperature low. The major share of thermal energy transferred at the lower temperature level may be the condensation energy of the steam which condenses after expansion (state change K-A in FIG. 42).

FIG. 42 illustrates how close the described thermodynamic process carried out by the engine, described with reference to FIG. 41, is to the ideal thermodynamic engine. The hatched area 13 below the line A-K indicates the theoretical amount of mechanical energy which is lost by condensing the steam. As the compression end temperature (point “B” in FIG. 42) is above ambient temperature (point “A” in FIG. 42), the exhaust gas may not be cooled below this temperature (point “J” in FIG. 42) in the recuperator 4113. Consequently, an amount of mechanical work equivalent to the hatched area 14 below the line J-K may be lost by the described engine. Advantageously, the total of these areas remains very small in comparison to the area enclosed by the cycle process A-B-C-D-E-F-G-H-J-K-A and, consequently, the efficiency of this thermodynamic cycle is relatively high.

In one illustrative embodiment, the compression ratio of the above described piston engine is 8:1. The compression end temperature (“E”) is relatively high (e.g., 800° C.). The efficiency may also be relatively high. A compression ratio may become less important for the process efficiency as long as the compression end temperature is maintained at a relatively high level by pre-heating the already pre-compressed air with the help of the recuperator. Other important parameters include final combustion temperature (“F”) and dew point (“K”). In the illustrative embodiment, the engine may reach an efficiency of approximately 80%. Conventional engines using state-of-the-art components (compressor turbine, expansion turbine, piston engine) will reach an efficiency of approximately 50%.

The compressor turbine 4011 and one or both of the expansion turbines 4114 and 4110 may be mounted on the same shaft (not shown). It is also possible that an additional generator may be connected to use the power surplus usually generated by the coupled turbines. Alternatively, one or both expansion turbines may be coupled to the crankshaft of the piston engine to deliver the surplus power to the crankshaft and then to an external consumer.

In an alternative embodiment, two or more units with one compressor turbine 4011, one recuperator 4113, and one expansion turbine 4114 each, may be arranged in a serial manner. In such an embodiment, the expansion turbine of the unit supplies working gas to the inlet of the compressor of the successive unit. This embodiment allows the hot exhaust gas from the expansion turbine 4110 or from the piston engine 4115 to be captured and utilized.

A higher mass flow through the compressor turbine 4011 recuperator 4113, and expansion turbine 4114 may be required as compared to the mass flow through the piston engine 4115. Repeated compression, recuperation, and expansion may avoid this, and only a minor efficiency decrease may occur because the recuperator temperature may remain high. For example, for a turbo-charged piston engine with two units, an exhaust gas having a temperature of 900° C. may enter the first recuperator. This first recuperator may reduce the exhaust gas temperature down to 500° C., and then the successive second recuperator of the second unit may reduce it to 150° C.

If the exhaust gas temperature is very high, the recuperator may not be able to heat the fresh air to the same high temperature because of material limitations, etc. If, nearly all of the thermal energy provided by the exhaust gas could be captured and transferred to the fresh air, a higher air mass would be required. For example, if exhaust mass flow was 1 kg/s, the exhaust gas temperature was 900° C. and the maximum recuperator temperature was 500° C.; then a fresh air mass flow of 2 kg/s may be required to absorb all of the exhaust gas energy between 900° C. and 100° C. In the illustrative embodiment, the temperature difference in the exhaust stream is 800° C. (e.g., 900° C.−100° C.=800° C.) temperature difference in the intake stream is 400° (e.g., 500° C.−100° C.=400° C.), and therefore, twice the mass flow may be required. To avoid this, a two-fold compression-recuperation-expansion may be carried out. The first stage compresses air and lowers the exhaust temperature from 500° C. to 100° C. while raising the temperature from 100° C. after compression to 500° C. Then, expansion may occur. The subsequent second stage again compresses the same expanded air and lowers the exhaust stream from 900° C. to 500° C. while raising the temperature from 100° C. to 500° C. The theoretical thermodynamic efficiency of the exhaust gas when using the complete temperature difference of 800 K (900° C.→100° C.) may be approximately 59% of the thermal energy between 900° C. and 100° C. The efficiency of the two-fold design may be approximately 48%. This may be acceptable in view of the significantly lower costs of simple mid-temperature heat exchangers compared to the more expensive high-temperature heat exchangers.

In an alternative embodiment, a parallel design where the exhaust gas stream is split in two partial streams with a half mass each, the efficiency relation may be 59% as a maximum compared to the same 48%. The fresh air stream may be compressed and heated by the first partial exhaust stream to 500° C., then expanded, then re-compressed and heated by the second partial exhaust stream to 500° C. again before expanded a second time. Due to the higher temperature gradient in the recuperators between the exhaust and fresh air streams, the heat exchangers may be smaller in the this embodiment.

It may also be possible to arrange the units in parallel, whereby the exhaust gas flow is split and supplied separately at the same temperature to the various recuperators. However, in this embodiment, the flow of the fresh air or air-fuel mixture through the units maintains a serial character, i.e., the working gas leaving one unit will be supplied to the inlet of the successive unit. Only the exhaust gas flow is divided.

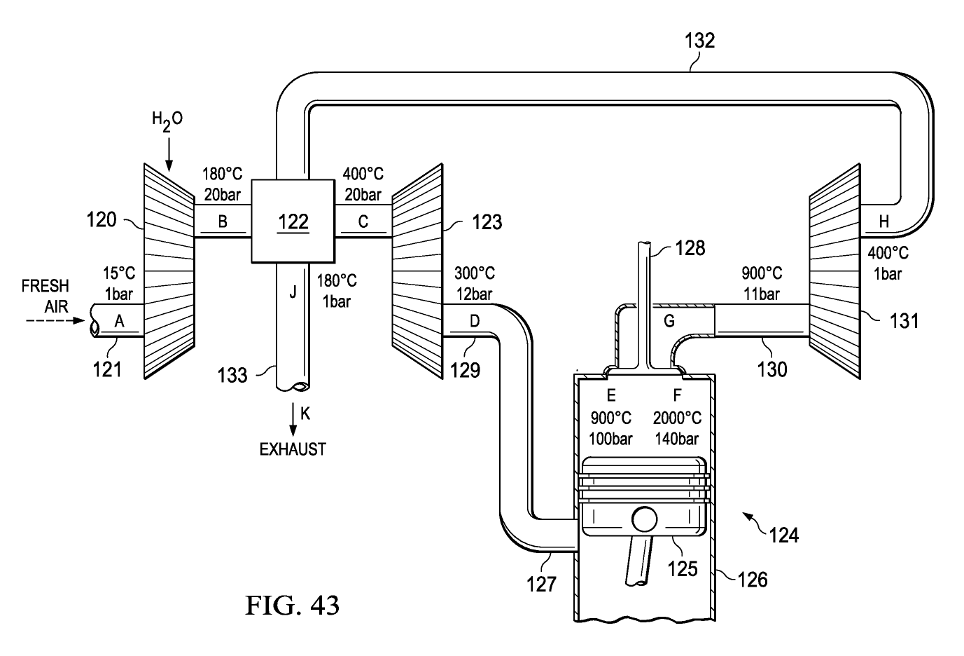

In another illustrative embodiment, a 2-stroke piston engine may be employed instead of a four-stroke piston engine. FIG. 43 is a schematic of a turbo-charged 2-stroke piston engine with a pre-expansion turbine. FIG. 44 is a theoretical S-T diagram of the thermodynamic process which is carried out by the piston engine of FIG. 43. The forthcoming values for temperature and pressure are for illustrative purposes and are not limiting in any way.

In the 2-stroke embodiment, the steps are carried substantially the same as described above for a four-stroke engine. A compressor turbine 120 aspires fresh air, through an inlet 121 and compresses it. The compressor turbine 120 may use vaporization of water to cool the compressed air. Then, the compressed air passes through a heat exchanger 122 where it is heated by an exhaust flow. Then, the heated air passes through an expansion turbine 123 where both its temperature and pressure is reduced. The warm air passes through an intake pipe 129 and into a 2-stroke piston engine 124, comprising a piston 125 reciprocating within the cylinder 126, where it is combusted and then exhausted through an exhaust pipe 130.

However, unlike the four-stroke embodiment, in the 2-stroke embodiment, the exhaust pipe 130 may be kept at a pressure lower than the intake pipe 129 because the exhaust valve 128 is open while the intake is open. The higher pressure in the intake pipe 129 displaces the hot exhaust from the cylinder 126 into the exhaust pipe 130. In one embodiment, the exhaust valve may be hydraulically operated, but it will be appreciated that the exhaust valve now be operated by any suitable means.

The exhaust is expanded in a second expansion turbine 131. Excess energy from the expansion turbines 123 and 131 may be used to run an electrical generator or other suitable device. The expanded air may then be passed through a pipe 132 to the heat exchanger 122, where it is cooled. Then, the air may be exhausted through an exhaust 133.

B: Turbo-Charged Piston Engine with Pre-Intake Expansion Turbine and High Pressure Exhaust Collection Valve Timing and Additional Exhaust Expansion Turbine

If the compression ratio of the compressor turbine increases, even with continuous vaporization of a liquid, the compression end temperature of the compressor may increase along with the entrance temperature into the recuperator. The recuperator may not be able to lower the temperature of the exhaust gas below the temperature of the freshly aspired and compressed air-steam mixture. As a result, a considerable amount of thermal energy may be unnecessarily discharged into the environment because the dew point is below this discharge temperature. Thus, a significant part of the useful thermal energy of the exhaust gas may no longer be lost to a condensing vapor but also by exhaust gas. In this case it may be advantageous to capture this additional thermal energy by providing a further expansion device in the exhaust stream after the recuperator.

The solution of this problem may be provided by a turbo-charged piston engine where the exhaust gas is further expanded after passing through the recuperator.

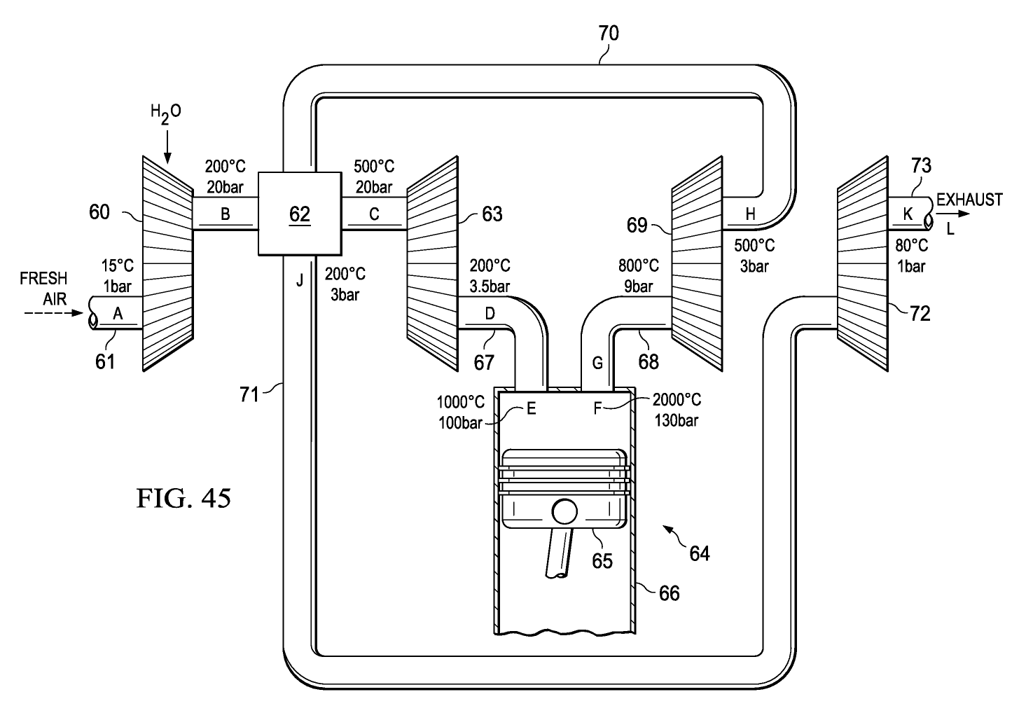

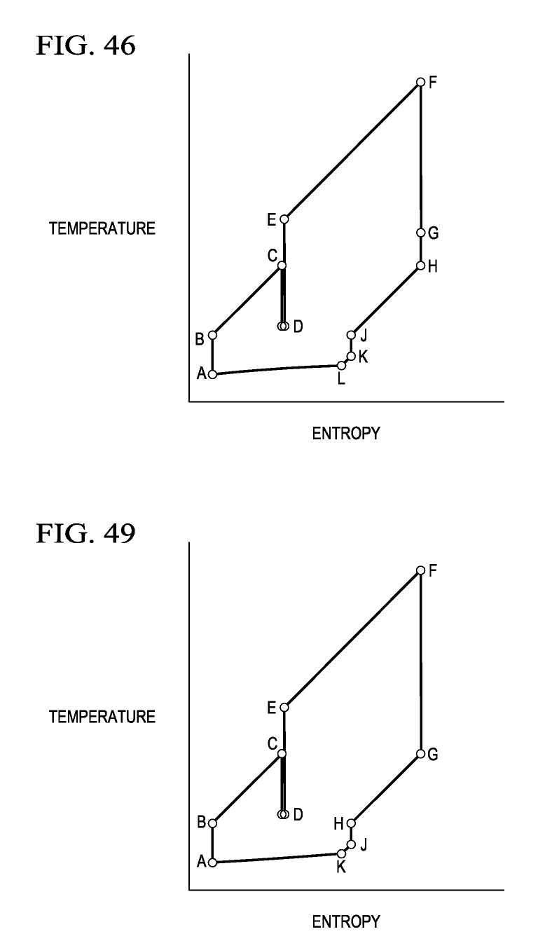

FIG. 45 is a schematic diagram of a turbo-charged piston engine where the exhaust gas is further expanded after passing through the recuperator. FIG. 46 is a theoretical S-T diagram of the thermodynamic process carried out by the piston engine shown in FIG. 45. The forthcoming values for temperature and pressure are for illustrative purposes and are not limiting in any way.

In this embodiment a compressor turbine 60 aspires air, through an inlet 61 and compresses it. The compressor turbine 60 may use vaporization of water in the course of compression. Then the compressed air passes through a recuperator 62 where it is heated by an exhaust flow. Then the heated air passes through an expansion turbine 63 where both the temperature and pressure are reduced. The warm air passes through an intake pipe 67 and into a four-stroke piston engine 64, comprising a piston 65 reciprocating within the cylinder 66, where fuel is combusted and then exhausted through an exhaust pipe 68. The exhaust pipe 68 may be at a higher pressure than the intake pipe 67. Consequently, in one embodiment, the valve timing is set in such a manner that no significant throttling takes place. The details of this valve timing are described above. The working gas is expanded in a second expansion turbine 69. The working gas is passed through a pipe 70 to the recuperator 62, where it is cooled. Finally, the cooled working gas passes through a channel 71 to a third expansion turbine 72, where it is further expanded and cooled. The third expansion turbine 72 ensures that the expansion end temperature is well below the compression end temperature of the compressor turbine 60 and near to the dew point of the steam contained in it. This may increase the efficiency of the system. Finally, the working gas may be exhausted to the environment through an outlet 73. Excess energy from the expansion turbines 63, 69, and 72 may be used to run an electrical generator or other suitable device.

This process may be illustrated by the following example. In FIG. 45 the compressor turbine 60 aspires fresh air with a temperature of approximately 15° C. and ambient pressure of approximately 1 bar (state point “A” in FIG. 46) through the inlet 61 and compresses it under continuous supply and vaporization of water to approximately 200° C. and approximately 20 bar (state point “B” in FIG. 46), to higher pressure and temperature than in case of the embodiments described above. This compression may be an isentropic state change as no significant amount of external heat is supplied or extracted. Hence, the line A-B in FIG. 46 which indicates this state change is a straight line in parallel to the temperature axis.

The compressed air-steam mixture passes through the recuperator 62 where it is heated to approximately 500° C. while maintaining its pressure at approximately 20 bar (state “C” in FIG. 46). The expansion turbine 63 now expands the heated air-steam mixture in an isentropic manner to approximately 200° C. and approximately 3.5 bar (state “D” in FIG. 46). No external thermal energy is provided or extracted, hence the isentropic expansion.

Next, the piston engine 64 which comprises a piston 65 reciprocating within the cylinder 66, first aspires the expanded air-steam mixture through its intake pipe 67. At the end of this intake stroke, the aspired air-steam mixture is located at the same state point “D” in the theoretical S-T diagram of FIG. 46 as after expansion in the expansion turbine 63. A simple displacement may occur from the expansion turbine through the intake pipe 67 into the cylinder 66. For better understanding, irreversibilities and losses are neglected at this stage of description.

The piston 65 moves up and compresses the aspired air-steam mixture to reach a compression end temperature of around 1000° C. and a pressure of around 100 bar. The compression ratio may be around 12 in case of this embodiment. Due to this high compression end temperature, difficult to ignite fuel can be used (for example, heavy fuel oil). The combustion of the fuel causes both temperature and pressure of the air-steam mixture (the working gas as now the composition has changed by burning the fuel) rise to approximately 2000° C. and approximately 130 bar, respectively (state point “F” in FIG. 46). Usually, such heavy fuel oil burns slowly so that the combustion process is more an isobaric than an isochoric state change (at the same volume the pressure at point “F” would reach approximately 180 bar at the indicated temperature of approximately 2000° C.).

Next, the piston 65 moves down to expand the hot working gas to a temperature of approximately 800° C. and a pressure of around 9 bar at its bottom-dead-center position (state point “G” in FIG. 46). The discharge valve (not shown) opens and the hot working leaves the cylinder 66 through the exhaust pipe 68. As described earlier, the valve timing is set in such a manner that a substantial displacement of the hot and pressurized exhaust gas into the exhaust pipe 68 occurs. In one embodiment, no significant throttling takes place. The expansion turbine 69 expands the exhaust gas further to an intermediate pressure of 3 bar and a corresponding temperature of approximately 500° C. (state point “H” in FIG. 46). This means that expansion is not effected to ambient pressure yet but maintained at a higher level to effect further expansion later (after the recuperator 62).

Through the pipe 70 the pressurized and hot exhaust gas is channelled to the recuperator 62 to heat the freshly aspired and compressed air-steam mixture from the compressor turbine 60. Consequently, the air-stream mixture cools down to approximately 200° C. at constant pressure of 3 bar (state point “J” in FIG. 46).

Finally, the cooler exhaust gas is supplied through the channel 71 to a second expansion turbine 72 where it is expanded to ambient pressure of approximately 1 bar and a corresponding temperature of around 80° C. after expansion (state point “K” in FIG. 46). Through the outlet 73 the expanded exhaust gas may be discharged into the environment. By mixing with ambient air, the exhaust gas may first cool down until it reaches the dew point of the steam (state point “L” in FIG. 46) according to the amount of injected water in the compressor turbine 60. By condensing the steam in ambient air, a large amount of thermal energy may be liberated and transferred to the environment as a lower thermal reserve. The second expansion turbine 72 ensures that the expansion end temperature is below the compression end temperature of the compressor turbine 60 and near the dew point of the steam in the exhaust gas. This may increase efficiency.

The compression ratio of the above described piston engine may be around 12:1. By providing the recuperator 62 to pre-heat the already compressed air or air-fuel-steam mixture nearly any suitable compression end temperature may be reached without the need to increase the compression ratio and, hence, the compression end pressure. To reach 1000° C. at a typical charge pressure of 2.3 bar for medium-charged piston engines and an intake temperature of 60° C., a compression end pressure of more than 250 bar may be reached with the required compression ratio of 29:1. This is clearly beyond the material resistance of state-of-the-art and even future piston engines. Advantageously, the high compression end temperature at moderate pressure in case of the illustrative piston engine allows the combustion of heavy fuel which is typically difficult to ignite.

In the illustrative engine shown in FIG. 45, an efficiency of around 80% may be achieved. In contrast, typical engines using state-of-the-art components (compressor turbine, expansion turbine, piston engine) may reach an efficiency of around 50% or more (in case of large piston engines where the cooling losses are decreasing) without the further improvement which will be described later.

The compressor turbine 60 and one or several of the expansion turbines 63, 69 and 72 may be mounted on the same shaft (not shown). It may also possible that an additional generator or other suitable device is connected to use the power surplus usually generated by these coupled turbines. Alternatively, one or several expansion turbines may be coupled to the crankshaft of the piston engine to deliver the surplus power to the crankshaft and then together to an external consumer.

Instead of employing a first expansion turbine 63, pre-expansion may also be carried out by the piston engine 64. Instead of using a compressor with liquid vaporization (e.g., vaporization of water) also a multi-staged and inter-cooled compressor may be employed. In this case the last (un-cooled) compressor stage may even provide a higher compression ratio with increased temperature. The second expansion turbine 72 will then expand and, consequently, cool down the exhaust gas well below this expansion end temperature of the last un-cooled compressor stage.

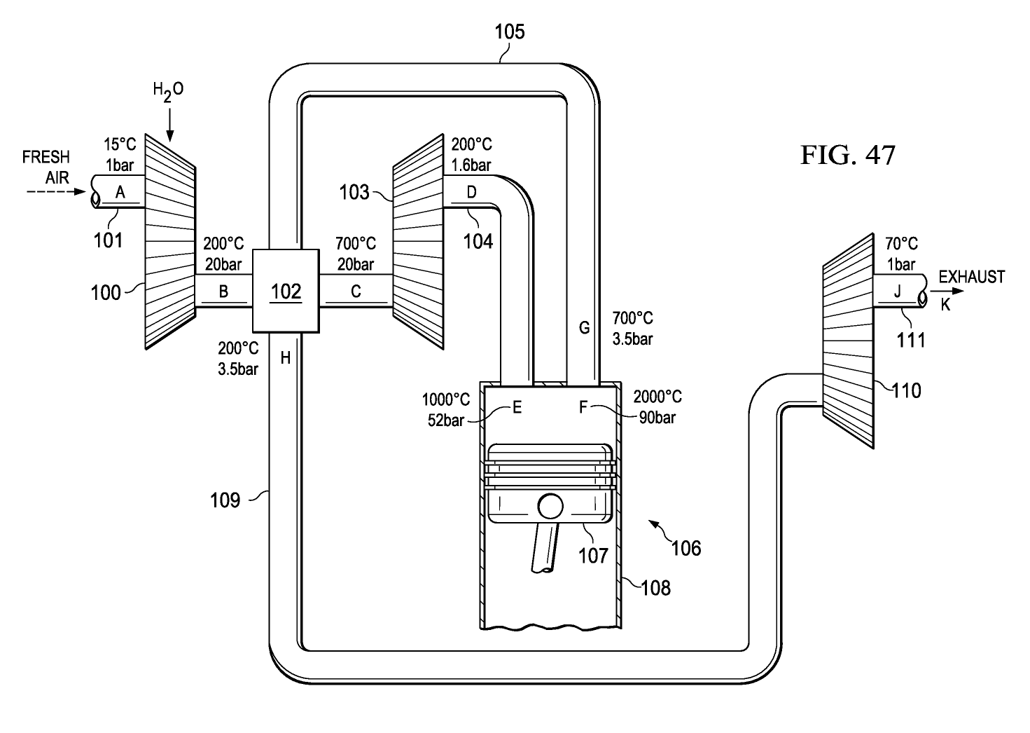

Instead of using the combination of an expansion turbine 69 and a recuperator 62, as shown in FIG. 45, a high-temperature heat exchanger may be used as shown in FIG. 47. FIG. 47 is a schematic of another arrangement of a turbo-charged four-stroke piston engine with a pre-expansion turbine 103 and a high-temperature heat exchanger 102. If a high-temperature heat exchanger 102 is used, the expansion turbine 69 between the piston engine 64 and the recuperator 62 of FIG. 45 may be eliminated. Furthermore, it should be noted that when the pre-expansion turbine 103 is used, the working gas may be under a high pressure when it is injected into the piston engine 106. Thus, this arrangement may be used with 2-stroke piston engine applications, where the pressure of the intake working gas might be higher than the pressure of an exhausting working gas in order to clear the piston chamber in one stroke.

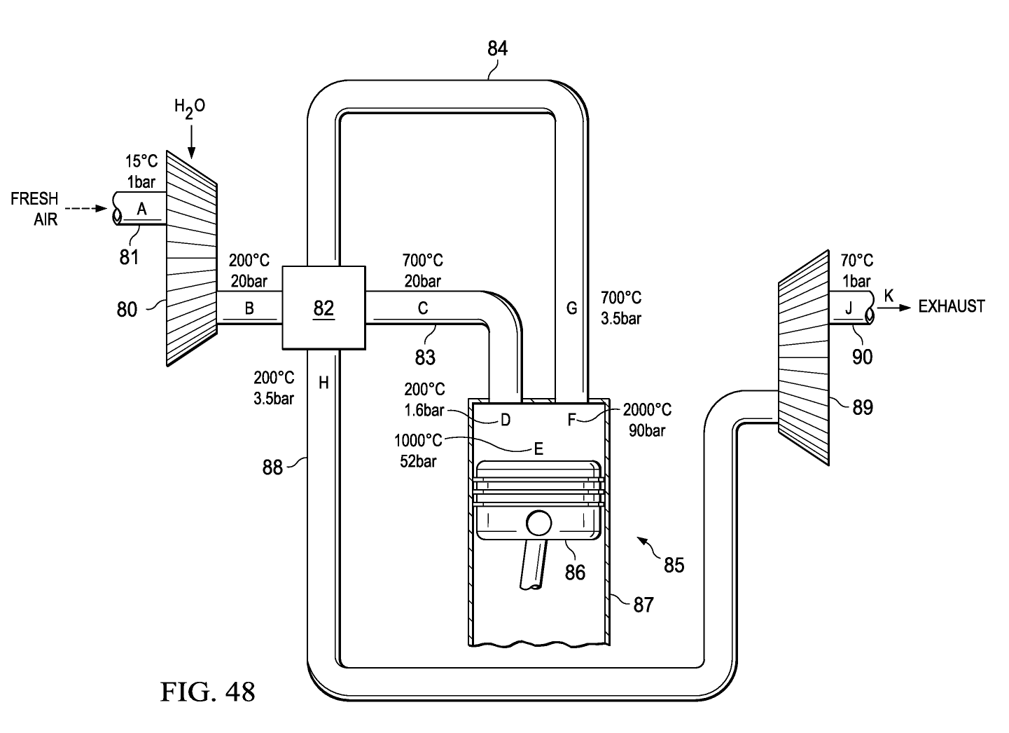

FIG. 48 will be explained in detail below. The embodiment shown in FIG. 47 differs from the embodiment of FIG. 48 in that the pre-expansion after the high-temperature recuperator 102 is carried out by a first expansion turbine 103 before the working gas is aspired by the piston engine 106 rather than pre-expanding in the piston engine itself as described in the embodiment shown in FIG. 48. As explained above, the expansion by an external expansion turbine 103, as shown in FIG. 47, allows for use with a 2-stroke piston engine. In most other respects, FIG. 47 and FIG. 48 are similar, so the example in FIG. 47 will not be described separately. The thermodynamics process of both FIGS. 47 and 48 are similar to that illustrated in FIG. 49.

C: Turbo-Charged Piston Engine with a High Temperature Heat Exchanger and Pre-Expansion Valve Timing

In case of higher compressing piston engines with limited combustion temperatures, a high-temperature recuperator-heat exchanger may be employed to without the need for an expansion turbine to reduce the pressure of the exhaust prior to passing through the recuperator (e.g., heat exchanger).

FIG. 48 is a schematic diagram of an embodiment where the hot exhaust gases heat a high-temperature recuperator before they are expanded in an external expansion device. FIG. 49 is a theoretical S-T diagram of the thermodynamic process which is carried out by the piston engine of FIG. 48. These figures will be explained in conjunction with one another. The forthcoming values for temperature and pressure are for illustrative purposes and are not limiting in any way.

In this embodiment, a compressor turbine 80 aspires fresh air through an inlet 81 and compresses it. The compressor turbine 80 may use vaporization of water in the course of compression. Then, the compressed air passes through a high pressure recuperator 82 where it is heated by an exhaust flow. The warm air passes through an intake pipe 83 and into a combustion chamber 85, comprising a piston 86 reciprocating within the cylinder 87. The intake valve (not shown) closes significantly before the piston 86 reaches the bottom-dead-center position. Consequently, an isentropic expansion is carried out in the piston engine. Thereafter, the working gas is combusted and then exhausted through an exhaust pipe 84. The working gas is passed to the high pressure recuperator 82, where it is cooled. The cooled working gas passes through another pipe 88 to an expansion turbine 89 where it is further expanded and cooled. Finally, the working gas is exhausted to the environment through an exhaust 90.

This process may be illustrated by the following example. The compressor turbine 80 aspires fresh air with a temperature of approximately 15° C. and ambient pressure of approximately 1 bar (state point “A” in FIG. 49) through the inlet 81 and compresses it under continuous supply and vaporization of water to approximately 200° C. and approximately 20 bar (state point “B” in FIG. 49). This compression is basically an isentropic state change as no external heat is supplied or extracted.

The compressed air-steam mixture passes through the high-temperature recuperator 82 where it is heated to approximately 700° C. while maintaining its pressure at approximately 20 bar (state “C” in FIG. 49). After the recuperator 82, no expansion occurs and the combustion chamber 85, which comprises a piston 86 reciprocating within the cylinder 87, directly aspires the hot and highly pressurized air-steam mixture through its intake pipe 83. The intake valve (not shown) closes significantly before the piston 86 reaches its bottom-dead-center position. Consequently, an isentropic expansion is carried out in the piston engine. This causes the pressure to drop to around 1.6 bar and a temperature of around 200° C. at the end of this pre-expansion in the combined intake-expansion stroke (state “D” in FIG. 49).

The piston 86 moves up and compresses the aspired air-steam mixture to reach a compression end temperature of around 1000° C. and a pressure of around 52 bar (state point “E” in FIG. 49), corresponding to an intermediate compression ratio of 12:1. The high compression temperature may permit this engine to use heavy fuel oil or another type of fuel which may be difficult to burn. Combustion of that fuel causes both temperature and pressure of the air-steam mixture (e.g., in one embodiment, referred to as the working gas since the composition has changed by burning the fuel, however, it may also be referred to as an exhaust gas) to rise to approximately 2000° C. and approximately 90 bar, respectively (state point “F” in FIG. 49).

The piston 86 moves down to expand the hot working gas to a temperature of approximately 700° C. and a pressure of around 3.5 bar at its bottom-dead-center position (state point “G” in FIG. 49). The discharge valve (not shown) opens and the still hot working leaves the cylinder 87 through the exhaust pipe 84 which channels the hot and still somewhat pressurized exhaust gas to the high-temperature recuperator 82. Here, the compressed fresh air-steam mixture from the compressor turbine 80 is heated to approximately 700° C., causing the exhaust gas temperature to drop to 200° C. while maintaining its pressure at approximately 3.5 bar (state point “H” in FIG. 49).

Subsequently, the expansion turbine 89 aspires the cooled exhaust gas through the pipe 88 and expands it further to ambient pressure of 1 bar and a corresponding temperature of approximately 70° C. (state point “J” in FIG. 49). Finally, the cooled and expanded exhaust gas is discharged into the environment through the exhaust 90. By mixing with ambient air, the exhaust gas first cools down until it reaches the dew point of the steam (state point “K”) according to the amount of injected water in the compressor turbine 80. By condensing the steam in ambient air, a large amount of thermal energy is may be transferred at low temperature to the lower thermal reserve of the engine, e.g., the environment.

### VII: Bypass Channel for Cooling

Combustion temperatures in piston engines may surpass the temperature resistance of an expansion turbine positioned to receive the exhaust flow from the piston engine. For most of today's simple expansion turbines of turbo-chargers, a gas temperature of 1200° C. may cause damage to the components. Conventional turbo-charged piston engines throttle exhaust gas to a lower pressure exhaust gas collection pipe to decreases the exhaust gas temperature. However, throttling is accompanied by a strong entropy increase and, hence, a significant and irreversible loss of mechanical power. For example, around 3.5% of the thermal power of the engine or around 1/10^{th} of the mechanical power in case of a typical conventional gas engine with an overall efficiency of 35% may be lost through throttling. It may be therefore advantageous to lower the exhaust gas temperature in cases where, for example, current expansion turbines may not withstand these high temperatures.

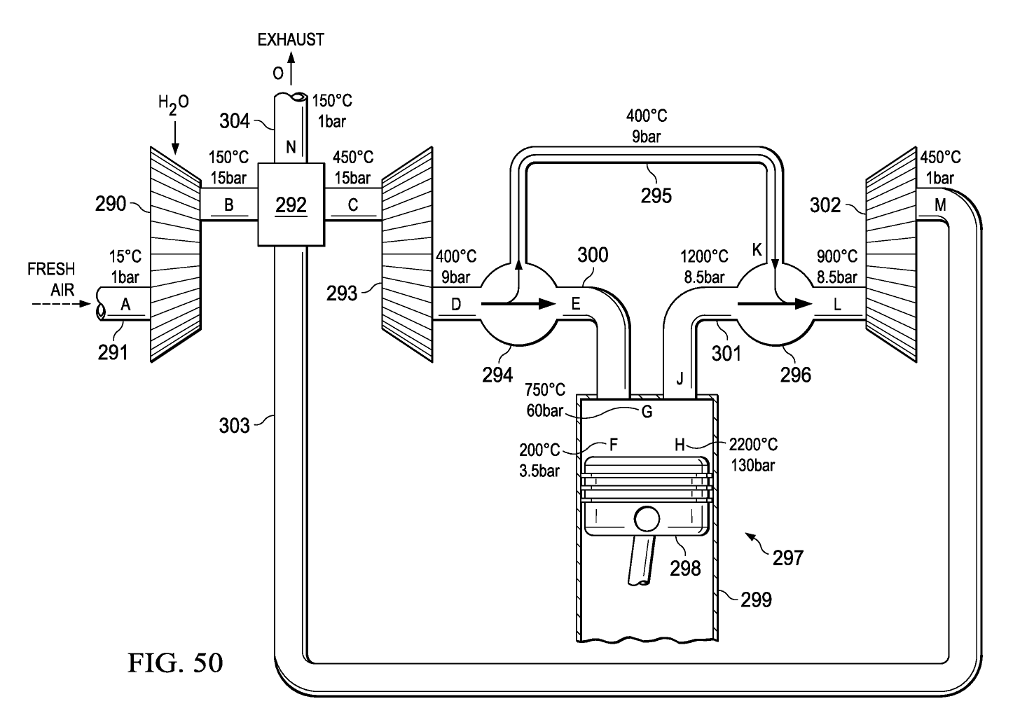

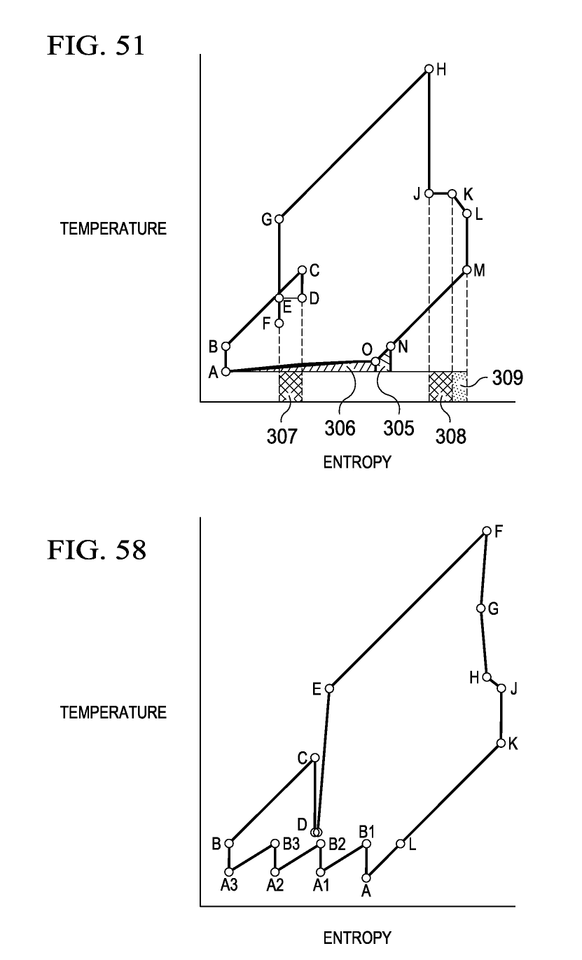

FIG. 50 is a schematic diagram of an embodiment where part of the compressed fresh air bypasses the piston engine and is mixed immediately after the piston engine with the hot exhaust gas. FIG. 51 is a theoretical S-T diagram of the thermodynamic process carried out by the engine according to FIG. 50. These two figures will be described in conjunction with one another. The forthcoming values for temperature and pressure are for illustrative purposes and are not limiting in any way.

The compressor turbine 290 aspires air with a temperature of approximately 15° C. and ambient pressure of approximately 1 bar (state point “A” in FIG. 51) through the inlet 291 and compresses it under continuous supply and vaporization of water to approximately 150° C. and approximately 15 bar (state point “B” in FIG. 51). It should be noted that a vaporisable liquid other than water may be used, but for the sake of this example water will be assumed; likewise for other examples involving any vaporizable liquid described herein. The compressed air-steam mixture passes through the recuperator 292 where it is heated to approximately 450° C. while maintaining a pressure at approximately 15 bar (state “C” in FIG. 51). The expansion turbine 293 now expands the heated air-steam mixture in an isentropic manner to approximately 400° C. and approximately 9 bar (state “D” in FIG. 51) to nearly match the pressure of the exhaust gas after expansion in the piston engine 297. Nevertheless, the pressure in state “D” may be somewhat higher to produce a constant flow of this compressed and pre-heated air to the exhaust pipe 301 without re-flow. The separation of an appropriate part of the compressed air-steam mixture may be controlled by the valve 294. The amount and pressure of the separated air may be controlled according to the load and revolutions of the piston engine 297. The valve 294 channels a portion of the compressed and pre-heated air into the bypass channel 295 for future mixing with the hot exhaust gas from the piston engine 297. In the theoretical S-T diagram of FIG. 51 this separation is indicated by the straight line D-E.

The remaining portion part of the compressed and pre-heated air is aspired by the piston engine 297 which comprises a piston 298 reciprocating within the cylinder 299 through its intake pipe 300. At the end of this intake stroke, the aspired air-steam mixture may be located at the same state point “E” in the theoretical S-T diagram of FIG. 51 as after separation of the bypassed working gas for future mixing. Next, the piston 298 performs a pre-expansion of the air-steam mixture during the remaining portion of its downward stroke. The air-steam mixture's temperature and pressure drop to approximately 200° C. and approximately 3.5 bar, respectively (state “F” in FIG. 51).

The piston 298 moves up and compresses the aspired air-steam mixture to reach a compression end temperature of around 750° C. and a pressure of around 60 bar. Combustion of the fuel occurs and both temperature and pressure of the combusted product increases to approximately 2200° C. and approximately 130 bar, respectively (state point “H” in FIG. 51).

The piston 298 moves down to expand the hot working gas to a temperature of approximately 1200° C. and a pressure of around 8.5 bar at its bottom-dead-center position (state point “J” in FIG. 51). The discharge valve (not shown) opens and the hot working gas leaves the cylinder 299 into the exhaust pipe 301. As described earlier, the valve timing is set in such a manner that a substantial displacement of the hot and still pressurized exhaust gas into the exhaust pipe 301 occurs. In one embodiment, no significant throttling takes place. The exhaust channel may be isolated with high-temperature resistant materials as, for example, ceramics, which may keep the temperature of the exhaust gas from being irreversibly lost.

According to the above described embodiment, in the mixing valve 296, the stream of the cooler but pressurized air, separated in advance by the valve 294, is mixed with the very hot exhaust gas from the piston engine 297. A mixing ratio of 3 parts of cooler separated air with five parts of hot exhaust gas may lead to a mixing temperature of around 900° C. for the above example. However, it will be appreciated any suitable ratio of cooler air to exhaust gas may be employed. The supply of the earlier separated cooler air is indicated in the theoretical S-T diagram shown in FIG. 51 as straight line J-K because the addition of mass increases entropy of the system. The mixing of the hot exhaust and the bypass stream may cause an entropy increase while lowers the temperature of the exhaust gas. This is indicated in FIG. 51 as line K-L.

The exhaust gas temperature may be low enough to enter the expansion turbine 302 without causing damage. The exhaust gas may be further expanded to ambient pressure of approximately 1 bar and a corresponding temperature of approximately 450° C. (state point “M” in FIG. 51) in the expansion turbine 302.

The de-pressurized but still hot exhaust gas is channelled through the pipe 303 to the recuperator 292 to heat the freshly aspired and compressed air-steam mixture from the compressor turbine 290. Consequently, the exhaust gas cools down to approximately 150° C. at ambient pressure of approximately 1 bar (state point “N” in FIG. 51). Finally, the cooled exhaust gas is discharged into the environment through the exhaust pipe 304.

By mixing with ambient air, the exhaust gas first cools down until it reaches the dew point of the steam (state point “O”) according to the amount of injected water in the compressor turbine 290. Finally, by condensing the steam in ambient air, a large amount of thermal energy is liberated at a temperature close to that of the environment.

The mechanical work lost in this discharge is indicated by the shaded areas. Shaded area 305 indicates the lost thermal energy through the exhaust air cooling in the environment. The shaded area 306 indicates the lost thermal energy through condensing steam in the environment. The shaded area 307 indicates the mechanical work associated with bypassing the compressed air separated by the valve 294. The shaded area 308 indicates the loss of mechanical work associated with supplying the bypassed air through the valve 296. Finally, the shaded area 309 indicates the loss of mechanical work associated with mixing the hot exhaust gas with cooler bypassed air. These losses are low compared to the overall mechanical work delivered by the thermodynamic process and the engine according to the embodiment. In case of the described embodiment, such a loss may be below 2% of the overall thermal power of the engine and, hence, around half of that associated with throttling to achieve the same exhaust gas temperature of approximately 900° C. upon entering the expansion turbine 302.

It will be appreciated that the pressure in the exhaust pipe 301 is maintained and, therefore, the expansion turbine 302 may be able to deliver sufficient power to drive the compressor turbine 290. Additionally, by controlling the valves 294 and 296 accordingly, the amount of bypassed cooler air can be varied and adapted to the actual requirements.

### VIII: Recirculation of Exhaust

To achieve low emission especially of NOx, but also to lower the combustion temperature because of durability reasons, it is common to re-circulate a certain part of the exhaust gas. Conventional external re-circulation systems cool the exhaust gas prior to mixing it with fresh air. Then, the mixture is supplied to the compressor turbine in turbo-charged engines or to the piston engine itself in naturally aspired engines. Cooling the exhaust gas is thermodynamically inefficient. Therefore, it may be advantageous to create a system to reuse the exhaust gas heat prior to the exhaust being re-circulated.

A: Turbo-Charged Piston Engine with Pre-Expansion Valve Timing and High Pressure Discharge Valve Timing, which Re-Circulates the Hot Exhaust Gas by Means of a Second Heat Exchanger

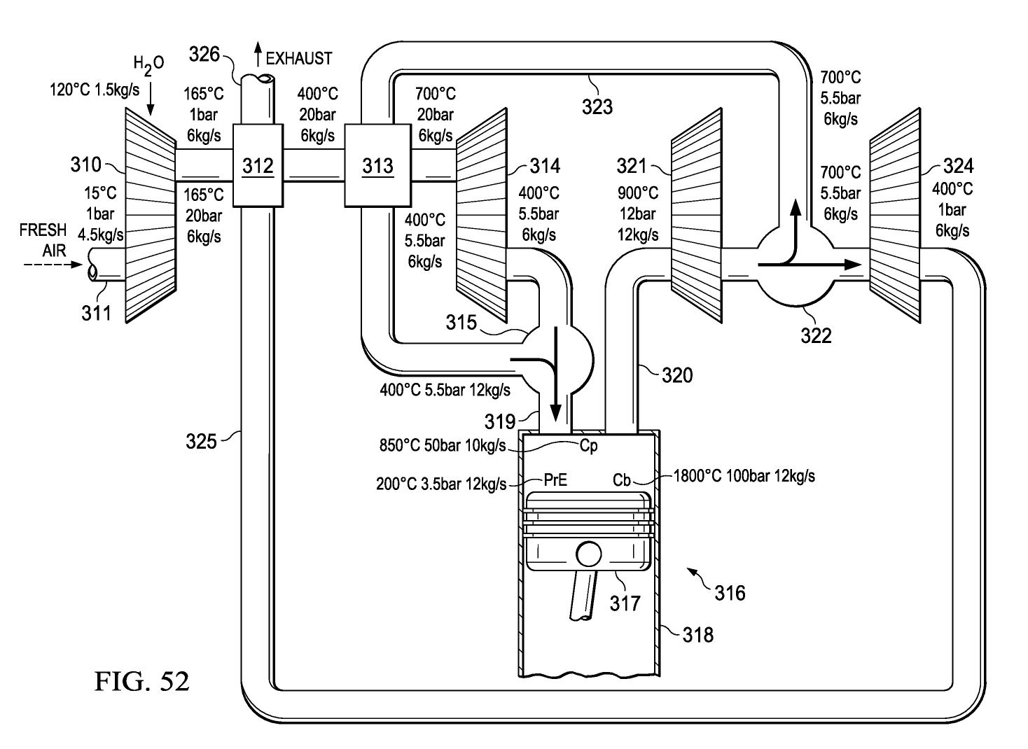

FIG. 52 is a schematic of a turbo-charged four-stroke piston engine which re-circulates the hot exhaust gas at a high temperature level by means of a second high-temperature recuperator. The forthcoming values for temperature, pressure and flow rate are for illustrative purposes and are not limiting in any way.

In this embodiment a compressor turbine 310 aspires fresh air, through an inlet 311 and compresses it. The compressor turbine 310 may use vaporization of water to cool the compressed air. Then, the compressed air passes through a first recuperator 312 where it is heated by a first portion of an exhaust flow. Then, the heated air passes through a second high-temperature recuperator 313 where it is further heated by a second portion of an exhaust gas flow. The further heated air then passes to expansion turbine 314 where both its temperature and pressure are reduced. Then, the expanded air is mixed with a first portion of a re-circulated exhaust in a mixer 315. By mixing of re-circulated exhaust gas air, only a minor entropy increase occurs. This may lead to an engine with increased efficiency. The air-re-circulated exhaust mixture passes through an intake pipe 319 and into a four-stroke piston engine 316, comprising a piston 317 reciprocating within the cylinder 318. Because the intake valve (not shown) is closed before the piston 317 reaches its bottom-dead-center position, the air-re-circulated exhaust mixture is pre-expanded. Then, the mixture is combusted and then exhausted through an exhaust pipe 320. The exhaust pipe 320 is at a higher pressure than the intake pipe 319. Consequently, the valve timing is set in such a manner that no major throttling takes place during the exhaust stroke. The details of this valve timing are described in the valve timing section of this specification. The exhaust is expanded in a second expansion turbine 321. The exhaust gas flow is divided in the controllable separator valve 322 so as to supply a second portion of an exhaust gas flow through the re-circulation pipe 323 to the second high-temperature recuperator 313. The first portion of the exhaust gas is delivered to the third expansion turbine 324 where it is expanded further to ambient pressure. It will be appreciated that the flow need not be equally divided in the separator valve 322. Other ratios according to the each actual condition (type of the engine, fuel, load, ambient temperature and pressure etc.) are possible and may be controlled by this separator valve 322. Through the pipe 325 the de-pressurized but still hot exhaust gas is channelled to the first recuperator 312 to heat the freshly aspired and compressed air from the compressor turbine 310.

All, or some, of the turbines 310, 314, 321 and 324 may be mounted on the same shaft and may be even formed in one single case. Excess energy from the expansion turbines 314, 321, and 324 may be used to run an electrical generator, or other suitable devices.

It should be noted that the three turbines 310, 314, and 324 may handle a reduced gas flow rate. External exhaust gas re-circulation which provides the re-circulated exhaust gas to the inlet of the first compressor turbine, 310 in case of this embodiment, may require larger turbines.

This process may be illustrated by the following detailed example. In FIG. 52, the compressor turbine 310 aspires an amount of approximately 4.5 kg per second of fresh air with a temperature of approximately 15° C. and ambient pressure of approximately 1 bar through the inlet 311 and compresses it under continuous supply and vaporization of water to approximately 150° C. and approximately 20 bar. The amount of vaporized water is approximately 1.5 kg/s. The compressed air-steam mixture passes through the first recuperator 312 where it is heated to approximately 400° C. while maintaining its pressure at approximately 20 bar. Afterwards, the pre-heated and pressurized air-steam mixture passes through a second high-temperature recuperator 313 where it is heated by the re-circulated exhaust gas to a temperature of approximately 700° C. The pressure and mass flow are approximately 20 bar and approximately 6 kg/s, respectively.

The first expansion turbine 314 now expands the heated air-steam mixture in an isentropic manner to approximately 400° C., resulting in a pressure of around approximately 5.5 bar. After the first expansion turbine 314, the fresh air-steam is mixed with hot re-circulated exhaust gas in the mixer 315 before the piston engine 316 aspires the air-steam-exhaust gas mixture through its intake pipe 319. The piston engine 316 comprises a piston 317 reciprocating within the cylinder 318. The mixing of the pressurized and hot fresh air-steam with the equally hot and pressurized re-circulated exhaust gas presents little entropy increase. There may be only a minor entropy increase caused by the so-called “mixing entropy” of two or more different types of gases or gases at different states relative to one another. In this embodiment air-steam and exhaust gas are mixed. The respective sub-components of the gas(es) may be nitrogen, oxygen, argon, carbon dioxide, etc. The mass flow of the re-circulated exhaust gas may also be around 6 kg/s. Therefore, an overall working gas flow into the piston engine of approximately 12 kg/s may occur.

The piston 317 moves down to aspire and after pre-closing of the intake valve (not shown), i.e., before the piston 317 reaches its bottom-dead-center position, and pre-expands the aspired working gas, including the re-circulated exhaust gas, to a pressure of approximately 3.5 bar, resulting in a temperature of approximately 200° C. The piston 317 moves up, and it compresses the working gas mixture to reach a compression end temperature of around approximately 850° C. and a pressure of around 50 bar. The high compression temperature ensures ignition of the fuel without problem although the oxygen content may be lower than in case of pure air. The combustion of the fuel causes both temperature and pressure of the working gas to rise to approximately 1800° C. and approximately 100 bar, respectively.

The piston 317 moves down to expand the hot working gas to a temperature of around 900° C. and a pressure of around approximately 13 bar at its bottom-dead-center position. The discharge valve (not shown) opens and the still hot working leaves the cylinder 318 through the exhaust pipe 320. As described earlier, the valve timing is set in such a manner that a substantial displacement of the hot and still pressurized exhaust gas into the exhaust pipe 320 occurs, and, in one embodiment, no significant throttling takes place.

The exhaust gas in the exhaust pipe 320 has a higher pressure than the fresh air after the first expansion turbine 314. Therefore, a first expansion is carried out by the second expansion turbine 321 to match the pressure of the exhaust gas after this expansion and the pressure of the fresh air-steam mixture after the first expansion turbine 314. This expansion results in a temperature of around approximately 700° C. at the pressure of approximately 5.5 bar. The exhaust gas flow is divided in the controllable separator valve 322 so as to supply an exhaust gas flow of approximately 6 kg/s through the re-circulation pipe 323 to the second high-temperature recuperator 313. The remaining exhaust gas (approximately 6 kg/s) is delivered to the third expansion turbine 324 where it is expanded further to ambient pressure, resulting in a temperature of around approximately 400° C. It will be appreciated that the flow need not be equally divided in the separator valve 322. Other ratios according to the each actual condition (type of the engine, fuel, load, ambient temperature and pressure etc.) are possible and may be controlled by this separator valve 322.

Through the pipe 325 the de-pressurized but still hot exhaust gas is channelled to the first recuperator 312 to heat the freshly aspired and compressed air-steam mixture from the compressor turbine 310. Consequently, it cools down to approximately 150° C. at ambient pressure of 1 bar and leaves with a flow rate of approximately 6 kg/s the outlet 326 into the environment. By mixing with ambient air, the exhaust gas first cools down until it reaches the dew point of the steam according to the amount of injected water in the compressor turbine 310. Afterwards, thermal energy is transferred to the environment by condensation of the steam or by simply mixing of that steam with ambient air.

B: Turbo-Charged Piston Engine with Pre-Expansion Valve Timing and High Pressure Discharge Valve Timing, which Re-Circulates the Hot Exhaust Gas without Cooling

When two different media are mixed together, a certain entropy increase is inevitable. However, as the temperatures of both media increase, the loss due to entropy decreases. Therefore, it may be advantageous to create a relatively efficient engine system in which a high temperature exhaust gas is re-circulated without the need to cool the exhaust prior to mixing.

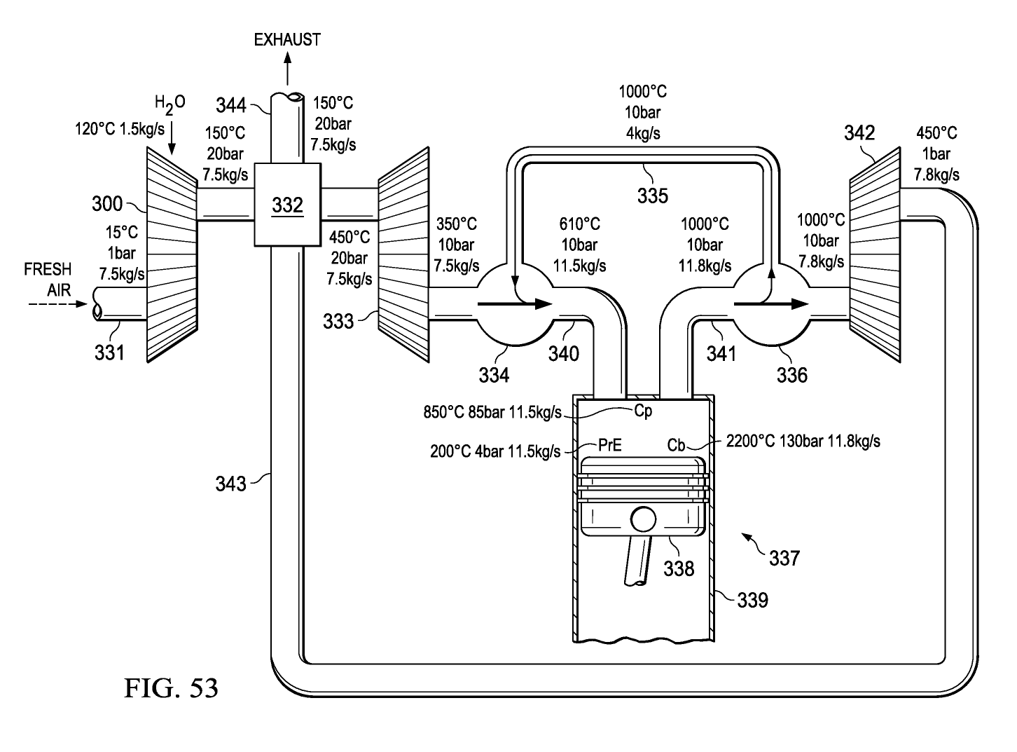

FIG. 53 is a schematic of a turbo-charged four-stroke piston engine which re-circulates the hot exhaust gas at a high temperature level by means of mixing with pressurized and pre-heated fresh air. The forthcoming values for temperature, pressure and flow rate are for illustrative purposes and are not limiting in any way.

In this embodiment, a compressor turbine 330 aspires fresh air, through an inlet 331 and compresses it. The compressor turbine 330 may use vaporization of water to cool the compressed air. Then, the compressed air passes through a recuperator 332 where it is heated by a first portion of an exhaust flow. Then, the heated air passes to expansion turbine 333 where both its temperature and pressure are reduced. Then, the expanded air is mixed with a second portion of a re-circulated exhaust in a mixer 334. The second portion of a re-circulated exhaust has a higher temperature but the same pressure as the air.

The mixing of the air with the hotter re-circulated exhaust gas presents only a minor entropy increase apart from the minimum entropy increase caused by the so-called “mixing entropy” of two or more different type of gases or gases at different states relative to one another. This may lead to an engine with increased efficiency. The air-re-circulated exhaust mixture passes through an intake pipe 340 and into a four-stroke piston engine 337, comprising a piston 338 reciprocating within the cylinder 339. Because the intake valve (not shown) is closed before the piston 338 reaches the bottom-dead-center position, the air-re-circulated exhaust mixture is pre-expanded. Then, the mixture is combusted and then exhausted through an exhaust pipe 341. The exhaust pipe 341 is at a higher pressure than the intake pipe 340. Consequently, in one embodiment, the valve timing is set in such a manner that no significant throttling takes place during the exhaust stroke. The details of this valve timing are described in the valve timing section of this specification. The exhaust gas in the exhaust pipe 341 has basically the same pressure as the fresh air-steam after the expansion turbine 333. The controllable separator valve 336 divides the exhaust gas flow so as to supply a second portion of an exhaust gas flow through the re-circulation pipe 335 to the mixer 334 where it is mixed with the fresh air from the first expansion turbine 333. The first portion of the exhaust gas is delivered to a second expansion turbine 342 where it is expanded to ambient pressure. It will be appreciated that the flow may be divided by the separator valve 336 according to the actual and possibly changing requirements. The first portion of the exhaust gas is then routed through the pipe 343 to the recuperator 332 to heat the freshly aspired and compressed air from the compressor turbine 330. Finally, it is discharged through the outlet 344.

All or some of the turbines 330, 333, and 342 may be mounted on the same shaft and may be even formed in one single case. Excess energy from the expansion turbines 333 and 342 may be used to run an electrical generator, or other suitable device.

This process may be illustrated by the following detailed example. In FIG. 53, the compressor turbine 330 aspires an amount of approximately 6 kg per second of fresh air with a temperature of approximately 15° C. and ambient pressure of approximately 1 bar through the inlet 331 and compresses it under continuous supply and vaporization of water to approximately 150° C. and approximately 20 bar. The amount of vaporized water is approximately 1.5 kg/s. The compressed air-steam mixture passes through the recuperator 332 at a flow rate of approximately 7.5 kg/s, where it is heated to 450° C. while maintaining its pressure at approximately 20 bar. Afterwards, the pre-heated and pressurized air-steam mixture is expanded by the first expansion turbine 333 in an isentropic manner to approximately 350° C., resulting in a pressure of around approximately 10 bar. After the expansion turbine 333, the fresh air-steam is mixed with hot re-circulated exhaust gas stream of approximately 4 kg/s in the mixer 334. The re-circulated exhaust gas has a higher temperature of approximately 1000° C. but the same pressure of approximately 10 bar.

The piston engine 337 aspires the air-steam-exhaust gas mixture through an intake pipe 340. The piston engine 337 comprises a piston 338 reciprocating within the cylinder 339. The mixing of the pressurized and pre-heated fresh air-steam with the hotter and pressurized re-circulated exhaust gas presents only a minor entropy increase apart from the minimum entropy increase caused by the so-called “mixing entropy” of two or more different type of gases (e.g., air, steam and exhaust gas with there respective sub-components as, for example, nitrogen, oxygen, argon, carbon dioxide etc.). The mass flow of the re-circulated exhaust gas may be around 4 kg/s. Therefore, an overall working gas flow into the piston engine of approximately 11.5 kg/s may occur and the aspired working gas has a temperature of around 610° C.

First, the piston 338 moves down to aspire the hot working gas at an overall flow rate of 10 kg/s and after pre-closing of the intake valve (not shown), i.e., before the piston 338 reaches its bottom-dead-center position, and pre-expands the aspired working gas (including the re-circulated exhaust gas) to a pressure of 4 bar, resulting in a temperature of approximately 200° C. Afterwards, as moving up, the piston 338 compresses the working gas mixture to reach a compression end temperature of around 850° C. and a pressure of around 85 bar. The high compression temperature ensures ignition of the fuel without problem although the oxygen content is lower than in case of pure air. The injection of approximately 0.3 kg/s of fuel and its immediate combustion may cause both temperature and pressure of the working gas to rise to approximately 2000° C. and approximately 100 bar, respectively.

The piston 338 moves down to expand the hot working gas to a temperature of around 1000° C. and a pressure of around 10 bar at its bottom-dead-center position. The discharge valve (not shown) opens and the still hot working leaves the cylinder 339 through the exhaust pipe 341. As described earlier, the valve timing is set in such a manner that a substantial displacement of the hot and still pressurized exhaust gas into the exhaust pipe 341, and no major throttling takes place.

The exhaust gas in the exhaust pipe 341 has basically the same pressure as the fresh air-steam after the expansion turbine 333. Therefore, further expansion may be necessary and the controllable separator valve 336 divides the exhaust gas flow so as to supply an exhaust gas flow of approximately 4 kg/s through the re-circulation pipe 335 to the mixer 334 where it is mixed with the fresh air-steam from the first expansion turbine 333. The remaining exhaust gas (approximately 7.8 kg/s) is delivered to the second expansion turbine 342 where it is expanded further to ambient pressure, resulting in a temperature of around 450° C. It will be appreciated that the flow may be divided by the separator valve 336 according to the actual and possibly changing requirements. Other ratios according to each actual condition (type of the engine, fuel, load, ambient temperature and pressure etc.) are possible and may be controlled by this separator valve 336.

Through the pipe 343, the de-pressurized but still hot exhaust gas is channelled to the recuperator 332 to heat the freshly aspired and compressed air-steam mixture from the compressor turbine 330. Consequently, it cools down to approximately 150° C. at ambient pressure of approximately 1 bar and leaves with a flow rate of approximately 7.8 kg/s the outlet 344 into the environment. By mixing with ambient air the exhaust gas first cools down until it reaches the dew point of the steam according to the amount of injected water in the compressor turbine 330. Afterwards, the major amount of thermal energy is transferred to the environment by condensation of the steam or by simply mixing of that steam with ambient air.

All or some of the turbines 330, 333 and 342 may be mounted on the same shaft and may be even formed in one single case. C: Turbo-Charged Piston Engine with Pre-Expansion Valve Timing and High Pressure Discharge Valve Timing, which Re-Circulates the Hot Exhaust Gas for Mixing in a Liquid Injected Screw Compressor

Vaporization of a liquid occurs more quickly at increased temperatures. It may be advantageous therefore to first compress a fresh air without a liquid, mixing it with a re-circulated exhaust gas at the same temperature and pressure, and then compress the mixture with liquid vaporization.

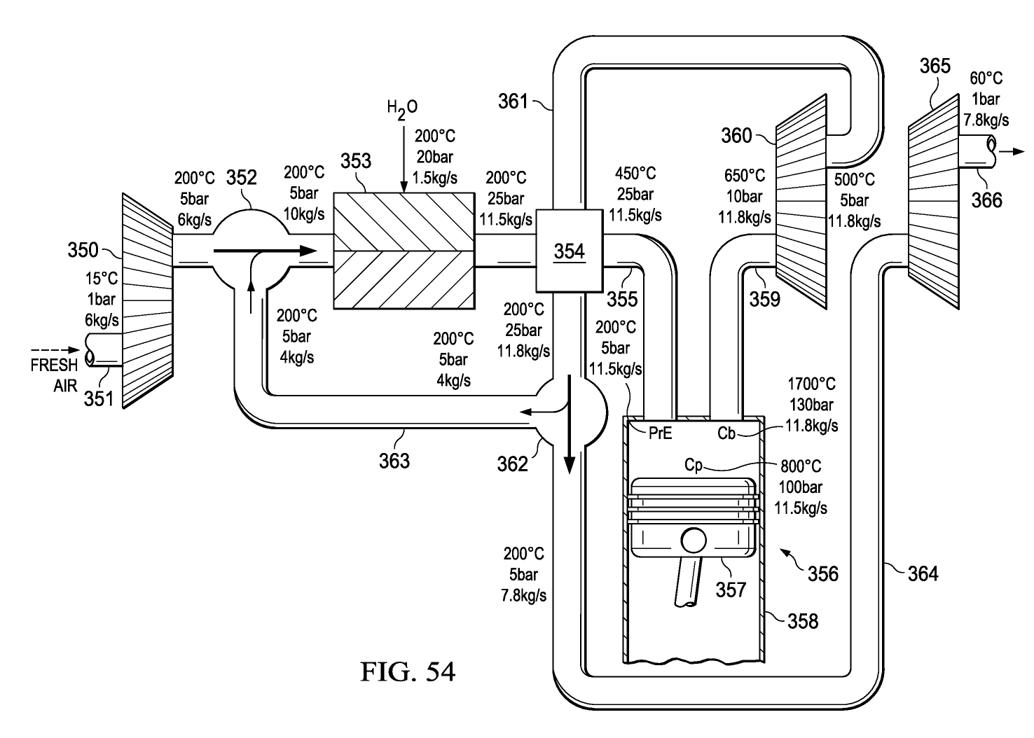

FIG. 54 is a schematic diagram of a turbo-charged four-stroke piston engine which re-circulates the hot exhaust gas at increased temperature and pressure levels where the fresh air is first compressed separately. The forthcoming values for temperature, pressure and flow rate are far illustrative purposes and are not limiting in any way.

In this embodiment, a compressor turbine 350 aspires fresh air, through an inlet 351 and compresses it. In the mixer 352, the compressed fresh air is mixed with a first portion of an exhaust gas flow at the same temperature and pressure levels. The air-re-circulated exhaust gas mixture, otherwise known as the working gas, is supplied to a screw compressor 353 which compresses it under continuous supply and vaporization. In some embodiments, the supplied water is pre-heated. Pre-heating of the water before vaporization increases the thermodynamic efficiency as the vaporization process is carried out nearer to the thermodynamic equilibrium. The energy required for such pre-heating may be derived from the cooling system of the piston engine and the still warm exhaust gas. The temperature of the injected water need not necessarily be at the same level as the temperature at which the compression is carried out. It can be higher in cases where a suitable source of thermal energy is available or lower if the cooling system of the engine cannot provide high temperatures. The compressed working gas-steam mixture leaves the screw compressor 353 and passes through the recuperator 354, where it is heated. The working gas-steam mixture passes through an intake pipe 355 and into a four-stroke piston engine 356. The piston engine 356 comprises a piston 357 reciprocating within the cylinder 358. Because the intake valve (not shown) is closed before the piston 357 reaches its bottom-dead-center position, the working gas-steam mixture is pre-expanded. Then, the mixture is combusted and then exhausted through an exhaust pipe 359. The exhaust pipe 359 is at a higher pressure than the intake pipe 355. Consequently, the valve timing is set in such a manner that no major throttling takes place during the exhaust stroke. The details of this valve timing are described in the valve timing section of this specification. The exhaust gas flows through the exhaust pipe 359 to the first expansion turbine 360. The exhaust gas, then, passes through the recuperator 354 where it heats the fresh working gas from the screw compressor 353. The controllable separator valve 362 splits the exhaust gas flow. A first portion of the exhaust gas flow and re-circulates through the re-circulation pipe 363 to the mixer 352. As described above, fresh air and re-circulated exhaust gas mix therein. A second portion of the exhaust gas flow is supplied to a second expansion turbine 365 where it is expanded to ambient pressure. Then it is discharged into the environment through the outlet 366.

It will be appreciated that the flow may be divided by the separator valve 362 according to the actual and potentially changing requirements. Other ratios according to the each actual condition (e.g., type of the engine, fuel, load, ambient temperature and pressure, etc.) are possible and may be controlled by the separator valve 362.

This process may be illustrated by the following detailed example. In FIG. 54, the compressor turbine 350 aspires an amount of approximately 6 kg/s of fresh air with a temperature of approximately 15° C. and ambient pressure of 1 bar through the inlet 351 and compresses it adiabatically to approximately 200° C. and approximately 5 bar. In the mixer 352, the compressed fresh air is mixed with the re-circulated exhaust gas at the same temperature and pressure levels of approximately 200° C. and approximately 5 bar, respectively. The re-circulated exhaust gas flow is approximately 4 kg/s. The produced working gas mixture is supplied to a screw compressor 353 which compresses it under continuous supply and vaporization of water to a pressure of approximately 25 bar while maintaining a temperature at approximately 200° C. The supplied water is pre-heated to approximately 200° C. and vaporizes at a rate of around 1.5 kg/s. As the working gas pressure upon aspiration by the screw compressor 353 is already at a level of approximately 5 bar the actual aspiration volume is largely reduced and a mechanical screw compressor may be used instead of a turbine. The screw compressor may be well-suited for the compression of a working gas under continuous vaporization of a liquid (e.g., water, etc.) as the compression takes a significantly longer time than in case of a turbine where the compression time per stage is around 0.1 ms, while even in a fast running screw compressor at least 10 ms may be reached.

Pre-heating of the water before vaporization increases the thermodynamic efficiency as the vaporization process is carried out nearer to the thermodynamic equilibrium. The energy required for such pre-heating may be derived from the cooling system of the piston engine and the still warm exhaust gas. The temperature of the injected water need not necessarily be at the same level as the temperature at which the compression is carried out. It may be higher in cases where a suitable source of thermal energy is available or lower if the cooling system of the engine cannot provide high temperatures.

The compressed working gas-steam mixture, otherwise known as the working gas in some embodiments, leaves the screw compressor 353 at a flow rate of approximately 11.5 kg/s and passes through the recuperator 354, where it is heated to approximately 500° C. while maintaining its pressure at approximately 25 bar. Afterwards, the pre-heated and pressurized air-steam mixture is directly supplied to the piston engine 356. The piston engine 356, comprising a piston 357 reciprocating within the cylinder 358, aspires the air-steam-exhaust gas mixture through an intake pipe 355.

The piston 357 moves down to aspire the hot working gas at an overall flow rate of approximately 11.5 kg/s and after pre-closing of the intake valve (not shown), i.e., before the piston 357 reaches a bottom-dead-center position, and pre-expands the aspired working gas to a pressure of approximately 5 bar, resulting in a temperature of approximately 200° C. Afterwards, as moving up, the piston 357 compresses the working gas mixture to reach a compression end temperature of around 800° C. and a pressure of around 100 bar. The high compression temperature may ensure ignition of the fuel, although the oxygen content is lower than in the case of pure air. The injection of approximately 0.3 kg/s of fuel and a immediate combustion causes both temperature and pressure of the working gas to rise to approximately 1700° C. and approximately 130 bar, respectively.

The piston 357 moves down to expand the hot working gas to a temperature of around 650° C. and a pressure of around 10 bar at a bottom-dead-center position. The discharge valve (not shown) opens and the still hot working leaves the cylinder 358 through the exhaust pipe 359 at a flow rate of approximately 11.8 kg/s. As described earlier, the valve timing is set in such a manner that a substantial displacement of the hot and still pressurized exhaust gas into the exhaust pipe 359, and no major throttling takes place.

The exhaust gas flows through the exhaust pipe 359 to the first expansion turbine 360 where it is expanded to a pressure of approximately 5 bar, resulting in a temperature of around 500° C. The exhaust gas then passes through the recuperator 354 where it heats the fresh working gas from the screw compressor 353 and cools down to approximately 200° C. maintaining its pressure at approximately 5 bar. The controllable separator valve 362 splits the exhaust gas flow and re-circulates an amount of approximately 4 kg/s through the re-circulation pipe 363 to the mixer 352. As described above, fresh air and re-circulated exhaust gas mix therein.

The remaining part of the exhaust gas is directly supplied to a second expansion turbine 365 where it is expanded to ambient pressure, resulting in a temperature of approximately 60° C. This part of the exhaust gas is discharged into the environment through the outlet 366 at a flow rate of approximately 7.8 kg/s.

It will be appreciated that the flow may be divided by the separator valve 362 according to the actual and potentially changing requirements. Other ratios according to the each actual condition (type of the engine, fuel, load, ambient temperature and pressure etc.) are possible and may be controlled by this separator valve 362.

D: Turbo-Charged Piston Engine with Pre-Expansion Valve Timing, which Re-Circulates the Hot Exhaust Gas and Mixes it with Oxygen-Enriched Air

Using oxygen-enriched air instead of pure air for thermal engines may be advantageous. This may lead to semi-closed engines where a large part of the working gas is re-circulated and only an amount of oxygen-enriched air is aspired and fed into the engine which is required to burn the fuel.

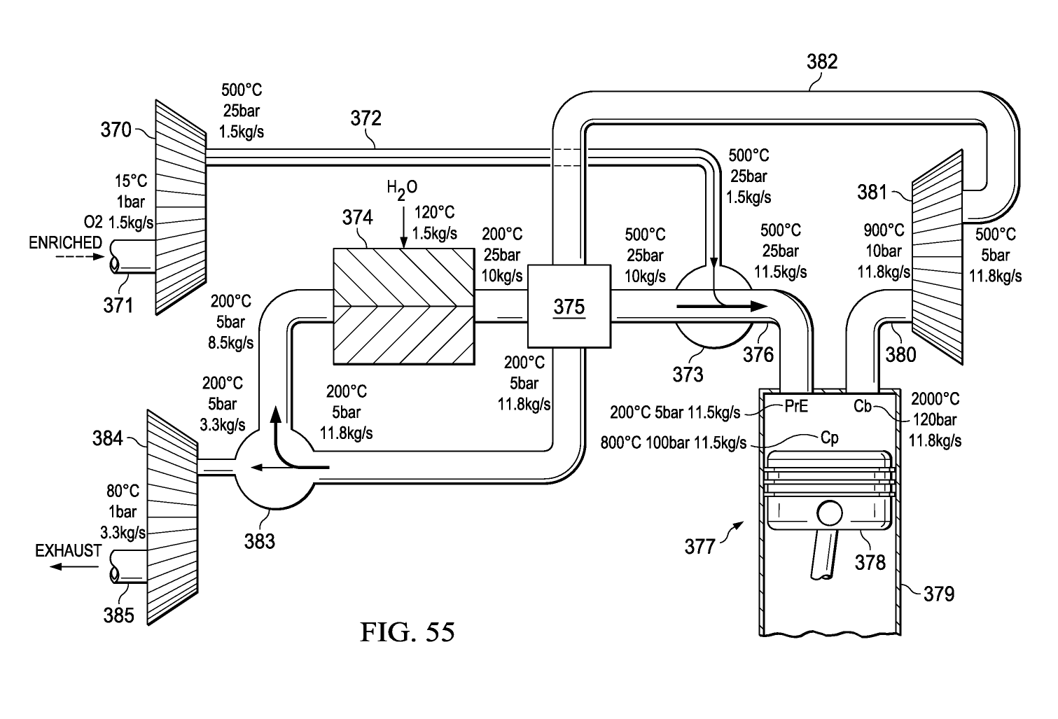

FIG. 55 is a schematic diagram of and embodiment of a turbo-charged four-stroke piston engine which carries out a semi-closed cycle by re-circulating a portion of the exhaust gas at increased temperature and pressure levels and aspiring oxygen-enriched for combustion. The forthcoming values for temperature, pressure and flow rate are for illustrative purposes and are not limiting in any way.

The oxygen-enriched air is produced by external equipment (not shown). In the illustrated embodiment, the oxygen content is increased to approximately 50%, but it be appreciated that any suitable oxygen content may be employed. This may be easily done by selective temporal absorber crystals as, for example, zeolith, or by any other suitable means. The energy consumed for this oxygen enrichment may be comparably low.

The compressor turbine 370, which may be replaced by a screw or rotary vane compressor, or any other mechanical compressor type, aspires oxygen-enriched air through the inlet 371 and compresses it. The compressed oxygen-enriched air is supplied through the pipe 372 to the mixer 373 where it is mixed with the re-circulated exhaust gas which has been compressed by the screw compressor 374 under continuous vaporization of and then pre-heated in a recuperator 375. The mixed working gas then flows through the intake pipe 376 to the piston engine 377. This piston engine comprises a piston 378 reciprocating in the cylinder 379. Because the intake valve (not shown) is closed before the piston 378 reaches a bottom-dead-center position, the working gas-steam mixture is pre-expanded. Then the mixture is combusted and then exhausted through an exhaust pipe 380. The expansion turbine 381 aspires the hot exhaust gas end expands it. The pipe 382 supplies the expanded exhaust gas to the recuperator 375 where the exhaust gas heats the re-circulated and compressed exhaust gas from the screw compressor 374. The subsequent controllable separator valve 383 splits the exhaust gas flow into a major flow and a minor flow. The major part of the exhaust gas is supplied by the separator valve 383 to the inlet of the screw compressor 374. The screw compressor 374 compresses the still pressurized and warm exhaust gas under continuous supply of water. As the exhaust gas already contains a considerable amount of steam, such compression begins nearer to the thermodynamic equilibrium as in case of a dry or fresh air. The large amount of re-circulated exhaust gas may improve this effect without significantly affecting the vaporization rate. The minor flow is supplied to the expansion turbine 384. This expansion turbine 384 expands the exhaust gas to ambient pressure. The corresponding expanded exhaust gas leaves the outlet 385.

This process can be illustrated by the following detailed example. In FIG. 55, the compressor turbine 370 (which may be replaced by a screw or rotary vane compressor, or any other suitable mechanical compressor type) aspires an amount of approximately 1.5 kg per second of oxygen-enriched air with a temperature of approximately 15° C. and ambient pressure of approximately 1 bar through the inlet 371 and compresses it adiabatically to approximately 500° C. and approximately 25 bar. These gas parameters correspond to that of the re-circulated and recuperated exhaust gas. The compressed oxygen-enriched air is supplied through the pipe 372 to the mixer 373 where it is mixed with the re-circulated exhaust gas which has been compressed by the screw compressor 374 under continuous vaporization of water to approximately 200° C. and approximately 25 bar and then pre-heated in the recuperator 375 to approximately 500° C. and approximately 25 bar. An amount of approximately 1.5 kg/s of water vaporises in the course of compression in the screw compressor 374 and is, therefore, added to the re-circulated exhaust gas flow of approximately 8.5 kg/s, resulting in an overall flow of approximately 10 kg/s which enters the mixer 373. The mixed working gas (oxygen-enriched air, re-circulated exhaust gas and steam in the following simply called “working gas” in some embodiments) then flows with a rate of approximately 11.5 kg/s through the intake pipe 376 to the piston engine 377. This piston engine comprises a piston 378 reciprocating in the cylinder 379. The intake valve (not shown) opens and aspires an according amount of working gas before it closes to allow the piston 378 to expand it to a temperature of approximately 200° C. at a pressure of approximately 5 bar.

The piston 378 moves up to compress the working gas to approximately 800° C. and a corresponding pressure of approximately 100 bar. Now, approximately 0.3 kg of fuel is injected and burns. The combustion causes the temperature to rise to approximately 2000° C. and the pressure to approximately 120 bar. The piston 378 moves down to expand the hot working gas to approximately 900° C. and a pressure of approximately 10 bar. The discharge valve (not shown) opens and the hot exhaust gas leaves the cylinder 379 at a flow rate of approximately 11.8 kg/s into the exhaust pipe 380.

The expansion turbine 381 aspires the hot exhaust gas end expands it down to a pressure of approximately 5 bar, resulting in an expansion end temperature of approximately 500° C. The pipe 382 supplies the expanded exhaust gas to the recuperator 375 where the exhaust gas heats the re-circulated and compressed exhaust gas from the screw compressor 374 and cools down to approximately 200° C. while maintaining a pressure at approximately 5 bar.

The subsequent controllable separator valve 383 splits the exhaust gas flow into a minor flow of approximately 3.3 kg/s which is supplied to the expansion turbine 384. This expansion turbine 384 expands the exhaust gas to ambient pressure resulting in a temperature of around 80° C. The corresponding expanded exhaust gas leaves the outlet 385 at a flow rate of approximately 3.3 kg/s into the environment.

The major part of the exhaust gas is supplied by the separator valve 383 to the inlet of the screw compressor 374 at a flow rate of approximately 8.5 kg/s. The screw compressor 374 compresses the still pressurized and warm exhaust gas under continuous supply of water to a pressure of approximately 25 bar while maintaining its temperature at approximately 200° C. As the exhaust gas already contains a considerable amount of steam such compression begins nearer to the thermodynamic equilibrium as in case of dry or fresh air. The large amount of re-circulated exhaust gas improves this effect without significantly affecting the vaporization rate as the temperature of the re-circulated exhaust gas remains high enough.

E: Turbo-Charged Piston Engine with Pre-Expansion Valve Timing, which Re-Circulates the Hot Exhaust Gas and Mixes it with Oxygen-Enriched Air and Furthermore has a Steam Condenser

If the steam content in the exhaust gas rises beyond a certain share, then the dew point may reach temperatures too high for an efficient engine operation because the dew point basically defines the lower temperature level of the engine in the thermodynamic Carnot model. A dew point above 70° C. to 80° C. is unacceptable under normal ambient conditions. To remove the increased steam content a condenser may be installed.

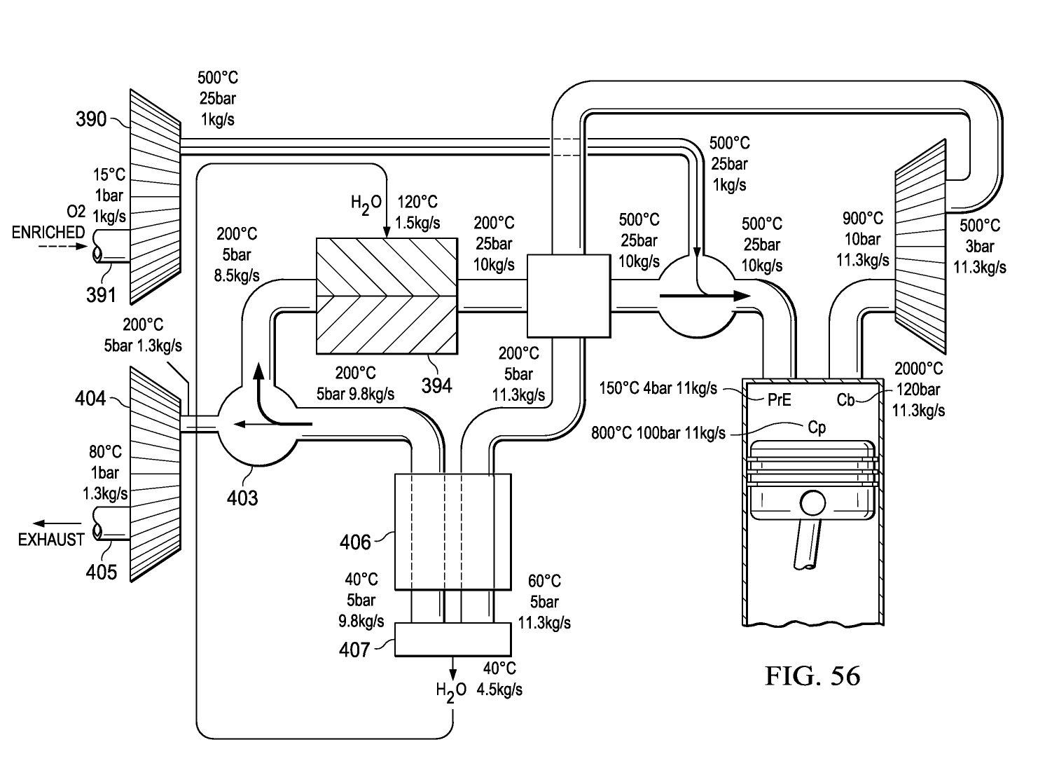

FIG. 56 is a schematic diagram of an embodiment of a turbo-charged four-stroke piston engine which employs a condenser to remove excess steam from the re-circulated exhaust gas. The engine uses highly oxygen-enriched air (oxygen content >70%) for combustion purposes. The forthcoming values for temperature, pressure and flow rate are for illustrative purposes and are not limiting in any way.

The embodiment shown in FIG. 56 differs from that shown in FIG. 55 only in that the compressor turbine 390 (which may be replaced by a screw or rotary vane compressor, or any other mechanical compressor type) aspires highly oxygen-enriched air with 75% oxygen content at an intake flow rate of only approximately 1 kg/s through the inlet 391 and compresses it adiabatically to approximately 500° C. and approximately 25 bar. Also, the exhaust gas passes through a recuperator 406 where it is cooled down to approximately 60° C. the dew point of the steam in the exhaust gas. Then, the condenser 407 removes the amount of water that was vaporized in the course of compression in the screw compressor 394.

The condensed water may be re-circulated to the screw compressor 394 for re-vaporization. The dried exhaust gas leaves the condenser with a temperature of approximately 50° C. and is re-heated by the new exhaust gas in the recuperator 406 again to a temperature of around 200° C. The separator 403 separates, as already described above, the re-circulated exhaust gas and the exhaust gas which is further expanded to ambient pressure in the expansion turbine 404 and discharged into the environment through the outlet 405.

By removing most of the steam produced by vaporization in the screw compressor 394, in the condenser 407, the dew point of the exhaust gas leaving the outlet 405 decreases and the overall thermodynamic efficiency of the piston engine rises as the temperature, or the lower thermal reserve, which is basically given by the dew points in the condenser 407 and after discharge into the environment, is decreased. Without the condenser 407, the steam content would quickly rise in the course of engine operation to a relatively high value, because even at a discharge rate of approximately 2.8 kg/s through the outlet 405 (the total of aspired oxygen-enriched air through the inlet 391, the vaporized water in the screw compressor 394 and the fuel mass) only the steam fraction may be over 50% causing a dew point of at least 85° C.

### IX: Multi-Stage Inter-Cooled Compressor

A multi-staged and inter-cooled compression may useful when a cool dry compressed gas is required. It may be used areas where no water is available to perform cooling in a compressor through vaporization. It may be also advantageous for mobile applications, like cars and trucks, where both space and weight are limited so that no major amount of water, or other fluid, may be carried along. Also, in very cold environments, such inter-cooling may show major benefits, e.g., in very cold areas where the ambient temperature is near or even well below 0° C. Under such circumstances a lower temperature of the cycle may be reached which is considerably below the lower temperature reachable with water or another vaporisable liquid. When combining such an inter-cooled compressor, with a heat exchanger (e.g., recuperator), a pre-expansion means, and ceramic or effusion isolation, a substantial increase in efficiency can be obtained, as explained by the following detailed descriptions.

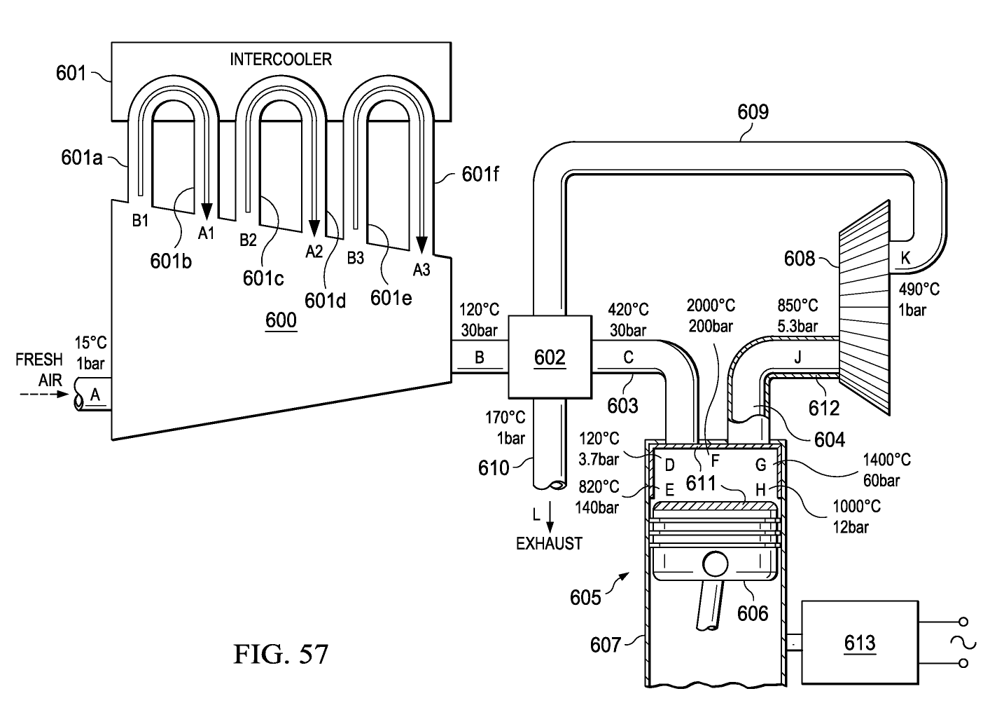

FIG. 57 shows a piston engines which combines multiple inter-cooled high-compression by a compressor turbine, a recuperator, pre-expansion in the piston engine, ceramic isolation of the combustion chamber, isolated exhaust gas path and minor throttling to provide all of the net mechanical power on the piston engine's crankshaft. FIG. 58 is a theoretical S-T diagram of the thermodynamic cycle carried out by the embodiment shown in FIG. 57. These figures will be explained in conjunction with one another. The forthcoming values for temperature, pressure and flow rate are for illustrative purposes and are not limiting in any way.

Please note that in all of the following embodiments the terms “ceramic layers” encompass not only layers of ceramic material but also other types of thermal isolation against the environment. For example, due to thermal stress reasons, the “ceramic layer” may have a metallic outer layer or any other surface to deal with rapidly changing temperature.

A multi stage compressor turbine 600, as shown in FIG. 57, aspires a gas at an ambient temperature and pressure. In the compressor turbine's 600 first stage, the turbine compresses the gas to a first temperature and pressure. Then, the gas is transferred to the intercooler 601 through a first pipe 601a. The gas is cooled to a second temperature, lower than the first temperature, while the pressure of the gas remains at the first pressure. Then, the gas is passed back to the compressor turbine 600 through a second pipe 601b. The compressor 40 compresses the gas to a third temperature, higher than the first and second temperatures, and a second pressure higher than the first temperature. The gas is then passed through a third pipe 601c and enters the intercooler 601 again. The inter-cooling and compressing cycle continues until a final temperature and pressure are achieved and the gas is discharged. If the multi-stage compressor turbine 600 is a part of a larger system, as shown in FIG. 57, the gas will then pass through a recuperator 602, a piston engine 605, an expansion turbine 608, the recuperator 602 again, and is finally discharged. The piston engine 605 may also be used to power a generator 613, or any other suitable device, through the engine's crankshaft.

This process may be illustrated by the following example. In FIG. 57, the radial compressor turbine 600 aspires fresh air at ambient conditions, around 15° C. and 1 bar, and compresses it under multiple inter-cooling in the external inter-cooler 601. The compressor turbine 600 comprises four radial stages, and the inter-cooler 601 has three cooling stages. After the first compressor stage, the compressed and, hence, heated air is supplied to the first inter-cooler stage through the outlet 601a and returned to the second compressor stage though the inlet 601b. Accordingly, the subsequent stages supply through the outlets 601c and 601e compressed and heated air to the corresponding second and third inter-cooler stages, while the inlets 601d and 601f receive the cooled air from the inter-cooler stages. The fourth compressor stage delivers the compressed air at a temperature of around 120° C. and a pressure of around 30 bar. The pressure compression ratio of each stage may be around 2.35:1. This value may also be reached with axial compressor turbines with 2 or 3 stages each. Radial compressor turbines may be better suited for smaller piston engines, axial turbines for larger piston engines.

This compression-recuperation process is shown in FIG. 58 as four adiabatic (isentropic) compression state changes A→B1 (compression in the first compressor stage), A1→B2 (compression in the second compressor stage), A2→B3 (compression in the third compressor stage) and A3→B (compression in the fourth and last compressor stage). The inter-cooling is indicated by state changes B1→A1 (corresponding to the outlet 601a and the inlet 601b), B2→A2 (corresponding to the outlet 601c and the inlet 601d) and B3→A3 (corresponding to the outlet 601e and the inlet 601f).

The recuperator 602 receives the compressed and heated air and increases the temperature further to around 420° C. while maintaining the pressure at around 30 bar (state change B→C). The compressed air, or air-fuel mixture if, for example, natural gas or liquid fuel has been supplied through the intake pipe 603 to the air by mixing or injection, is supplied to the piston engine 605.

The piston engine 605 comprises a piston 606, which is reciprocating in the cylinder 607. To decrease cooling losses, ceramic layers 611 are formed to isolate the surfaces of the combustion chamber. The ceramic layers 611 may be delimited by the top surface of the piston 606, an annular area of the cylinder 607 surface exposed to the working gas at ignition, and that part of the cylinder 607 head facing that combustion space. Alternatively, the ceramic layers 611 cover the entire piston 606 and cylinder 607. In other embodiments, ceramic valves may be used instead of or in addition to ceramic layers 611.

The piston engine 605 aspires the compressed and pre-heated air or air-fuel mixture and carries out a pre-expansion so as to lower the pressure to approximately 3.7 bar and a corresponding temperature of approximately 120° C. This expansion is in theory a pure isentropic state change, but in practice—taking into account the limited efficiency of the piston engine and some re-flow of thermal energy to the freshly aspired air from the hot ceramic surfaces due to earlier combustion processes and cycles—some entropy increase may occur. This is indicated in FIG. 58 by the line C→D which is somewhat inclined to higher entropy values to indicate this effect.

By moving up, the piston 606 compresses the working gas to finally reach a pressure of approximately 140 bar and a temperature of approximately 820° C. This corresponds to a volume compression ratio of around 13:1, e.g., a medium compression ratio for today's super-charged stationary gas and diesel engines. The state change D→E in FIG. 58 depicts this state change by a line slightly inclined towards higher entropy as the compression stroke is not completely isentropic due to efficiency deficits of the piston engine itself and also due to re-flow of thermal energy from the ceramic layers 611, especially at the end of compression when the working gas pressure rises sharply.

Ignition occurs and the fuel is burnt. This is indicated in FIG. 58 by the line E→F. It will be appreciated, however, that the actual combustion line may be somewhat more complicated as several effects may occur which may deviate the line in the theoretical S-T diagram. For example, limited combustion speed which already leads to a certain piston movement and, hence, expansion may be the case.

During and immediately after combustion, the working gas temperature of around 2000° C. is much higher than the temperature of the ceramic layers 611, and also the pressure of the working gas of around 200 bar is high, a significant flow of thermal energy takes place from the hot and pressurized flue gas in the cylinder 607 to the ceramic layers 611. Consequently, the ceramic layer surface is heated but the overall flow of thermal energy through the thickness of the ceramic layers 611 may be low. This flow of thermal energy means a temperature decrease of the expanding working gas, which may be quicker than the temperature decrease would be—even in case of a perfect adiabatic and isentropic state change. This is indicated in FIG. 58 by the line F→G which is inclined towards lower entropy values (dS=dQ/T is smaller than zero as thermal energy is extracted from the working gas to the ceramic layer surface, i.e., dQ<0).

At a certain intermediate expansion point G, which is typically before the halfway point, is passed by the piston towards a bottom-dead-center position, the temperature of the expanding and, hence, cooling working gas may equal the surface temperature of the ceramic layers 611 that were heated in the course of the preceding partial expansion. In the described embodiment, the temperature at point G reaches around 1400° C. and the corresponding working gas pressure is around 60 bar. With little or no temperature difference left, no transfer of thermal energy may take place and in the course of the ongoing expansion, the working gas temperature may drop significantly below the ceramic layer temperature. This causes a re-flow of thermal energy from the now hotter ceramic layer surfaces to the working gas. Consequently, the temperature drop of the expanding working gas may be lower than would be the case even for a perfectly isentropic and adiabatic expansion (dQ>0 and, hence, dS=dQ/T>0). The state change line G→H, which indicates the remaining working gas expansion until the bottom-dead-center of the piston is reached, may therefore be inclined toward higher entropy values. The expansion end temperature reaches around 1000° C. at an expansion end pressure of around 12 bar.

An additional feature of the described embodiment is that all of the net power produced by the engine, including the super-charger part composed by the compressor turbine 600 and the following expansion turbine 608, may be delivered by the crankshaft of the piston engine, and may drive, for example, a generator 613 to produce electricity. This means that the whole charger portion of the engine is an external device. In other words, the expansion turbine 608 may produce at least enough mechanical power that may be required to drive the compressor turbine 600; in one embodiment, the expansion turbine 608 produces only enough power to drive the compressor turbine 600 and no more. There will be no net power produced by the turbo-charger, and, in the case of traditional turbo compound systems, the power must either be transferred to the crankshaft by means of a gear or belt drive, or must be used by an additional generator or other power consuming device.

The aforementioned characteristic of this embodiment are achieved by throttling the exhaust gas after expansion in the piston engine 605 into the exhaust gas collection pipe 604 (state change H→J in FIG. 58). To minimize the thermal losses in this pipe 604, the pipe 604 is isolated by insulating means, such as ceramic layers 612. Also, all exhaust channels in the cylinder head (not shown) of the piston engine 605 may also be isolated.

It will be appreciated that in case of this embodiment, throttling may be carried out to a minor extent as compared to traditional engines. The pressure after throttling is maintained at a pressure of around 5.3 bar whereas traditional engines usually have a pressure after throttling of 2 or 3 bars. Also, the exhaust gas temperature may be considerably higher before and after throttling than in the case of traditional engines. Both characteristics lead to a lower entropy increase than is the case in traditional engines. It is therefore possible to throttle somewhat without losing a significant share of efficiency. For example, the efficiency decrease by the described throttling of this embodiment may be around 1% as compared to more than 3% in the case of traditional engines. This 1% efficiency loss may be largely compensated by the lack of efficiency-consuming gears. Furthermore, operating costs may also be lower because no external power devices, such as gears, belts, generators are required.

The pressure of around 5.3 bar is further lowered in the subsequent expansion turbine 608 by expanding the hot and pressurized exhaust gas down to ambient pressure of around 1 bar. This expansion results in an exhaust gas temperature of around 490° C. This means a temperature gradient of 70K in the recuperator 602 and, consequently, a compact and cheap heat exchanger. The expansion in the turbine 608 is indicated in FIG. 58 by the line J→K which is somewhat inclined towards higher entropy values to reflect the limited efficiency of this expansion turbine 608. After passing through the recuperator 602 and heating the compressed fresh air from the compressor turbine 600 (state change K→L in FIG. 58), the expanded exhaust gas leaves the exhaust 610 with a temperature of around 170° C., taking into account thermal losses from the recuperator 602 to the outside cause by limited thermal isolation of pipes and the recuperator 602 itself. By mixing with ambient air, the exhaust gas further cools down and finally reaches substantially ambient temperature. The line L→A indicates this final cooling process.

The illustrative embodiment may reach overall efficiencies of 55% or even higher. Due to the fact that nearly all of the produced net power is available at the crankshaft, complexity and costs of the overall arrangement may be reduced. Known turbo compound systems require a complex and expensive additional power engine which is coupled to the crankshaft. Especially in the case of maritime vessels or electricity generation, it is desired to have all or at least nearly all of the produced power at the crankshaft so as to drive one propeller or one generator. In the case of varying loads, the complete charger system may operate independently at different rotation speeds, pressures etc. No adaptation to the crankshaft rotation is necessary. This may also increases the efficiency in part-load.

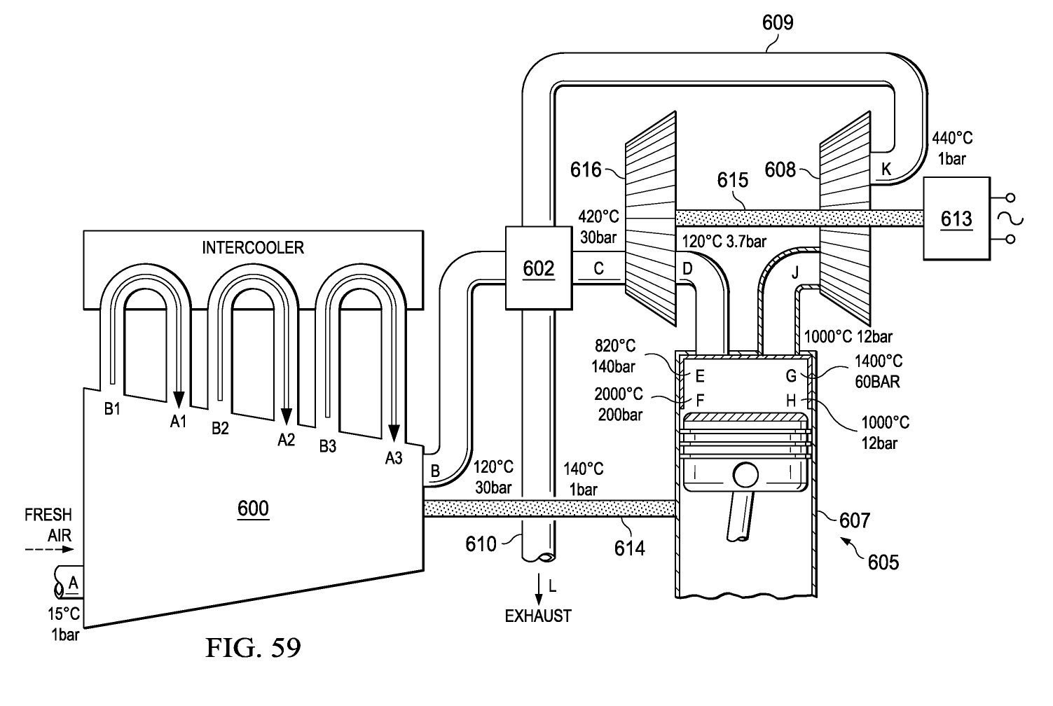

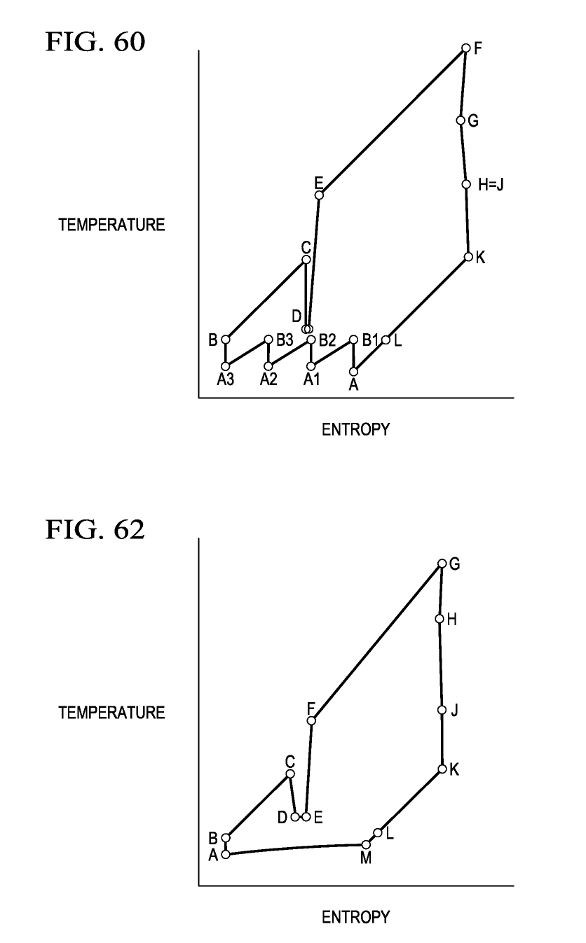

Another embodiment is shown in FIG. 59 where all of the mechanical energy may be delivered on the shaft of the expansion turbines. FIG. 60 is a theoretical S-T diagram of the thermodynamic cycle carried out by the embodiment shown in FIG. 59. These figures will be explained in conjunction with one another. Corresponding elements between the embodiments according to the FIGS. 57 and 59 are denominated with the same reference numbers. Additionally, the forthcoming values for temperature, pressure and flow rate are for illustrative purposes and are not limiting in any way.

The inter-cooled compression of fresh air is carried out in a multi-stage inter-cooled compressor turbine 600 as above (state changes A→B1→A1→B2→A2→B3→A3→B in FIG. 60). The main difference between the two embodiments is that the present embodiment shown in FIG. 59 performs a pre-expansion after the pre-heating in the recuperator 602 (state change B→C) in an external second expansion turbine 616 (state change C→D). Temperature and pressure after this pre-expansion is basically the same as has been the case for the above embodiment after the pre-expansion is carried out by the piston engine 605. In this embodiment the piston engine 605 performs little or no pre-expansion and receives the working gas at a temperature of 120° C. and a pressure of around 3.7 bar. The combustion space of the piston engine is isolated in the same manner with ceramic layers or ceramic components.

After expansion in the piston engine, the same flow and re-flow of thermal energy to and from the ceramic layers or components (F→G→H in FIG. 60) occurs. The exhaust gas is not throttled here, but, instead, is displaced at basically constant pressure into the exhaust gas collection pipe at a temperature of around 1000° C. and a pressure of around 12 bar. The state J after throttling corresponds to the same state H as where no throttling is carried out. Both the temperature and pressure are higher than is the case in the above described embodiment. Due to the higher pressure expansion ratio (approximately 12:1) in the expansion turbine 608, a lower exhaust gas temperature may be reached. This directly corresponds to a higher efficiency as no entropy increasing throttling occurs. The higher exhaust gas temperature with throttling indicates an entropy increase and corresponding efficiency decrease. The exhaust gas is supplied through the pipe 609 to the recuperator 602 where it heats the compressed fresh air (state change B→C) from the compressor turbine 600 while cooling down (state change K→L in FIG. 60). Finally, the exhaust gas is discharged into the environment through the exhaust 610, but at a lower temperature than in the case of the above described embodiment, around 140° C. as compared to around 170° C. In one illustrative embodiment, this lower final discharge temperature indicates a somewhat higher overall efficiency of between 1% and 2% or possibly more.

The two expansion turbines 616 and 608 are mounted on a common shaft 615 and together drive the generator 613 to produce electricity. On the other hand, the piston engine 605 directly delivers the compressor turbine 600 through the shaft 614. No power from the two expansion turbines 616, 608 is used to drive this compressor turbine 600. By choosing the pressure and compression-expansion ratio of all three turbines 600, 608 and 616, and the operating parameters of the piston engine 605, the power of the piston engine 605 may be as needed by the compressor turbine 600. In this case, the combination compressor turbine 600 and piston engine 605 may act as the external passive device which delivers compressed working gas to the expansion turbines 608 and 616 so that all of the net power is produced on the shaft 615. Also, in this case the net power is delivered only on one single shaft. Consequently, only one generator or other consumer of mechanical power may be required.

Of course, all other strategies as have been described earlier, may be applied. These include, but are not limited to: an additional expansion turbine after the recuperator to reduce the discharge temperature further; liquid vaporization instead of inter-cooling in the compressor; water injection into the cylinder 607 in the course of a first part of compression, etc.

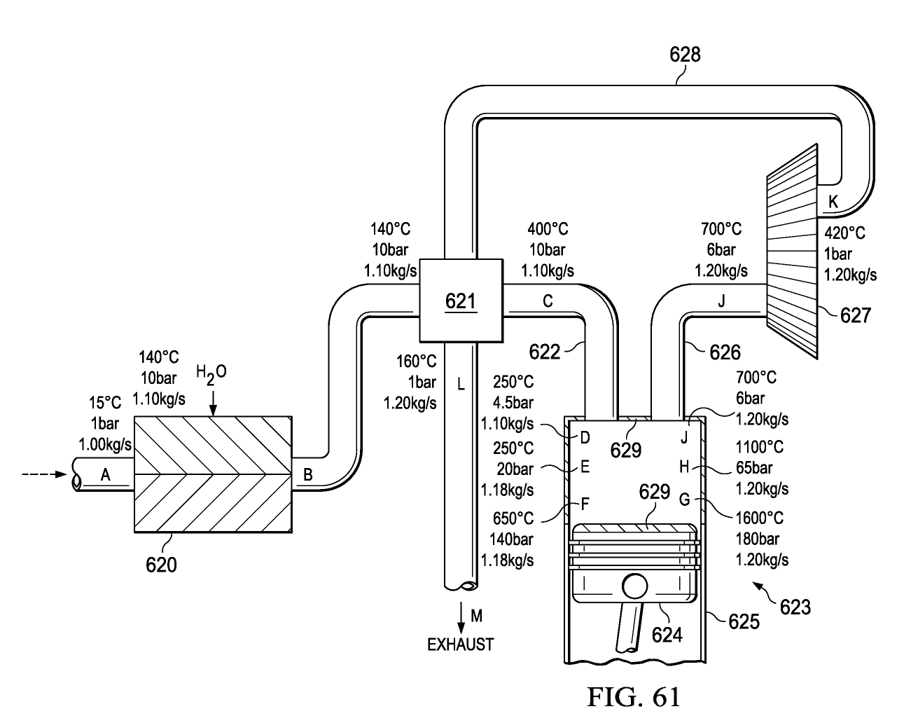

Referring now to FIG. 61, a piston engine 623 with around 1.5 MW of thermal power and an efficiency of greater than 50% is shown. The pre-compression may be carried out by a screw compressor 620 which compresses fresh air under continuous vaporization of water. Contrary to the both embodiments described above, this piston engine 623 uses a combination of ceramic and effusion isolation. The corresponding surfaces layers 629 are made of a ceramic material and have cavities for effusion isolation formed therein, as described in detail in earlier embodiments. Effusion isolation cannot avoid the thermal radiation emitted by the hot combustion gas, and other hot particles formed therein in the course of combustion, and pass through this “curtain” of insulating gas flowing out of the cavities. This radiation may be absorbed by the surface of the combustion space and heat the combustion space accordingly. However, effusion isolation lowers the transfer of thermal energy because this radiation only significantly heats the combustion space during a very short period of time of the highest combustion temperature. The amount of thermal energy absorbed by the combustion space surface may be considerably lower than in case of a pure ceramic isolation. This is indicated in FIG. 62 by lines G→H and H→J which are more in parallel to the T axis than in case of FIGS. 58 and 60, e.g., basically vertical. An portion of the thermal energy transferred to the surface layers 629 is re-transferred to the expanding working gas as soon as the temperature of the expanding working becomes lower than the temperature of the ceramic layers.

The forthcoming values for temperature, pressure and flow rate are for illustrative purposes and are not limiting in any way. The screw compressor 620 aspires fresh air at ambient condition of around 15° C. and 1 bar (point “A” in FIG. 62) and compresses it under continuous supply and vaporization of water to a pressure of around 10 bar, resulting in a temperature of around 140° C. The amount of vaporised water is approximately 0.1 kg/s. This compression my be nearly an isentropic state change. Hence, the corresponding line A→B (FIG. 62) is nearly in parallel to the T axis. In the recuperator 621 the compressed working gas (air-steam mixture) is heated to around 400° C. while maintaining of pressure around 10 bar (state change B→C in FIG. 62). The piston engine 623 aspires this pre-heated and pre-compressed working gas and pre-expands it to around 4.5 bar and a temperature of around 250° C. (C→D). At this temperature, the working gas is sub-saturated with steam and may vaporise any injected water due to the increased temperature and pressure of the working gas.

The piston 624 moves up and starts to compress the working gas. Water is injected into the piston chamber at a rate of around 0.08 kg/s and vaporises due to the increased pressure and temperature of the working gas, until a pressure of around 20 bar is reached. Because of the vaporization energy of the injected water, the temperature is nearly constant at around 250° C. (state change D→E in FIG. 62). Entropy rises because the vaporization of a liquid in a sub-saturated space is an irreversible process. However, as the pressure is substantially higher than ambient pressure, this vaporization occurs nearer to equilibrium than would be the case for a lower pressure. Hence, an entropy increase will decrease the theoretical cycle efficiency only by 2% to 3%, while, on the other hand, a efficiency increase may occur due to the larger condensation energy transferred at the comparably low dew point.

After the piston has reached the intermediate point “E”, water injection stops. Point E is situated at around 75% of the piston's travel to top-dead-center and is equivalent to an “isothermal” compression ratio of 4:1. Further adiabatic compression is carried out for the remainder of the compression stroke (E→F). Consequently, both temperature and pressure rise and finally reach values of 650° C. and 140 bar, respectively. Now, combustion of the fuel begins as fuel is supplied at a rate of around 0.02 kg/s (state change F→G). Combustion raises the temperature to around 1600° C. and the pressure to around 180 bar causing a minor inflow and then an out-flow of the gases from the cavities in the surface layers 629.

As the piston 624 continues moving towards a bottom-dead-center position, the working gas is expanded and the gas in the cavities starts to move out, thereby producing an insulating layer on the combustion chamber surfaces. Any thermal energy transferred by radiation or by the short in-flow of the flue gas immediately upon combustion (as the combustion pressure is a little higher than the compression end pressure for a short period of time) is stored in the surface of the layers 629 and not transferred to any external cooling liquid or the engine jacket. Therefore, a considerably lower transfer of thermal energy occurs in this phase as compared to the above described embodiments which only employ ceramic isolations. Consequently, the line G→H indicating this first phase of expansion is less inclined towards lower entropy values because the transferred thermal energy (dQ) is lower. As soon as the temperature of the expanding working gas has reached the value of the surface layers 629, being approximately 1100° C. and approximately 65 bar (point “H”), thermal energy re-flow into expanding working gas begins. The corresponding state change line H→J is, therefore, inclined towards higher entropy values. With the piston 624 at or near the bottom-dead-center position, the working gas temperature has decreased to approximately 700° C. and a pressure of 6 bar. The working gas may then be transferred by opening the exhaust valve and the movement of the piton 624 into the exhaust gas collection pipe 626 at substantially constant pressure and temperature.

The expansion turbine 627 further expands (J→K) the still pressurized and hot exhaust gas to ambient pressure of approximately 1 bar and a corresponding temperature of approximately 420° C. The gas then passes through the recuperator 621 where it is cooled to approximately 160° C. while maintaining its pressure of approximately 1 bar (K→L) before being discharged into the environment through the exhaust. By mixing with ambient air, the working gas cools down to its dew point and condensation of the steam occurs. In case of hot and/or dry environments, condensation may not occur but rather the steam may be diluted in ambient air. The described engine may reach efficiencies of approximately 50% or more.

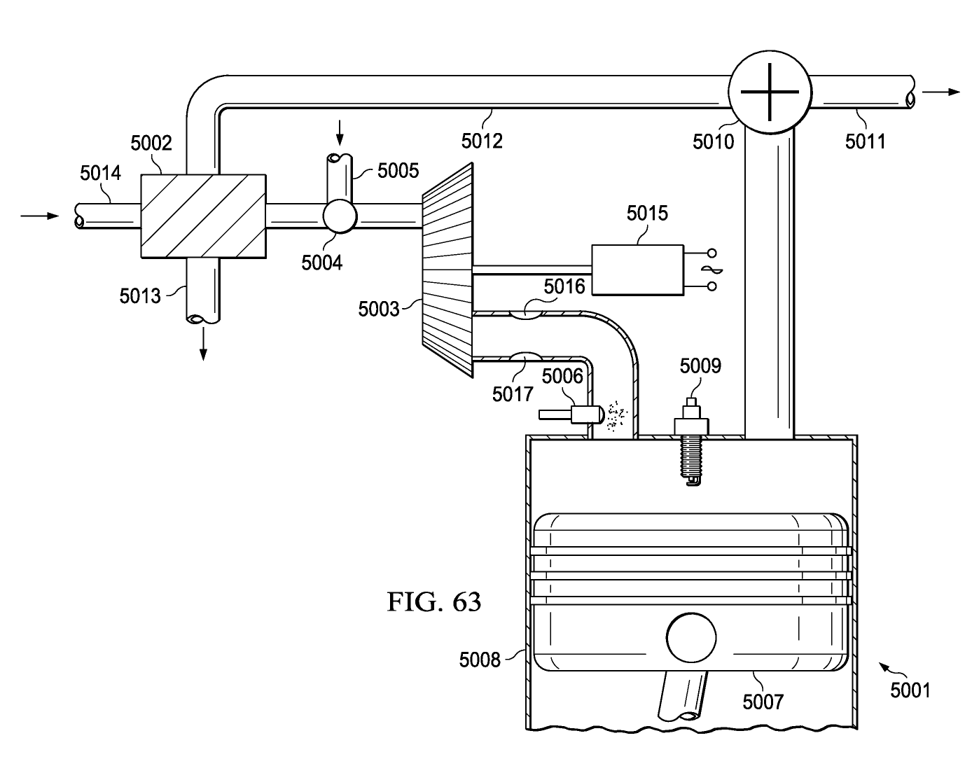

FIG. 63 shows the basic arrangement or system 5000 having a piston engine 5001 with a heat exchanger 5002 and an expansion turbine 5003, according to one illustrative embodiment. Under or near full-load, the inlet flap or valve system 5004 may be controlled in such a manner that the fresh air is directly aspired through the inlet channel 5004 and may be controlled in such a manner that the fresh air is directly aspired through the inlet channel 5005. The expansion turbine 5003 may be idle and allow the fresh air pass without expansion (this can also be accomplished by a non-shown bypass). The injection nozzle 5006 injects the corresponding amount of fuel before the gas (now air-fuel mixture) is aspired by the piston 5007 into the cylinder 5008. This mixture may be compressed and then ignited by the actuation of the spark plug 5009. The fuel burns and the rising pressure drives the piston 5007 downward to produce mechanical energy. Afterwards, the still hot combustion gas is discharged through the outlet flap or valve system 5010 into the outlet channel 5011 and finally into the environment. Under or near full-load, the outlet flap or valve system 5010 controls the flow of the hot exhaust gas in such a manner that only a part of the exhaust gas is guided through the channel 5012 into the heat exchanger 5002 in order to maintain this heat exchanger 5002 at a sufficiently high temperature. The exhaust gas flowing through the heat exchanger 5002 may be discharged into the environment through the outlet 5013.

If the load is reduced, more of the hot exhaust gas may be guided into the channel 5012 by the outlet flap or valve system 5010 to increase the heating power of the heat exchanger 502. The inlet flap or valve system 5004 now controls the flow of fresh air so that more fresh air is aspired through the inlet 5014 and passing through the heat exchanger 5002 where this fresh air is warmed up. To adjust the temperature of the air guided to the expansion turbine 5003 additional cool air may be aspired through the inlet 5005 and mixed in or after the inlet flap or valve system 5004. The expansion turbine 5003 now expands this heated air and delivers mechanical power to the generator 5015 for generating electricity. A temperature sensor 5016 and a pressure sensor 5017 may detect the gas state of the aspired air, i.e., its temperature and pressure. These detected parameters may be used to adjust the inlet flap or valve system 5004 and the outlet flap or valve system 5010 in such a manner that the desired air temperature and pressure after the expansion turbine 5003 are achieved. The temperature may be as high as 200° C., or higher, and the pressure may drop to ⅕^{th} of ambient pressure, or lower, after the expansion turbine 5003. The elevated air temperature may help to assure a complete evaporation and homogeneous distribution of the fuel injected by the nozzle 5006.

Under part-load, or partial load, since the temperature is higher than ambient temperature and the pressure is below ambient pressure, the mass flow of the aspired air into the piston engine's cylinder 5008 may be lower than under full-load.

In one illustrative embodiment, existing engines may be modified to approximate the system 5000. The heat exchanger 5002 may be relatively small, since, in partial load, a reduced heat power may be transferred from the exhaust gas to the freshly aspired air as compared to the thermal power of the engine at full-load. Some flaps may be omitted or replaced by another suitable control mechanisms (e.g., valves, etc.).

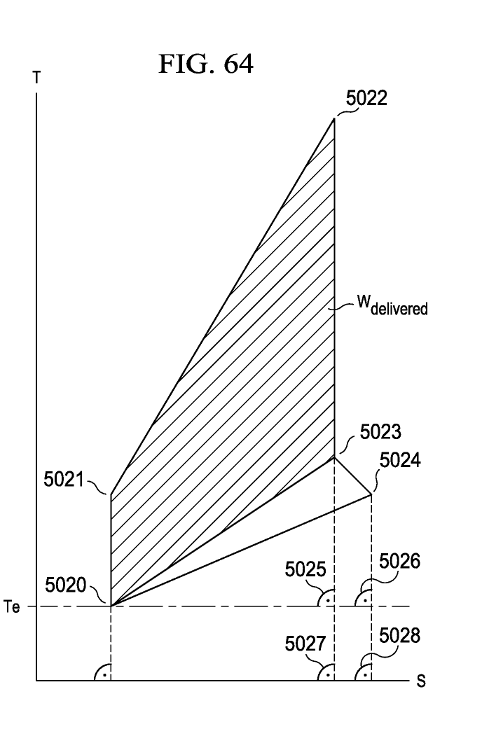

FIG. 64 shows an example of a thermodynamic process carried out under full-load for a four-stroke Otto engine in a theoretical S-T diagram. To simplify the description, an ideal gas is assumed. First, the air is compressed adiabatically (state change 5020 to 5021); then, the fuel is burnt (5021 to 5022), thereby raising the temperature and pressure in the cylinder 508. The hot combustion gas is expanded adiabatically (5022 to 5023). As soon as the discharge valve opens, the still hot and pressurized combustion gas is discharged into the environment (5023 to 5024). This discharge constitutes an anisentropic throttling, i.e., the temperature lowers and the entropy rises. No significant, in principle, reversible, isochoric cooling occurs but an irreversible throttling from the high pressure in the engine's cylinder (which may well exceed 5 bar) down to ambient pressure (around 1 bar). Afterwards, the exhaust gas is cooled down to ambient temperature usually by mixing with the ambient air (5024 to 5020).

The mechanical work W delivered can be deduced from FIG. 64 by calculating the area enclosed by 5020-5021-5022-5025-5020, where 5025 indicates the crossing between the perpendicular from 5023 (e.g., end of expansion) onto a parallel of the entropy axis at the temperature of the environment Te and subtract the area enclosed by 5025-5026-5028-5027-5025, (which indicates the loss of mechanical work imposed by the anisentropic throttling 5023 to 5024), as well as the area of the triangle 5020-5024-5026, which is the usable waste heat generated by this process. The subtracted area (rectangle 5025-5026-5028-5027 plus triangle 5020-5024-5026) may be equal to the triangle 5020-5023-5025. Hence, the work delivered by this thermodynamic process is equal to the area enclosed by the line 5020-5021-5022-5023-5020 and produces the result for the Otto process. It will be appreciated that the lines 5021-5022, 5020-5024 and the corresponding lines in the following FIGURE s may be exponential and/or not necessarily straight, but to simplify description straight lines are shown.

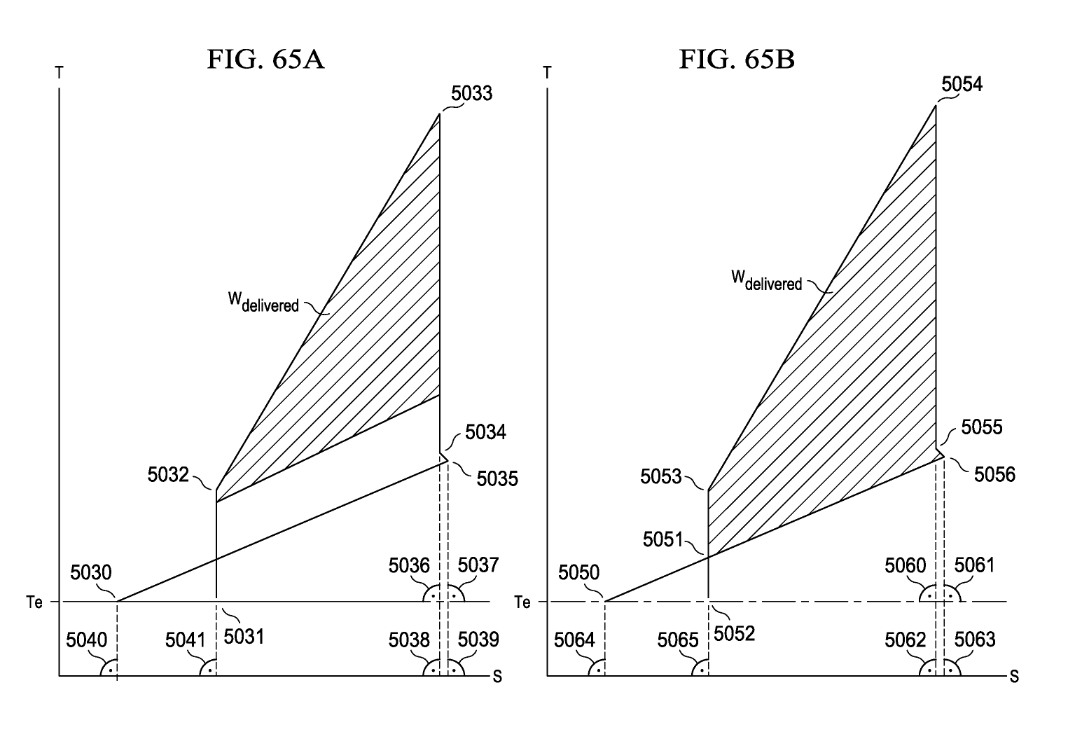

FIG. 65a shows an example of a thermodynamic process carried out in partial load for a conventional Otto engine with throttle in a theoretical S-T diagram. When the engine aspires fresh air, the throttle causes an isenthalpic state change which increases the entropy while basically maintaining the air temperature (state change 5030 to 5031). The gas pressure lowers, and the expansion work is converted into heat to maintain the air temperature. Now, the gas is compressed adiabatically (5031 to 5032) and the fuel is burnt (5032 to 5033) afterwards. The engine expands the hot combustion gas adiabatically (5033 to 5034) until the piston reaches again the bottom-dead-center position (point 5034). Now, the exhaust valve opens and the still hot gas is discharged into the environment (5034 to 5035). This discharge is, as indicated above with reference to FIG. 64, a throttling process so the entropy rises while the temperature decreases (here, the throttling is not isenthalpic). Finally, the hot exhaust gases are mixed with ambient air and the temperature decreases to ambient temperature (5035 to 5030). It will be appreciated that in low partial load conditions, the pressure at the end of adiabatic expansion (5033 to 5034) may be even below ambient pressure which may decrease the amount of mechanical work delivered even further. This causes a re-flow of ambient air or exhaust gas in the exhaust pipe upon exhaust valve opening and will increase, both, temperature and entropy of the working gas (i.e., the line 5034-5035 would be inclined upwardly.)

The mechanical work produced by this thermodynamic cycle is given by the area enclosed by 5031-5032-5033-5036-5031 minus the area of the triangle 5030-5035-5037, the usable waste heat from the engine, and the area of the rectangles 5036-5037-5039-5038, the loss because of the irreversible throttling upon discharge, and 5030-5031-5041-5040, the loss because of the irreversible throttling upon intake. The remaining area, W, i.e. work delivered, is depicted in FIG. 65a in thatched lines. As will be apparent from a comparison of FIG. 64 and FIG. 65a, the mechanical work delivered by the partial load condition is considerably lower than the mechanical work delivered in the full-load condition. It will be appreciated that both figures indicate the specific heat, energy, entropy, and mechanical work so that the relative size of the areas may be a measure for each corresponding efficiencies. In FIG. 65a, the mechanical work and, hence, a measure for the efficiency of the process in the unthrottled (full-load) case, would be given by the much larger area enclosed by 5031-5032-5033-5034-5031.

In case of deep partial load operation (e.g., when the expansion end pressure is below ambient pressure), re-compression occurs when the exhaust valve opens; consequently, the line 5035-5030 in FIG. 65a may be moved upward and point 30 is moved more left increasing further the area of the triangle 5030-5035-5037. Therefore, the delivered work and the efficiency are further decreased.

FIG. 65b shows an example of a thermodynamic process carried out in partial load for a Otto engine according to an illustrative embodiment in a theoretical S-T diagram. Also, heat energy, entropy, and mechanical work are indicated as illustrated values that are not limiting in any way. According to the illustrative embodiment, first, the fresh air to be aspired may be heated in the heat exchanger 5002. The corresponding state change is shown in FIG. 65b as 5050 to 5051. Now, the hot air may be expanded adiabatically in the expansion turbine 5003 (state change 5051 to 5052). The engine may aspire the warm and expanded air and compress it adiabatically (5052 to 5053). Now, the fuel may burn and increase temperature and pressure of the gas (5053 to 5054). The piston moves down and expands the gas adiabatically (5054 to 5055). Finally, the exhaust valve opens and discharges the hot gas (5055 to 5056). This exhaust gas may be used to heat the freshly aspired air which may be equivalent to waste heat recovery.

The mechanical work produced by this thermodynamic cycle is given by the area enclosed by 5052-5053-5054-5060-5052 minus the area enclosed by 5052-5051-5056-5061, the usable waste heat from the engine, and minus the area of the rectangle 5060-5061-5063-5062, the loss because of the irreversible throttling upon discharge. Contrary to the throttled cycle in FIG. 65a, no throttle loss, which would be the area of the rectangle 5050-5052-5065-5064, occurs. Additionally, the usable waste heat enclosed by 5050-5051-5052 may be used for heating the freshly aspired air. Ultimately, the area which must be deducted from 5052-5053-5054-5060-5052 may be much smaller than is the case for the process depicted in FIG. 65a. Consequently, efficiency may be improved.

The rising temperature of the freshly aspired air may be limited by the maximum compression temperature to avoid knocking. Elevating the heating temperature may cause a higher intake temperature of the piston engine and-because of the fixed compression ratio—a higher compression end temperature. Adding the temperature increase by combustion may also result in a combustion temperature that may be too high. In particular, cooling losses and the production of nitrogen oxides may be elevated. So, the heating temperature of the freshly aspired air in the heat exchanger may be limited. However, due to the lowered compression end pressure (i.e., less air mass has been taken into the cylinder), the compression end temperature may increase.

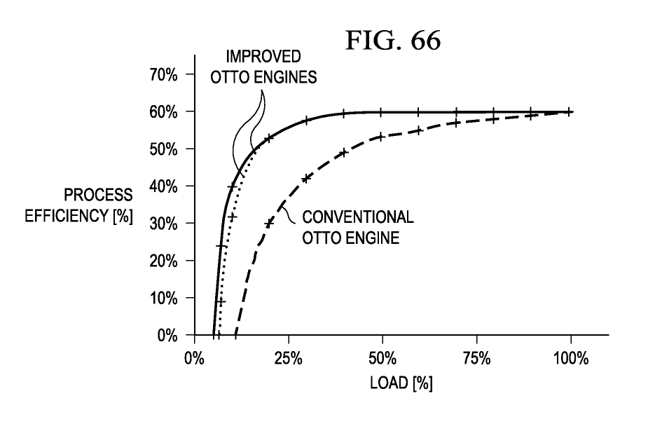

FIG. 66 shows a theoretical diagram for the process efficiency at various loads, and comparing conventional Otto engines and Otto engines according to an illustrative embodiment. Again, for the sake of this comparison, an ideal gas has been assumed. The parameters of temperature and pressure after the expansion device may be chosen in such a manner that the process efficiency is as high as possible for a given load while the compression temperature does not exceed a permitted, or pre-determined, limit. Here, the load may be defined as equal to the filling factor of the cylinder's engine (e.g., actual aspired air mass compared to the maximum air mass which may be aspired). As shown, the curve for the conventional Otto engine (dashed line in FIG. 66) is below the curve for an Otto engine according to the illustrative embodiment. In one embodiment, with a load below 11%, the efficiency may be zero or negative, i.e., the thermodynamic losses of this process are exceeding the produced mechanical work, thus, causing a complete stoppage of the engine. On the other hand, the process carried out by an engine according to the illustrative embodiment crosses the zero line at a load of 5% (with variable valve timing control-solid line in FIG. 66) and 6% (fixed valve timing-dotted line in FIG. 55).

It will be appreciated that, for very deep loads, an engine according to the illustrative embodiment may have some advantages (e.g., at 0% theoretical efficiency of the conventional Otto engine, the engine according to the illustrative embodiment still may show a theoretical efficiency of 36% and 42%, respectively). Therefore, vehicles equipped with an engine according to the illustrative embodiment may save in stop-and-go and city traffic or at low speeds (e.g., below ⅓rd of the maximum speed). The solid line labeled “improved Otto engines” may be for an Otto engine according to the illustrative embodiment which has an advanced valve control system for the exhaust valve, i.e., opening moment and duration of the exhaust valve may be adjusted. These systems may be useful for more powerful engines, as well. The lower dotted line also labeled “improved Otto engine” is for an Otto engine according to the illustrative embodiment without such an advanced valve control system. Even with a simple valve control having fixed control timing, the efficiency of an Otto engine according to the illustrative embodiment may be improved compared to conventional Otto engines.

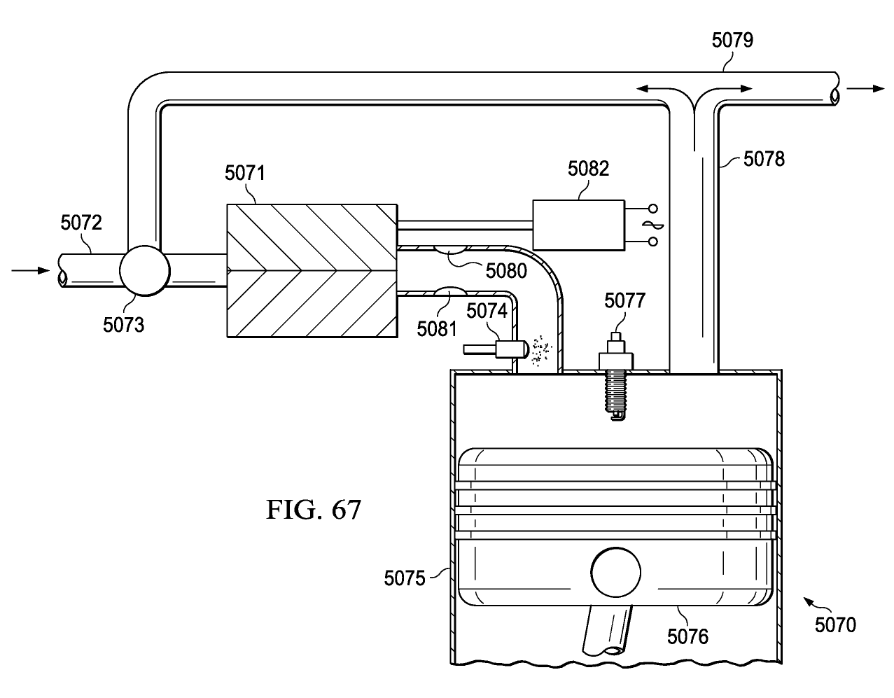

FIG. 67 shows an arrangement of a piston engine 5070 using exhaust gas recirculation (EGR) and a screw expander 5071 as mechanical expansion device according to an illustrative embodiment. The fresh air enters through an inlet 5072. The exhaust flap or valve system 5073 may mix this fresh air with a portion of hot exhaust gas. The mixing temperature may depend on the temperature of the exhaust gas (which may exceed 700° C.) and the amount of exhaust gas added. The mixture may be expanded in the screw expander 5071 to a pressure below ambient pressure. An injection nozzle 5074 injects the corresponding amount of fuel before the air-exhaust gas mixture enters the cylinder 5075 and is compressed by the piston 5076. The spark plug 5077 ignites the air-fuel mixture and combustion occurs. After expansion, the still hot combustion gas may be discharged into an outlet channel 5078. A part of the hot exhaust gas which is controlled by the exhaust flap or valve system 5073 may be channelled back to the inlet. The remaining part may be discharged into the environment through the outlet 5079.

As previously mentioned above, making adjustments based on the temperature and pressure measured after expansion by the screw expander 5071 may help increase efficiency. Therefore, a temperature sensor 5080 and a pressure sensor 5081 may be employed accordingly. A control device (not shown) may adjust the exhaust flap or valve system 5073 in such a manner an appropriate temperature and pressure of gas entering the cylinder may be achieved. In one example, the combustion temperature in the cylinder 5075 is limited, for example, combustion temperatures beyond a certain limit may increase the production of nitrogen oxides beyond appropriate limits.

In the described embodiment, the screw expander 5071 may drive a generator 5082 which in turn produces electricity to operate primary (e.g., oil pump, water pump etc.) or secondary (air condition, headlights, etc.) devices. Of course, the generated power may also be used in another manner (e.g., via direct coupling to the crankshaft).

In case of engines supercharged by a mechanical compressor, the compressor may be used in partial load to expand the aspired and heated air while the same compressor compresses the aspired air without previous heating in super charged mode. The heating of the aspired air may be achieved by a heat exchanger or by exhaust gas recirculation (EGR) or a combination thereof.

In conventional EGR systems, the amount of re-circulated exhaust gas in Otto engines rarely exceeds 25% of the whole gas flow. For that reason, the temperature of the air-exhaust gas mixture before the screw expander 5071 rarely reaches the level required for deep partial load operation at the highest possible process efficiency. Consequently, EGR may constitute an additional means to heat the freshly aspired air but may not replace the heat exchanger 5002 completely if high efficiency shall be attained in very low partial load operation. On the other hand, in cases where partial load operation mainly is carried out, e.g., down to ⅓rd of maximum load, an EGR system may be sufficient because in deep load operation the fresh air may be heated up by 200 K or more.

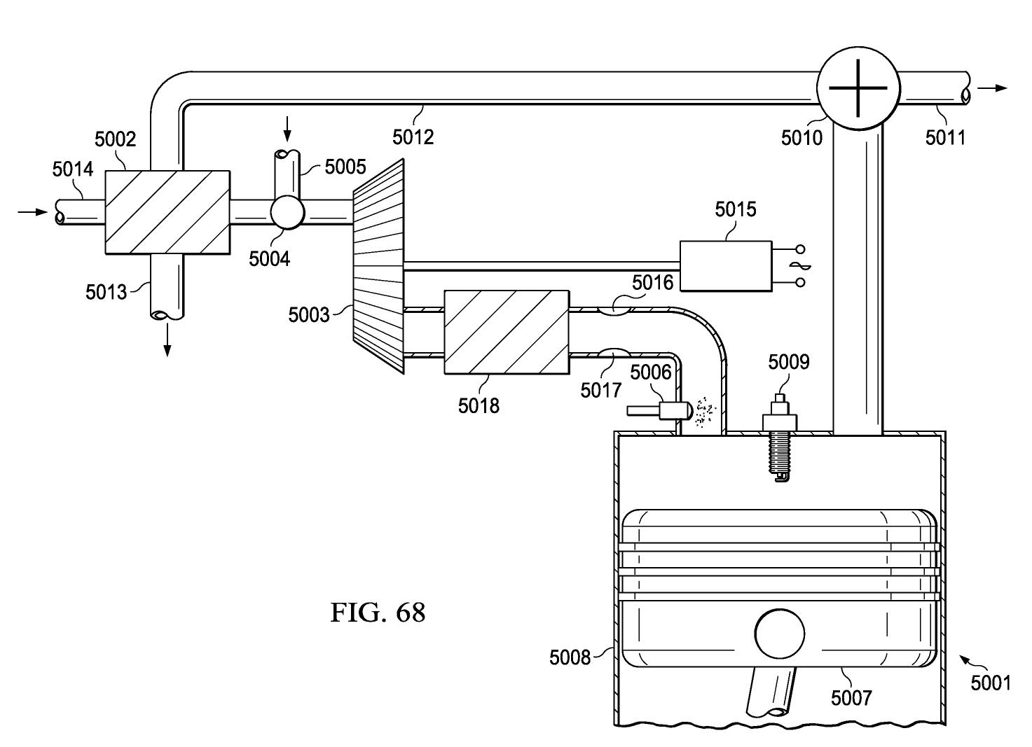

Historically, the average power of cars has increased consistently. A certain amount of power is advantageous, e.g., as to reduce overtake time, etc. Together with an improved (i.e., lowered) aerodynamic resistance, an engine is usually running in partially loaded condition, and may be used to run, or partially not run, other tasks or devices. For example, waste heat recovery may be carried out in partial load. FIG. 68 shows an example of such an engine which carries out waste heat recovery in partial load. Compared to the illustrative embodiment described with reference to FIG. 63, only a second heat exchanger 18, acting as a cooler, is added.

In partial load, the first heat exchanger 5002 may heat the freshly aspired air to a higher temperature than described above. The expansion turbine 3 may then expand this hot air to a pressure below the intake pressure. After expansion, the air temperature may still be too high. To achieve an appropriate intake temperature for the piston engine 5001 in partial load, the second heat exchanger-cooler 5018 cools the expanded air to a lower temperature (e.g., 40-60° C., etc.). The remaining structure of the engine and the corresponding performance may be equivalent to that described with reference to FIG. 63.

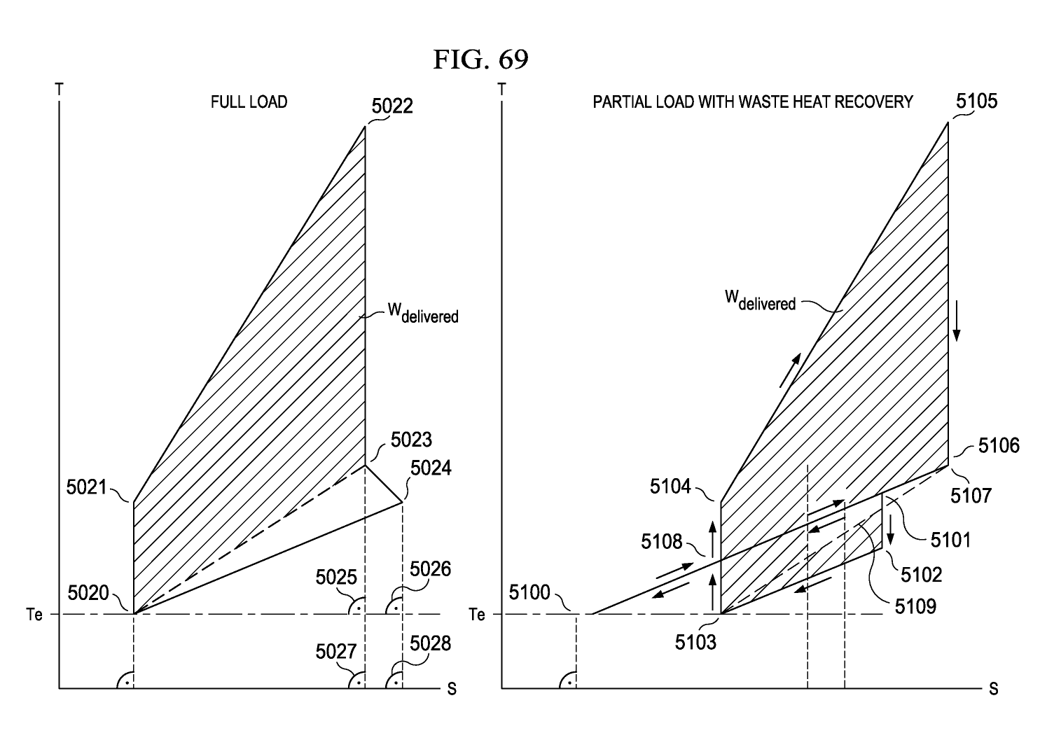

FIG. 69 shows an illustrative comparison of the theoretical thermodynamic cycle carried out by a naturally aspired Otto engine under full-load (on the left) versus the theoretical thermodynamic cycle carried out by an engine in partial load with waste heat recovery of the thermal energy contained in the hot exhaust gas in accordance with an illustrative engine as described herein.

In waste heat recovery mode in partial load, the fresh air may be aspired and heated in the first heat exchanger 5002 (state change 5100 to 5101 in FIG. 63). Now, the heated air enters the expansion device 5003 (an expansion turbine in case of this embodiment) and may be expanded to an appropriate pressure level depending on the actual load of the piston engine 5001 (5101 to 5102). After expansion and the accompanied temperature decrease, the air may be cooled by the second heat exchanger/cooler 5018 (5102 to 5103 in FIG. 63). Now, the cooled and de-pressurized air may be aspired by the piston engine 5001 after fuel has been injected by the nozzle 5006.

The piston 5007 may compress the aspired air (5103 to 5104) and, then, the spark plug 5009 may ignite the air-fuel mixture to start combustion of the fuel. Consequently, the temperature rises (5104 to 5105). Now, the piston 5007 moves down and expands the hot flue gas (5105 to 5106) until it reaches a bottom-dead-center position. The exhaust valve(s) (not shown) open and some throttling may occur into the exhaust pipe (5106 to 5107).

An appropriate share of the hot exhaust gas may be returned through the re-circulation pipe 5012 by the valve 5010 to the first heat exchanger 5002. The hot re-circulated exhaust gas heats the freshly aspired air and cools down (state change 5107 to 5100). This means that the thermal energy of the hot exhaust gas may be used to heat the freshly aspired air. In one example, no fuel is required for this. Together, the part of the compression stroke which is equivalent to the state change 5103 to 5108 (5108 is the point in FIG. 69 where the compression line crosses the heating line of the freshly aspired air), the heating process 5108-5101 (which is part of the complete heating process 100 to 101 in the first heat exchanger 5002), and the expansion process 5101 to 5102 carried out by the expansion turbine 5003 and the cooling 5102 to 5103 in the second heat exchanger-cooler 5018, complete the thermodynamic cycle. This cycle transforms at least part of the thermal energy contained in the hot exhaust gas into useful mechanical, or by means of a generator 5015, electrical energy.

It will be appreciated, that the piston engine 5001 itself may form part of this waste heat recovery engine. In one example, no additional compressor device may be required.

The waste heat recovery may be carried out in partial load. The illustrative embodiments may significantly reduce fuel consumption when a car engine is running in deep partial load, as well as in other modes.

As shown in FIG. 69, the process efficiency of the illustrative embodiment may not only maintained in partial load but overall process efficiency may be increased. In contrast, shown in FIG. 66, for Otto engines, efficiency decreases under partial load.

Thus, in one embodiment, in partial load operation, the aspired fresh air is first warmed up by the hot exhaust gases of the engine in a heat exchanger and subsequently expanded in an expansion device where it renders mechanical power before the expanded fresh air is delivered to the piston engine. In one example, the amount of fresh air and hot exhaust gas passing through the heat exchanger is controlled by flaps or valves to adjust the temperature of the air before entering the expansion device according to load and revolution speed of the engine. Exhaust gas recirculation (EGR) may be used instead of or in addition to, the heat exchanger. Part of the hot exhaust gas may be mixed with the freshly aspired air to increase the temperature before this air-exhaust gas mixture is expanded in the expansion device. A heat exchanger may be employed, either before or after mixing in order to increase the temperature of the air-exhaust gas mixture.

In one example, the expansion device may also be a free running mechanical or turbo expander which is coupled to a generator for generating electricity. Free running means that the expander is not coupled to the piston engine's crankshaft or synchronized with it. This allows independent flow control in the expansion device and, hence, independent control of the expansion pressure after the device such that one or more process parameters (e.g., temperature, pressure, etc.) may be adjusted in order to achieve the highest overall efficiency of piston engine and expansion device.

In another example, an additional heat exchanger acting as a cooler may be installed after the free running expansion device. The first heat exchanger may heat the aspired air to a temperature above the temperature of the aforementioned embodiments, e.g., near to the exhaust gas temperature. In this case, the combination of the first and second heat exchanger, as well as the expansion device, may form part of a waste heat recovery means which, together with the compression of the piston, is able to make use of the hot exhaust gases at least in partial load. This may decrease fuel consumption without the need of an external waste heat recovery engine.

The power of a piston engine may depend on the air mass flow through the engine and the amount of fuel burnt. The arrangement, according to an illustrative embodiments, decreases the mass flow of the aspired fresh air since the expansion device expands the preliminarily warmed up fresh air. Consequently, the piston of the engine receives, in the course of the intake stroke, warm air (or a warm air-fuel mixture) at lower pressure than the environment pressure. In conventional Otto engines with a throttle, this lower pressure may be achieved by isenthalpic and substantially isothermal throttling. However, no substantial throttling occurs in the illustrative embodiments. Instead, a reversible expansion may be carried out by delivering power through the expansion device. The preliminary heating increases the power delivered and helps assure that the expanded air enters the intake system of the cylinder at a sufficiently high temperature.

Generally, for a given load, at least one heating temperature and expansion pressure combination exits that ensures a optimum efficiency of a piston engine coupled with an expansion device. However, each combination depends on several characteristics as, for example, ambient pressure and temperature, the actual design and embodiment of the engine and any auxiliary devices, etc. Therefore, as is the case for traditional engines, testing may be performed to determine the optimal parameters (e.g., temperature, pressure) for a given load. From these parameters, a control means (e.g., controller) of the engine may determine the optimum pre-heating temperature and pre-expansion pressure as the engine operates under a given load. The control means may be operable to actuate actuators or other suitable devices in order to achieve a desired temperature and pressure for a given load to maintain engine operation at a suitable efficiency and performance.

Today's mobile engine applications (e.g., cars and trucks), as well as other engine applications, include a large number of electrical devices which may be supplied with the additional electricity generated by the expansion device. Examples, include, but are not limited to, air conditioning, headlights, auxiliary equipment of the engine, cooling water pump, oil pump, etc. Hybrid cars may benefit from the illustrative embodiment(s), because the engine frequently runs in partial load. The generated electricity by the expansion device may load the large battery which is characterizing this car type.

The external expansion device may be directly or indirectly coupled to the crankshaft or powertrain. Additionally, if the air temperature after the expansion is too high for delivery to the piston engine, an optional cooler may be employed to reduce the air temperature further while substantially maintaining its pressure.

In one non-limiting example, a method for operating a piston engine in partial load, according to an illustrative embodiment, may include the steps of: (1) heating the aspired fresh air by means of the hot exhaust gases through a heat exchanger or direct mixing, (2) expanding the heated air in an expansion device, and (3) delivering the expanded air to the intake system of the piston engine.

Heating the fresh air and expanding it before delivery to the intake system of the piston engine may help maintain the efficiency of the piston engine at low loads. The illustrative embodiments may also be implemented as an improvement to existing piston engines.

Diesel engines may benefit from the illustrative embodiments. Even in partial load, the expansion end pressure (the pressure of the hot gases in the engine's cylinder upon discharge) in diesel engines surpasses ambient pressure and may be used for further expansion. Contrary to turbo charger systems where this high pressured gas is used to drive the compressor turbine, the illustrative embodiments may provide pre-heating and pre-expansion before the air enters the intake system of the piston engine and, thus, the expansion end pressure of the piston engine may be reduced. This may mean a greater expansion of flue gases and, hence, higher efficiency. By reducing the air flow also in diesel engines with one or more devices according to the illustrative embodiments, more fuel per air unit may be burnt and the average combustion temperature may rise. This may mean another increase in efficiency. Therefore, the illustrative embodiments show benefits also for diesel engines in partial load, as well as, Otto engines.

In one example, by using the hot exhaust gases for heating of the fresh air, no additional fuel may be required for increasing the air temperature.

While the foregoing description and drawings represent many embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. For example, it should be appreciated that while the above described systems and methods are directed to employing techniques to make more efficient piston engine systems, the above described systems and method may be used jet engines, gas turbines, etc. The presently disclosed embodiments are therefore to be considered in all respects as illustrative and not restrictive, the scope of the invention being indicated by the appended claims, and not limited to the foregoing description.

According to an illustrative embodiment, a reciprocating piston engine system includes: a cylinder having: an inner chamber, and an exhaust port in fluid communication with the inner chamber; an exhaust collection pipe in fluid communication with the exhaust port of the cylinder, the exhaust collection pipe including an inner surface and an interior volume, wherein the interior volume is substantially maintained at a first pressure; and a piston reciprocatingly disposed in the inner chamber of the cylinder, the piston operable to cycle through a power cycle; wherein the power cycle includes a combustion stroke, the combustion stroke having a start and an end; wherein an exhaust gas in the inner chamber of the cylinder has a second pressure at the end of the combustion stroke; and wherein the first pressure is substantially equal to the second pressure.

According to an illustrative embodiment, a method for operating an internal combustion engine, the internal combustion engine includes a cylinder having an inner chamber, an intake port in fluid communication with the inner chamber, an intake valve operable to open and close the intake port, an exhaust port in fluid communication with the inner chamber, and an exhaust valve operable to open and close the exhaust port, the method includes the steps of: moving the intake valve to an open position to open the intake port; introducing a working gas to the inner chamber through the intake port; moving the intake valve to a closed position to close the intake port; compressing the working gas to produce a compressed working gas; combusting the compressed working gas to produce an exhaust gas; moving the exhaust valve to an open position to open the exhaust port; exhausting the exhaust gas through the exhaust port; and moving the exhaust valve to a closed position prior to a subsequent movement of the intake valve to the intake valve open position.

According to an illustrative embodiment, a cylinder head for use with an internal combustion engine, the cylinder head includes: an exhaust channel having an inner surface; and an exhaust isolation member located in the exhaust channel.

According to an illustrative embodiment, an reciprocating piston engine system includes: a combustion chamber for receiving a working gas and combusting the working gas to produce an exhaust gas at a first pressure; and an exhaust collection pipe in fluid communication with the combustion chamber, the exhaust collection pipe operable to receive the exhaust gas, wherein the exhaust collection pipe is maintained at a second pressure, and wherein the first pressure is substantially equal to the second pressure.

According to an illustrative embodiment, a reciprocating piston engine system includes: a compressor for receiving a working gas, the compressor operable to compress the working gas to produce a compressed working gas; a vaporizable fluid delivery device associated with the compressor for delivering a vaporizable liquid to the working gas; a recuperator in fluid communication with the compressor, the recuperator operable to provide thermal energy to the compressed working gas to produce a heated, compressed working gas; a combustion chamber in fluid communication with the recuperator, the combustion chamber operable to combust the heated, compressed working gas to produce an exhaust gas; and a first expander in fluid communication with the combustion chamber and the recuperator, the expander operable to expand the exhaust gas to produce an expanded exhaust gas, wherein the expanded exhaust gas provides thermal energy to the recuperator.

According to an illustrative embodiment, a reciprocating piston engine system includes: a first compressor for receiving a working gas, the first compressor operable to compress the working gas to produce a compressed working gas; a first recuperator in fluid communication with the first compressor, the first recuperator operable to provide thermal energy to the compressed working gas to produce a heated, compressed working gas; a second compressor in fluid communication with the first recuperator, the second compressor operable to compress the heated, compressed working gas to produce a heated, twice-compressed working gas; a vaporizable fluid delivery device associated with the second compressor for delivering a vaporizable liquid to the heated, twice-compressed working gas; a second recuperator in fluid communication with the second compressor, the second recuperator operable to provide thermal energy to the heated, twice-compressed working gas to produce a twice-heated, twice-compressed working gas; a combustion chamber in fluid communication with the second recuperator, the combustion chamber operable to combust the twice-heated, twice-compressed working gas to produce an exhaust gas; and a first expander in fluid communication with the combustion chamber, the first recuperator and the second recuperator, the first expander operable to expand the exhaust gas to produce an expanded exhaust gas, wherein the expanded exhaust gas provides thermal energy to at least one of the first and second recuperators.

According to an illustrative embodiment, a reciprocating piston engine system includes: a compressor for receiving a working gas, the compressor operable to compress the working gas to produce a compressed working gas; a vaporizable fluid delivery device associated with the compressor for delivering a vaporizable liquid to the working gas; a recuperator in fluid communication with the compressor, the recuperator operable to provide thermal energy to the compressed working gas to produce a heated, compressed working gas; a first expander in fluid communication with the recuperator, the first expander operable expand the heated, compressed working gas to produce a heated, expanded working gas; a combustion chamber in fluid communication with the first expander, the combustion chamber operable to combust the heated, expanded working gas to produce an exhaust gas; and a second expander in fluid communication with the combustion chamber and the recuperator, the expander operable to expand the exhaust gas to produce an expanded exhaust gas, wherein the expanded exhaust gas provides thermal energy to the recuperator.

According to an illustrative embodiment, a reciprocating piston engine system includes: a compressor for receiving a working gas, the compressor operable to compress the working gas to produce a compressed working gas; a vaporizable fluid delivery device associated with the compressor for delivering a vaporizable liquid to the working gas; a recuperator in fluid communication with the compressor, the recuperator operable to provide thermal energy to the compressed working gas to produce a heated, compressed working gas; a first expander in fluid communication with the recuperator, the first expander operable expand the heated, compressed working gas to produce a heated, expanded working gas; a combustion chamber in fluid communication with the first expander and the recuperator, the combustion chamber operable to combust the heated, expanded working gas to produce an exhaust gas, wherein the exhaust gas provides thermal energy to the recuperator; and a second expander in fluid communication with the recuperator, the expander operable to expand the exhaust gas to produce an expanded exhaust gas.

According to an illustrative embodiment, a reciprocating piston engine system includes: a compressor for receiving a working gas, the compressor operable to compress the working gas to produce a compressed working gas; a vaporizable fluid delivery device associated with the compressor for delivering a vaporizable liquid to the working gas; a recuperator in fluid communication with the compressor, the recuperator operable to provide thermal energy to the compressed working gas to produce a heated, compressed working gas; a combustion chamber in fluid communication with the recuperator, the combustion chamber operable to combust the heated, compressed working gas to produce an exhaust gas, wherein the exhaust gas provides thermal energy to the recuperator; and an expander in fluid communication with the recuperator, the expander operable to expand the exhaust gas to produce an expanded exhaust gas.

According to an illustrative embodiment, a method for operating an internal combustion engine, the internal combustion engine includes a cylinder having an inner chamber, an intake port in fluid communication with the inner chamber, an intake valve operable to open and close the intake port, and a piston reciprocatingly disposed in the inner chamber of the cylinder, the method includes the steps of: heating a working gas to produce a heated working gas; moving the piston from a top-dead-center position towards a bottom-dead-center position; moving the intake valve to an open position; introducing the heated working gas through the intake port to the inner chamber; and moving the intake valve to a closed position prior to the piston reaching the bottom-dead-center position.

According to an illustrative embodiment, a reciprocating piston engine system includes: a compressor for receiving a working gas, the compressor operable to compress the working gas to produce a compressed working gas; a tank in fluid communication with the compressor, the tank operable to contain a vaporizable fluid and substantially saturate the working gas with a vapor to produce a saturated working gas; a recuperator in fluid communication with the tank, the recuperator operable to provide thermal energy to the saturated working gas to produce a heated, saturated working gas; a combustion chamber in fluid communication with the recuperator, the combustion chamber operable to combust the heated, saturated working gas to produce an exhaust gas; and a first expander in fluid communication with the combustion chamber and the recuperator, the expander operable to expand the exhaust gas to produce an expanded exhaust gas, wherein the expanded exhaust gas provides thermal energy to the recuperator.

According to an illustrative embodiment, a method for operating a reciprocating piston engine includes the steps of: compressing a working gas in a compression stroke; and introducing a vaporizable liquid to the working gas during at least a portion of the compression stroke.

According to an illustrative embodiment, a reciprocating piston engine system includes: a compressor for receiving a working gas, the compressor operable to compress the working gas to produce a compressed working gas; a first vaporizable fluid delivery device associated with the compressor for delivering a vaporizable liquid to the working gas; a recuperator in fluid communication with the compressor, the recuperator operable to provide thermal energy to the compressed working gas to produce a heated, compressed working gas; a first expander in fluid communication with the recuperator, the first expander operable expand the heated, compressed working gas to produce a heated, expanded working gas; a combustion chamber in fluid communication with the first expander and the recuperator, the combustion chamber operable to combust the heated, expanded working gas to produce an exhaust gas, wherein the exhaust gas provides thermal energy to the recuperator; a second vaporizable fluid delivery device associated with the combustion chamber for delivering a vaporizable liquid to the heated, expanded working gas prior to the combustion thereof; and a second expander in fluid communication with the recuperator, the expander operable to expand the exhaust gas to produce an expanded exhaust gas.

According to an illustrative embodiment, a reciprocating piston engine system includes: a compressor for receiving a working gas, the compressor operable to compress the working gas to produce a compressed working gas; a first vaporizable fluid delivery device associated with the compressor for delivering a vaporizable liquid to the working gas; a recuperator in fluid communication with the compressor, the recuperator operable to provide thermal energy to the compressed working gas to produce a heated, compressed working gas; a combustion chamber in fluid communication with the recuperator, the combustion chamber operable to combust the heated, compressed working gas to produce an exhaust gas, a second vaporizable fluid delivery device associated with the combustion chamber for delivering a vaporizable liquid to the heated, compressed working gas prior to the combustion thereof; and an expander in fluid communication with the combustion chamber and recuperator, the expander operable to expand the exhaust gas to produce an expanded exhaust gas, wherein the expanded exhaust gas provides thermal energy to the recuperator.

According to an illustrative embodiment, a reciprocating piston engine system includes: a cylinder having: an inner chamber having an upper portion; a piston reciprocatingly disposed within the inner chamber and movable between a top-dead-center position and a bottom-dead-center position, the piston having a top face; a combustion space defined by the top face of the piston when the piston is in the top-dead-center position and the upper portion of the inner chamber of the cylinder; a first insulating layer disposed on the top face of the piston; and a second insulating layer disposed on the upper portion of the cylinder inner chamber.

According to an illustrative embodiment, an engine system includes: a crankshaft; a first reciprocating piston engine coupled to the crankshaft, the first reciprocating piston engine operable to combust a fuel to produce mechanical power and an exhaust gas having thermal energy, wherein the produced mechanical power is delivered to the crankshaft; a heat exchanger in fluid communication with the first reciprocating piston engine and operable to extract at least a portion of thermal energy from the exhaust gas; and a second reciprocating piston engine in fluid communication with the heat exchanger and coupled to the crankshaft, the second reciprocating piston engine operable to be powered by the extracted thermal energy to produce mechanical power, wherein the produced mechanical power is delivered to the crankshaft.

According to an illustrative embodiment, a method for cooling an exhaust gas in a reciprocating piston engine, the method includes the steps of: providing a working gas having a first temperature; channelling a first portion of the working gas to a bypass channel; combusting a second portion of the working gas to produce an exhaust gas having a second temperature; and combining the exhaust gas and the first portion of the working gas to produce a unified gas having a third temperature, wherein the third temperature is between the first and second temperatures.

According to an illustrative embodiment, a method of recirculating exhaust gases, the method includes the steps of: providing an first oxygen enriched gas; combusting the oxygen enriched gas to produce an exhaust gas; compressing a portion of the exhaust gas to produce a compressed exhaust gas; mixing the compressed exhaust gas with a second oxygen enriched gas to produce a mixed gas; and combusting the mixed gas to produce an exhaust gas.

According to an illustrative embodiment, an engine system includes: a multi-stage intercooled compressor for receiving a working gas, the compressor operable to compress the working gas to produce a compressed working gas; a recuperator in fluid communication with the compressor, the recuperator operable to provide thermal energy to the compressed working gas to produce a heated, compressed working gas; an insulated combustion chamber in fluid communication with the recuperator, the combustion chamber operable to combust the heated, compressed working gas to produce an exhaust gas; an insulated exhaust collection pipe in fluid communication with the insulated combustion chamber and operable to receive the exhaust gas; and an expander in fluid communication with the insulated exhaust collection pipe and the recuperator, the expander operable to expand the exhaust gas to produce an expanded exhaust gas, wherein the expanded exhaust gas provides thermal energy to the recuperator.

According to an illustrative embodiment, an engine system includes: a compressor for receiving a working gas, the compressor operable to compress the working gas to produce a compressed working gas; a vaporizable fluid delivery device associated with the compressor for delivering a vaporizable liquid to the working gas; a recuperator in fluid communication with the compressor, the recuperator operable to provide thermal energy to the compressed working gas to produce a heated, compressed working gas; an insulated combustion chamber in fluid communication with the expander, the combustion chamber operable to combust the heated, compressed working gas to produce an exhaust gas, and an expander in fluid communication with the combustion chamber and recuperator, the expander operable to expand the exhaust gas to produce an expanded exhaust gas, wherein the expanded exhaust gas provides thermal energy to the recuperator.

1. A reciprocating piston engine system comprising:
a cylinder comprising:
an inner chamber, and
an exhaust port in fluid communication with the inner chamber;
an exhaust collection pipe in fluid communication with the exhaust port of the cylinder, the exhaust collection pipe including an inner surface and an interior volume, wherein the interior volume is substantially maintained at a first pressure; and
a piston reciprocatingly disposed in the inner chamber of the cylinder, the piston operable to cycle through a power cycle; wherein the power cycle includes a combustion stroke, the combustion stroke having a start and an end; wherein an exhaust gas in the inner chamber of the cylinder has a second pressure at the end of the combustion stroke; and wherein the first pressure is substantially equal to the second pressure.

2. The reciprocating piston engine system of claim 1 further comprising an exhaust valve, wherein the exhaust valve is movable to open and close the exhaust port.

3. The reciprocating piston engine system of claim 2 further comprising a solenoid for moving the exhaust valve between an open and closed position.

4. The reciprocating piston engine system of claim 1 further comprising expansion turbine in fluid communication with the exhaust collection pipe, the expansion turbine operable to receive the exhaust gas and expand the exhaust gas to produce an expanded exhaust gas at a third pressure, and wherein the third pressure is less than the second pressure.

5. The reciprocating piston engine system of claim 1 further comprising an exhaust isolation member located in the exhaust collection pipe.

6. The reciprocating piston engine system of claim 5 wherein the exhaust isolation member comprises an isolation chamber formed in the exhaust collection pipe.

7. The reciprocating piston engine system of claim 6 wherein the isolation chamber is filled with a fluid.

8. The reciprocating piston engine system of claim 5 wherein the exhaust isolation member comprises a reflective material for minimizing radiation losses.

9. The reciprocating piston engine system of claim 5 wherein the exhaust isolation member comprises a material having low thermal conductivity.

10. The reciprocating piston engine system of claim 9 wherein the material is a ceramic.

11. The reciprocating piston engine system of claim 5 wherein the exhaust isolation member comprises an insert.

12. The reciprocating piston engine system of claim 11 wherein the insert is polished.

13. The reciprocating piston engine system of claim 11 wherein the insert is offset from the exhaust collection pipe inner surface so as to define a cavity therebetween.

14. A method for operating an internal combustion engine, the internal combustion engine comprising a cylinder having an inner chamber, an intake port in fluid communication with the inner chamber, an intake valve operable to open and close the intake port, an exhaust port in fluid communication with the inner chamber, and an exhaust valve operable to open and close the exhaust port, the method comprising the steps of:
moving the intake valve to an open position to open the intake port;
introducing a working gas to the inner chamber through the intake port;
moving the intake valve to a closed position to close the intake port;
compressing the working gas to produce a compressed working gas;
combusting the compressed working gas to produce an exhaust gas;
moving the exhaust valve to an open position to open the exhaust port;
exhausting the exhaust gas through the exhaust port; and
moving the exhaust valve to a closed position prior to a subsequent movement of the intake valve to the intake valve open position.

15. The method of claim 14 wherein at least one of the intake valve and exhaust valve are movable by a solenoid.

16. A method for operating a piston engine, the method comprising the steps of:
combusting a working gas to produce an exhaust gas having a first pressure; and
exhausting the exhaust gas into an exhaust gas flow path having a second pressure, wherein the second pressure is substantially equal to the first pressure.

17. The method of claim 16 further comprising expanding the exhaust gas to produce an expanded exhaust gas, wherein the expanded exhaust has gas a third pressure, and wherein the third pressure is less than the second pressure.

18. A cylinder head for use with an internal combustion engine, the cylinder head comprising:
an exhaust channel having an inner surface; and
an exhaust isolation member located in the exhaust channel.

19. The reciprocating piston engine of claim 18 wherein the exhaust isolation member comprises an isolation chamber formed in the exhaust channel.

20. The reciprocating piston engine of claim 19 wherein the isolation chamber is filled with a fluid.

21. The reciprocating piston engine of claim 18 wherein the exhaust isolation member comprises a reflective material for minimizing radiation losses.

22. The reciprocating piston engine of claim 18 wherein the exhaust isolation member comprises a material having low thermal conductivity.

23. The reciprocating piston engine of claim 22 wherein the material is a ceramic.

24. The reciprocating piston engine of claim 18 wherein the exhaust isolation member comprises an insert.

25. The reciprocating piston engine of claim 24 wherein the insert is polished.

26. The reciprocating piston engine of claim 24 wherein the insert is offset from the exhaust channel inner surface so as to define a cavity therebetween.

27. An reciprocating piston engine system comprising:
a combustion chamber for receiving a working gas and combusting the working gas to produce an exhaust gas at a first pressure; and
an exhaust collection pipe in fluid communication with the combustion chamber, the exhaust collection pipe operable to receive the exhaust gas, wherein the exhaust collection pipe is maintained at a second pressure, and wherein the first pressure is substantially equal to the second pressure.

28. The reciprocating piston engine system of claim 27 further comprising an expansion turbine in fluid communication with the exhaust collection pipe, the expansion turbine operable to receive the exhaust gas and expand the exhaust gas to produce an expanded exhaust gas at a third pressure, wherein the third pressure is less than the second pressure.

29. The reciprocating piston engine system of claim 28 wherein the expansion turbine is configured to develop energy from the received exhaust gas and deliver the energy to a generator.

30. The reciprocating piston engine system of claim 28 wherein the expansion turbine is configured to develop energy from the received exhaust gas and deliver the energy to an engine crankshaft.

31. A reciprocating piston engine system comprising:
a compressor for receiving a working gas, the compressor operable to compress the working gas to produce a compressed working gas;
a vaporizable fluid delivery device associated with the compressor for delivering a vaporizable liquid to the working gas;
a recuperator in fluid communication with the compressor, the recuperator operable to provide thermal energy to the compressed working gas to produce a heated, compressed working gas;
a combustion chamber in fluid communication with the recuperator, the combustion chamber operable to combust the heated, compressed working gas to produce an exhaust gas; and
a first expander in fluid communication with the combustion chamber and the recuperator, the expander operable to expand the exhaust gas to produce an expanded exhaust gas, wherein the expanded exhaust gas provides thermal energy to the recuperator.

32. The reciprocating piston engine system of claim 31, wherein the heated, compressed working gas has a first temperature and a first pressure, wherein the combustion chamber pre-expands the heated, compressed working gas such that the heated, compressed working gas has a second temperature and a second pressure prior to combustion, wherein the second temperature is less than the first temperature, and wherein the second pressure is less than the first pressure.

33. The reciprocating piston engine system of claim 31 further comprising a second expander in fluid communication with the recuperator, the second expander operable to receive the expanded exhaust gas from the recuperator and expand the expanded exhaust gas to produce a twice-expanded exhaust gas.

34. The reciprocating piston engine system of claim 31 further comprising a pre-compressor in fluid communication with the compressor, the pre-compressor operable to receive a fresh working gas and compress the fresh working gas to produce the working gas.

35. The engine system of claim 31 wherein the compressor and the vaporizable liquid delivery device are operable to saturate the compressed working gas with vapor.

36. A reciprocating piston engine system comprising:
a first compressor for receiving a working gas, the first compressor operable to compress the working gas to produce a compressed working gas;
a first recuperator in fluid communication with the first compressor, the first recuperator operable to provide thermal energy to the compressed working gas to produce a heated, compressed working gas;
a second compressor in fluid communication with the first recuperator, the second compressor operable to compress the heated, compressed working gas to produce a heated, twice-compressed working gas;
a vaporizable fluid delivery device associated with the second compressor for delivering a vaporizable liquid to the heated, twice-compressed working gas;
a second recuperator in fluid communication with the second compressor, the second recuperator operable to provide thermal energy to the heated, twice-compressed working gas to produce a twice-heated, twice-compressed working gas;
a combustion chamber in fluid communication with the second recuperator, the combustion chamber operable to combust the twice-heated, twice-compressed working gas to produce an exhaust gas; and
a first expander in fluid communication with the combustion chamber, the first recuperator and the second recuperator, the first expander operable to expand the exhaust gas to produce an expanded exhaust gas, wherein the expanded exhaust gas provides thermal energy to at least one of the first and second recuperators.

37. The reciprocating piston engine system of claim 36 further comprising a second expander in fluid communication with the second recuperator, the second expander operable to receive the expanded exhaust gas from the second recuperator and expand the expanded exhaust gas to produce a twice-expanded exhaust gas.

38. The reciprocating piston engine system of claim 36, wherein the twice-heated, twice-compressed working gas has a first temperature and a first pressure, wherein the combustion chamber pre-expands the twice-heated, twice-compressed working gas such that the twice-heated, twice-compressed working gas has a second temperature and a second pressure prior to combustion, wherein the second temperature is less than the first temperature, and wherein the second pressure is less than the first pressure.

39. The engine system of claim 36 wherein the second compressor and the vaporizable liquid delivery device are operable to saturate the compressed working gas with vapor.

40. A reciprocating piston engine system comprising:
a compressor for receiving a working gas, the compressor operable to compress the working gas to produce a compressed working gas;
a vaporizable fluid delivery device associated with the compressor for delivering a vaporizable liquid to the working gas;
a recuperator in fluid communication with the compressor, the recuperator operable to provide thermal energy to the compressed working gas to produce a heated, compressed working gas;
a first expander in fluid communication with the recuperator, the first expander operable expand the heated, compressed working gas to produce a heated, expanded working gas;
a combustion chamber in fluid communication with the first expander, the combustion chamber operable to combust the heated, expanded working gas to produce an exhaust gas; and
a second expander in fluid communication with the combustion chamber and the recuperator, the expander operable to expand the exhaust gas to produce an expanded exhaust gas, wherein the expanded exhaust gas provides thermal energy to the recuperator.

41. The engine system of claim 40 wherein the compressor and the vaporizable liquid delivery device are operable to saturate the compressed working gas with vapor.

42. A reciprocating piston engine system comprising:
a compressor for receiving a working gas, the compressor operable to compress the working gas to produce a compressed working gas;
a vaporizable fluid delivery device associated with the compressor for delivering a vaporizable liquid to the working gas;
a recuperator in fluid communication with the compressor, the recuperator operable to provide thermal energy to the compressed working gas to produce a heated, compressed working gas;
a first expander in fluid communication with the recuperator, the first expander operable expand the heated, compressed working gas to produce a heated, expanded working gas;
a combustion chamber in fluid communication with the first expander and the recuperator, the combustion chamber operable to combust the heated, expanded working gas to produce an exhaust gas, wherein the exhaust gas provides thermal energy to the recuperator; and
a second expander in fluid communication with the recuperator, the expander operable to expand the exhaust gas to produce an expanded exhaust gas.

43. The engine system of claim 42 wherein the compressor and the vaporizable liquid delivery device are operable to saturate the compressed working gas with vapor.

44. A reciprocating piston engine system comprising:
a compressor for receiving a working gas, the compressor operable to compress the working gas to produce a compressed working gas;
a vaporizable fluid delivery device associated with the compressor for delivering a vaporizable liquid to the working gas;
a recuperator in fluid communication with the compressor, the recuperator operable to provide thermal energy to the compressed working gas to produce a heated, compressed working gas;
a combustion chamber in fluid communication with the recuperator, the combustion chamber operable to combust the heated, compressed working gas to produce an exhaust gas, wherein the exhaust gas provides thermal energy to the recuperator; and
an expander in fluid communication with the recuperator, the expander operable to expand the exhaust gas to produce an expanded exhaust gas.

45. The reciprocating piston engine system of claim 44, wherein the heated, compressed working gas has a first temperature and a first pressure, wherein the combustion chamber pre-expands the heated, compressed working gas such that the heated, compressed working gas has a second temperature and a second pressure prior to combustion, wherein the second temperature is less than the first temperature, and wherein the second pressure is less than the first pressure.

46. The engine system of claim 44, wherein the compressor and the vaporizable liquid delivery device are operable to saturate the compressed working gas with vapor.
